(19) United States
(12) Patent Application Publication
(10) Pub. No.: US 2019/0340714 A1
(43) Pub. Date: Nov. 7, 2019

(54) System To Facilitate Idea Development

(71) Applicant: Jethro Bennett, Liverpool (GB)

(72) Inventor: Jethro Bennett, Liverpool (GB)

(21) Appl. No.: 16/402,208

(22) Filed: May 2, 2019

(30) Foreign Application Priority Data
May 2, 2018 (GB) 1807196.9
May 2, 2018 (GB) 1807197.7
May 2, 2018 (GB) 1807198.5
May 2, 2018 (GB) 1807199.3

(51) Int. Cl. G06Q 50/18; G06Q 10/06; G06Q 30/08; G06Q 30/02

(52) U.S. Cl. CPC G06Q 50/184; G06Q 30/0201; G06Q 30/08; G06Q 10/0639

(57) ABSTRACT

A platform to facilitate idea or project development comprises: storing information relating to and/or providing at least one of: product development providers; patent providers; product launch facilitators. In various embodiments, there may be advanced video disclosure solutions, to facilitate presentation of the project. In various embodiments, success rates of various providers may be displayed to the or any project creator.

### REFERENCES TO RELATED APPLICATIONS

This application claims priority to all of the following British Patent Applications: [GB] numbers 1807196.9 (filed on May 2, 2018); 1807197.7 (filed on May 2, 2018); 1807198.5 (filed on May 2, 2018); and 1807199.3 (filed on May 2, 2018), the disclosures of which are all herein incorporated by reference, in their entirety.

The present invention relates to a method/system of helping inventor(s) progress with their invention (and hopefully get it to market, and more hopefully to gain (financial) success with it), and may also be seen and/or defined as a business method. However, as will be stated, it may be used for any industry/endeavour, not limited to the field of invention. Thus, it may be relevant to (and/or provided for) development and/or facilitation of any idea, not limited to an invention or physical product.

### BACKGROUND

Presently it is very difficult (verging towards impossible) for an individual inventor to get a product (invention) to market. Apart from the obvious financial difficulties and challenges of making, manufacturing, developing, and patenting an invention, another problem is that the ‘territory’ of how to carry out such an act (get an invention to market) is not fully known or understood, particularly by first-time inventors. Due to this in part, first-time inventors are vulnerable to companies that broadly define themselves as ‘invention development companies’. The companies tend to have business models set up more to monetize the inventor than to facilitate the inventor in getting success.

The present invention seeks to provide a solution to this problem(s). (It is preferably primarily a system/platform and/or solution for inventors with physical inventions, but aspects (or a whole) of the present invention may be used to facilitate method-type inventions, such as business methods, processes and/or any abstract (non-physical) inventions). The platform/system and/or solution is not limited to use for ‘inventions’.

According to one aspect of what is claimed, (and in no way limiting the disclosure in the present application), there is provided: a method, comprising; having a platform comprising providers to take up a project of a user, wherein some or all of the providers provide in at least one of the following fields: patenting; product development; launch; monitoring success rates of some or all of the providers in terms of the success rate they have at projects they take up reaching a success threshold; making the success rate available to users.

According to another aspect of what is claimed, (and in no way limiting the disclosure in the present application), there is provided: a method, comprising: compiling and/or having a database of users; compiling and/or having a database of providers; relaying a project of one of the users to one provider, or a plurality of the providers; allowing the provider, or the plurality of the providers, to make a bid or offer to take on the project; relaying the bid or offer to the user; allowing the user to accept the bid or offer; monitoring whether the project attains a success threshold; calculating a success rate of projects the provider takes up attaining the success threshold; relaying the success rate to users.

According to another aspect of what is claimed, (and in no way limiting the disclosure in the present application), there is provided: a method, comprising: compiling and/or having a database of providers to take up projects of users; compiling and/or having a database of users; monitoring a success rate of a provider at projects they take up attaining a success threshold; relaying a project of a user to a provider, (or a plurality of providers); allowing the provider to make a bid or offer to take up the project; relaying to the user the provider's success rate at projects they take up attaining a success threshold; allowing the user to accept the bid or offer.

### BRIEF DESCRIPTION OF THE DRAWINGS

The invention will now be more particularly described, by way of example only and in no way limiting the scope of the invention, in which:

FIG. 1 is a ‘map’ of the facilitatory system for helping inventors progress with their invention, in diagrammatic/flowchart style, starting on the left, and finishing on the right;

FIG. 2 is the same map (ie ‘map to invention success’), with several more details, which will be discussed; and

FIG. 3 shows the same map, wherein there is an added step of another optional patent search after the proof of principle step;

FIG. 4 shows a similar map, where a step entitled ‘build assessment and journey planner’ is part of the map;

FIG. 5 shows a similar map, where a (preferably worldwide, high quality) patent search service is provided earlier on in the journey/model;

FIG. 6 shows a possible user-interface that may be used to help explain the journey/model/system to the inventor (or user) and/or to deliver their assets to them (eg purchased or free items);

FIG. 7 shows one possible preferred embodiment of a user-interface that may be used to help explain the journey/model/system to the inventor (or user) and/or to deliver their assets to them (eg purchased or free items), wherein the user interface may be paid-for and may allow the inventor to go save journey save details for and journey status of a plurality of inventions at once;

FIG. 8 shows a preferred embodiment of the map/model for how to help inventors, with a ten step system;

FIG. 9 shows a user interface (preferably provided via software and/or programming and/or code) modified for the map/model shown in FIG. 8;

FIG. 10 shows a particularly preferred embodiment of a system for how to develop (and/or facilitate development of) an idea, with an 8 step system;

FIG. 11 shows a preferred embodiment showing steps of how an idea is developed, converted into a product (at least a prototype) and uploaded to a database of people/parties who can help get the product to market;

FIG. 12 shows a first view of a compass-type method of pointing a user in the right direction to the next step they should focus on and complete;

FIG. 13 shows a second view of a compass-type method of pointing a user in the right direction to the next step they should focus on and complete;

FIG. 14 shows a third view of a compass-type method of pointing a user in the right direction to the next step they should focus on and complete;

FIG. 15 shows a fourth view of a compass-type method of pointing a user in the right direction to the next step they should focus on and complete;

FIG. 16 shows a fifth view of a compass-type method of pointing a user in the right direction to the next step they should focus on and complete;

FIG. 17 shows the preferred embodiment of the method depicted in a similar or the same way, broken up into stages;

FIG. 18 shows how the same concept (which may be provided as an app and/or on a website) may be used to provide a means for the user to contact and/or send a message; and

FIG. 19 explains in greater detail how the configuration may provide means for a user to view and/or use any or all of the said functions and/or views of the configuration;

FIG. 20 shows a more advanced embodiment of a user interface;

FIG. 21 shows a screen shot from a video/presentation, explaining/showing information to how invention development can be seen as comprising three modules/disciplines/areas/fields;

FIG. 22 shows a preferred embodiment of a map/set of steps of the/a platform/system/model, for how to help inventors, in the example;

FIG. 23 is a representation of how the platform/system/model may comprise product launch facilitators, and how a video/trailer video of a project/product(s) may be used as a presentation method;

FIG. 24 shows/represents how the product launch facilitators (or any providers) may be categorized by/on the system/platform;

FIG. 24 shows/represents an example of how the video may be sent out to a plurality of providers/product launch providers, preferably via an upload system, and preferably in a targeted manner;

FIG. 26 represents/shows how the platform may comprise a database(s) of, and/or stored information relating to, providers in any or all of: product development; patenting; and launch/success/release facilitation/services/help;

FIG. 27 shows how the platform/system comprising providers in any or all of the fields of product development, patenting, and ‘launch’ may be used with (and/or comprise) the or any set steps as previously laid out, and/or may utilize a ‘map’ system/journey;

FIG. 28 represents an example of the system/platform, and that it may comprise both the database of (and/or stored information relating to) providers in any or all of the categories/fields, as well as the/a set steps system;

FIG. 29 denotes, roughly, how different providers (of/or different fields/categories/modules) may provide different service(s) at different steps of the system/platform;

FIG. 30 denotes much the same as FIG. 29, but shows an alternative way of looking at the example platform/system, which might be that the user(s) and/or projects/ideas of the user(s) are on the outside of the system, and then enter ‘into’ the system/platform, and go through the example journey of the steps;

FIG. 31 is a slightly updated/amended version of what is shown previously in FIG. 17;

FIG. 32 shows a basic example flowchart of a user, (in the example shown, an inventor), using the system;

FIG. 33 shows an example financial arrangement/model for the example of FIG. 32 (denoted by way of a piechart);

FIG. 34 shows a different example financial arrangement/model for the example of FIG. 32;

FIG. 35 shows a further different example financial arrangement/model for the example of FIG. 32;

FIG. 36 shows a basic example flowchart of a different user, (in the example shown, an inventor), using the system;

FIG. 37 shows an example financial arrangement/model for the example of FIG. 36;

FIG. 38 shows a different example financial arrangement/model for the example of FIG. 36;

FIG. 39 shows a basic example flowchart of a different user, (in the example shown, an inventor), using the system;

FIG. 40 shows an example financial arrangement/model for the example of FIG. 39;

FIG. 41 shows the same example financial arrangement/model for the example of FIG. 39 as shown in FIG. 40, but after more than 5 years has elapsed, thus showing how the/any agreement/model may change in time;

FIG. 42 shows a basic example flowchart of a different user, (in the example shown, an inventor), using the system;

FIG. 43 shows an example financial arrangement/model for the example of FIG. 42;

FIG. 44 shows a basic example financial arrangement/model, which may be typical in a licensing deal scenario;

FIG. 45 shows how a patent provider may be involved in a financial arrangement/model;

FIG. 46 shows how a patent provider (or any party) may get a portion of a share of a user and/or a licensee company (or any other party/provider);

FIG. 47 shows a screenshot of a webpage to facilitate a user in entering into, and/or signing up to become part of, the system/platform;

FIG. 48 is a basic flowchart, showing how the/a platform/system may comprise a ‘screening out’ step/feature, whereby a user and/or project can only progress if it and/or they successfully attains a provider (preferably a product/project development provider) to work on the project;

FIG. 49 is a representation of how the system/platform preferably is, or comprises, a success centric system, wherein a, or a plurality of, providers, may benefit financially, from success of a project(s) they work on;

FIG. 50 is a basic flowchart, showing how an embodiment of a success rate system/concept may be provided;

FIG. 51 is a basic example of how a success rate may be shown, shown by way of example on, and/or provided by way of, a virtual badge;

FIG. 52 is a basic example, similar or the same as that shown in FIG. 51, showing how more information of a provider may be shown;

FIG. 53 is an example representation of bids/offers coming in from providers for a project from a user;

FIG. 54 shows a close-up of one of the offers from FIG. 53;

FIG. 55 is a flowchart, showing how a user may be provided with success rate information of a provider(s);

FIG. 56 shows an embodiment of how it may be possible for a project to be posted onto the/a platform/system, via an online form, in the example;

FIG. 57 shows an embodiment of how the/a projects may be relayed and/or made available and/or viewable to providers;

FIG. 58 shows an example of an online bid/offer form, which a provider may be able to use to make an offer for the project;

FIG. 59 is an example of how there may be provided a search function, which may be usable for the user to find and/or view a provider(s);

FIG. 60 is a flowchart which generally/roughly denotes how there may be provided both a ‘post and bid’ function (or any project inputting function), and/or a search function, which both may be available for a user;

FIG. 61 is a flowchart/representation of a method/platform/system which preferably comprises a provider database, and which preferably stores and/or monitors provider success rate information and/or relays success rate data/information to users;

FIG. 62 is very similar to FIG. 53, but now shows success rate information provided without a virtual badge, and in a very simple way;

FIG. 63 shows a close-up of one of the offers from FIG. 52, just as FIG. 54 shows a close-up of one of the offers from FIG. 53;

FIG. 64 is a basic representational flowchart, showing/denoting a user/project using a product development provider, successfully licensing their project/product(s)/invention, with a success threshold being reached/attained;

FIG. 65 is a representation, showing that a user has used a patent provider, a product/project development provider, and a product launch facilitator for their project, and a success threshold was attained;

FIG. 66 shows the same representation as FIG. 65, but with a/the success threshold not attained;

FIG. 67 shows the same representation as FIG. 65, this time showing/denoting that the or any provider may together form a team;

FIG. 68 shows an example/representation (similar to previous Figures), showing an example of how a user may use two different product launch facilitators/providers, possibly of two different types;

FIG. 69 is a representation of an example similar or the same to FIG. 65, now showing how the success rate(s) of provider(s) may be affected, with a success threshold attained;

FIG. 70 is the same/similar to FIG. 69, but now showing how the success rate(s) of provider(s) may be affected, with the/a success threshold not attained;

FIG. 71 is a basic flowchart showing steps of a success rate system/concept;

FIG. 72 is a basic flowchart, denoting a way of looking at and/or defining an embodiment of a success rate system/concept;

FIG. 73 shows a flowchart similar in part to FIG. 71, and showing how a success rate(s) may be updated and/or calculated;

FIG. 74 shows a basic (and partially representative) example of a possible interface for a product launch facilitator and/or provider (and/or any provider);

FIG. 75 shows a basic example/representation of offers being received (similar, for example, to FIG. 53, but now showing offers relevant to launch);

FIG. 76 again shows an example of a basic example/representation of a potential interface for a product launch facilitator and/or provider (and/or any provider);

FIG. 77 is a basic flowchart showing an example of how a method may be used to help a user attain a product launch facilitator (or any provider) and/or attain the best possible product launch facilitator (or any provider) and/or provide the best possible deal, regarding attaining a product launch facilitator (or any provider);

FIG. 78 is an example of a portion or a whole of a possible webpage;

FIG. 79 is an example of/on an interface where a user/creator may be able to see sales and/or profit and/or money data of a project(s); and

FIG. 80 is an example of/on an interface where a user/creator may be able to see more detailed data for a particular project or projects.

### DETAILED DESCRIPTION

Before describing the possible steps of the invention, it should be noted that any step may comprise:

a) facilitating the inventor in carrying out an action (or the purpose of the step) themselves;

b) Outsourcing personnel to carry out an action (or the purpose of the step), in which case, the proprietor of the invention (or whoever is utilizing the present invention to help inventors) may receive (a portion of) pay via any outsourced work (eg if a patent search service is outsourced, the proprietor/utilizer may financially benefit, eg from any fee paid by the inventor);

c) the proprietor/utilizer of the present system/invention having staff to carry out an action (or the purpose of the step), (in which case, payment by the inventor may be made directly to the proprietor/utilizer)—eg the company using the system to help inventors may have staff to carry out a patent search, and/or drafting (and filing) of a provisional patent application, and/or creating of a proof-of-principle or a prototype of an invention, etc etc;

d) simply offering guidance—eg useful information;

e) simply explaining the step with a view to explain how the model/system for facilitating inventors works. (As will be shown, preferably there is provided an email sign-up list whereby the inventor can be taken through the system step-by-step (or substantially step-by-step).

A preferred embodiment of the invention (ie system (which may also be a business method) for facilitating inventors will now be described. However, any combination of any step(s) may be claimed. Thus any step described may be optional and/or preferable to the system, or may, in a future claim, be defined as essential. Any aspect of the invention may be claimed.

Referring to the drawings, step 1 is the beginners patent search. Preferably this comprises a tutorial to facilitate the inventor in doing a basic patent search for themselves.

Preferably the tutorial comprises teaching/showing the inventor how to create ‘keyphrase(s)’ for their invention concept. A Keyphrase is here a term used to define a ‘brief description’ of the invention (usually just a few words). Intent is that the inventor is helped in creating at least one keyword (and preferably several—for example, three) and then the Keyphrase(s) are used to conduct the search.

Preferably the tutorial comprises a part showing how to use the Keyphrase(s) to search via Google Patents, but any other patent search engine may be shown/used, eg Espacenet. Preferably the tutorial also comprises a part showing how to use the Keyphrase(s) to search using a (standard) internet search engine—for example, Google.

Thus the beginners patent search (step 1), in its preferred embodiment, comprises:

a) showing the inventor how to create at least one Keyphrase for their invention (and preferably three Keyphrases);

b) showing the inventor how to do an internet search (eg via Google) for their invention using their Keyphrases;

c) showing the inventor how to do a patents search for the invention (preferably via Google Patents.

In its preferred embodiment, such a tutorial is provided via video (ie it is (or comprises) a video tutorial.

Preferably, as shown, (element 1b of the drawings), there is provided a ‘Pro’ (ie professional) version. Preferably the standard version is free for the inventor. Preferably the Pro version incurs a fee (for example, $45). Preferably the Pro version includes added guidance and/or tuition, and includes added video footage, thus providing further value for the inventor, and help to do an even better search for their invention.

Preferably, as shown, (element 1c of the drawings),there is provided an ‘X Pro’ (ie even more advanced/professional) version. Preferably this incurs still a further cost (eg, $125), which cost may include the inventor receiving the Pro version as well. Preferably the X Pro version comprises watching a highly skilled patent practitioner conduct a ‘beginners patent search’ type search (ie creation of Keyphrase(s), and using the Keyphrase(s) to conduct a search via Google Patents (or any other patents search engine), (and also preferably doing a standard internet search using the Keyphrase(s). Preferably the X Pro search shows the highly skilled patent practitioner encountering prior art for the invention he is conducting the search for, and shows how the highly skilled patent practitioner reacts to the prior art in attempting to still try to patent the invention. It will be obvious that such a tutorial may be of high value to an inventor, particularly if they are to carry out a beginners patent search of the type that is taught (preferably) in all versions of the beginners patent search (1, 1b, 1c).

In step 2, the inventor is facilitated in getting patent pending on their invention. As stated earlier, this step may comprise:

a) facilitating the inventor in carrying out an action (or the purpose of the step) themselves. (ie the inventor in drafting and filing their own provisional patent application)

b) Outsourcing personnel to carry out an action (or the purpose of the step (eg drafting (and filing) a provisional patent application for the inventor)), in which case, the proprietor of the invention (or whoever is utilizing the present invention to help inventors) may receive (a portion of) pay via any outsourced work (eg if a patent search service is outsourced, the proprietor/utilizer may financially benefit, eg from any fee paid by the inventor);

c) the proprietor/utilizer of the present system/invention having staff to carry out an action (or the purpose of the step) (eg drafting (and filing) a provisional patent application for the inventor), (in which case, payment by the inventor may be made directly to the proprietor/utilizer)—eg the company using the system to help inventors may have staff to carry out a patent search, and/or drafting (and filing) of a provisional patent application, and/or creating of a proof-of-principle or a prototype of an invention, etc etc;

d) simply offering guidance—eg useful information (eg about how to get patent pending, particularly via a ‘provisional patent application’ or the like (eg a ‘non-paid GB patent application);

e) simply explaining the step (ie getting patent pending) with a view to explain how the model/system for facilitating inventors works. 1e the importance of this step in the grander scheme of the system (and therefore the grander scheme of the inventor getting their invention to market).

Preferably, in an embodiment where the inventor is facilitated in carrying out the step themselves, the step comprises (ie there is offered/provided) digital (preferably video-based) program(s) to help the inventor get patent pending. Preferably the program(s) shows the inventor how to draft a provisional patent application (which is preferably done via a video tutorial(s)), and preferably the program(s) show the inventor how to file the provisional patent application once they've filed it. (This may be done via a screen capture video tutorial showing footage of how to file a provisional patent application via the USPTO website, for example (or the UKIPO website for UK inventors, or any patent office website). Preferably the showing of how to do this (how to draft and file a provisional patent application (or the like)) is done via one digital program, which gives the inventor the power the get patent pending.

The inventor may be facilitated by a ‘patent pending package’ (preferably purchasable), which may include multiple digital (video-based) programs. Such a package may also comprise a program that may teach the theory of how a provisional patent application works. The program (or any other program) may also comprise teaching the inventor how to draft a basic patent Claim 1 for their invention (which it will be obvious to those with skill in the art can be a very important skill in terms of improving likelihood that a provisional patent application (or any priority document) will successfully give an inventor the benefit of priority for a future application that claims back to it.

Such a package may also include a program that shows inventors how to convert any of: sketches, CAD/computer graphics, and photographs into black line patent drawings. Such a program may comprise a tutorial (preferably screen capture of substantially screen capture) showing how to achieve this via, for example, a well-known graphics software program, such as, for example, Adobe Illustrator.

Thus, in a preferred embodiment of step 2, there is provided a package to facilitate the inventor in getting patent pending, which comprises three programs. Preferably the package and/or program(s) can be purchased (by credit card, Paypal, or any other means), and preferably the inventor can gain immediate access to the program(s) once payment is completed—eg via a password (which may be sent via email) to gain access to a private protected website, or alternatively by the inventor having an interface which, once the package/program(s) is purchased, ‘unlocks’ the matter they have bought within their interface.

The programs are simply termed ‘digital’ as they are preferably video based, and may be ‘embedded’ in some way for viewing. However, the program(s) and/or package may be claimed without using the term ‘digital’, which is a preferable description/definition.

Preferably the inventor can pay for the package and/or program(s) in one payment, or in monthly instalments.

(As stated, in an alternate embodiment of this step (or one that runs parallel (since all of the aforementioned possibilities for each step (a) to e)) may run parallel to each other, the steps not being limited to one or the other) to the aforestated preferable embodiment(s)), the action of getting patent pending (eg via drafting and filing a provisional patent application) may be done for the inventor.

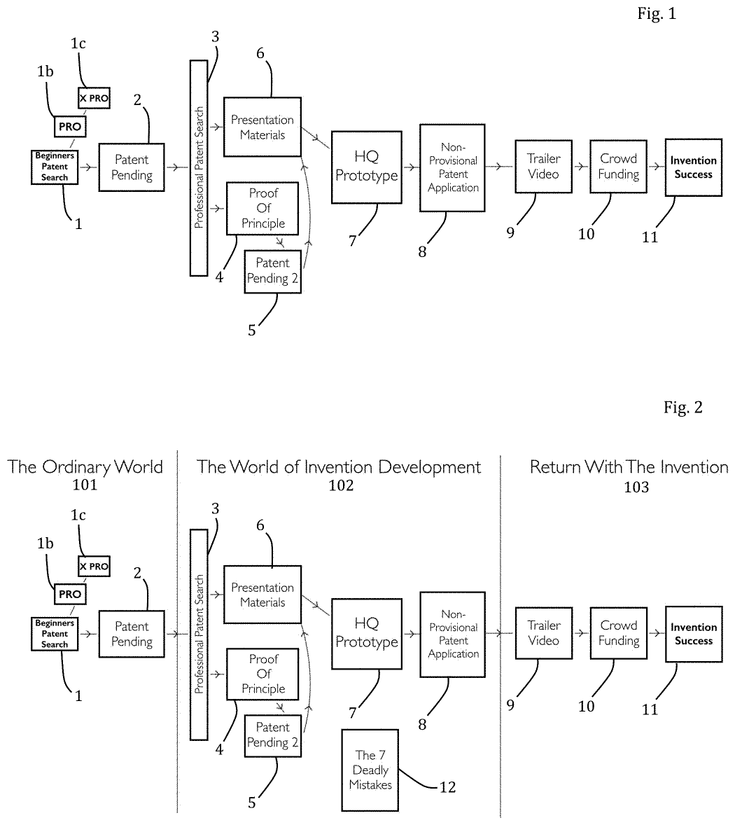

Step 3 in several of the early drawings (eg FIG. 1) is a ‘professional patent search’. This is intended (in its most likely embodiment) to be a patent search carried out by a skilled individual (most preferably a professional patent searcher). Preferably this is outsourced, with a significant fee paid by the inventor, with the outsourced party and the outsourcer both gaining financially. It could be carried out by staff of proprietor/utilizer of the system to help inventors.

As an alternative, a (digital) program may be purchasable by the inventor which shows them how and/or teaches them and/or gives them the skill (and therefore gives them the power) to conduct their own high quality (preferably worldwide) patent search.

Preferably the program comprises showing them how a professional patent searcher (eg a patent office examiner (former or present)) carries out a world-class search, in such a way that the inventor can then themselves carry out a very high quality patent search. This may be purchasable (and accessible) similarly to how the aforementioned patent pending package/program(s) are purchasable and accessible.

One of the reasons this step may be provided (on top of the beginners patent search step) is that steps 4 and 6 may be fairly (or highly) expensive. Therefore it may be advisable (in certain circumstances) to conduct a higher quality patent search before the inventor commits financially (and in time/cost etc) to steps 4 and 6.

Step 4 in the early drawing(s) is the ‘proof-of-principle’ stage. This is where a basic (but functional) version of the invention is built to prove the concept of the invention. Any of options a) to e) previously mentioned may be offered. (or any other options, which is also the case for any other step(s)).

It should be noted that, with some inventions, it may simply be too complex or expensive to do a proof of principle (ie the inventor may not be able to or afford to do it (or it may be had/impossible to find/hire the expertise to do it). In such cases, steps 4 and 5 may be skipped, and the inventor may be forced, for example, to go to step 6 (or any step). This may also be the case for method/business method patents, where it may be very difficult to build a real-life example of the invention (which may, for example, require website building/coding, or any other complex job/action).

Step 5 in the early drawing(s) is ‘patent pending 2’. It will be obvious to those with skill in the art that the proof of principle stage often leads to dramatic new understandings and changes to the invention. New information may come to light about the invention which was not included in the first (provisional) patent application. In such situations, it is often desirable to file a new (provisional) patent application which includes the new information (which may include patentable matter). Thus this stage informs the inventor about this (and may show the inventor how to do it). In a particularly preferred embodiment of the system for facilitating inventors, preferably one of the programs in the patent pending package (step 2) shows how to do this (eg how to add the new information into the previously filed provisional patent application (which may include adding drawing(s) and/or description), which may then be filed again.

Sometimes the whole inventive concept is changed by the understandings garnered from the proof of principle stage to such an extent that the original filed provisional patent application may have become redundant. Thus a new provisional patent application (for a new inventive concept) may be drafted and filed at this stage.

Step 6 in the early drawing(s) is the presentation materials stage. Presentation materials are used by inventors to help them present their invention and may include, for example, graphics of their invention and/or video, or any other means to facilitate presentation of their invention. Sometimes large amounts of money are paid for such presentation materials (which may include folders/binders/brochures (which may all be digital or ‘real’). Preferably guidance is given to the inventor for how presentation materials should be used (and how they should not). The inventor may also be able to purchase presentation materials at this stage (which may include video and/or graphics of their invention—eg video animation (in 3D preferably) and 3D graphics), and which may also include brochures and/or website etc (which may be password protected), which may include other information about their invention (such as information on results of their patent search, proof of principle (eg pictures and information), information about the inventor themselves, whether they are patent pending, etc etc.

This may all be provided and/or facilitated with a view to helping the inventor present their invention. Significant payment may be taken (paid by the inventor) for this.

It is feasible other methods of how to present an invention may be shown and/or taught. For example, it may be shown how to create a (preferably animated) Powerpoint or Keynote (or the like) presentation of an invention. Such a tutorial may incur a fee (ie the inventor may pay for such tuition).

Step 7 in the early drawings is HQ Prototype. ‘HQ’ stands for High Quality. Intent in this step is to build a high quality prototype that is close to looking like and functioning like the finished product of the invention. (ie fit for sale (or substantially fit for sale). This can be significantly expensive. Preferably guidance is given about this stage. It is feasible the service (of creation of such a high quality prototype) is provided to the inventor. This may be carried out by the proprietor/utilizer of the system for facilitating inventors, or may be carried out by a third party. In either case, the proprietor/utilizer preferably benefits financially.

It is feasible the system comprises an added stage (not shown in the drawings), where the system comprises a system to facilitate disclosure of the invention to parties who may be able to help progress the invention (eg build an HQ prototype and/or get the invention to market. Thus the system may comprise a database of such ‘helper’ parties. Thus the work done to this point (in particular the presentation step) may be particularly useful—for example, the system may allow for video presentations of the invention (or any type of presentation) to be uploaded and be viewable to such ‘helper parties’. The helper parties then may be able to contact the inventor (either directly or via the proprietor/system) with a view to carrying out work on the invention (eg making a prototype and/or bringing it to market.

The system may include means for the inventor to view such offers, and possibly to choose who (eg which offer) to move forward with. Helper parties may be able to bid on the invention, with the inventor receiving the bids and preferably choosing which bid to move forward with.

The fact that the inventor is patent pending (step 2) may be very useful to give an added level of legal protection for the inventor if they decide to disclose in such a way, although other (eg confidentiality) agreement(s) may be in place which the helper parties may have to sign in order to use the system.

Step 8 in the drawings is the Non-Provisional stage. This is where a non-provisional patent application is drafted and filed (for prosecution) at the patent office(s).

It will be well known that a practitioner (such as a patent attorney or patent agent) is usually hired by an inventor to do this. If so, preferably guidance is provided. Many times miscommunication and/or breakdown of communication between inventor and practitioner leads to defective patent application(s) being drafted, eg with defective claims that do not protect the invention as they might, or, worse still, with incomplete disclosure in the application to allow for fully protective claims to be supported, even if such claims may have been granted.

Thus, preferably at this stage, a (preferably digital) program (not dissimilar in nature to the other programs aforementioned with regard to getting patent pending, preferably) is provided. Intent of the program, preferably, is to help the inventor have the best chance of getting a perfect patent granted. This may include basics like help on which practitioner to hire, and may include more important information like how to read though and check the claims (especially the claim 1) that their practitioner has drafted, to make sure it is claiming the invention in a way that the inventor agrees with and no miscommunication with the practitioner has occurred. It may also show how to read through the whole application so as to check there is full disclosure of what the inventor considers to be their inventive concept. One intent is to avoid the inventor having a ‘bad patent’ granted (ie one that can be designed around when more binding (or ‘perfect’) protection could have been achieved.

However, an inventor may, for one reason or another (eg lack of money, or desire to master/learn the skillset) desire to draft and file their own non-provisional patent application. Therefore preferably there is provided (purchasable) a (preferably digital), video based program on how to draft a non-provisional patent application, which preferably comprises tuition from a highly skilled patent practitioner, who may be showing drafting parts of (or a whole of) a non-provisional patent application for an example invention.

All such programs mentioned may (or may not be) video based. Preferably theye are all video based.

The system may include a database of patent attorneys/agents/practitioners who can draft and file (and preferably prosecute) a non-provisional patent application. Any time that the system successfully connects an inventor/user and patent practitioner where money changes hands (eg inventor pays practitioner) the proprietor/utilizer of the system may benefit financially. Any financial arrangement between proprietor/utilizer and patent practitioner may be in place (eg monthly/annual fee from the practitioner to be listed on (or a part of) the system, so that they can be hired.)

Step 9 in the drawings is Trailer Video. Intent of this stage is to facilitate the inventor in creating (or having) a high quality trailer video (usually about one to two minutes long) explaining (and possibly to some extent marketing) their invention. Preferably the video leverages the HQ prototype the inventor has had made. Thus a high quality video and ‘vision’ of the invention can be created.

Preferably the trailer video includes high quality, pre-scripted audio. It is possible this stage may include a template and/or tuition to facilitate the inventor in creating (ie drafting) their own script. It may, in such a case (or any case) also comprise tuition for how to record the script (eg how to download/install and/or use audio recording software to achieve this), or the inventor may be able to purchase/hire professional voice talent. Similarly their may be provided tuition and/or a template for how to storyboard (and shoot) the video, so that the inventor can create the trailer video themselves. However, creation of such videos, especially to a high quality, is not a simple task, and it is possible this service (creation of the trailer video) may be offered to the inventor, and be purchasable. (This may be created by the proprietor/utilizer of the system to facilitate inventors (ie 1^{st} party, which may include staff) or may be provided by a 3^{rd} party, in which case, preferably the proprietor/utilizer financially benefits from the work. The system may include a database of providers for this, or any other step.

In situations where the inventor does not have any prototype (eg where invention is too expensive/complex to carry out a prototype) animated (eg 3D animated) graphics of the invention may be created as the trailer video. This service again, may be charged and purchasable by the inventor, and may be carried out on a 3^{rd} party or 1^{st} party basis (or in any way/by any party/provider).

Step 10 in the early drawings (eg FIG. 1) is crowdfunding. One intent of the crowdfunding stage is to generate enough funds for certain actions—eg the inventor might crowdfund to get their first production batch of their invention made 9or for any other reason) Guidance may be provided to help inventors budget and understand what they need to crowdfund money for. (ie basic crowdfunding business plan). In a preferred embodiment of the present system for how to facilitate inventors, the trailer videos is leveraged (ie used) in the crowdfunding. For example, on most crowdfunding platforms, video can be used and there is usually a main video in any crowdfunding campaign. Thus in this step, preferably the trailer video (or at least part(s) of it, form part of the main crowdfunding video for the inventor.

Preferably a template is provided to help the inventor create a good ‘main video’—ie crowdfunding video. This may include any of: a section where they introduce themselves; a section where the inventor(s) explains the basic background of how the invention came to be; a section where the development story of the invention is explained; a section where the trailer video (from step 9) is played; and a section where they explain where the crowdfund money will go; and a section where they explain the prizes the funders will get if the job is successfully funded.

A template may be provided to the inventor (preferably purchasable) for how to create their crowdfunding script. However, this may be challenging for someone not skilled in such an act to achieve. Thus this service (either creation of the script, or of the whole video (which may include filming of the inventor, which the inventor may have to perform themselves), may be purchasable by the inventor, and may be carried out on a 1^{st} party or 3^{rd} party basis. In either case, preferably the proprietor/utilizer of the present invention benefits financially.

There may be provided guidance on how to use and leverage social media (especially for use on crowdfunding campaigns). This may include setting up and/or use of Facebook, Twitter, etc.

Step 11 in the early drawing(s) (eg FIG. 1) is invention success. This is intended to mean that, if the crowdfunding step is successful, the inventor now has the finance, and can get their invention to market. (eg they may be able to buy a first batch of stock, which can be sold). However, it will be obvious there may be other steps (or mini-steps) of the process, such as, but not limited to:

a website build step (having a website that can sell the invention e.g. if it is to be done/being sold by the inventor, rather than a 3^{rd} party retailer). This may be offered to the inventor (purchasable) and carried out on a 1^{st} or 3^{rd} party basis;

a packaging step, which may show how to package the invention (as a product). This may include tuition, and/or may include resources (such as connection to individuals or companies that can carry out such packaging). A fee may be charged for use of such resources;

a presentation step, where the inventor is taught how to present their invention to potential retailers (or any other parties). It is feasible a program (eg digital, eg video based) is offered and purchasable for the inventor to learn how to do this. It is feasible personnel can be hired by the inventor to do this. The proprietor/utilizer may benefit financially from this; and

a route to market step; where the inventor is taught about route to market, and such matters.

Element 12 in FIG. 2 is ‘The 7 Deadly Mistakes’. Preferably this is a video based resource (although it may alternatively (or also) be an eBook and/or provided by any informational method-eg as basic as text, eg on a website/webpage for example, and/or even in print) that is provided to the inventor, in the example, preferably once they purchase, buy, or complete step 2. (In other embodiments, as will be seen, this resource and/or information may be made available earlier, and/or right at the starts and/or freely, and may not require any payment, and may not require the user/inventor to have completed any other step(s). This resource is intended to explain to them the biggest mistakes inventors make in moving forward with their invention. One draft of the resource has the mistakes listed as this:

Mistake 1: using an invention development company

Mistake 2: getting a bad patent search

Mistake 3: getting a bad patent granted

Mistake 4: Misuse of Presentation Materials

Mistake 5: Not having a Map (or Plan) to Success

Mistake 6: Not Realising Invention is a Skillset

Mistake 7: Not leading your Invention Journey

This is just one example, taken by way of example only.

Preferably information is delivered to the inventor to explain to them about each mistake, and preferably to provide (in one way or another) the solution. At its most basic, this may simply comprise written text. In a preferred embodiment, video content (and/or a video) is delivered for/relating to each (or any) mistake. The term ‘The 7 Deadly Mistakes’ is just one title or ‘skin’ for such a concept, and there may be any number of mistakes, and such content warning the inventor of mistakes may be delivered by any means.

It is feasible (as briefly mentioned) that rather than the inventor haphazardly receiving all these items of content in an unrelated way, that the system comprises a type of dashboard/interface for the inventor. This may be password protected. Thus the inventor may sign in to their dashboard interface and may have access to various (or all of) their resources via that interface. For example, their program(s) they've purchased may be stored (and/or accessible) on their interface, their beginners patent search (eg their Keyphrases and results) may be storable on their interface. Thus the interface may greatly enhance the experience of the inventor. The interface may also show where the inventor is on ‘the inventor's journey’ by showing them where they are on the map (eg a map similar to as seen in FIG. 1 and FIG. 2, or any map/system disclosed, and/or any map/system, not limited to what is disclosed). This may be beneficial in focusing the inventor on what they need to do next to progress in the invention journey.

It may also be useful for marketing purposes for the proprietors/instigator of the system; for example, the system may be configured so that it recognizes what step the inventor is on (or has to achieve next) to progress in the journey to invention success. Thus it may market to the inventor accordingly. For example, if the system sees that the inventor has done the beginners patent search, but has not bought the patent pending package (or any solution for getting patent pending), it may send the inventor email(s) and/or alerts and/or information tailored to try to get the inventor to move forward with that step and/or help with that step and/or relevant to that step (or the step they're on).

The interface may store details about the inventor (such as email address) which may be leveraged to send the inventor information and/or email(s), etc.

Email Sign Up

Preferably the inventor (preferably free of charge) can be taken through the whole system/journey step-by-step (or substantially step-by-step).

One possible way of doing this would be an email sign up. For example, the inventor may be able to sign up, and may be sent an email each day (for example) with each day the inventor receiving content and information about the next step of the invention journey.

Thus, on day 1, the inventor may receive content about the beginners patent search (step 1). On day 2, content regarding getting Patent Pending (step 2), etc, etc. Thus they may be taken through the whole ‘journey’ (eg on a virtual level), without having to commit to buying anything. Thus they may be taken sequentially through the journey, step by step. Email is just one way to do this. They may be emailed and then re-directed to login to their interface, where the new information may be available.

In the HQ Prototype stage, (step 7 in the early drawings (eg FIG. 1)) help and/or guidance may be given with regard to product design. This may include a program (purchasable) being offered, which may help the inventor with product design (and may give them the power to design their own product).

Having previously been described (and defined) with reference to the invention industry (and facilitating of inventors), it will be clear that such a system may be viable for any industry, particularly where a person is being facilitated to obtain a goal, and particularly where the person (user) must be taught and/or receive service(s), program(s), product(s), etc. Thus such a system may be used (and claimed) for any industry. Such a system preferably comprises mapping a journey, providing the map to a user (and preferably explaining what the map is and that it will be used as a guide to obtain a set goal), preferably taking the user through the map (preferably each step at a time, or substantially so), and preferably providing product(s) (The word ‘product’ will now be used as a generic term to describe any product(s), program(s), service(s) etc at any or all steps of the journey.

Preferably (and this may also apply to the example of facilitating of inventors), the map is provided (or at least alluded to) on a webpage. This may be provided in the form of a graphic (for example on a website homepage), which graphic includes the map. There may be accompanying information to explain what the map is to the user, and why it is useful to them. This may be provided by means of an accompanying video.

There may be provided (as aforestated) an offer to go on a ‘free tour’ of the journey/map where the user is taken through the steps of the map/journey. It may be explained that if the user follows the steps, they will get success.

Any free tour (or any information provision) may be facilitated by a mailing list (or any other method of dispersing the information to the user).

Preferably the system is configured so that it recognizes what step of the journey/map the user is on. Thus if the user has completed all stages (steps) of the journey up to (in the shown example) Presentation Materials, and has purchased all relevant material to complete those steps, the system may recognize that their next step is the ‘HQ Prototype’ step (or whatever step it may be in any other industry/endeavour). This may be useful in helping the user and/or marketing to the user accordingly; if the system intelligently ‘recognizes’ that they are on this step, they may be sent relevant information to help them on this step, which may be both useful for the user, and also useful for the proprietor/utilizer of the system, as it may help to market relevant product(s) to that user. This may be done in an automated, or substantially automated, manner. Thus, in the example stated, if the user is at the HQ prototype stage, and the proprietor/utilizer has a product(s) to sell to the user (eg it may be a digital program that teaches them about the process, or they may have staff and/or 3^{rd} party providers stored on their database and/or available to provide the HQ Prototype service to the user, the system may be configured to send them information and/or messages about this aspect whilst they are ‘stuck’ on (or recognized to be on) this stage/step. This may be achieved wholly, or to some extent, by automated messages and/or emails (or any contact method). This may comprise the system having automated email(s) (or any contact means) set up for the user to receive when ‘stuck’ on (or recognized to be on) that stage/step.

Thus relevant content may be sent to the user accordingly.

It will be obvious that one preferred method of how to achieve this may comprise the user having an individual dashboard/user-interface (as previously mentioned). This may allow the system to provide an individualized experience for the user, most particularly with reference to what step of the map/journey they are on. Content may be delivered via the user-interface/dashboard. The user may be alerted to new content available on their user-interface via email alert(s).

Thus the system may provide an individualized (or substantially individualized) experience for each user, and this may comprise a private (preferably password-protected) user-interface for the user, and may comprise automation (such as automated emails and/or content made available to the user, and some or any automation (particularly with reference to delivered content) may be automated with reference to what stage/step the user is on.

The system may also store what step (of the journey/map) the user is on, which information may be accessible, so that, for example, if the proprietor/utilizer of the system wants to send bespoke content to a user(s), they may do so with reference to what step the user(s) is on, and may know what step the user is on. This may also be checkable (what step the user is on), which may have customer service benefits.

It is feasible, therefore, that if, say, the proprietor/utilizer of the system wants to send an email out (or any contact method) that there is a 20% reduction for one week on all HQ prototyping services, they may be able to send such information to users that are on that particularly stage of the journey, but have not completed it. And it may be possible to make sure that such a message/information is not sent to users that have completed that step, and may not be sent to users who at a step several (or any amount of) steps before the HQ Prototype step. This example is taken by way of example only, and may be relevant to any industry/endeavour, not limited to facilitation of inventors, and not relevant to any particular step and/or product(s).

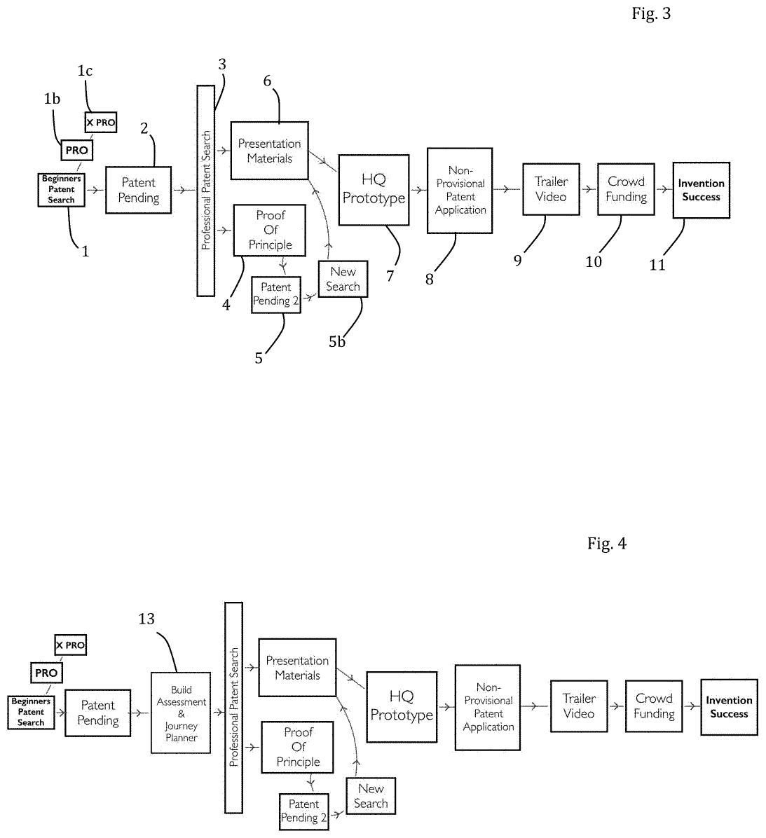

Referring to FIG. 3, there I shown an embodiment of the invention (wherein it is a system to facilitate inventors), wherein there is shown a further step (step 5b), which is a further patent search that may be done/carried out/provided/facilitated, etc after the proof of principle step. It will be obvious to those with skill in the art that often new information (including feasibly new inventive steps) come to light at the proof of principle step when the invention is built (or simply added information that may be relevant to patenting the invention). In the same way that step 5 may therefore be useful (to file another (provisional) patent application including the new information (which may comprise new inventive step(s)), so, if new inventive step(s) and/or aspect(s) have been revealed at this step (particularly where the invention has evolved to include any new inventive step), it may be useful and/or beneficial to carry out a new patent search on the new inventive step(s) and/or information. Thus there is shown a new possible step (step 5b) for a new patent search that may be carried out after the proof of principle step. This may be offered, charged for, explained, etc as aforementioned with regard to any step.

It is extremely possible (or likely), in a preferred embodiment, that steps 5 and 5b may in fact swap position so that the new patent search (step 5b) occurs in the model before the patent pending 2 step (step 5). This is because it may be beneficial, (if new information and/or inventive step(s) are revealed) to carry out a patent search for such matter before deciding whether to include the new information in a patent application (which may be a provisional, but may also feasibly be a non-provisional patent application).

It is also feasible that there is a Design step (not shown in the drawings, as part of the model. Preferably such a step occurs after the proof of principle step, and before the Presentation Materials step, and more preferably (with reference to FIG. 3, it occurs after step 5b (and after step 5) and before step 6.

In the Design step, the invention may be designed. There may be provided tutorials and/or program(s) (which may be digital program(s) not dissimilar to the programs as aforementioned, to teach and/or show how to do Product Design (or any other type of Design relevant to designing an invention). However, it is feasible ‘Design’ may simply be part of the Presentation Materials step (step 6). Thus, in one embodiment of the invention, the Presentation Materials step (step 6 in the early drawings (eg FIG. 1)) may be defined as a ‘Design and Presentation’ step, or a ‘Design and Presentation Materials’ step.

The embodiments described above are provided by way of example only, and any aspects and or step(s) of the invention may be claimed.

In FIG. 4, an extra step is provided (compared to FIG. 3), wherein there is provided a step (numbered 13), called the ‘build assessment and journey planner’ step. At this step, preferably a highly skilled engineer (preferably with significant experience in manufacturing) assesses the invention of the inventor, most particularly with a view to seeing how the invention should be built, and potentially isolating any issues (such as manufacturing issues, etc). Preferably this engineer (which is used as a broad term) is hired by, a staff member of, or acting as a hired consultant for, the overall provider of the overall proprietor/provider of these services to inventors.

The invention may also be assessed by another inventor(s)/designer(s) who may assess it from a product viability point of view. In combination between the engineer and the inventor(s)/designer(s), the provider of the system may feasibly decide whether they want to help bring the invention to market, which may be done free of charge, or may incur a fee. In either case, preferably an agreement is signed between the parties which may define profit rights, etc if the invention becomes profitable.

In order to receive the build assessment from the engineer(s), preferably the inventor must provide a brief disclosure of their invention idea, which may, for example, be limited to one page of written text disclosure, plus drawing(s).

Once the invention has been assessed, it may be offered to the inventor that the engineer, (or preferably a different employee/consultant for the provider of the service), may write up a Specification for the first build of the invention concept, which will tend to be a ‘proof of principle’ type build. (Although it may feasibly be a more advanced build). This may incur a further cost. The build assessment and the Specification are preferably charged separately, but may be charged as one fee.

Furthermore, preferably the inventor is advised on the steps of the Journey they must complete to get their invention to market. (This is the ‘journey planner’ part of the step, although this may feasibly be provided as a separate step). This is preferably carried out by a director or staff member of the provider/proprietor of the service, who can assess the invention and make sure exactly what route the inventor needs to take to get the invention to market. The journey planner conclusion/information may be provided to the inventor as a PDF (or any document).

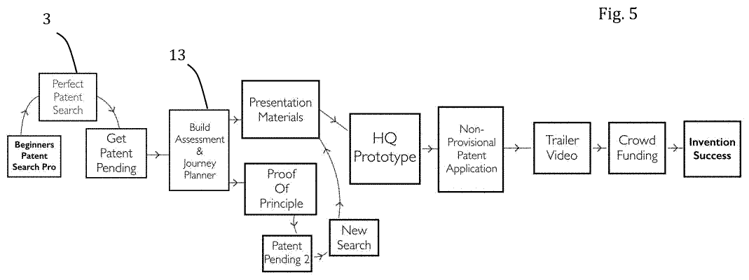

There is shown an embodiment of the inventive system to facilitate inventors in FIG. 5, wherein order has been altered. For example, there is now a professional patent search service (numbered ‘3’), (which is termed the ‘Perfect Patent Search’), now located/provided earlier on in the model. The inventor can now disclose their invention to have a (very preferably worldwide) patent search carried out, and can then get patent pending based on the results of the patent search. For example, if the patent search (3) shows their general invention idea is not patentable, but that certain features (previously considered optional) are novel and patentable, now, for example, a provisional patent application can be drafted, either by the inventor or by the or a provider, focusing solely on the feature(s) that have been shown to be patentable by the patent search (or at least not focusing on feature(s) that have been shown not to be novel). This may lead to a more focused (provisional) patent application and/or route to patent.

The ‘build assessment and journey planner’ step (numbered 13) in the embodiment of the system shown in FIG. 5, can now come directly before the proof of principle step. One intent is that it can be assessed whether a proof of principle is possible, or not (for various or any technical/financial reasons). Thus the journey can be ‘planned’ (hence the term ‘journey planner’) as to whether the inventor next goes to the proof of principle step, or whether they should/will by-pass this step and go straight to presentation of materials. Thus the build assessment and journey planner step solves this problem and defines which route the inventor will take. (This is why there are two arrows (and possible directions) coming out of the build assessment and journey planner step box in FIG. 5.

Following the patent search step (numbered 3 in FIG. 5), a basic provisional patent application may be drafted for the inventor. Preferably they are then given means to file the provisional patent application. Preferably they are facilitated in so doing by a (screen-capture) video of how to file their provisional patent application, preferably via the USPTO website (or any other website where relevant, such as the UK IPO for UK inventors). Preferably the filing video is provided as part of a program(s) and more preferably as part of a package of programs, which may help the inventor improve/add to the provisional patent application provided to them, and/or understand it.

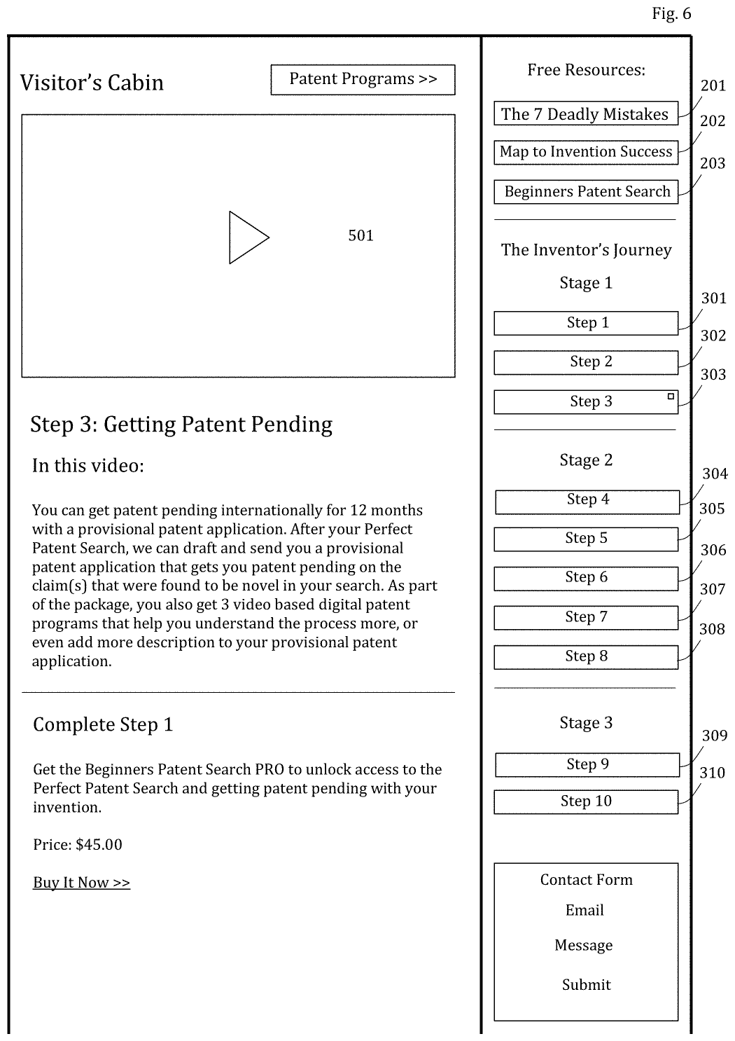

Referring to a possible user-interface, there is shown in FIG. 6 a user interface for the inventor (or any user in any embodiments not limited to the invention process/industry). The user preferably has to sign up to get access to their user-interface, eg by giving their email.

Inside the interface, there are some clickable tabs on the right side. Each tab can be clicked to open up information for that step/resource. (This is just one way of delivering many items of information on a very compact interface, and is taken by way of example only).

There are several free resources, including a tab 201 to open the 7 Deadly Mistakes eBook resource (which may then be downloaded/viewed—preferably each (or any) of the deadly mistakes comprises a video to show/explain the deadly mistake); a tab 202 to open the Map To Invention Success resource, which may comprise a video explaining the map and/or a PDF download of the map; and a tab 203 to open a, beginners patent search resource, which when clicked preferably opens up a video tutorial of how to do a quick beginners patent search.

(There can be seen a video 501 on the interface. Whichever tab is pressed, in the general video area, a video, or some other information, appears, relevant to the tab pressed. Essentially, the example interface functions as a widget).

It can also be seen on the user-interface that there are tabs for each step of the journey/model/system (hitherto explained) for getting an invention to market (although the same system may be used for other industries not limited to invention). There are shown tabs 301, 302, 303, 304, 305, 306, 307, 308, 309, and 310 for steps 1 to 10 respectively (although there may be any number of steps as part of the system. There is also shown a contact form below the tabs (which may be provided in any way, at any location, or not at all), which contact form allows user to contact provider of the system.

There is also shown a ‘patent programs’ tab on the interface. This may be used either for the user to access free trials of any of the patent program(s) herein mentioned in the present application, or to access full versions of the program(s) once they have been purchased. Any patent program(s) mentioned in the present application may be accessible once purchased via the user's user interface.

In the example embodiment, the tabs for each step are split into 3 stages. When each step tab is clicked, preferably a video 501 appears explaining about that step. Thus the user can quickly, via a compact and intuitive user-interface, be delivered a very significant amount of information, and a ‘tour’ of the model/journey. This is preferably provided free.

In the shown example of FIG. 6, a small square/icon can be seen at top right of the step 3 tab. This denotes that that tab has currently been clicked and is active. Therefore the video 501 preferably is showing content to the user about step 3 (which is preferably a step for getting patent pending, as seen in map of FIG. 5). Under the video 501, some information about the video, including title of the step (Step 3: Getting Patent Pending), and some information about the video and step, is shown.

Still further underneath, an exhortation is seen to the user to ‘Complete Step 1’. This is an example where a user has signed up, and has accessed their interface (shown in the drawing), but has not yet bought/purchased step 1. (which is preferably the Beginners Patent Search PRO version, as shown in various maps in the drawings).

Underneath the exhortation, there is a message which states that step 2 (can be unlocked by buying step 1, and there is a link/button that the user can use to buy step 1, and get the Beginners Patent Search PRO item. This is an example of one preferred embodiment of how the inventive system runs, whereby the user cannot progress to a step until they have bought all the steps before that step (unless otherwise allowed by the provider of the system to skip a step). Thus user may have to sequentially ‘complete’ each step (which is preferably achieved by buying a service/product for that step) before proceeding to the step that follows that next step.

Once the user completes/purchases that step, preferably their user-interface is updated so that they are able to purchase, in this case, step 2. When they purchase step 1, preferably the exhortations previously seen to ‘Complete Step 1’ are replaced by exhortations and preferably payments link/button etc to complete/buy step 2. The step 1 tab may also change colour (or there may be provided any other denoting signal) that step 1 has been completed. Furthermore, preferably they can, having paid for step 1 (Beginners Patent Search PRO) now access the Beginners Patent Search PRO asset via their user-interface. It may, for example, be provided by clicking on the step 1 tab, which previously would otherwise have shown a video about it. Thus the user-interface can be used to provide access to paid (or free) assets for the user.

As stated, this is an example where the user must complete each step sequentially. However, the inventive system is not limited to such a method, and may, for example, have ‘optional’ steps, where a user need not complete a step to move onto/purchase a step that follows it. Thus, in one embodiment, a user may be able to purchase step 2 (preferably a worldwide patent search service) without having bought step 1 (preferably the Beginners Patent Search PRO tutorial).

Preferably, as stated, the user's interface is updated when they purchase a step. Preferably this is done on a software level (programmed so to do). However, if such programming was not available to provider of the system, they could, for example, simply set up a new page/interface to correspond to each step which has been completed/purchased. Thus the user may buy, for example, step 1, and may, upon buying, be sent/emailed new login details for the new ‘step 1 interface’. In the new interface, they have access to the step 1 asset (preferably the Beginners Patent Search PRO), and are able to purchase step 2. However, in a preferred embodiment, the updating of the interface is done via programming. This leads to a more elegant result and experience both for the provider of the system, and the user, since they do not constantly have to change their login details or be given new login details.

The system may be configured so that the system recognizes what step the user is on, and send them information particularly relevant to the next step they need to complete (and/or the step they're on). Thus if the user has completed/bought step 1 (eg Beginners Patent Search PRO), then information they receive (eg via the mailing list or of any general description) may be optimized to whet their appetite about step 2 (or step 3) to both excite them to complete the next step, and to help them complete it.

Thus it can be seen that user can be taken through the system/journey sequentially, and can be delivered information sequentially, or in an optimized manner, and that this can be achieved, in part or in whole, via a user-interface, which may be programmed intelligently to achieve this.

The embodiments described above are provided by way of example only, and various other modifications will be apparent to persons skilled in the art, without departing from the scope of the invention as defined by the appended claims.

Any novel subject matter or combination including novel subject matter disclosed herein, whether or not within the scope of or relating to the appended claims, or any statements of invention, may be claimed. Thus any feature(s) disclosed herein may be combined to form an invention that is claimed.

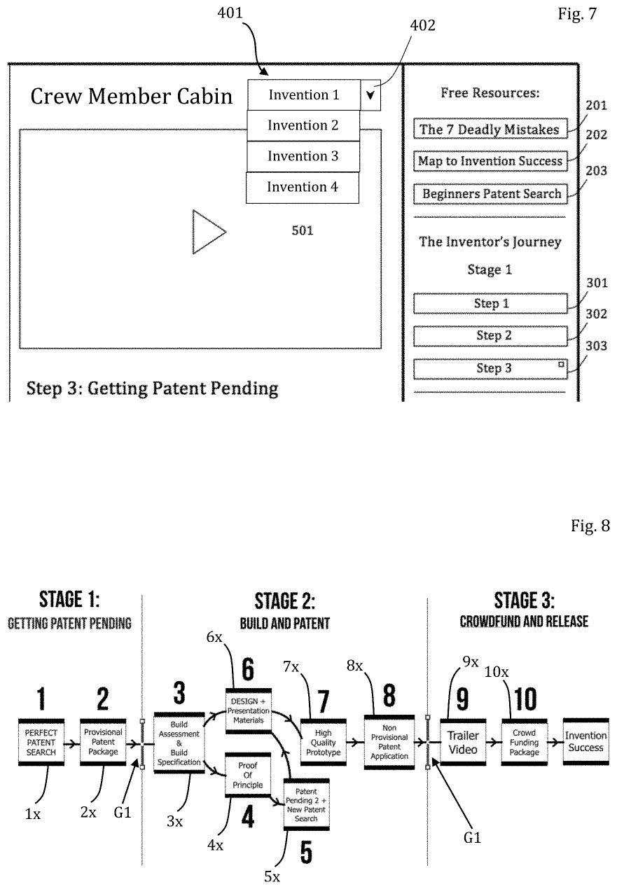

There is shown in FIG. 7 one embodiment of a user-interface where the user can save the journey status of several inventions at once. It may be that a user gains access to a user-interface (such as the embodiment shown in FIG. 6) wherein details and/or status regarding a limited number of inventions (eg perhaps only one) can be saved at once. Thus the (preferably free) user-interface may have limited functionality.

In the shown example, the inventor has four inventions (invention 1, invention 2, invention 3, and invention 4) stored on the system, each of which they are taking through the journey/system via the interface.

However, it will be obvious that many inventors have many inventions, and may want to take the many inventions through the system/journey as set out. Thus there may be provided a (preferably paid-for) option of paying for an interface that has less limited functionality. Thus there is shown an embodiment in FIG. 7 wherein there is provided (by way of example only) a drop down checkbox 401, which comprises (by way of example) a clickable drop-down icon 402. The user, in the shown example, can click the drop-down icon 402, and choose between multiple inventions of theirs whose details/journey status, etc are stored within their user-interface.

Thus, for example, they may have reached Step 3 with one invention (eg invention 4), but be on Step 7 with another invention (eg invention 1). They may be able to name the inventions to make it clearer which invention they are selecting.

When they click/select invention 1, their interface may show that they have completed Step 7. This may be clear by colouring of the Step icons, for example (or any other way). When they click on/select invention 4, their interface may alter so that it is clear they have only reached completion of Step 3 for that invention and are now on Step 4. Thus it can be seen that a user-interface may be provided that can store details and/or information and/or journey status of multiple inventions.

In the given examples, the (preferably free) interface of FIG. 6 is shown with a name/title stating “Visitor's Cabin” (or “Visitor's interface”, or word(s) to that effect).

Preferably the inventor (or user, as this system is not limited, in alternative embodiments, to the invention industry/process/journey, and may be used for any endeavor/field/industry/journey and/or user) can upgrade (preferably for a (preferably small) monthly fee to the shown “Crew Member” cabin (or “Crew Member's interface”, or word(s) to that effect) of FIG. 7, which has the shown increased functionality of allowing the user to store details and/or information and/or journey status of a plurality of inventions which can be selectably chosen (in any way, not limited to a drop-down menu 401, for example)

The embodiments described above are provided by way of example only, and various other modifications will be apparent to persons skilled in the art, without departing from the scope of the invention as defined by the appended claims.

Any novel subject matter or combination including novel subject matter disclosed herein, whether or not within the scope of or relating to the appended claims, or any statements of invention, may be claimed. Thus any feature(s) disclosed herein may be combined to form an invention that is claimed.

Referring to FIG. 8, there is provided one particularly preferred embodiment of the model/map/system for how to help inventors bring inventions to market.

The model/map, as shown (or substantially as shown—perhaps in a different looking design, but showing the same steps to a significant or exact degree) may be provided, as a map, to the inventor (ie user).

There are ten steps in total in the map/model as shown in FIG. 8, with step 1 numbered ‘x1’, step 2 numbered ‘x2’, etc etc. The map/model is broken up into 3 STAGES (which are shown on the map), with STAGE 1 being entitled ‘GETTING PATENT PENDING’; STAGE 2 being entitled ‘BUILD AND PATENT’ and STAGE 3 being entitled ‘CROWDFUND AND RELEASE’. Thus in the shown embodiment of the model, STAGE 1 is about facilitating the inventor in getting patent pending (and most specifically, getting patent pending via a provisional patent application); STAGE 2 is about building the invention of the inventor (most specifically, proving the principle and/or prototyping the invention within the 12 months patent-pending status the inventor achieved in STAGE 1, culminating in the inventor having a non-provisional patent application filed to have the invention searched and examined at a patent office(s), with the benefit of having built the invention to a prototype level (which any skilled patent-writer will know, is extremely beneficial to have done, before filing a non-provisional patent application); and STAGE 3 is about facilitating the inventor in crowdfunding their invention (and in particular, facilitating them in so doing by providing or facilitating the creation of a video of the prototype (achieved in STAGE 2), which may then be used as part of a crowdfunding campaign, and possibly helping the inventor further by helping them with information and/or management and/or a template system for how to create and manage a crowdfunding campaign, for example, on Kickstarter.

There is also shown G1, which appears in the map/model as the gateway to STAGE 2 (and thus the gateway to invention development); and G2, which appears in the map/model as the gateway to STAGE 3 (and thus the gateway to ‘returning home’ with the invention.

The steps of the preferred embodiment as shown in FIG. 8 will now be described.

In step 1 (x1) a patent search service is provided. Preferably the service starts by providing a free patentability assessment, given to the inventor by a skilled patent practitioner. Preferably the skilled practitioner (if it is decided that the invention may be patentable and/or that a patent search may be useful and or desired and/or beneficial) ascertains what the invention(s) is. Preferably a high quality patent search (preferably a high quality worldwide patent search) of the invention(s) is then done. The patent search may be carried out by the skilled patent practitioner, or may be carried out by another party, which another party is preferably a highly skilled patent searcher or team, and more preferably is a patent office examiner or former patent office examiner.

The next step (x2) is the Provisional Patent Package step. Preferably, at this step, when the results are received from the patent search in step 2, if any of the patent claims come back clear, a provisional patent application is drafted for the inventor to get them patent pending on the claim(s) (ie the invention(s) defined in the claim(s)) that came back clear from the search.

Thus it can be seen the step 1 and step 2 are integrated and go together; in step 1, claim(s) are drafted which form the basis (and definition) of the patent search. Then the inventor, in step 2, is facilitated in getting patent pending on the claim(s) that come back clear from the patent search in step 1 (if any claim(s) do come back clear). The provisional patent application may be drafted by the skilled patent practitioner, or by any other party, most preferably a party that is a highly skilled patent practitioner(s).

Preferably, as part of the step 2 provisional patent package, they may receive a digital (patenting) program(s), which preferably include a filing video (or filing information) to show the inventor how to file their provisional patent application via a patent office online filing system (eg the USPTO online filing system) so that they can get patent pending (internationally) on their invention for 12 months. The digital program(s) are preferably much as discussed and disclosed earlier in the present application, which disclosure may be used as a basis of definition for these or any program(s) provided at step 2.

In Step 3 (x3), a build assessment is conducted, preferably by a highly skilled engineer(s) who may have significant manufacturing expertise and/or experience. One intent of this step is to ascertain any problems with how the invention will be built/manufactured, even before embarking on building and/or developing the invention, with a view to manufacture. This step may also iron out any problem(s) that may not have been conceived of (or may have been) by the inventor. A build specification may be provided and/or drawn up. It is feasible at this step, a ‘journey planner’ bonus and/or step may be provided, whereby the journey for how the inventor will get the invention to market is drawn up, for example by showing the inventor exactly which steps of the map/model they will need to complete to get their invention to market. This may be particularly useful if it is that certain inventions can by pass particular steps. The journey planner information may be provided to the inventor as a document (eg PDF document) and/or in any other way.

One intent of step 3 is to ready the path for step 4 (x4) where a proof of principle of the invention is built. This usually entails building a fairly basic version of the invention (not a finished prototype), which may be useful for testing purposes and/or making sure the invention can function as desired and/or intended.

In step 5 (x5) information and/or a service may be provided if new information comes to light, following building of the proof of principle in step 4, which is relevant to patenting of the invention. For example, the inventor may use their digital patent program(s) preferably provided to them as part of step 2 to add information (ie ‘matter) to their provisional patent application, and file it with the new information ascertained from making the proof of principle. Alternatively, such a provisional patent application may be drafted for them by a skilled patent practitioner, which may incur a further fee from them.

If a whole new (potentially patentable) inventive concept comes to light following build of the invention in step 4, they may require not only to get patent pending on it, but may require or want a patent search to be done, in which case a patent search service may be provided, which patent search service is preferably extremely similar, or the same, to the 2 step process of STAGE 1, whereby a patent search is conducted based off of claims, and the inventor is preferably then facilitated in getting patent pending with a provisional patent application as in step 2. It will be obvious to any skilled patent practitioner that such a ‘new provisional patent application’ specification for a ‘new inventive concept’ may be added to the specification of the old provisional patent application drafted in step 2, and filed as a provisional patent application containing disclosure of both or (all/more) inventive concepts.

Step 6 (x6) is shown as ‘Design/Presentation Materials’. This is intended to be a step where presentation materials for the invention are created/provided. The term ‘DESIGN’ is intended to imply that, as part of this step (or feasibly as an added step to the map/model), the inventive concept may be put through/go through a ‘design’ process, where, for example, a product designer designs the inventive concept into what closely resembles (or is) a final product design/embodiment. One intent of this step is to realize a high quality final prototype-type design (and preferably commit it to (3D) render), so that it can be used as a visual guide for the next step (prototype) so that the prototype can be made to look like the high quality product design embodiment.

It is also feasible presentation materials may be provided to the inventor that can help them present their inventive concept to potentially interested parties (eg potential investors, licensing companies that may manufacture the invention and pay the inventor a licensing fee, etc). However, it is well known to those with skill in the art of the invention process that such presentation materials (with current systems at least) very rarely lead to such deals. Thus the DESIGN and presentation materials step (x6) is intended primarily to realize the design of the future product which contains the inventive concept(s), with a view to the prototype being made to resemble (and/or directly match) the design.

In the next step (x7) the invention is prototyped. This service may be provided to the inventor and/or provided in any way, and/or the inventor may be facilitated by proprietor of the map/model/system for facilitating inventors, eg by connecting the inventor to any party(s) that can carry out a prototype for the invention (which at this point has now become a product).

Step 8 (x8) is shown as the non-provisional patent application step. This has already been described at length with reference to other embodiments of the inventive map/model/system in the present application, and (any of) what is described in previous disclosure may be provided. Preferably a digital program is offered/sold to the inventor which educates them about the non-provisional patent application (and its process), and about the prosecution phase at the patent office. This may help the inventor better understand (and read) the provisional patent application drafted for them by a patent practitioner. The system/model may provide drafting services to draft (and/or file) the non-provisional patent application for the inventor, which may incur a fee.

Step 9 (x9) is a trailer video step. This has been described previously.

Step 10 is a crowdfunding step. This has been described previously.

Preferably each step (or many of the steps) incur a charge/fee from the inventor for the service(s) (which term may include any product(s)) provided at that step (and/or to ‘complete’ that step).

Thus, in some embodiments, the system/model could, feasibly, be defined as a system for developing and manufacturing (and/or bringing to manufacture) an article (ie an invention/product), which is modified by the process. (It should also be noted (as mentioned previously), that the ‘producf/idea’ does not have to be a physical product/idea—eg it may be an app, and/or a website, and/or a business, and/or a business model, etc. Any project may be facilitated and/or developed).

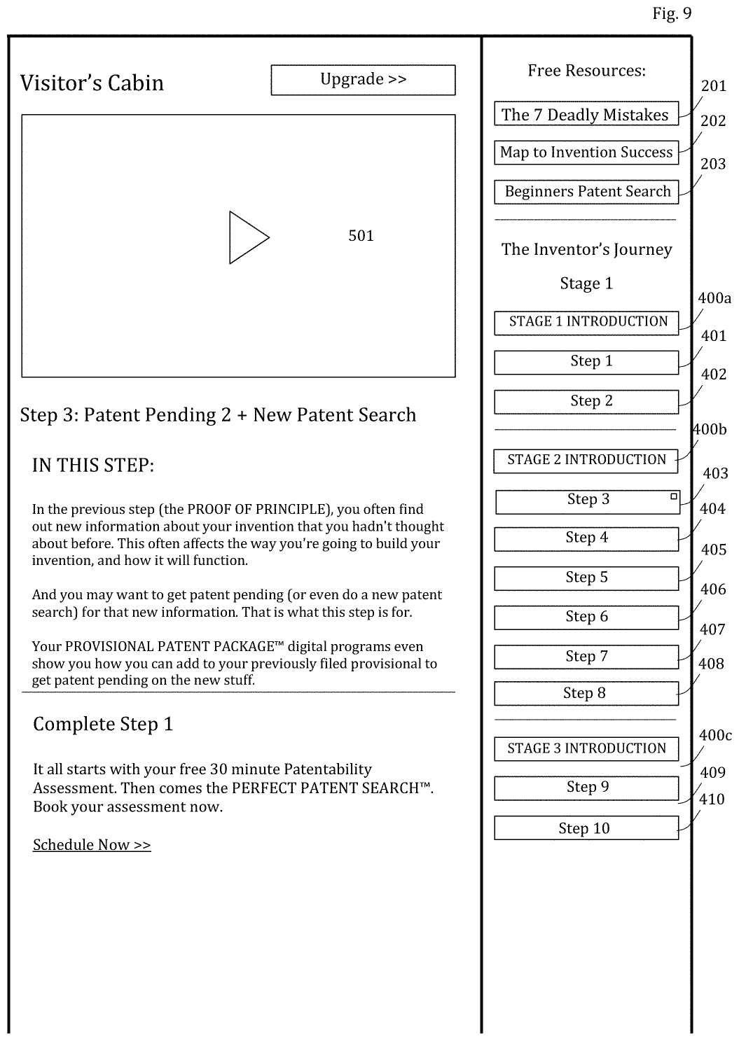

There is shown in FIG. 9 an embodiment of a user interface, similar to that shown in FIGS. 6 and 7, modified to suit the embodiment of the map/model/system shown in FIG. 8. Intent of the user-interface is to disclose information to the inventor to explain the model/map/system to them, and to make them aware of any services/products offered at each step, with a view to them being enticed to use the system (and thus the services on offer).

There are shown video tabs 401-410 to show videos explaining each step of the model/map/system. (ie step 1 tab (numbered ‘401’), when selected/clicked by a user, opens up (in the example embodiment) a video 501 in the viewing area, explaining that step to the inventor. When any step tab is clicked/selected, other resources may be available to the inventor—eg downloadable PDF's/information, etc.

There is shown video tab 400a, which when selected/clicked opens up a video in the viewing area that has an introductory video that explains about STAGE 1, including, preferably, its purpose (for the inventor) and preferably a brief outline of the steps that will be accrued out to complete it.

Similarly there is shown tab 400b, which when selected/clicked opens up a video in the viewing area that has an introductory video that explains about STAGE 2, including, preferably, its purpose (for the inventor) and preferably a brief outline of the steps that will be accrued out to complete it.

Similarly there is shown tab 400c, which when selected/clicked opens up a video in the viewing area that has an introductory video that explains about STAGE 3, including, preferably, its purpose (for the inventor) and preferably a brief outline of the steps that will be accrued out to complete it.

There is shown an ‘upgrade’ icon, which may be selected and/or clicked by a user to upgrade their account, eg to achieve ‘crew member’ status, which may lead to the inventor/user being provided with an enhanced user-interface, eg usable for a plurality of different inventions.

The or any user-interface is preferably provided by way of software, the software programmed to carry out any of the function and/or functionality and/or display any of the matter (including structural and/or visual aspects and/or elements such as those seen in the Figures which show a user-interface) as disclosed in the present application. The software may comprise code, which may be configured and/or designed to carry out any of the function and/or functionality and/or display any of the matter (including structural and/or visual aspects and/or elements such as those seen in the Figures which show a user-interface) as disclosed in the present application. The present invention (and any disclosure and/or disclosed feature(s) and/or element(s) disclosed in the present application, may be claimed and/or patented as software.

In the map shown in FIG. 8, there are provided large numbers on the map (numbered 1 to 10) to denote the sequence/order the steps are intended to be carried out in. This may help the inventor understand how the map works, and such annotations may be provided on the map if it is provided and/or shown, for example, on a webpage, or a downloadable document, such as a PDF for example. Any PDF provided of the or any such map/model/system may be annotated with brief annotations to give a quick summary to the inventor of what the step is and/or entails.

Any of the features and/or concepts for a model/map/system as disclosed with reference to the invention process, may be implemented for an alternate process, with steps relevant to that alternate process. Thus any such system for an alternate process may be claimed, claiming any features disclosed in this application when not limited to being provided for the invention process.

The embodiments described above are provided by way of example only, and various other modifications will be apparent to persons skilled in the art, without departing from the scope of the invention as defined by the appended claims.

Any novel subject matter or combination including novel subject matter disclosed herein, whether or not within the scope of or relating to the appended claims, or any statements of invention, may be claimed. Thus any feature(s) disclosed herein may be combined to form an invention that is claimed.

Disclosure of a Particularly Preferred Embodiment

The or a particularly preferred embodiment of an inventive method of facilitating idea development will now be disclosed, in no way limiting a scope of the invention. Whilst it will be described in isolation, the or any invention disclosed may be claimed comprising any feature(s) (or ‘step(s)’) disclosed, and/or in combination with any other feature(s) ((or ‘step(s)’) set out in the rest of the present application. Any combination of any feature(s) in the present application may be combined to form an invention claimed, and supported by, the present specification and/or drawings.

(Thus) there is shown, in FIG. 10, a method of facilitating idea development. Preferably it is partly computer implemented (as will be described).

As laid out, the preferred method comprises 8 steps, preferably carried out in a particular order. Thus the steps, in FIG. 10, are shown ordered, in number 01-08 to represent the steps and their preferred order.

In step 1, a patent search step/service is provided, which preferably (as has been stated/disclosed) comprises a (free) patentability assessment being provided for an idea of an idea creator (eg an inventor), with patent claim(s) then drafted to define the invention, and the scope of the search that will be carried out. The claim(s) may include an independent claim as well as several (or any number of) dependent claims so that important dependent feature(s)/inventive step(s) will be searched if the general inventive concept (ie independent claim) is found not to be novel.

The patent claim(s) are then preferably sent to a highly skilled patent practitioner (preferably a former patent office examiner), to conduct a search, based on the patent claim(s). Thus the search is similar in nature to how a search is carried out at a patent office.

If any of the claims come back clear from the search (or if the search shows up any patentable matter or any possible patenting strategy that could be of value to the idea creator (eg inventor), preferably in step 2, there is a service/step/product to get the idea creator patent pending on that matter (and/or any other matter).

Preferably a service is provided whereby a patent application is drafted for the idea creator. This patent application may use the claim(s) that came back clear from the patent search service/step as the basis for the patent application, and the claims may either be filed with the patent application, or may be incorporated into the Specification of the patent application by way of disclosure, preferably to guarantee the idea creator (eg inventor) getting patent pending on the matter that came back clear from the search. Drawing(s), of course, may be included in the patent application.

This patent application is then preferably filed as a provisional patent application (ie not including search and examination fees for the patent office). If this is done via the UKIPO (UK Patent Office), then such a patent application may be filed free. If the filing is done via the USPTO, the filing of a provisional patent application may incur a charge.

Preferably the ‘provisional’ patent application is drafted for the idea creator by a skilled person (which may, of course, incur a charge). Preferably the (provisional) patent application is also filed for the idea creator (eg as part of the service). However, as has been stated, the idea creator may purchase (or be given access to) program(s) which may facilitate in drafting (and filing) their own provisional patent application. Furthermore, it is possible a ‘hybrid’ service may be provided, whereby a ‘snippet’ is provided to the idea creator (which may, for example, be a snippet of text (and may also include any drawing(s)), which includes disclosure of any claim(s) that came back clear from the patent search service/step (or any matter relevant to any patenting strategy decided on in light of the patent search results), whereby the idea creator can use the snippet as part of a (provisional) patent application, and may be able to add to the disclosure (and may be provided with patent program(s) (preferably video based) to show them how to do that), and may also be provided with means to file the (provisional) patent application themselves.

Having got patent pending, the next step of the system is for a first basic version of the idea to be built (often called a ‘proof-of-principle’ or ‘proof-of-concept’). This will now be referred to as a ‘product proof’. Preferably there is included as part of the method/system for facilitating idea development a database of product development providers. This may include ‘teams’ (ie collections of individuals who work together), and/or may also include individuals. Many of the providers may be (professional) product designers or engineers. Thus such people are professionals in the field of product development, and may be skilled in any or all of building products, designing products, CAD, aspects of manufacture (such as ‘made-for-manufacture’ design), etc.

In one preferred embodiment, there is provided a means for the idea creator (either of their own accord, or helped by, or done by an alternate party, such as a member of staff of the method/system) to upload a disclosure of their idea to the system, so that it is viewable by product development providers who may be able to make a judgement as to whether they would like to provide a service to develop the idea into a product.

(The term ‘product’ here is used to imply that, at the least, a ‘prototype’ of the idea is built (ie a working version). More preferably, the term ‘product’ implies a prototype that looks and functions as close to a finished ‘sales-ready’ version of the idea as possible. It is also feasible that the term ‘product’ may even imply an actual finished product, (rather than simply a prototype) which is actually sales-ready. Note: when the ‘idea’ is not for a physical product (eg a web idea for how to sell something on the web), then a ‘product’ of such an idea may be any basic (or advanced) working version or demonstration of the idea.

The idea creator may be aided in disclosing and/or uploading their idea to such a database of product development providers. For example, a template may be provided for how to disclose the idea. This may include certain questions being asked for the idea creator to answer. This may include help in how to quickly, effectively and professionally disclose the idea. This may include advice and/or help and/or info as to (or how to) include drawings, sketches, etc as part of the disclosure. This may help the product development providers understand the disclosure and therefore the idea.

There may be a charge to the idea creator either for being able to upload their idea to the database of product development providers, or for the help provided to help them disclose the idea, or both.

The term ‘idea creator’ is a broad term and may often be just one person who has created or ‘come up with’ the idea. However, the term ‘idea creator’ is not limited to always defining one person, and may, for example be a term used for a plurality of persons when more than one person has been involved in the creation or ‘coming up with’ an idea. For example, a person may come up with an idea. Then their son may make an improvement to the idea. They may then move ahead with trying to develop the idea. In this case, the ‘idea creator’ could be the one, or the other, or could be both. Thus the term ‘idea creator’ is a broad term.]

The method/system may be configured so that the product development providers are categorized into categories of their expertise/fields of interest. Thus a provider who is particularly able/skilled in electronics and lighting may be categorized into a general field of ‘electronics, and into a more specific field of ‘lighting’. A provider may be categorized into multiple general and/or specific fields/categories. Thus the database of product development providers may include categorization of the providers into fields and/or categories.

Likewise the idea of the (or any) idea creator may be categorized before it is uploaded to the system. This may be carried out for every idea. Thus if an idea creator comes up with an idea in the field, for example, of lighting, their idea may be categorized, for example, in the field of ‘lighting’ (or in the general field of ‘electronics’ and the specific field (ie sub-category) of ‘lighting’. Thus when the idea is uploaded to the system/database of providers, a ‘match’ may be made, so that providers with particular skill or speciality (or ‘interest’) in that field are prompted and/or notified when an idea is uploaded to the system that is relevant to their skills and/or interest. It will be obvious that it may not be necessary to ‘categorize’ both parties (provider and idea). The providers may be categorized on the system, and when an idea is to be uploaded to the system, the category of the idea (or of providers desired to develop the idea) may be chosen (either by the idea creator or a staff member, for example, of the system). Thus, more generally speaking, this preferred feature may be described/defined as the idea and the product development provider being ‘matched’.

In one preferred embodiment of the method/system, there is provided a bidding system, wherein the providers, on seeing the idea disclosure (which is preferably provided via a computer implemented method) may bid (ie make an offer) for moving forward with developing the idea into a product.

(Note: Even graphics services, or any services at all to help develop the idea in any way, may be considered to be a product development service).

Thus a product development provider may make a bid/offer. For example, an individual or team may make an offer of $5000 to develop the idea (and may state what they will carry out for such an amount). Thus there may be provided means for the provider to bid, and means for the idea creator to receive the bids. This preferably includes a text interface where a text message can be sent by the provider to the idea creator.

Similarly, a second provider may see the disclosure, and may bid $3500. A third provider may see the idea disclosure, and bid $10,000. The idea creator may have the ability to choose which provider they would like to develop the idea. Preferably the providers cannot see each others' bids, which may increase competition as they may want to make a lower bid than competitors in order to secure the job of developing the idea.

In one preferred embodiment, success rate of the product developers in successfully getting products to market (and, more preferably, with the success rate further being defined as defining that the idea creator made more money than they spent either with the product development provider, or with the product development provider+using the method for facilitating idea development (which may include patenting and any other service(s) on the system)—ie success rate of generating a ‘profit’ for the idea creator) may be displayed to the idea creator.

For example, in the example given above, the idea creator may have received the three bids of $3500, $5000, and $10,000 from the product development providers. They may also see the previous success rates of the providers displayed for each bidder. Thus they may see that the $3500 bidder has currently not brought any products to market generating a profit for any idea creators. (No percentage success rate, or ‘zero’ percent at generating profit for idea creators); that the $5000 bidder has a previous success rate of 10% at generating profit for inventors/idea creators more than what they spend; and that the $10,000 bidder has a previous success rate of 26% at generating profit for inventors/idea creators more than what they spend. Other values may be displayed—for example, the idea creator may be able to see the actual number of projects that the product development provider (PD provider) has successfully generated a profit for inventors/idea creators on, rather than just a percentage. Other values may include previous work/portfolio, reviews, ratings, etc.

Thus bids may be received, and preferably there is provided means for the idea creator to hire one of the providers. (This may be achieved simple from clicking a ‘hire’ button, for example). A payment system may then be included, which may include being able to take payment for and/or from the idea creator, and may include being able to transfer the payment to the provider, and may include an escrow service of holding the payment in escrow from the idea creator until a milestone or service has been complete. (The system may allow for payment to be made via services such as PayPal and/or bank transfer, and/or credit card and/or any other method/means, etc, etc)

Preferably, in this step, a product proof is built first (before a more advanced product prototype). However, this may not always be necessary, and a product proof may only be required when an inventive concept (or product concept) needs to be proved to be workable.

Thus in step 03 of the method (as shown in FIG. 10), preferably a product proof is built of the idea.

If the product proof proves the principle of the idea/invention, preferably the next step (step 04) is the full patent application step, whereby a patent application is filed for search and examination at a patent office. (In cases such as use of the UK Patent Office, this may in fact not require a ‘new’ filing of a patent application, and instead, it may simply be that fees for search and examination (and perhaps, a small application fee) can be paid for the same application filed in step 2, to get the application searched and examined).

Thus a filing is made for search and examination. Preferably the application is filed at the UK IPO (UK Patent Office) under acceleration, with results received within approximately 8 weeks or less.

Preferably the idea creator waits until results are received before moving onto the next steps, although it may well be that the next step(s) or certain aspects of the next step are available to the idea creator whilst this wait for official patent office results goes on.

Next step (step 05) is preferably the product design step. This is where a product designer (preferably) designs the concept into a design that will be used to prototype the idea into a product prototype. The intent of this design step is usually to design the idea into a finished product (ie same or similar to that which will be used when the product launches). This step may well be carried out by the or a provider hired in step 04, or may be carried out by any other provider.

It will be well-known to professional product designers that often a product is fully designed very early on in the development process, or alternatively, a product may sometimes be fully designer later, or may be re-designed subject to required changes (or improvements) in the product's functionality. Thus this step may be carried out partially or fully in a different order (ie earlier) than that shown on the system in FIG. 10.

The product design step will tend to include 3D graphics (built in 3D rendering software), which at least shows outer aesthetics of the product, and may even incorporate internal engineering aspects. Some part of the product design may be 3D printable, and may be usable as part of the next step—the product prototype.

In step 06, a product prototype is built. Again, this may well be done by the same provider hired at step 03. The intent of this step is to make an as-close-to-sales-ready version of the product as possible—but usually a one-off version, thereby not having to expend tens of thousands of pounds/dollars on tooling/manufacturing, etc.

Step 07 of the shown example is a Marketing step. This could more roughly be called a ‘presentation’ step. An intended most important service/function of this step is to create a video of the product prototype in action, often fully storyboarded, scripted and narrated (although a script and narration may not always be required). Such a video may previously have been disclosed using a term such as ‘trailer video’. The intent is to make a short, stimulating, informative, and engaging video of the product prototype in action (ie live footage showing the prototype). This step (marketing) may also include providing a website for the idea creator and their product. This may incur a charge. It may also include information and help regarding social media, eg how to set up a Youtube channel and upload the video of the prototype to Youtube®. It may also include service(s)/product(s)/help for how to set up a Facebook® channel, or any other social media outlet.

In step 08, preferably the method for facilitating idea development comprises a database of product launch facilitators (PLFs). The PLFs may include potential licensee companies that the idea creator may be able to enter into an agreement with to license their idea (ie the licensee company may launch the product, thereby taking it to market); they may include retailers, who can retail the product(s)/project, (eg high street stores/chains, for example); they may include investors, who can invest in the project, and may also be able to help get the product to market. Such ‘investors’ may simply invest (with no further input or little further input into actually launching the product) or may be akin to ‘Dragons’ or ‘Sharks’ that receive an equity amount (or any financial agreement) and help the idea creator launch the product and/or build a successful business round the product.

Thus the PLF database includes parties who can help (or be involved in) launch of the product. These are just several examples of PLF's—there may be other types of PLF's. But the intent of this step is to get ‘SUCCESS’ with the product, and that, of course, means launching the product, so the PLF's are providers to facilitate, in one way or another, launch of the product. This may even include specialists who specialize in helping inventors (or any idea creator) in ‘self-launching’ their product. (eg via their own website, or other websites, such as, but not limited to, Amazon®, Ebay®, or the like, etc).

The database for product development providers, and the database for product launch facilitators may each be a separate database, or may be the same database. The overall system may be referred to as The Mainframe, and may also be defined as a ‘platform’.

Note: In situations where there it is disclosed and/or defined that there is a database [for a particular party-type]; and a database [for another particular party-type], it includes within its scope there being a database [for both the particular party-types], (ie the database for the first particular party-type and the database for the other particular party-type being the same database. (ie There may be a database, with both party-types being sub-categorized/included on that same database). (Of course, it is also possible that the databases are different databases). Thus, if it is disclosed/defined that there is a database for providers, for example, and a database for users/creators, for example, (which is a different party-type than providers), then that includes within its scope there being a separate database for each party-type, and a database that includes both party-types. In such a case, (where the database for the different party-types is the same database), then that database is an example of a database [for a particular party-type]; and a database [for another particular party-type].

In this step, in the preferred embodiment, the video (‘trailer video’) of the product in action is uploaded to the database of PLF's. The intent is that the PLF's, on seeing the video of the prototype in action, can very quickly (within seconds) assess whether 1) they think the product is commercially viable, and 2) they are interested in trying to get (or help get, or play a part in getting) the product launched (and perhaps entering into a business agreement with the idea creator to do so).

One primary aim (for idea creators who want to license their product) is to facilitate licensing of the product. Thus similarly as per the process regarding disclosing/uploading of ideas to the database of product development providers (PDPs), PLFs (including potential licensee parties) may be categorized as to the fields of their expertise and/or interest in bringing products to market. For example, an entrepreneur who owns a chain of exercise gyms may join the system as a PLF. He may be categorized on the system under a category, for example, of health and fitness. Having been so categorized, he may now be alerted/notified when product videos are uploaded to the system that are in the category of ‘health and fitness’.

Thus, for example, if an idea creator has come up for an idea for a new exercise machine for a gym, and has preferably had the product developed by a PDP, and converted into a product video, when the product video is uploaded to the system (preferably at step 08), the PLF may get notified/alerted of the product/product video, and may be provided with a link (or any means) to watch the video. The system may be secure and confidential and all providers of any sort (including any PDP's and PLF's) may be signed up to confidentiality agreement(s) and/or clause(s).

Thus the PLF can view the video, and, if they are interested in the product, several options may be available to them. First, they may be able to ‘save’ or ‘favourite’ a video so that the product/product video is stored on/in their account (or via any other means and/or in any other way) for them to watch later if they choose. (Preferably all parties (idea creator, PDP and PLF all have password-protected accounts they can sign into, with the system primarily preferably being a computer implemented/facilitated method/system).

The PLF may also be able to ‘show interest’ in the product/product video, to signify that they are potentially interested in playing a role in launching the product. The idea creator may be made aware/notified, via their account, if any PLFs have ‘saved’/‘favourited’ their product, or if any PLFs have ‘shown interest’ in their product, or either, or both.

If a PLF decides they would like to actively play a role in launching (or playing a role in launching) the product, they may initiate contact with the idea creator and/or make a bid/offer. Similarly to the process with hiring (and receiving bids from) PDPs, the idea creator may receive notification of such offers/bids, which are preferably viewable inside their account/interface.

Thus in the example given above, the PLF who owns a chain of gyms, if he sees the product video and thinks this is definitely a product he could buy for use in his gyms, (and which could be sold to other gyms), he may be able to initiate contact and/or make a bid/offer to help the product get launched (which could, for example, include him buying a number of units of the product, or generally helping launch the product). Preferably, rather than making general contact, the PLF may be obliged to make a bid/offer. (If a PLF is a potential licensee company that may want to launch the product wholly themselves, the offer/bid may include a licensing deal for the idea creator, and may include details regarding the royalties amount the idea creator will receive. Of course, if the idea creator received multiple such bids, the idea creator may be able to choose which deal best suits them (eg financially). This increases competition, and may therefore lead to better agreements/bids for the idea creator.

Unlike the process regarding bids made by the PDPs, it is possible if bids/offers are made for the product by other PLF's that this may be displayed and made known to other PLF's. It will be obvious that this will still further increase interest and competition in the products, since a PLF will not want to ‘lose’ a product they are (financially) interested in, and is therefore more likely to bid/offer (and to do so more aggressively) if they know other PLF's are trying to launch the product.

Thus a ‘bidding war’ may break out for particularly desired products. Again, success rates of the PLFs may, potentially, be made available—(of generating profit for idea creators). Other details of the or any PLF may be shown and viewable by the idea creator, such as commercial background, field of endeavour/expertise, achievements, (past sales figures), etc.

If the PLF is a retailer, the system may work slightly differently, in that interest shown by the retailer may still further need a PLF to help launch the product in order to get it to the retailer. For example, a retailer who retails health products may like a product that helps kids sleep better at night, and may signify that this is a product they are interested in selling. Nevertheless, if any tooling/manufacturing (+packaging, or any other cost) is required, the idea creator may not have the funds to launch the product. Therefore an investor may be required to invest in the project/product. If retailer signify they are interested in selling the product, this information may be made available to potential investors on the system (or to any other PLF).

Preferably, the intent of this step is to have the product launched, and/or for the idea creator to receive financial reward such that they have made a profit and/or for the user to connect with a PLF that can help them and/or play a role in the product(s)/project being launched and/or the user in making money and/or a profit.

PLFs may be charged in order to have access to the system and/or hold an account on the system.

PLFs may be able to view information pertaining to previous steps of the journey/system the idea/product has gone through. For example, a PLF may be able, if interested in a product, to view the results, for example, of the idea creator's patent search for that idea. Or, more preferably, may be able to view the patent office results for their patent application. Such results/info of previous steps (or simply of patenting results/info) may be made available in any way to the PLF.

Having access to previous (or extra) information about the idea/product (and/or patenting) may incur an extra charge, so that the PLF has to pay a fee to get this (and/or any other) added value information. Such a charge may be a one-off charge (eg a charge to view extra information for one product, or a selected amount), or may be, for example, a long-term charge, such as a charge per month, or per year, which then gives the PLF the ability to view such added information on any products during the time they're signed up to such a package.

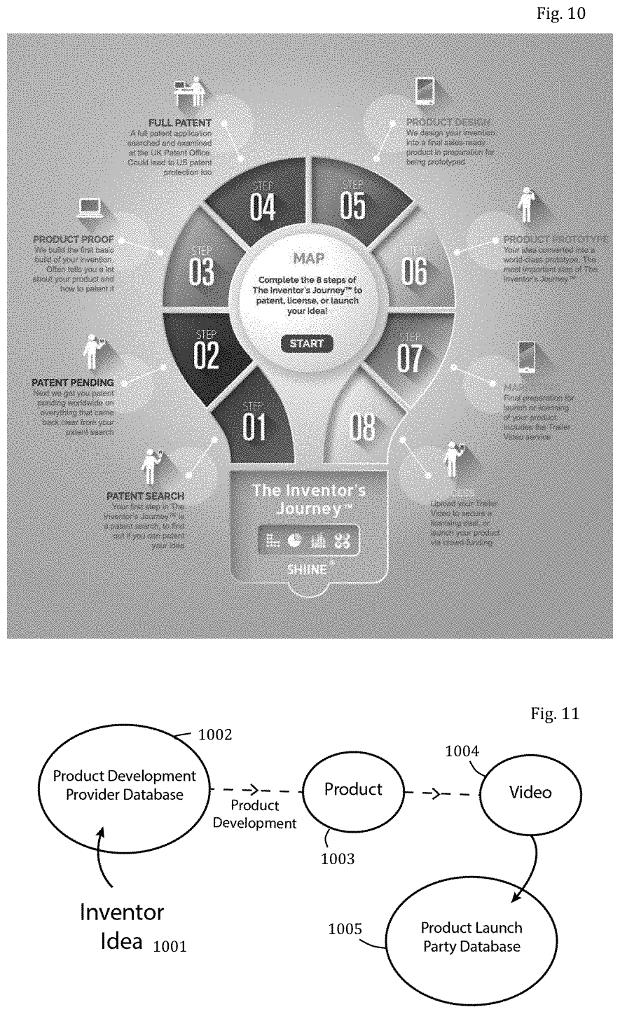

There is shown in FIG. 11 a basic embodiment of an invention that comprises an idea creator uploading/disclosing an idea 1001 to a data base 1002 of product development providers (PDPs). (The idea 1001 being uploaded to the database is shown in the example representation being an idea of an inventor, but it could be any idea (eg a product concept that is not patentable), and is not limited to being a ‘physical’ product, and could be, for example, a business method idea, a web idea, an app, a method, etc, etc.

The product, having been taken up by a product development provider (PDP), is developed by the PDP into a product 1003 (preferably a prototype that looks and functions as close to a sales-ready version of the product as possible). (If the idea is a website idea, the ‘product’ may be a prototype version of the website, showing the idea/website in action. So the same with an app—the ‘product’ may be a prototype version (or even a finished version) of the app. Thus the idea is not limited to being a physical product).

A product video 1004 is then made, which shows the prototype in action. It is feasible (though not preferred) that, in cases such as an app (or even website idea) that a product video may not be necessary, and instead a demo version of the product may be made available for using for the PLFs, rather than a video being provided. (Or both may be provided).

The product video is them uploaded/disclosed to a product launch facilitator database 1005. Hopefully a connection is made between the idea creator and a product launch facilitator (PLF) that enables the product to be brought profitably to market (or successfully, where profit is not sought by the idea creator).

The PLF may receive a percentage of profit of sales of the product (or a percentage of profit and/or equity of any business that is formed around or by or including the product). This bids of different amounts (eg of investment and/or percentage—eg percentage of equity) may be made (and may be viewable by the idea creator on the system, preferably via their account, and the idea creator may be able to choose which bid/offer to move ahead with.

Anchoring the Steps

As shown clearly, preferably the method comprises certain steps that must be completed by the idea creator (8 steps are shown in the example of FIG. 10). More preferably, the method comprises certain steps that must be completed, in a certain order.

As stated previously, (in earlier parts of the present application), the method may include a user-interface for the idea creator (or any user). In one preferred embodiment, the user is ‘anchored’ at the next step of the method/system they have not presently completed. This may include consultation (eg from a staff member of the method/system or such company that employs the method/system) to ascertain which step the user needs to complete next.

For example, if the user is an inventor who have invented a proposed invention, and they have not had a patent search yet, preferably they are ‘anchored’ at the patent search step, in such a way that they are not able (or ‘allowed’) to access products, services, etc in future steps. This is a way to control the journey of the user to make sure they carry out steps in a particular order, which may, for example, be extremely important in them moving forward correctly with their idea and optimizing their chances of success.

As stated, preferably there is provided a user-interface for the user, and when ‘anchored’ at a particular step, certain products, services and ‘abilities’/options may be shut off, or not available for the user. More options may open up in their user-interface as they go through the journey and complete a next step(s).

Regarding step 03 (or any step of any system which includes disclosing an idea to a database of product development providers (PDPs) with a view to having an idea developed into a product (or having a basic product developed into a more advanced product), such a step may not be allowed until a patent search, at least, has been carried out for the idea, and furthermore, such a step may not be allowed until the idea is also patent pending. Preferably the patent search and patent pending step are carried out by the or a company that employs the method/system for facilitating idea development. However, it is feasible either or both may have been carried out (or may be carried out) by an alternate provider(s), in which case, it is feasible the or a company that employs the method/system for facilitating idea development may check whether the steps have been adequately carried out, and, if so, allow the user to progress as if such step(s) have been completed. Alternatively, it may be adjudged that the user must carry out the steps with the company that employs the method/system for facilitating idea development, particularly if it is adjudged the steps were carried out to a substandard or dubious level elsewhere.

Having stated that it is possible, in one embodiment, that the idea creator is not allowed access to the product development provider database until after a patent search and/or patent pending step has been completed, it is, alternatively, feasible that the patent search and/or patent pending step are not carried out (or, feasibly, even not allowed) until after the idea has been disclosed/uploaded to the PDP database, and at least one bid has been received from a PDP to develop the idea into a product. In a still more limited embodiment, it is feasible the patent search and/or patent pending step are not carried out (or, feasibly, even not allowed) until after the idea has been disclosed/uploaded to the PDP database, and a bid from a PDP have been received and accepted by the idea creator. Such an embodiment may be employed to make sure that any idea for which a patent search and/or patent pending step is provided/sold are more likely to be commercially viable product ideas, because if a PDP has agreed to develop the idea, it may be indicative that the idea is likely to have some chance, at least, of being commercially viable (rather than in a case where no bids are received from any PDP, which may suggest the idea is not a particularly good one).

Thus, in the shown example, in one embodiment, it is feasible access to step 03 (or any step of disclosing/uploading an idea to a database of PDP's with a view to a PDP developing the idea into a product) is prevented until step 01 and step 02 are completed (or any step that preceded such a disclosing/uploading to a PDP database.

Yet in an alternate embodiment, it is feasible step 01 and step 02 (or any patenting step) is not allowed/accessible to the user until an agreement has been reached with a PDP to develop the idea into a product. (or at least to have received a bid(s) to develop the idea into a product). For the sake of the present application and/or claims, such an ‘agreement’, whereby a PDP has bid to develop an idea into a product, and an idea creator has accepted the bid, will be termed a ‘link’ between the idea creator and a PDP. So the same term ‘link’ may be used in a claim to define when an offer/bid has been accepted (or any agreement reached) between an idea creator and a product launch facilitator.

If an Inventor/Idea Creator has Already Built a Product Proof

It will be obvious that some inventors (or any idea creator) will have built a basic functioning version of their invention/product idea (or idea of any sort), perhaps done by themselves) before entering into the system. (ie before coming into contact with a company employing the method/system.

If this is the case, then with reference to the example embodiment of FIG. 10, it will be obvious that the step of Product Proof (step 03) will already have been carried out by the inventor/idea creator. Thus this step is already complete. Furthermore, once the patent search (step 01 in the example) is completed, if it comes back showing patentable, matter, there is no need to file a ‘provisional’ patent application, because step 03 (proving the principle of the product) has already been done, so a user may move straight from step 01 to step 04. This a user who already has a functioning version of their idea, and enters the system, does not need to complete steps 03 and steps 02 when traveling through the journey with a company employing this system.

In rare cases where an idea creator enters the system (ie engages a company employing the method/system) wherein they already have a prototype (eg of a sort adjudged to be fit for making a product video of), they may be obliged to complete the patent search step (if their idea may be patentable) and the full patent step (if their idea is patentable), or may be allowed to go straight to the marketing step (ie having a product video made). They may then be allowed to upload/disclose their product video to the PLF database.

Financial Incentives for Providers (and Feasibly for the Method/System)

In this disclosure, there have effectively been disclosed at least 3 parties that are helping the idea creator (user). They include: 1) a company/entity that employs the or any such inventive method of facilitating the user in developing their idea into a product (and hopefully launching the product), which company/entity will now be termed the ‘owner’ of the system/method/platform for the following portion of the disclosure in the present application; a product development provider (PDP) to develop the idea (or a basic product version they have) into a product (preferably a high quality prototype); and a product launch facilitator PLF), who may be an investor, potential licensee company, retailer, or any specialist or party who can help get the product launched.

Thus there are mentioned three relevant parties: owner, PDP, and PLF. All three of the parties (or any one or more) may have a financial interest in the successful release/launch of a product.

For example, with reference to the PDP's, it is possible they receive a percentage of profit from successful sales or licensing of a product they develop. For example, at time of bidding, it may be shown (or known/made aware) to the user (idea creator) that the PDP they choose will receive 20% of all profit generating from the sales/licensing of the product they develop. Thus the idea creator may choose a PDP to develop their idea into a product. It may be developed, and may be launched by the idea creator. The PDP may then receive 20% of the profit generated from sales of the product, or 20% of the amount the idea creator receives either from the sales of the product (eg the idea creator may only own 50% of the business that the product creates, in which case, the PDP may get 20% of the 50%, thereby totally 10%. (This is given by way of example and in no way limits how percentage amounts are derived from product success, to any PDF). Alternatively, once the PDP are apportioned a 20% cut of profits (or of any amount, not limited to profit), that figure may be static, even if the idea creator gives up some equity of the product or a business relevant to the product. Thus in such an example where the idea creator gives up 50% equity, the PDP may nevertheless retain a full 20% of the 100% of the product/business.

If the idea creator licenses the product, the PDP 20% may only be with reference to the amount made by the idea creator. Thus is the idea creator licenses their product and only receives 10% of profit generated from product sales, the PDP may then receive 20% of that 10%, which would be 2% of profit from sales. Alternatively, the 20% amount may either remain static (ie the PDP still receive 20% of the total of profit generated from product sales, with the idea creator than receiving 10% (in tis example), and the licensee company, for example, receiving 70%, or an arrangement may be provided where the 20% is lowered in a case where the product is licensed, but perhaps not so low as 2%. Thus the PDP may receive a different profit percentage and/or amount, dependent on whether the product is launched by the idea creator themselves, or whether it is licensed (or sold) by the idea creator.

Such agreements (eg agreements that financially benefit the PDP) may even be relevant when a patent is sold by the idea creator, such that the idea creator benefits financially from sale of the product. Thus the PDP may, feasibly, financially benefit from sale of a patent of the idea creator, relevant to the product

It may be that the system is configured all PDP's receive the same percentage amount (or any amount). Eg all PDP's may receive 20% of profits from successfully launched products that they developed. Or it may be that the PDP gets to choose what percentage it receives. This percentage (or any amount) may then be shown to the idea creator when bids are received from PDP's to develop the idea, and this figure may therefore be relevant to the idea creator in deciding which PDP to choose/select/hire.

It may also be that the percentage is different, dependent on how developed the idea is when it first is disclosed/presented to the PDP. Eg if the idea creator already has a product proof, the PDP may receive less of a (profit) amount if the product is successfully launched, than if the PDP developed the idea into a product from scratch, for example, or from the idea creator not having a product proof.

Preferably, if a percentage (or any amount) is received by the PDP, it is preferably only received for a set limited time. For example, the PDP may receive 20% of the profit generated from the product, but only for 6 years, with the 20% (or any amount/percentage) then defaulting back to the idea creator after that time.

Regarding the PLF's, it will be obvious that if a potential licensee company make an agreement with the idea creator, and take the product to market, the agreement will typically be for the idea creator to receive a small percentage of profit generated from sales of the item (or any amount, such as an amount of money per unit sold), with the lion-share going to the licensee company that release the product.

For investors, if they invest in a way as made clear on programs such as Dragon's Den®, Shark Tank®, etc, it will be clear they may well invest with a view to attaining an equity share of the business that is formed by the product (and its sales). This will be obvious. Such agreements may be reached using the method of facilitating idea development (and/or launch) as disclosed in the present application. Such agreements tend not to be for limited set portions of time, although it is feasible such agreements may be for a limited set portion if time, with all profit amounts agreed upon later defaulting to the idea creator. However, as stated, these such agreements tend not to be for limited set portions of time.

The owner of the system/model (or party that employs the method of facilitating idea development, which owner and party tend to be the same entity), may also benefit financially from the method of facilitating idea development. For example, the owner may receive an amount (which may be a profit amount, or any amount) from any or all of: the idea creator, the PDP, or the PLF if a product is successfully (and profitably) launched, using the system. Such an arrangement may be made clear to any of those parties to which it is relevant, and it may be required, if such agreements are provided, for them to sign such an agreement, in order to use the system/platform.

For example, the owner may receive 1.5% of profit (or any amount) generated from sales of the product (indefinitely). Alternatively, the owner may receive 1.5% of profit (or any amount) generated from sales of the product for 6 years (or any set time).

Alternatively, the owner may receive a lump sum (perhaps $5000) for any product that successfully launches and generates a particular amount of profit (eg $20,000). There may be further payments required dependent of any further thresholds of profit generated from sales of the product being met.

Alternatively, the owner may receive a percentage (or any amount) of the profit made by a PLF if a product is successfully and profitably launched. Or the owner may even be paid an amount by the PLF for any product they make an agreement with to launch or help launch.

Similarly, the owner may receive a percentage (or any amount) of the profit made by a PDP if a product they develop is successfully and profitably launched. Thus is the PDP are getting 20% of the profit generated from sales of a product they developed, the owner may in turn get 5% of that amount (ie a 1& total of profits generated from successful launch of the product.

There are many other ways the owner may benefit financially, not in any way limited to the examples given. As has been stated, the owner may charge any of the parties, simply for being able to use the system. Eg there may be an annual charge for PLF's, or, for example, an initial registration charge (or even a monthly charge) for PDP's.

Crowdfunding

Whilst there has been a significant focus in this portion of the disclosure in this present application on the concept of an idea creator using someone else to launch (or help launch) heir product, typically with them losing equity, it will be well-know that crowdfunding gives the opportunity for an idea creator/user to fund the release of their product (and in fact, effectively make their first sales, through ‘pledges’), without losing equity.

Thus, in a preferred embodiment of the inventive method/system to facilitate idea development, the option to crowdfund is either provided as an alternative, or along with, using a PLF of the sort previously discussed.

Thus it is very possible, rather than disclosing/uploading the product video to a database of PLF's, an option to crowdfund may be provided. This may involve a crowdfunding package to help the idea creator create a crowdfunding campaign themselves, and/or may involve providing a service to take care of the crowdfunding campaign for the idea creator. This may be done by the PDP, or by the owner of the method/system to facilitate the idea creator, or may be provided by a specialist team (eg specialist video team) who specialize in creating crowdfunding campaigns.

Whosoever provides the means for the idea creator to crowdfund the product may either be included on the database of PLF's (and accessible in the same or a similar way), or may be accessible in a wholly different way (and perhaps via a different database/connection method.

The inventive method/system may allow the user to choose which option they prefer to do (crowdfund, or use traditional PLF's such as potential licensees, investors, etc), and may channel the idea creator accordingly to help them link with a relevant provider. The or any crowdfunding providers may be staff of the owner, and/or may be freelance.

Thus step 08 (in the given example) preferably comprises both the possibility of linking with PLF's, or of crowdfunding the product. As stated, crowdfunding specialists may be deemed PLF's and may be on the PLF database. Crowdfunding specialists may even be included as part of a product development provider, whereby they have formed a team, so that the PDP not only develops the product, but offers an all-in-one service to help launch the product via crowdfunding.

As for crowdfunding, so for video creation (ie making a product video)—this may be done by specialist teams/provider(s), who may operate separately, or may operate as part of ‘teams’ thereby incorporated into a PDP(s). It may be attractive for idea creators to hire a PDP knowing that they can not only develop the idea into a product, but successfully launch it via crowdfunding. As stated, the PDP may receive a profit amount (or any amount) of profits generated from sales of the product, and may receive an amount if the product is successfully launched, particularly if they launch it themselves (eg via crowdfunding).

It will be obvious that the video (product video) may be used as part of the crowdfunding campaign (eg in a main campaign video)

Compass

As stated, in a preferred embodiment of the method/system to facilitate idea development, the system comprises a set sequence of steps which must be completed, in a certain order. This is done in order to maximize the likelihood of a commercially viable idea being successfully developed into a product, and successfully launched, preferably generating a profit for the idea creator. In the case of inventive idea (patentable ideas), the shown preferred embodiments (in particular, FIG. 10, though not limited to FIG. 10) show not just how to develop an invention idea into a product, but how best to interweave patenting. Thus the system shows product developing, and patenting, interwoven.

One thing that may be particularly useful is a type of ‘compass’ that continually points the user/idea creator in the right direction, telling them the next step they need to focus on, and complete, in order to get to success, using the system (or any system for that matter).

Thus there is shown in FIGS. 12-16 a sequence showing one embodiment of how such a ‘compass’ may be provided. In FIG. 12, there is shown a question, within the ‘map’ of the steps (although the question may be provided anywhere, not limited to the position it is shown).

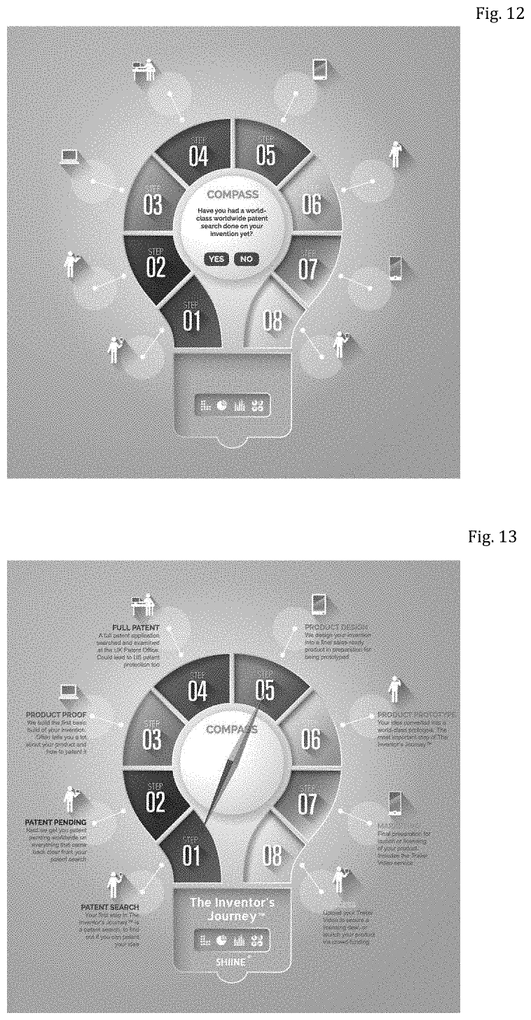

The question asks, in general terms ‘have you had a patent search yet?’. If the user clicks/chooses/selects the button that says ‘no’ (thereby stating that they have not had a patent search yet), they then see what is shown in FIG. 13, where a compass needle has pointed to step 01 (patent search), thereby telling them that ‘patent search’ is the next step they need to focus on and complete. (The needle is provided by way of example only—any indication or pointing element, or any method for telling the user what they need to do next may be provided).

Preferably below the compass (or anywhere), text is provided to explain and make clear what the next step is, and perhaps giving a brief explanation why and/or what the step entails.

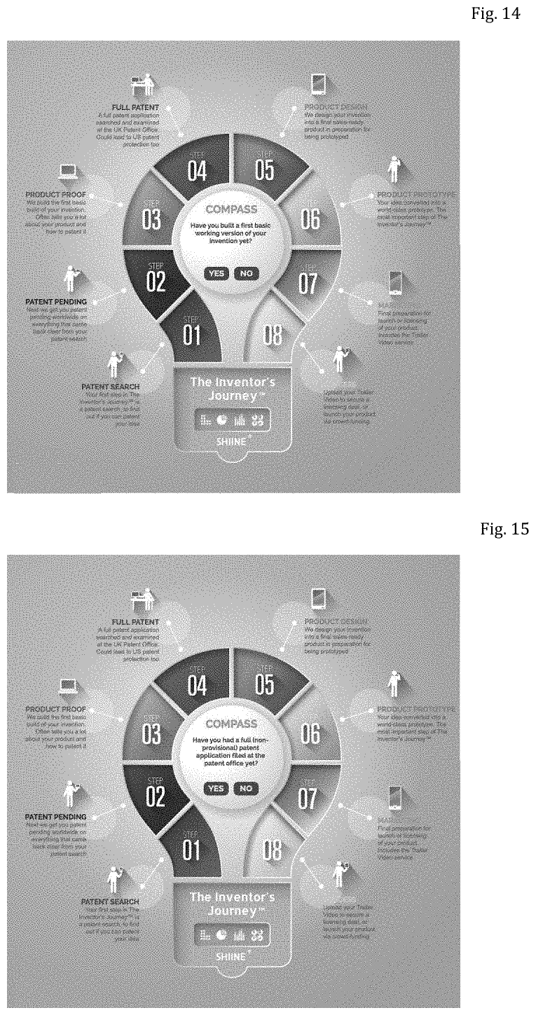

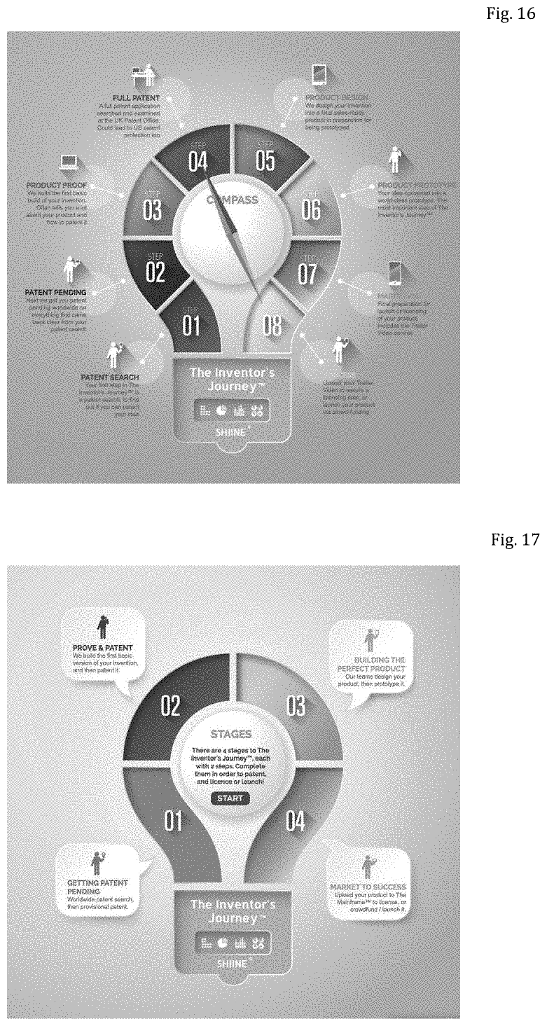

However, if the user responds by choosing ‘yes’, thereby stating that they have had a patent search, they are shown what is seen in FIG. 14, whereby a new question is provided asking whether they have built a product proof yet (basic working version of their product concept). If they respond ‘yes’ to this question, they are then shown what is shown in FIG. 15, whereby a new question is asked, asking them, generally, whether they've filed a full patent application for search and examination at the patent office. If they choose ‘no’, they are shown what is shown in FIG. 16, where the compass has now ascertained that the next step they need to focus on and complete is step 04 (full patent application), and the needle of the compass (the coloured part of the compass) is pointing to step 04. Thus, by asking a sequence of questions, the compass can ascertain which step the idea creator (eg inventor) need to focus on and compete next, (Again, explanatory text may be provided below, or anywhere (including in the central portion where the question is shown in some of the depictions.

This ‘compass’ type system may be provided by way of an application (eg coded), a PDF, on a website, or by any other method. The compass-type concept need not necessary heavily resemble a compass. However, it functions like a compass, pointing the user towards their destination of success, which destination is invention success if the user is an inventor. Any system/configuration which asks the user a sequence of questions, and then points the user to a desired destination, by telling them what step they must focus on and complete next, as part of a system that comprises steps to get to the desired destination (preferably which must be completed in a certain order), is considered, for the sake of the present application, to be a compass. The compass does not have to literally ‘point’ (ie have a pointing element), ie it could simply state what the user must do next, thus ‘pointing’ them in the right direction, either literally, or metaphorically. Nevertheless, preferably the compass does comprise a pointing element.

The embodiments described above are provided by way of example only, and various other modifications will be apparent to persons skilled in the art without departing from the scope of the invention as defined in the appended claims.

FIG. 17 shows an embodiment of the method and/or configuration of how to show the method, broken up into stages. In the shown example, the previous eight steps shown (or any number of steps for any system) are broken up into four stages (although they may feasibly be broken up into any number of stages. In the shown preferred embodiment, the first two steps (patent search+(‘provisional’) patent application) of the eight step system combine to form stage 01 (as depicted), which is stated as being ‘getting patent pending’; steps 3 and 4 of the eight step system combine to form stage 02 (as depicted), which is ‘prove and patent’ (preferably including the ‘proof-of-principle Product Proof step, and a full (non-provisional) patent application step); steps 5 (product design) and 6 (product prototype) of the eight step system combine to form stage 03 (building the perfect product); and steps 7 (marketing) and step 8 (success) of the eight step system combine to form stage 04 (market to success). This is a preferred embodiment.

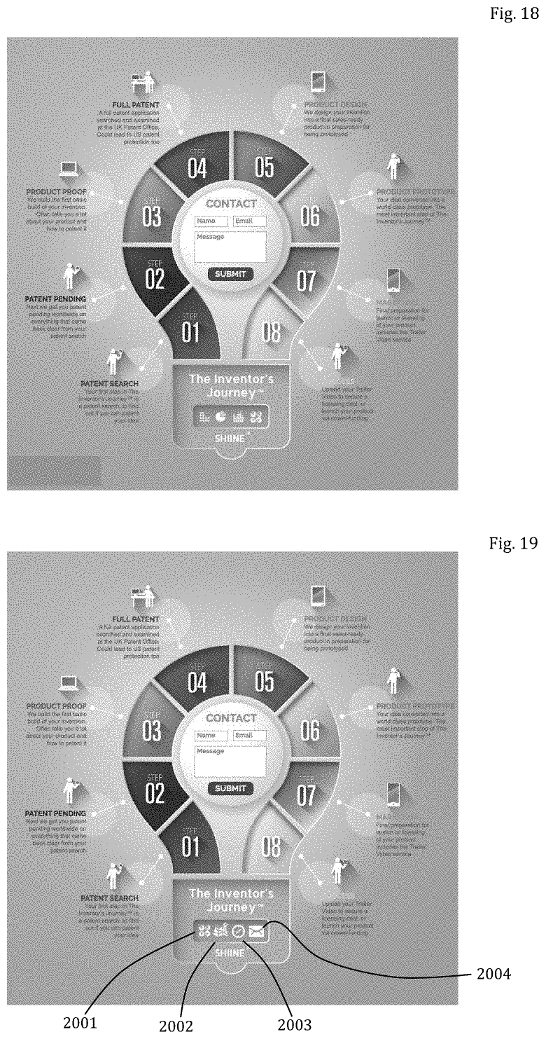

Regarding FIG. 18, it is shown how the lightbulb-type configuration (or any configuration not limited to a lightbulb configuration) may provide means to allow a user to send a message and/or make contact with the provider/owner of the system/configuration (usually the owner of the inventive method). This configuration may be run on a website, or an app, or via any other means.

Referring to FIG. 19, it is made more clear that this application and/or configuration (which may be coded for an app and/or website, for example) may allow for any or all the views and/or options that have previously been shown. For example, in the preferred embodiment as shown, there are shown icons 2001, 2002, 2003, 2004. These may be clickable (or in any way selectable) icons. Icon 2001, in the shown example, represents the ‘stages’ view (as an embodiment shows in FIG. 17). Thus if a user chooses/clicks/selects icon 2001, in the preferred example embodiment, they may see a view such as that shown in FIG. 17. This is not limited to the shown embodiments, or to a method/system wherein the idea is an ‘invention’. It may be used for any method/system, having any number of steps and/or any number of stages. (Icon 2001 is shown as looking like four small elements together, which is intended, in the example, to represent/indicate the four stages of the shown example method/system to facilitate idea development.

Icon 2002, in the shown preferred embodiment example, is shown as a map-looking icon. If the map icon 2002 is clicked/selected in the shown preferred embodiment, a view such as that shown in FIG. 10 (or any of the views showing the map of the method/system (the map preferably comprising certain steps, preferably to be completed in a certain order) is preferably shown.

Icon 2003 in the shown example is an icon denoting a compass. When the compass icon is selected/clicked, preferably the compass application/configuration/view/function (as previously disclosed) is made available to the user.

Icon 2004 in the shown example is an icon depicting an email type icon (ie letter, etc), although it could show any ‘send’ type element/depiction/message. If a user clicks/selects icon 2004, in the shown preferred embodiment, they are provided with means to message the system and/or proprietor/owner/runner of the method/system (or any party to receive the message). In the shown example, the means to message the system/method/a receiving party is provided within the (viewing) window of the configuration, which in the shown example, is within a lightbulb (or lightbulb-type) configuration, although it could be any configuration.

The application/configuration may be configured so that the icons 2001, 2002, 2003, 2004 enlarge when the user runs a cursor (or any selecting element) over them. This may make it more obvious that the icons are selectable/actionable. An icon selected may be highlighted in some way when selected (eg enlarged, or coloured, or any other means of showing the icon is selected) to make it clear what icon and view/function has been selected.

Referring to business method, as stated, there may be provided means for a user to get patent pending, which may include patenting programs (preferably video patenting programs which include showing/teaching a user (preferably an inventor) how to get patent pending. In one preferred embodiment, a user is allowed to get access, and ‘come aboard’ (as previously alluded to) to get access to the method/system and/or access to service(s)/product(s) at the or each step of the system, and may pay an amount of money to do so, which may, for example, include or be a monthly subscription payment. This may, for example, be offered free for a first month, with payment taken thereafter.

Thus to get access to the system and/or interface(s) such as that shown in FIG. 6 and FIG. 7, (or any other journey concept and/or invention shown and/or disclosed in present application) the user may be given (free) access to patenting programs (or to any experience and/or information and/or asset(s) and/or program(s)), and may then be charged a payment to experience being taken through the steps of the journey/method/system.

Thus, in one preferred embodiment, wherein the user is an inventor, the inventor may, for example, be able to gain access to their journey interface, and may gain access to patenting programs including a program(s) to show the inventor how to get patent pending (preferably by themselves (as previously aforementioned)), which may be provided, for example, on a free trial of a certain amount of time, and the inventor (user) may then be charged a monthly subscription. Alternatively, payment details may be taken initially, with no payment taken for a trial period (eg one month/30 days) at which point a first monthly payment is taken and monthly payment taken thereafter. Annual payment plans may also be provided. The user (eg inventor) may not be able to start the journey (ie steps) until they have ‘come aboard’ (and perhaps have starter a payment plan, or started a free trial which leads to a payment plan). Thus in the example where the user is an inventor, the inventor may not be able to get a patent search (step 1) until they have ‘come aboard’ (or in any way entered into an agreement), such as, for example, gaining access to a ‘journey’ interface (some example of which have been disclosed in the present application). It is, alternatively, feasible that such a requirement, rather than being required in order to access the first step of the journey, may be required further into the journey, the user therefore being able to start the first step(s) of the journey and/or gain access to product(s)/service(s) for the first step(s), but having to enter into an agreement and/or come aboard and/or gain access to a user interface (which may be a journey user-interface) to access later steps (eg step 3, or any step.

The embodiments described above are provided by way of example only, and various other modifications will be apparent to persons skilled in the art without departing from the scope of the invention as defined in the appended claims.

The appended claims define limited inventions. However, it should be recognized and understood that the disclosure of the present application includes a vast array of inventions, not limited to inventions set out in the appended claims and/or any statement(s) of invention.

For example, if the present disclosure of the present application (inclusive of drawing(s) and/or description) discloses features a to z, it should be recognized and understood that any invention may be claimed, comprising any feature(s) out of features a to z. Thus if the appended claim 1 defines the invention claimed as comprising essential features a, b, and c, it should be understood that an invention may be claimed comprising solely feature a, or solely feature b, or solely feature c, or any combination of features a, b, and c. Furthermore, it should be understood that an invention may be claimed comprising any of feature(s) d to z, whether or not also comprising any of features a, b, or c.

A final claim is appended which serves to signify that I reserve the right to claim any invention, comprising any feature, or combination of features, disclosed in the present application (inclusive of drawing(s) and/or description). This statement (and/or final appended claim), if so desired, should be seen as a statement of invention, stating any invention, comprising any feature(s) disclosed in the present application. It is intended (or plausible) that such invention(s) may be claimed in a future application(s) which claims benefit of priority of the present application. The present disclosure of the present application supports such invention(s)/claim(s).

Referring to the system/platform when used for helping inventors, it is feasible a patent attorney(s)/agent(s)/practitioner(s) may be paid in part (or fully) based on success of the product(s)/invention(s) which they work to help protect and/or based on success of the idea creator/inventor. For example, if a product is successfully launched by a person using the system/platform, it may be, for example, that the patent practitioner(s) may be paid a percentage of profit and/or money generated by the product. It is also feasible, if a product is successfully launched/licensed/released, that the strength and/or importance of the patent(s) attained by the patent practitioner is assessed (eg by another patent specialist(s)), and that the amount and/or percentage that the patent practitioner is paid is dependent on the strength/importance/quality of the patent protection attained and/or patent work conducted by the patent practitioner(s).

For example, taken by way of example only, if it is deemed that a patent practitioner(s) has attained ‘perfect’ patent protection of a given invention/product with the product(s)/invention(s)—thus ‘perfectly’ protecting the product(s)/invention(s)), and that invention/product is successfully licensed/released/launched in a way that generates money and/or profit for an idea creator(s)/inventor(s) (or if any financial agreement is reached that generates money and/or profit for an idea creator(s)/inventor(s)), then the patent practitioner might be awarded, for example, four and a half percent of all profit generated by the product(s) and/or invention(s) and/or inventor(s). (Alternatively, for example, the patent practitioner(s) may be awarded an amount(s) and/or bonus(es), dependent and/or based on success of the product(s)/invention(s) and/or financial success of idea creator(s)/inventor(s). If the patent protection attained by the patent practitioner(s) is not ‘perfect’, but is nonetheless strong, and gives the idea creator(s)/inventor(s) a significant advantage over any competitor(s), by protecting intellectual property such that, for example, important preferred embodiment(s) are protected, then the patent practitioner(s) may be awarded, for example, two and a half percent of all profit generated by the product(s)/invention(s) and/or inventor(s). (Alternatively, for example, the patent practitioner(s) may be awarded an amount(s) and/or bonus(es), dependent and/or based on success of the product(s)/invention(s) and/or financial success of idea creator(s)/inventor(s), which lump sum/amount/bonus(es) may be less than the amount(s) and/or bonus(es) that may have been awarded to the patent practitioner(s) if they had attained ‘perfect’ patent protection for the invention(s)/products(s). Thus it can be seen that high quality patent work can be incentivized by patent practitioner(s) being paid in part (or fully), dependent on/based on success of the product(s)/invention(s) they work to attain patent protection for.

If a percentage amount (as mentioned above) is paid to the patent practitioner(s), such agreement may last for any amount of time. One possibility, for example, is that such an agreement lasts for the duration of the patent(s) attained by/via the patent practitioner's work. Such agreements may be territorial; eg if a patent practitioner(s) has attained patent protection for a client/idea creator(s)/inventor(s) in the United States of America, then the percentage they receive may be only the percentage of profit and/or money generated by the product(s)/invention(s) in the United States of America, for example. However, this may or may not be the case. It should also be stated that, if the idea creator(s)/inventor(s) licenses the product(s)/invention(s) to a third party (eg a product development team (and/or any party) who help develop and/or launch the product(s)/invention(s), then the percentage awarded to the patent practitioner(s) may be with reference to money and/or profit attained by either, any, or all party(s). Thus the percentage may be based on with reference to money and/or profit attained by the idea creator(s)/inventor(s), for example, or a third party (eg a product development team (and/or any party) who help develop and/or launch the product(s)/invention(s), and/or any party(s) the product(s)/invention(s) are licensed to and/or sold by. (The term ‘product(s)/invention(s)’ is considered to be very broad, and even includes product ‘concept(s)’/idea(s)).

Such an arrangement may incentivize the patent practitioner(s) playing a more dynamic role in the product development of the product(s)/invention(s).

Bonus payment(s) (or any amount(s)) may be paid to the patent practitioner(s) based on milestones being reached of how much money and/or profit the product(s)/invention(s)/idea creator(s)/inventor(s) have made.

Any or all such agreements may be agreed between the patent practitioner(s) and)/idea creator(s)/inventor(s)and/or may be agreed by any user(s) of the system/platform (eg idea creator(s)/inventor(s) with the platform/system and/or owners/runners of the platform/system. Thus it is feasible such agreements may be a requirement that the platform/system makes of the idea creator(s)/inventor(s)/user(s), in order for them to be able to use the system. This may also be the case with any other agreement(s), relating to payment and/or awarding of pay and/or amount(s) and/or bonus(es) and/or percentages with regard to any other part of the process—eg to product development team(s), launch/license/release specialist(s)/helper(s) (which may include specialist video makers, for example, who may help make videos of the product(s)/invention(s), to help them be launched/licensed/released), or to any other party(s). However, it is also feasible that some, or many, or all such agreements are not always preconfigured in such a way, and may, instead, require negotiation. Thus negotiation may take place between any relevant party(s), for such agreement(s)/amount(s)/bonus(es)/percentage(s) to be agreed.

As mentioned, it may be adjudged how important, strong, or ‘perfect’ the patent protection is that is attained by a patent practitioner(s). This may affect how much the patent practitioner(s) benefit (financially) from any success of the product(s)/invention(s). Thus, as part of the platform/system, there may be an adjudication/judgement step, where it is adjudged how strong/good or ‘perfect’ the patent protection attained is, and/or how strong/good/high quality or ‘perfect’ the patent work conducted by the patent practitioner(s) is. Such assessment is, of course, preferably done by patent specialists, and may be done by myself (the applicant of this patent application) and/or any patent specialist(s)/practitioner(s) that I either judge to have the skills/expertise to assess such a matter and/or by patent specialist(s)/practitioner(s) I have trained to have the necessary insight and/or ability and/or skills to assess such matters.

It is feasible patent practitioner(s) may be able to choose which project(s) they work on (ie perform/conduct patent services for). It is feasible patent practitioners are categorized in the field(s) of invention they are particularly able/skilled/interested in conducting work on. Thus, similarly to as previously disclosed with reference to any other provider(s)/service(s) of the platform, it is feasible that invention(s) are categorized, and that, via a database, for example, which database may include the patent practitioner(s), and also may include the categorization(s)/field(s) assigned to the patent practitioner(s), any invention(s) brought to the platform/system by an inventor(s)/idea creator(s) may themselves be categorized in a field(s), and that the invention/disclosure/information about the invention(s) may then be relayed/sent (in some way) (and/or made accessible) to the patent practitioner(s) who are categorized in the same or a similar and/or relevant field(s). This may be useful to make sure disclosure(s)/invention(s)/information about the or an invention are sent to patent practitioners who may, potentially, be interested and/or able to take up the case/invention(s) to provide patent work/service(s). It may also be useful to make sure patent practitioner(s) are not informed/sent disclosure(s) of invention(s) that are outside their field of interest/expertise. For example, if an invention is brought into the system/platform by an idea creator/inventor/user and is in the field of bio-chemistry, or is, for example, a software type invention, or a business method, for example, it will be obvious that such fields are, perhaps, specialist fields of patenting; not all patent practitioners, for example, draft and file patent applications in the field of bio-chemistry. Therefore if an invention in a specialist field of patenting is brought into the system, it may be best/beneficial, if only patent practitioner(s) who are skilled and/or expert in such a field(s) are notified of the invention(s)/disclosure(s). Just as practitioners may be categorized by field(s) that they are skilled (and perhaps interested) in providing for, so there may be provided negative fields for practitioners—eg a patent practitioner may in no way be interested in and/or skilled in the field of automotive (eg car) inventions, or bio-chemistry, for example. Thus it is feasible those field(s) may be assigned to that practitioner as ‘negative’ field(s), so that, if invention(s) are brought into the system/platform that are in such fields, that practitioner is never notified of such invention(s)/disclosures. Nevertheless, it is feasible all disclosure(s)/invention(s) may be viewable by practitioners, for example through a search engine, or, for example, through all disclosure(s)/invention(s) that are brought to the system/platform being viewable by all practitioners (for example, via a website).

Negative fields may be used for any practitioner/provider, not limited to patent practitioners. Thus product development party(s) (eg teams) may be apportioned negative fields, as may be, for example, potential investors, or launch specialists/helpers of any sort.

Patent practitioner(s)/provider(s) may be able to ‘bid’ on taking up a project/case. Thus it is feasible that patent practitioners may compete against each other (in a sense), by being able to provide higher or lower bids for patent work and/or completing patent work relating to any step(s) of the journey/system/platform (or any other patent work). Alternatively, the or each patent practitioner (and/or the system/platform) may have set price(s) for certain service(s). Thus, if a patent practitioner sees a project they particularly want to provide work for (eg because they think the invention/product concept has a good chance of generating money/profit when released and/or if they particularly want to take up the project for any other reason, such as, for example, that the invention/project is in a field of particular interest to them), they may be able to bid a price/amount to charge, and may even, perhaps, be able to bid to do the work free. Whilst this would be an unusual system for patent work, it is feasible low prices may be incentivized by the fact that a patent provider/practitioner may be able to generate a vast amount of money from doing patent work on a project, if the project generates commercially (financially) successful product(s). To give an example, if a patent practitioner gets, for example, ‘perfect’ patent protection for an invention, and product(s) are generated/released that generate $1.6 Million in profit/money, protected by the patent work (eg one or a plurality of patents), then, if the patent provider/practitioner is, for example, awarded 4.5% of the profit/money generated, they may, for example, for that one project, receive $72,000 for that one project. It will be obvious that projects may generate less, but may also generate far more than that amount. Thus, in certain situations, the practitioner may make a huge amount of money from any one (or a plurality of) project(s), if the project(s) are (highly) commercially successful. Similarly, if bonus payment(s) are paid to the practitioner/provider once milestones are reached in how profitable/successful the product(s) becomes, so too money may be generated by/paid to the practitioner/provider.

It is feasible many patent provider(s)/practitioners may be hired and/or provide services on the platform/system.

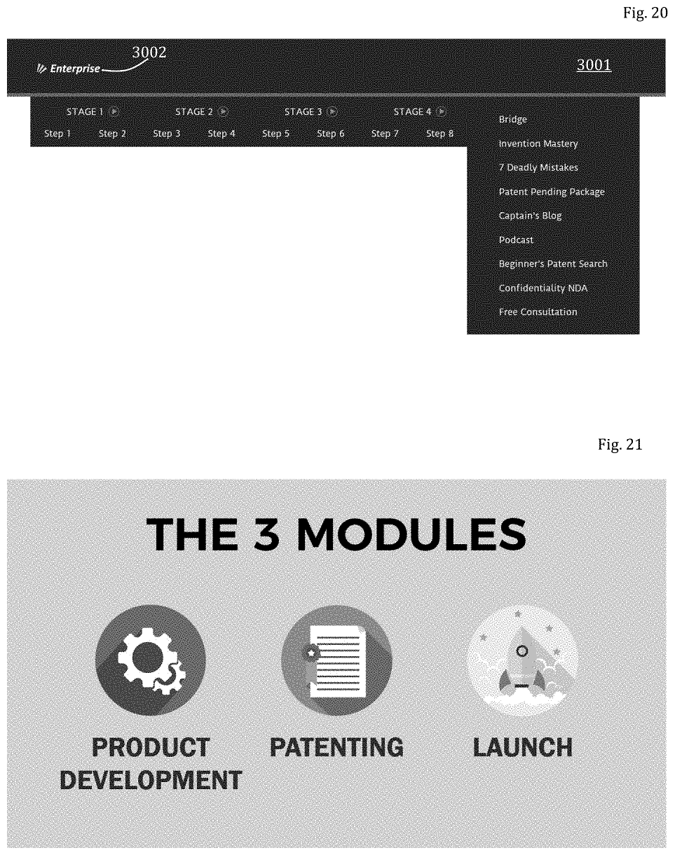

There is shown in FIG. 20 a possible user interface provided for users. This may play some role in the process and/or system/platform, or may simply be an interface for the users, for other reasons. In the example, the interface is provided via a website. It may, for example, be provided as an application and/or any software. This is a slightly more advanced interface that shown in FIG. 6. The example shown is relevant to when the platform/system and/or interface is used/provided for inventors. There is shown, in the example navigation bar 3001 at a top of the interface (which may be a webpage in the example). In the example, the navigation bar does not have any links to navigate to, since this is a simplified embodiment, but it will be obvious it may have such links. There is, however, shown a logo 3002 on the navigation bar.

Under the navigation bar (on the example) is a top portion. In the example, the top portion has links, which show ‘STAGE 1’, ‘STAGE 2’, ‘STAGE 3’, ‘STAGE 4’. In the example, there is a play icon next to each such link/word, which is to denote, in the example, a video can be watched by clicking on the link for that STAGE. (However, any information, not limited to a video(s) may be provided). In the example, if a user clicks/selects the play button/link, they can watch a video that explains that step of the journey/process (in this case, an inventor's journey). This may be done via a pop-up video, or any other way.

Underneath the STAGE links are links for each step of the journey the user must (or can) go through. In the example, under STAGE 1, there are links for step 1 and step 2. Preferably, these too can be clicked/selected to access more information about the step the user clicks/selects, which may, or may not, include a video(s), and which may, or may not, include written text about that step. The reason, in the example, why step 1 and step 2 links are provided below STAGE 1 is to denote that STAGE 1 consists of or comprises step 1 and step 2. So the same for STAGE 2, which has step 3 and step 4 underneath it, denoting that STAGE 2 consists of or comprises step 3 and step 4. So the same for STAGE 3 with step 5 and step 6, and for STAGE 4, with step 7 and step 8. It will be obvious that a vast array of arrangements may be provided for how to arrange such a thing, and the example shown is shown by way of example only.

All the disclosure/information previously disclosed with relation to any other interface may also be provided with reference to the example of FIG. 20.

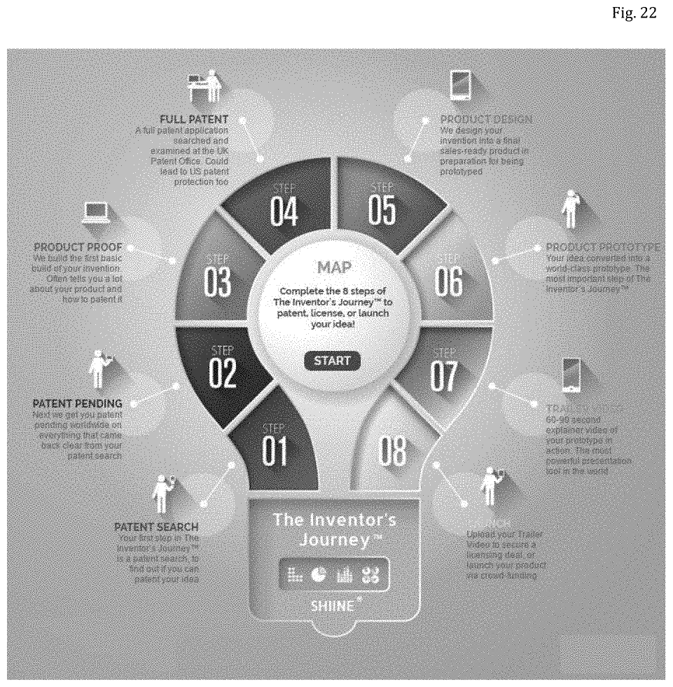

The STAGE/steps, in the example, correlate to the steps as shown in FIG. 22 (and similarly in other drawings) of the ‘map’. As stated, user(s) may be ‘anchored’ at the step they are on, so that they must go through the steps in sequence/correct order. (Of course, if the user has completed a step themselves or before they enter the platform/system/method (such as Product Proof—step 3 in the preferred embodiment), then they may be able to skip that step, and there may be several (or at least one) other situation where a step(s) may be skipped)

On the right side, there are shown more links, which show links for: Bridge, Invention Mastery, 7 Deadly Mistakes, Patent Pending Package, Captain's Blog, Podcast, Beginner's Patent Search, Confidentiality NDA, and Free Consultation. In the example, these are shown in a side formation/arrangement, going downwards. (Note, it may be that the 7 Deadly Mistakes and Invention Mastery links are swapped in position, so that the 7 Deadly Mistakes link is above the Invention Mastery link, rather than below it).

In the example, each tab/link can be clicked to open up (and/or get more access) to information. (This is just one way of delivering information on a very compact interface, and is taken by way of example only).

The top link uses the word ‘Bridge’ and, in the example, effectively acts as a ‘Home’ page. This may be the default page the interface opens up on. This page may also, for example, include links to download the map of journey for the inventor to go through. It may also include updates/new messages, etc.

The next link down in Invention Mastery. This is preferably a course that teaches the inventor about how invention development works. Thus when this link is clicked/selected, preferably a video(s) can be accessed, and more preferably a video series. This is preferably an educational video series for how to master invention development. An example of how this may be achieved in seen in FIG. 21, where a thumb/frame is taken from an educational video and/or presentation. It shows an attempt to teach an inventor(s) ‘The 3 Modules’ that make up invention development-product development, patenting, and launch. These are then preferably individually taught to the inventor, by explaining the steps that make up each module. The inventor is therefore educated as to why the steps of the journey they're on need to be completed. The order of the steps of each module is also preferably explained, so that the inventor knows how important it is what order the steps are completed in.

The next tab/link down is entitled 7 Deadly Mistakes. This is preferably a program (although it could be any information) and is preferably a video program teaching inventors arguably the 7 worst mistakes (or at least 7 bad mistakes) they can make with their invention. Intent is to stop them from making these mistakes by educating them. Preferably each deadly mistake is provided by its own video.

The next link tab below is the Patent Pending Package link. Preferably the Patent Pending Package comprises one (and preferably more, and most preferably three) video programs that facilitate the user/inventor in getting patent pending on their invention. (Example embodiments/disclosure relating to such program(s) has already been provided earlier). By clicking this link/tab, in the example, the user can either access these programs, or access a trial to one or more of the programs. The trial may include some of the parts/videos of the program(s) being locked/not accessible. In broader terms, by clicking/selecting the link, the user can access more information about how to get patent pending and/or about getting patent pending.

The next tab/link is Captain's Blog. This is a link to a blog, which may have more invention information and/or help.

The next tab/link down in Podcast. This is a link to a podcast relating to the journey of the inventor.

The next link down in Beginner's Patent Search. This is a link which preferably goes to a tutorial for how to do a basic patent search. Preferably this is a video tutorial. Preferably the tutorial shows how to do a basic patent search, including on Google Patents. Preferably the tutorial shows how to do a basic patent search, including on internet search.

The next tab/link down is Confidentiality NDA. Preferably if a user clicks/selects this, they are taken to a page/part where they can download an NDA. Alternatively, it may download immediately when the link/tab is clocked/selected. This is preferably simply a gift which they can use to disclose their invention confidentially to any 3^{rd} party (eg outside of the platform/system). However, this NDA may not be required at all for use on the system/platform, since such confidentiality agreement/arrangement may be handled in a different way. Thus this should just be seen as a gift for the inventor. It is feasible (though not required at all) that this NDA may be used by the inventor in order to disclose their invention(s) confidentiality to, for example, provider(s) providing services/help on the system/platform. However, as stated, this NDA may not be needed/used for such purposes, and may thus be a friendly gift given to the inventor/user.

The next tab/link is Free Consultation. Preferably once clicked/selected, this gives the user more information/help on how to set up a free consultation (or simply takes them one step forward in setting up a free consultation). Thus, for example, if a user/inventor wants to start the journey of moving forward with their invention, a free consultation may, for example, be required to do this.

It will be extremely obvious that this is just one possible arrangement for providing a user-interface for an inventor/user. Even if similar links/tabs are provided, it will be extremely obvious that they may be arranged in many different ways/arrangements.

Preferably the top portion (with STAGE and step links/words) and the side portion (with the tabs/links which have just been briefly described) scroll with the webpage/interface as the user moves down the webpage/interface. Thus the navigation bar 3001, for example, may not scroll. However, for example, the top portion and side portion may scroll as the user moves down the page, thus making sure that such links/portions are always on-screen as the user moves down the page/interface. Any or both portions may scroll in such way. Preferably both scroll in this way. I believe this may be referred to as ‘pinning’. Thus the top and/or side portion may be pinned, so that each or both always stay on screen, no matter how far down a user scrolls/moves down the page/interface.

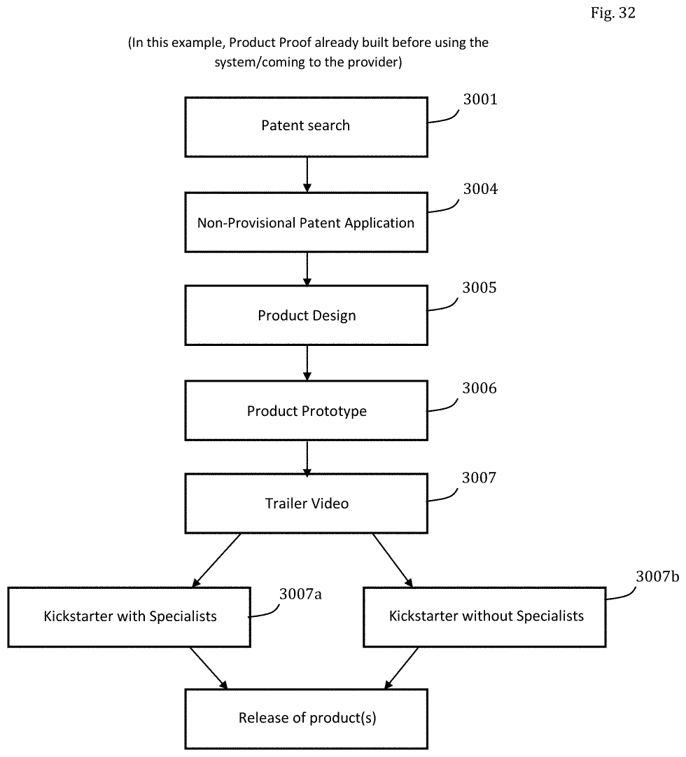

There is shown in FIG. 22 a particularly preferred embodiment of the map. The map shows steps for the inventor to move forward in, and as stated, user may be ‘anchored’ at each step, to make sure they complete the steps in the right order to optimize their chances of success. In the example, each 2 steps correlates to a STAGE as shown in FIG. 17 (or better shown in FIG. 31). Thus steps 1 and 2 form STAGE 1 (Getting Patent Pending); steps 3 and 4 form STAGE 2 (which is preferably called ‘Build And Patent’ rather than ‘Prove And Patent’); steps 5 and 6 form STAGE 3 (Building The Perfect Product); and steps 7 and 8 form STAGE 4 (which is preferably called ‘LAUNCH’ rather than ‘MARKET TO SUCCESS’).

It has been disclosed in the present application that the platform/system may allow for/include an invention (or any matter relating to an invention and/or disclosure of an invention) to be ‘uploaded’ in some way so that the invention/idea/product may be viewable by a provider(s) and/or helper(s), who can help with progressing the invention/idea/product/project. It has also been stated that this is not limited to an invention, or even a ‘product’; it may, for instance/example, be used for a person to try to get help with a business idea or project and/or a business concept and/or a business, for example. Preferably, as stated, there are a plurality (and may be many) providers/helpers. Thus the system/platform may be extremely useful for getting the idea (which is a broad term here) to a plurality of parties that may help (in one way or another, such as, for example, investing, product development, strategizing (eg marketing and/or business strategy), patenting, intellectual property, video creation/making, and/or many other possible helping fields.

It should also be stated that uploading may occur at any point of the system/platform. So, for example, referring to FIG. 22 for example, it is feasible the idea creator's/user's idea may be uploaded/delivered right at the start of the system/process, in order, for example, to get a patent provider(s) to help with the or any patent service/work (such as, for example, the patent search at step 1). Thus, for example, if an inventor has an invention in the field of floor cleaning apparatuses, and wants to move ahead with getting a patent search, it is feasible that, either right from the start (eg by the inventor inputting details of the field of their invention/idea), or after a consultation, for example, with a staff member, that the invention/idea is sent (or a piece(s) of content and/or information relating to the invention/idea) is sent to relevant provider(s), who may then be able, for example, to decide on whether they want to provide (patent) services for the invention/idea and/or to find out more, or not). This may be done intelligently by the system/platform (eg the information relating to the idea/invention is inputted and/or uploaded to the system/platform, and the system/platform then delivers (and/or makes accessible) the or some of the information to relevant provider(s), eg by computing which provider(s) offer service(s) or have expertise and/or interest in the type/field of the invention/idea, or may be done by a person(s) (eg by the person(s) receiving disclosure of the idea/invention and/or holding information relating to the invention/idea, and then notifying relevant provider(s) and/or delivering a disclosure of the invention/idea to relevant provider(s).

Thus, for example, with reference to the example of FIG. 22, a disclosure/idea/invention (or any information relating to a disclosure/idea/invention) may be uploaded to the platform/system (and/or delivered to provider(s)) at, for example, for/before step 1, to attain a patent provider(s)/practitioner(s), to provide patent service(s)/work; for/before step 3, to attain a provider who can help or can build a proof of principle of the idea/invention/concept (which need not be a physical product and may, for example, be an App, website idea, online business, business idea/concept, etc, etc); for/before step 4, to attain a patent provider(s)/practitioner(s) to help draft and/or file (or in any way help with) a non-provisional patent application, for search and examination at the patent office; for/before step 5, to attain a provider who can help or can design the idea/invention/concept (and possibly provide relevant graphics, etc); for/before step 6, to attain a provider who can prototype (preferably creating an advanced prototype) the idea/invention/concept; for/before step 7, to attain a provider(s) who can help create a video of the idea/invention/concept (preferably of an (advanced) prototype of the idea/invention/concept), for example to help license/release (or in any way help presentation) of the idea/invention/concept; for/before step 8, as may have been discussed/disclosed previously, to get the video of the idea/invention/concept (preferably of an (advanced) prototype of the idea/invention/concept), to party(s) who can either help license/launch/release/crowdfund the idea/invention/project/product, or may actually be a retainer, licensing/licensee company/investor, for example, etc, who may enter into an agreement with the idea creator(s) for the idea (eg a financial agreement). One example of a financial agreement would be a licensing agreement. A disclosure/idea/invention (or any information relating to a disclosure/idea/invention) may even be uploaded to the platform/system (and/or delivered/made accessible) to provider(s)) at, for example, for/before step 2, to attain a patent provider(s)/practitioner(s), to provide patent service(s)/work to help the inventor(s) get patent pending, eg with a provisional patent application. This could involve any part of the process of a provisional patent application, for example filing, drafting, consulting, etc, etc. These example of what is done, and ‘steps’ are provided with reference to the example of FIG. 22 by way of example only, and it will be obvious the system/platform and/or ‘journey’ may take on a completely different shape and/or form and/or nature, especially if the system/platform is used to help idea(s) (the term ‘idea’ here being an exceptionally broad term) that are not invention(s) and/or not physical product(s), for example. Nevertheless, even if the system/platform is provided to help invention(s)/inventor(s), it will be obvious the example is shown by way of example only, and obvious the system/platform and/or ‘journey’ may take on a completely different shape and/or form and/or nature. Thus the example (and the ‘steps’) are shown by way of example only, and it is possible a system/platform may be provided that does not comprise ‘steps’, for example and/or does not comprise a set-up where users must go through pre-ordained ‘step(s)’, for example.

Thus at various or any step or point of the journey/platform/system, the platform/system/method may comprise a way to gain access to many possible providers, at any point.

The system/platform may facilitate (and/or allow) any party to contact with and/or work with any other party. For example, the platform/system/method may allow for/facilitate a product development team/provider in being in communication with/communicating with a patent practitioner/provider, for example if the two providers are working on the same invention/idea/project. Thus providers (even in different field of help) may be facilitated in communicating. Providers in the same field of help may also be facilitated in such way. This may help if one provider/team needs the expertise/help of another provider/team. Possible methods of communication may include ability to instant message between providers, for example (which may be allowed for communication with and/or between users as well). The platform/system may provide a secure workspace(s) for the user and provider(s) the user is using (eg via web interface/software). Thus any or all party(s) working on a project may be able to communicate together. This may include instant messaging, for example, and may include email notification ability, so that a user(s)/provider(s) is emailed if a new message is posted/entered on the workspace by a user/provider. The platform/system may allow for exchange of contact information, such as, for example, any of email; skype ID/name; phone number; address, etc, etc. This may be useful for contact between user(s) and provider(s), for example.

‘Uploading’ here is a broad term, and wherever the term ‘uploading’ is used in the present application, it should also be stated that the disclosure/idea/invention may simply be ‘sent’ to and/or made accessible and/or viewable to the provider(s), or the provider(s) may in some way be notified of the disclosure/idea/invention and/or given access to view/find out about/find out more about the disclosure/idea/invention. Thus, for example, if an inventor enters the system/platform with an invention, a person/member of staff may receive a disclosure of an/the invention, and may then relay the invention/idea/disclosure to any relevant provider(s)—eg patent work provider(s), or product development provider(s), etc. Thus this may be done in a very simple way, or more complex methods of delivering content may be provided, such as uploading a (trailer) video of an invention/product on to a mainframe and/or platform, which then intelligently notifies and/or delivers the content to any or relevant provider(s). Thus the system/platform may itself notify/deliver the content to the or relevant provider(s), and/or a person/human may do it. And, as stated, wherever the term ‘upload’/‘uploaded’ or the like is used in the present application, it is also here made clear that the platform/system may employ any other method (not limited to an ‘upload’ method) to deliver the or any information to any party (eg a provider) of/on the system. Thus, rather than being limited to any ‘uploading’ method, in any embodiments that are described/disclosed as using such a system/method, the platform may, rather than that, use/comprise any delivery method for delivering information and/or a disclosure and/or trailer video, for any part/step of the platform/system where information and/or a disclosure and/or trailer video is sent and/or received by a party and/or provider.

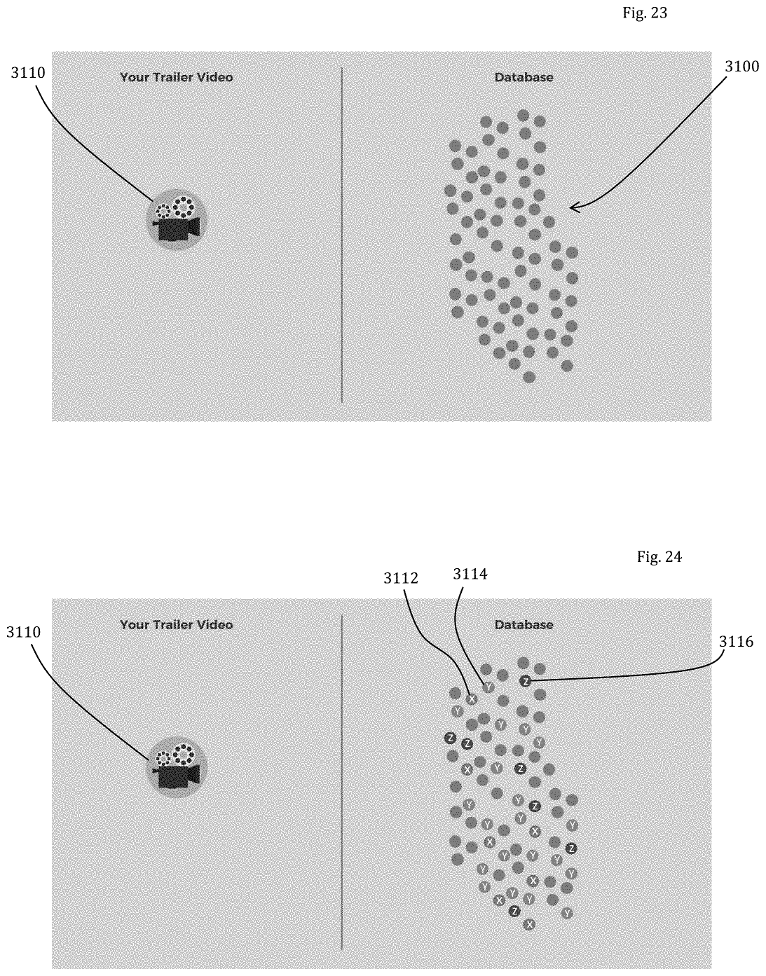

Referring to FIG. 23, there is shown a representation of the system/platform may comprise product launch facilitators (PLF's) 3100, (which may also be called simply product launch/specialists/parties), eg companies that an inventor/user can license their product(s)/invention(s) to, and/or investors that an inventor/user can gain investment from, to help launch a product(s) and/or business, and/or direct TV sales and/or infomercial experts/professionals and/or companies, that can play a part in and/or help a user get their product sold on TV. This may even include trailer(s), who may be a PLF. It is also possible there may be professional crowdfunding specialists, eg team(s) or individual(s) who specialise in creating crowdfunding campaigns and/or videos, such as on Kickstarter, for example (or any other crowdfunding site/resource/method/outlet.

The information may be stored as a database and/or the platform/system may comprise a database of the or any PLF's. FIG. 23 is a representation of an example wherein the platform/system may comprise a database of the or any PLF's (and/or a database comprising the or any PLF's 3100). In the example representation, each circle under the word ‘database’ represents a product launch facilitator (eg a company the user can license to, or, for example, an investor, or, for example, a kickstarter specialist team, who can help create (and perhaps manage a (preferably high quality) kickstarter and/or crowdfunding campaign for the user and/or the user's product(s). (As has been mentioned previously, the ‘user’ (ag an inventor, for example) may be one person, but is not limited to being one person, and may, for example, be multiple people. Furthermore, the user may be any ‘party’, including, but not limited to, a company, for example. Thus the term ‘user’ is a broad term.

Icon 3110, in the representation, represents a trailer video of the user's product (preferably having already been executed into an advanced prototype previously, preferably via a PDP (product development provider) on the system/platform. The trailer video may, or may not, have been made as a service as part of the system/method/platform. It may be a fairly basic video, or may, feasibly, be a more advanced video.

As previously stated, PLFs (and any other providers, eg product development and/or patent practitioners) may be categorized. For the present example, it will be imagined that the trailer video (which may, it should be said, be any video, for example) is for a product of a user that is in the field of kids' safety headware. And, for the present example, it will be imagined that the user wishes to license the invention/product(s). Therefore their ‘target’, one might say, is ideally a company that the user can license their invention/product(s) to (thus such a party could be said to be a licensee company, with the user potentially being the licensor).

Therefore, in the present case, if the user does not want to crowdfund, then it would be ideal if the PLFs 3100 that are specialist crowdfunding providers (if the system/platform has categorized them as this, which it preferably does) are not targeted. Thus, if the system/method/platform categorizes the invention/product and/or video in the field of kids' safety items and/or kids' clothing and, for example, categorizes that the user wants to license (and not crowdfund), it allows, for example, the system to ‘rule out’ PLFs that are non-relevant. Another example may be if, of the PLFs 3100, there are one (or more) that are companies who make and/or manufacture and/or sell vacuum cleaning apparatuses. Again, if the system/platform has them categorized as such (eg in the field of (vacuum) cleaning apparatuses and (vacuum) cleaning apparatus accessories), then if the video/invention/product is categorized on the system/platform as being in the field of kids' safety headware (and/or kids' clothing items, for example), then, again, the system/platform can ‘know’ that this video/disclosure/product(s) perhaps would not be ideal for that provider. Thus the system/platform may, for example, not notify such a provider and/or send out and/or make accessible/viewable the example trailer video of this example to such PLFs. Therefore the system/platform can, in a preferred embodiment, ‘screen out’ providers that are non-relevant to the user's product/idea/invention/concept. (This may be possible for all providers, not limited to product launch providers/facilitators (who are also, for the present application, considered to be ‘providers’). Thus such categorization may be possible for patent providers/practitioners (PPs) and/or product development providers (PDPs), etc, etc.

However, now looking at FIG. 24, let it now be imagined that the PLFs 3112 denoted with an ‘X’ represent PLFs that are companies that make/manufacture (and perhaps sell) products in the field(s) relevant to the invention(s)/product(s) of the user (and thus of the example video 3110). And let it be imagined that these PLFs noted with an ‘X’ are interested in such products, and may potentially want to enter into a licensing agreement with users of such product(s), (if they like the product(s) and see value (eg commercial value) in it). And such companies may potentially want to bring such product(s) to market (if they like the product(s). Therefore, for this example, such PLFs would be ‘targeted’.

And let it be imagined, for the present example, and again looking at FIG. 24, that the PLFs 3114 marked with a ‘Y’ represent may just be general providers such as broader companies, or investors, for example, who may not have specific interest or background in that product field, but may be able to help the user in some way. These providers may, potentially, be targeted as well (or may not). (An example may be an investor who has general ability to bring many products to market, or has route to market expertise, generally, for many different types of products, which may include this (example) kids' safety headware product, or perhaps that may have been categorized on the system/platform as being interested in ‘kids' products’, for example. (It will be obvious that product(s)/video(s) and PLFs (or any provider) may be categorized in more than one field). It may be up to the user if they want such parties to be targeted as well. (eg If the user says they are also potentially interested in investment, eg for an entrepreneur(s)/party to invest in them, to help launch their product(s)/business, then such PLFs may also be targeted. If the user is not interested in this, then such PLFs may not be targeted).

Another ‘Y’ example, for example, may be retailers that retail products in the same (or similar) field as the product(s) of the user and/or video. Whilst such parties (ie retailer(s)) may, or may not be able to help get a product(s) to market, it may be that they can give feedback and/or show interest in whether they would like to retail such a product(s). If they do, then it might open up a greater possibility and/or probability) of the user successfully moving forward with getting a licensing deal and/or getting the product(s) to market and/or having a PLF taking up the product(s), because it may be a good indicator that the product could be successfully retailed. It is feasible retailers (if they are involved on the system/platform) may team up with and/or have allegiances with some or any PLFs (eg potential licensee companies). It is also feasible such retailer(s) may, potentially be able to bring a/the product(s) to market themselves. If this is the case, it is feasible they may be able to sign a licensing deal(s) with the/a user. It is feasible retailer(s) may be able to make and/or manufacture (and sell) the/a product.

For the sake of the present example, it will be imagined that the PLFs 3116 are specialist crowdfunding providers—most preferably providers that can help create (and perhaps manage) a crowdfunding campaign, eg on sites like Kickstarter, for example. These parties may specialise in making crowdfunding campaign videos (eg videography) and/or any or all other aspects of crowdfunding (eg campaign management). (Ascertaining and defining a correct/appropriate ‘target amount’ for a crowdfunding campaign may require knowing tooling/manufacturing costs for a product/project. This may be worked out either by these PLF parties, and/or by PDPs of the project. Thus such information may be provided to the user as part of the system/platform, at some point).

For the present example, it will be imagined (as stated) that the user intends and wants to license their product(s). Thus, for the present example, the system/platform may ‘screen out’ such PLFs that are crowdfunding specialists, since the user, here in this example, does not want to crowdfund the product(s) (which typically is done in order to launch an invention/product/concept/thing oneself, rather than via licensing). Thus, in this example, such specialist crowdfunding PLFs may not be notified and/or have the video/disclosure sent out and/or made viewable/accessible to them. (or at least may not be ‘specifically’ targeted. However, it will be clear that, for users that want to crowdfund, that such PLFs that are crowdfunding specialists may be targeted in this way. Thus the video/product/project may be categorized, for example, for crowdfunding, in such situations, and crowdfunding specialist PLFs may be targeted. If they (a crowdfunding specialist PLF) sees the disclosure and/or video of the project/product(s), and wants to take up the project (and help to try to get it crowdfunded), they may be able to accept the project. Preferably they may be able to bid/make an offer on the project. Preferably other crowdfunding specialist PLF may be able to bid/make an offer. This may lead to multiple bids/offers. This may lead to better options and/or lower prices for the user, who preferably can choose from the bids/offers.

It will be obvious that providers can be categorized, and sub-categorized into still more specific fields. Thus, it is feasible (although crowdfunding specialist PLFs may be able to provide crowdfunding services for any or all project(s)), that crowdfunding specialist PLFs may even be sub-categorized into specific field(s) of project/product/concept. Thus a crowdfunding specialist PLF that is particularly experienced and skilled at successfully getting ‘tech’ products crowdfunded may be categorized as a crowdfunding specialist PLFs, and sub-categorized (for example) under ‘tech’ product(s)/project(s).

For the present example, though, as previously stated, the user has a product(s) in the field of kids' safety headware, and they want to license (not crowdfund). Thus the example ‘z’ crowdfunding specialist PLFs may be screened out in this situation and/or may not be notified, and/ore may not have the video and/or disclosure made viewable/accessible to them (or, at least, may not be specifically targeted).

(Preferably, in such an example, just category ‘x’ PLFs are targeted).

In FIG. 25, it is represented how, in a preferred embodiment, the platform/system facilitates dispersing the video (preferably a trailer video) to relevant PLFs. For example, it may be that only the ‘x’ PLFs are targeted. Preferably they are notified of the (trailer) video. This may come in the form of an email (for example) and/or a message and/or notification of any sort within the PLF's account, for example. Their account on the platform/system may be synchronized with their email (or may not), such that they get notified by email when a (trailer) video relevant to them (ie for which they have been targeted) is uploaded to the system. The small icons 3110 of the video 3110 represent that the video, having been uploaded (or ‘received’ in any way) on the system/platform, preferably can be sent out and/or made viewable/accessible to a plurality of (preferably targeted) providers (PLFs in this case). So the same for any other disclosure (not limited to video) for any provider(s) (not limited to PLFs), at any point on the system/platform/journey, not limited to the example shown—ie at any point in the system, information and/or a disclosure (not limited to a video and/or trailer video) may be sent out to possible (preferably targeted) providers, not limited to PLFs. Thus the or any provider may be a PDP, and/or a PP, for example).

Line 3120 represents the platform's ability and/or feature(s) to disperse and/or send out the video/disclosure. Preferably the platform comprises an upload system, where the video can be uploaded, and the or relevant PLFs are targeted in a substantially automated manner (eg if categorization of PLFs and the video/project(s)/concept(s) is used). However, it should be noted that ‘uploading’ is disclosed by way of example, and wherever the term ‘uploading’ (and the like) is used, it will be obvious the platform need not comprise an ‘upload’ feature/mechanism/step/protocol, and the video/disclosure (and/or any information) may be sent out to potential providers (or any party) in any way, not limited to uploading, or an upload feature. The video/disclosure and/or information may be sent out and/or made viewable/accessible to provider(s) in any way. This is the case for any embodiment disclosed in the present application, even where the term ‘upload’ and the like is used/disclosed with reference to the or any embodiments.

As previously stated, the or any provider(s) (PLF in this case) may then be able to bid/make an offer and/or communicate with the user. As aforestated, if a bid/offer is made, it is feasible the fact that the bid/offer has been made (and possibly further information, such as the bid/offer amount) may be made clear to other PLFs. This could spark interest from the other PLFs because it will be obvious that, if a PLF finds out that another PLF has made a bid/offer, it might spark their interest that that project/product is of value. Furthermore, if the bid/offer amount and/or nature is made known to the other PLFs, it may lead to one of them offering a better/improved bid/offer amount and/or nature and/or agreement, in order to ‘beat’ the previous bid/offer from the other PLF. Thus this could lead to the user getting a better deal/offer/bid. Preferably, the user gets to choose which bid/offer to agree to (although they preferably are not required to take up any of the offers/bids if they do not want). As aforestated, user and any PLFs may be able to communicate via/on the platform/system and/or may be able to communicate away from the platform/system. One example of being able to communicate via/on the platform/system would be instant message. Another example of being able to communicate via/on the platform/system would be message (eg electronic and/or account-to-account. Thus, as aforestated, preferably users and providers all have an account(s) on the system/platform. Other examples of user and any PLFs being able to communicate via/on the platform/system may include any of: call(s), meeting(s), conference(s) eg video conference(s). These may use first party technology and/or software of the platform/system, or may, for example, use third party technology and/or software.

It should also be stated that it is feasible, for some project(s)/product(s), that both licensing PLF(s), and crowdfunding specialist PLF(s) may be targeted. This may be the case where a user is interested in either one (or both) of the options of licensing and crowdfunding, or simply wants to have a chance of attaining a PLF for either one of those things.

If a user attains a crowdfunding specialist PLF, hopefully the crowdfunding specialist PLF creates and/or manages (or at least provides assistance with, and preferably significant assistance) a crowdfunding campaign for the user. This may include creation of higher quality videography (ie video making) for the crowdfunding campaign than the quality of the trailer video/disclosure to them from the user/for the user's project/product(s).

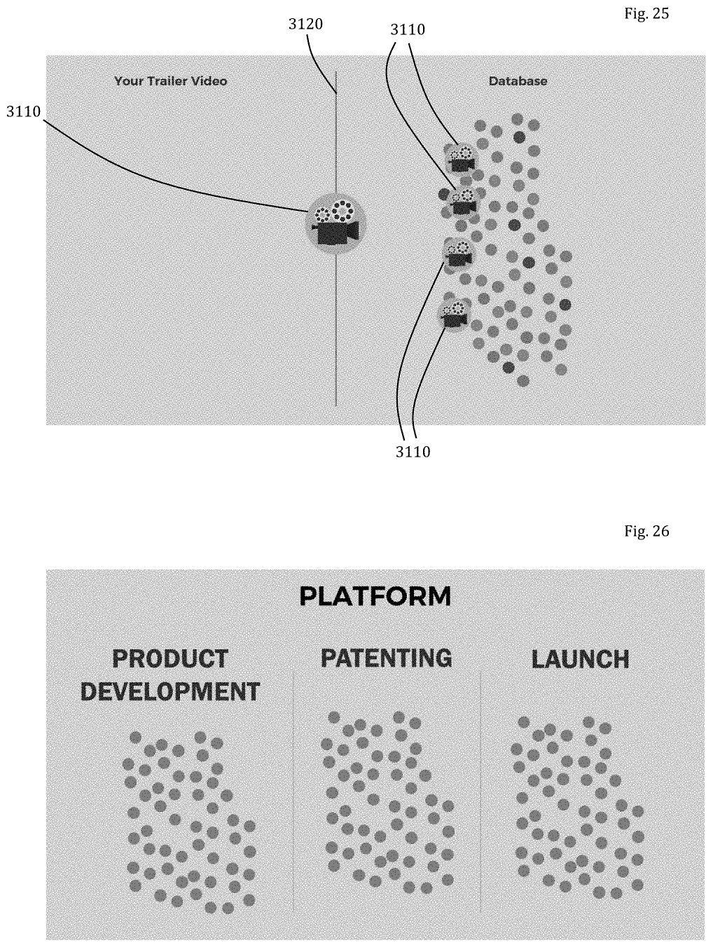

Regarding the system/platform in a broader light (and not focusing on distribution and/or making available trailer videos and/or targeting of PLFs), as shown in FIG. 26, the platform/system preferably comprises any of: product development providers (PDPs); patent providers (PPs) eg patent attorneys/patent agents (although it is feasible there may be specialist patent searchers that are neither patent attorneys or patent agents); and product launch facilitators (PLFs), which may also be referred to and/or be considered to be product launch specialists (PLSs) and/or product launch providers (PLPs), and which, as aforestated, may comprise (and are not limited to) potential licensee companies to license an invention(s)/product(s)/concept(s) to, investors, crowdfunding specialists, direct TV sales and/or infomercial specialists/professional(s)/companies, even retailers, etc, etc. Preferably, the platform/system comprises product development providers (PDPs); patent providers (PPs); and product launch facilitators (PLFs). (This is particularly relevant to inventions, and it will be obvious, if the system/platform is used for ideas/concepts/things that are not patentable (ie not inventions), then patent providers (PPs) may or will not be required. The platform/system may provide both for product(s)/concept(s) that are, and others that are not, patentable. Thus for some projects/products/ideas/concepts the platform/system may facilitate/provide for patent services, and for others it may not. The system/platform is preferably able to provide for both.

In FIG. 26, each circle represents (by way of representation alone) a provider. Thus there are shown PDPs (under ‘product development’), PPs (under ‘patenting’), and PLFs (under ‘launch’). As aforementioned, these three things could be seen to be the 3 ‘modules' of invention development’ (as shown/denoted in FIG. 21). Thus, preferably, the platform comprises providers who provide for each of the three modules.

The platform/system may thus comprise a database of any or all of PDPs, PPs, and PLFs. The platform/system may comprise any or all of a separate database of PDP; a separate database of PPs; a separate database of PLFs, or the information may be provided by way of one combined database, which comprises any or all of the information relating to any or all of: PDPs; PPs; PLFs.

As aforestated, it is possible different providers of different types may work together. This may be done as separate entities (eg a PP(s) taking care of patenting, a PDP(s) taking care of product development, (and possibly a PLF(s) providing with regard to helping/facilitating launch/success of the project(s)). As stated, these providers may or may not work together. It is feasible different providers from any of the modules work together and/or may form a team. Thus a team may comprise of a provider(s) for a plurality of the modules (product development/patenting/launch). Alternatively, or in combination, allegiances may be formed between providers of different disciplines/modules (product development/patenting/launch). It is also feasible different providers even within the same module may form allegiances and/or become a team. For example, two different product development individual(s)/team(s) (ie ‘providers’) may team up, during a project (or projects). This may be beneficial to source experts/providers of differing skills/capabilities.

It is also feasible PLFs (eg crowdfunding specialists, investors, licensing companies, infomercial/direct TV sales experts/companies) may form allegiances, either within themselves (ie with other PLFs), and/or with providers from within other module disciplines (eg product development and/or patenting). For example, a particular investor or licensing company may form an allegiance with a particular product development provider who they have seen do exceptional work developing a product to a high degree (and perhaps enhances the product's chance of being commercially successful). It will be obvious, then, that it may be in the interest of the PLF to form an allegiance with (and/or team up with) the PDP, because if the PDP does product development on a project/client they may benefit financially from, they will know that the work done by the PDP, due to its quality, may or will enhance the chances of the product(s) becoming successful (eg commercially), which in turn may be in the financial interest of the PLF (eg if they are set to financially profit from financial success of the product(s)/project in any way). Thus the PDP (which may itself be a ‘team’ of a plurality of product development specialists/people) and the PLF may together form a ‘team’ (and/or form an allegiance). So the same is the case for PPs (patent providers), who may also be part of a ‘team’ with either PDP(s) and/or PLF(s). Furthermore, a ‘team’ may even comprise a plurality of PPs. Thus a ‘team’ may comprise any combination of PPs, PDPs, PLFs, of any number or amount.

It may also be that the platform/system comprises a database and/or stored information relating to users (eg inventors, for example). Preferably, users pay a fee to use the system/platform. For example, users may pay a monthly fee, for example, for having access to (and/or being ‘aboard’) the system/platform.

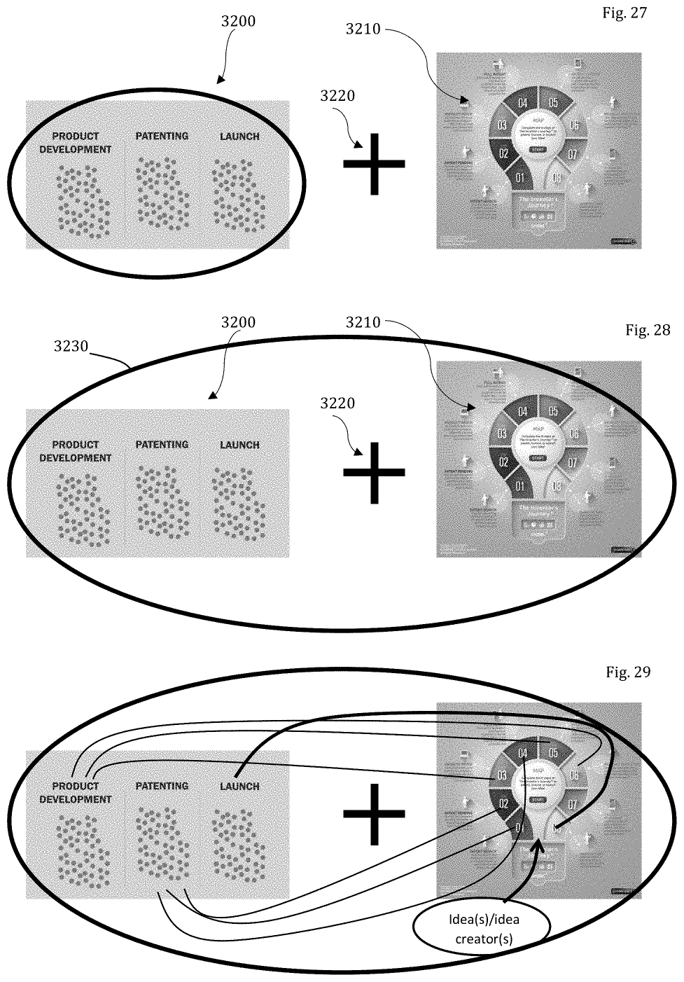

Referring now to FIGS. 27 to 30, FIG. 27 shows how the platform/system comprising providers in any or all of the fields of product development, patenting, and ‘launch’ may be used with (and/or comprise) the or any set steps as previously laid out. Thus, in FIG. 27, it is shown how the platform may comprise a database(s) 3200 (and/or stored information) of providers in any or all of the aforementioned categories/fields, (and may also comprise a database and/or stored information relating to users) and also include taking the user through a journey/system of set steps 3210 (not limited to the example shown and/or previously described). ‘Plus’ sign 3220 simply denotes that the database of (and/or stored information relating to) providers may be used in combination with the (or any) set steps system.

In FIG. 28, the surrounding circle 3230 represents an example of the system/platform, and that it may comprise both the database of (and/or stored information relating to) providers in any or all of the categories/fields, as well as the set steps system. Preferably, thus, in entering into/using the platform/system, the user is taken through a pre-determined step(s) in a substantially or fully pre-determined way. Thus incredible resources in terms of providers can be provided to the user, and the system can be configured to optimize the user's chance of getting success with their project(s). ‘Success’ will tend to mean making a profit with their project, although it is feasible success may be defined in other ways, not limited to that. For example, it is not at all impossible that the system/platform may be used to develop a non-profit project/idea. Nevertheless, the or any providers may be provided to the user, whether or not the project is for profit.

FIG. 29 denotes, roughly, how different providers (of/or different fields/categories/modules) may provide different service(s) at different steps of the system/platform. This is denoted by lines that extend from a given step of the example steps system, leading to providers of a particular module. Thus, for example, one can see lines extending from step 1, step 2, and step 4 of the example steps system 3210, going to the providers associated with the ‘patenting’ module. This is because, in the example shown, these ‘steps’ of the system are patenting steps of the journey/system. (eg step 1: patent search; step 2: provisional patent application; step 3: full (non-provisional) patent application). Thus it is feasible PPs (patent providers) may provide a service at this step(s). (As aforestated, this may or may not be the case, because the platform/system may facilitate the user in carrying out some or any of the said patenting steps, by themselves and/or without the need for a patent practitioner.

The platform/system (in the shown example) may also comprise means for the user's project (eg an invention(s) of an inventor) to be ‘sent out’ to relevant providers, for the user to be able to get a provider to provide a service/help for that step. Thus it may be very useful to have a database and/or stored information relating to patent providers, and a project (perhaps which has been categorized as being within a certain field/category) may be sent out/made accessible/viewable to the (or relevant patent providers) (who may themselves be categorized in categorie(s)/field(s) and/or sub-categorie(s)/field(s)), which provider(s) may then be able to provide a service(s)/help for the user, eg at that particular step of the journey/system. As previously mentioned, if the project, and also the provider (here a patent provider) are categories, then it may be possible to more effectively send relevant projects to relevant providers. (eg to send a mechanical device invention out to patent provider(s) who have interest and/or skill in the field of providing patent help/services for eg drafting a patent application for (and/or patenting) mechanical device invention(s).

As previously mentioned as regard to video disclosures (or any other part of the platform/system), it is possible patent providers may be able to bid/make an offer for a project (ie to provide patent work/help/service(s)). As previously mentioned, (eg with regard to other aspects of the system/platform) they may be able to do this wholly through the system/platform (eg by having a (user/provider) account, and the user also having a (user) account.

Alternatively, for example and provided by way of example alone, a patent provider may charge a set fee, and may, for example, see a disclosure of an invention and/or see (and/or be sent and/or receive information relating to) a project they may provide patent service(s)/work/help on, and may simply make clear that they are keen and/or would like to and/or are available to provide service(s)/work/help for that project. This information may be relayed (eg to the user). The fee they charge (and that the user pays, for example) may be pre-decided on/by the platform/system (or may, for example, be annotated/disclosed/shown on the providers profile, and or anywhere shown to the user, so that they know what they may need to pay).

This is described with regard to PPs by way of example, but equally may be done/provided/possible with regard to PDPs and/or PLP. FIG. 29 also shows lines going from step 3, step 5 and step 6 to the providers in the field of product development (ie PDP) (which are preferably stored on a database, for example). In the example, step 3 is product proof (proof of principle—the first or a basic build of an invention/product; step 5 is product design, and step 6 is product prototype (ie a more advanced (preferably as close to sales-ready as possible) build of the product). Thus for any of these steps, it is possible (similar to as previously described with reference to PPs), that information and/or a disclosure and/may be sent out to and/or received by the PDP(s), who may then be able to provide service(s)/help/work for the project. Again, as previously stated (with reference to PPs and also in more detail previously, relating to ‘bidding/offers’) the or any PDP may then be able to bid/make an offer to the user/creator(s), to work on the project. The user may then be able to choose which provider to move ahead with. Again, as aforestated with reference to any other part of the system/platform, the project/product(s)/invention may be categorized, and it may be that PDP are also categorized into a categorie(s)/field(s) and/or sub-categorie(s)/field(s)), and this may help to optimize the right providers gaining access to and/or being notified of project(s)/product(s)/invention(s) in their correct area of skill and/or interest and/or experience and/or expertise. This can help connect the right projects to the right/best providers.

Thus it will be obvious that, if a user has not built a version of their product/invention yet (not limited to inventions or physical products, and also including, for example, apps, website concepts, or even businesses and/or business models, for example), and if the user needs to have a proof of principle built at step 3, for example, then the project (or any information) may be sent out to and/or received by PDPs (preferably who are stored on a database, and preferably sent out and/or received selectively, by/to PDPs in the same or similar category(s)/field(s) of the project/product(s)/invention(s). This may lead to the user getting a provider at that step, to carry out that step. (Note, once a provider has been got or ‘attained’ by the user, it may or may not be needed to get further providers relating to that ‘module’—for example, if a PDP is successfully attained at step 3, preferably the same PDP also carries out/provides at step 5 and step 6 (the other steps, in the example, relating to product development). So the same may be the case for PPs, and PLFs), although it is possible a plurality of PDPs may provide for the user, for any reason. For example, it may be that the PDP that provided at step 3 did not do a good job for the user. Thus it is possible, when it comes to step 5 (or to do the same step), that a new PDP may be sought after for the user. This may or may not be done the same way as previously described (ie a disclosure and/or information being sending out and/or being received by the provider, relating to the project). So the same for PPs and PLFs, where it is feasible only one provider need to attained, but it is also possible the same method may be used to attain more than one or several PPs for the user.

So as has been said for PPs and PDPs may also be the case for PLFs. In FIG. 29, circle 3240 represents that the system/platform preferably also comprises user(s) and/or ideas/projects of user(s) (preferably a database(s) of user(s) and/or ideas/projects of user(s)). Arrow 3250 represents that the idea/project can (then) ‘enter’ into the system/platform, being taken through and/or going through a set sequence of steps. Ideally, the user/project starts at step 1 (or the earliest relevant step). However, it will be obvious that it is feasible some projects may enter into the system where some steps have already been done/completed. For example, (in an extreme case), a user may have already released a product in the marketplace, which, for example, has not performed well. It may have been made public many years ago, and therefore no new features can be patented (and/or may simply not be patentable). If it is decided the product(s) need to be re-designed (eg it may not be designed well, and it may be decided it needs to be redesigned to have a good or better chance of success), then it may be that the project is ‘dropped in’ at step 5 (product design, in the example shown), so that it can be re-designed, eg by a professional product designer(s) (ie a PDP), which might, for that example, be the first thing that needs to be done and/or is best for that project. It will be obvious that the same method as previously described by be used to attain a PDP (eg a disclosure and/or information being sent out to and/or received by PDPs (preferably via categorization optimization, as previously described). Bidding/offer(s) etc (and/or all other concepts previously disclosed) may or may not take place and/or be provided.

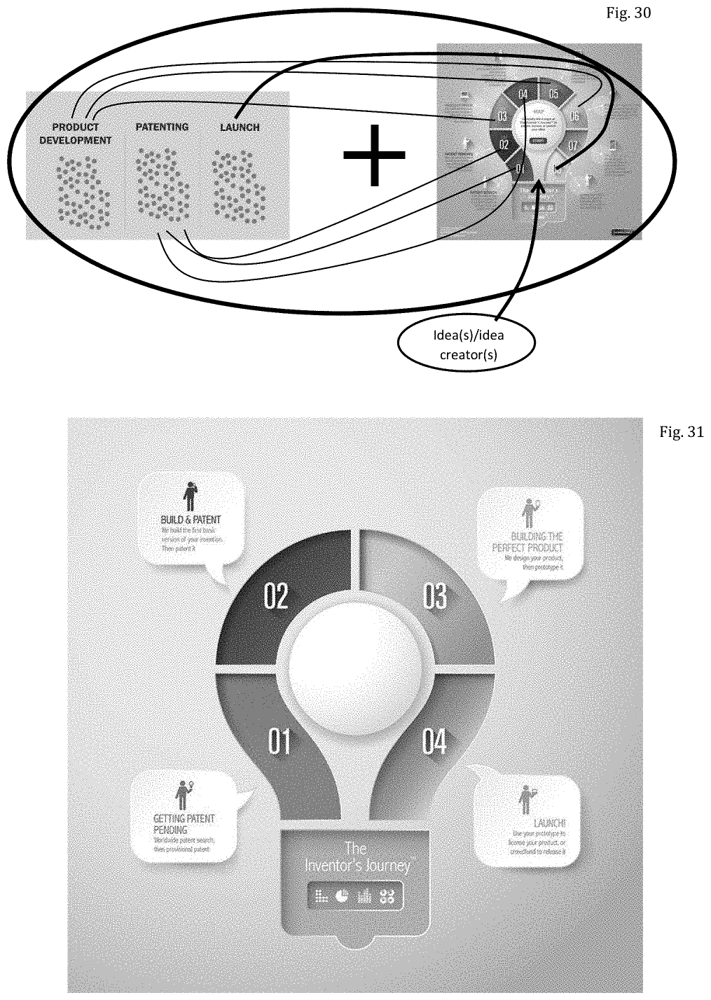

FIG. 30 denotes much the same as FIG. 29, but shows an alternative way of looking at the platform/system, which might be that the user(s) and/or projects/ideas of the user(s) are on the outside of the system, and then enter ‘into’ the system/platform, and go through the journey of the steps, preferably facilitated by the providers (which the platform/system preferably comprises a database(s) of).

FIG. 31 is a slightly updated version of what is shown previously in FIG. 17, with the names of each ‘STAGE’ of the example embodiment updated, but much the same. The stages now shown are: STAGE 01: Getting Patent Pending; STAGE 02: Build and Patent;

STAGE 03: Building the perfect product; and STAGE 04: Launch!

As has previously been mentioned, this is just one embodiment/example, relating to ‘inventions’, but the system/platform is not limited to providing for and/or being used for inventions. For example, for a product (eg a consumer product) that is not patentable, nonetheless the system/platform may be used (even the same/similar one as shown in many of the drawings), but may simply exclude the patenting steps. Thus the product development step(s) (eg steps 3, 5 and 6 in the example) and/or the launch steps (eg steps 7 and 8 in the example) may be provided, without the patenting steps. The system/platform is also not limited to the examples/embodiments provided. For example, the platform/system may be provided not even including any patent step(s).

In FIG. 32, there is shown a basic example flowchart of a user (in this case an inventor) using the system, trying to patent and launch their product(s)/invention (which is an embodiment of a project). In the embodiment shown (and all the embodiments relating to FIGS. 32, 36, 39, 42, the user (an inventor, in the examples) the platform/system/method comprises/uses the steps as set out generally in FIG. 22, although the examples are not limited to using that system/embodiment.

In the example shown, as stated at the top of the flowchart, the user has already built a proof of principle (Product Proof) of their invention, before, for example, coming into contact with the platform/system and/or provider of the platform/system.

They are provided with a patent search 3001 (step 1 of the example of FIG. 22 and other examples shown). Their patent search shows, in the example, that there seems to be patentable matter. Therefore, because they have already built a proof of principle (and thereby completed step 3 of the example of FIG. 22 and others), and because filing a full (non-provisional) patent application (step 4 of the example of FIG. 22) gets them patent pending, just as a provisional patent application (step 2 of the example of FIG. 22) would, they are able to skip step 2, and because they have already completed step 3 themselves, they then have a non-provisional patent application 3004 (ie a patent application for search and examination at the/a patent office) filed at the/a patent office. Preferably this is done at one of the quicker patent offices, so the results from the search and/or examination can be acquired within (or well within) 12 months of the date the (or the user's first) patent application is filed, thus giving them the results well before the 12 month deadline within which they must file at any other territories, to be able to ‘claim priority’ back to this (or their first) patent application. This step may comprise providing the user with a product(s)/program(s)/service(s) to facilitate drafting and filing of the patent application. Preferably the non-provisional patent application drafting and/or filing is done by a patent provider (PP), such as a patent attorney or patent agent, for example. It is possible that, either at this step, or at the patent search step before, a PP has been acquired for the inventor via use of the/a database of PP's. The or a PP may be provided for/to the inventor in any way. It may be as simple as the user coming into contact with the PP during use of the system/platform. It may be that the user is simply introduced to the PP. It may be that a PP is designated to the user and or user's project. It may be that the PP is found via using the previously mentioned ‘categorization’ technique, possibly as simply as ascertaining what ‘category’/field the invention is in, and then alerting all relevant PP's who may be able to provide patent work/services/help for that project. As previously stated, bidding/offering by the PP(s) may or may not be provided/present.

Preferably results from the patent office (ie search, and preferably search and examination results) are received, before moving to the next step (which in the shown example, is Product Design 3005 (step 5). Results are preferably achieved first, so that it can be ascertained if the patent office (examiner) deems any commercially viable claim(s) (or material) to be allowable for patent, at that time.

In the Product Design step 3005, in the example, preferably the inventor/user's product is designed by a professional product designer (ie a PDP) into a final product. This may (or may not) include the PDP providing several (or more), ie more than one, possible design for what the finished product may look like. Preferably, these are put to the user, and communication between user and PDP preferably occurs, to decide on what the finished design should be and/or which design to choose. Amendment(s) and/or alteration(s) to the design(s) may occur. The early part of this process may include the PDP making illustration(s)/sketch(es) of the design(s). Once chosen, preferably the PDP (or any provider) commits that design into a final 3D render/image of the final product design. This step may also (and preferably also) includes designing (and preferably committing to 3D/render) of the product packaging too. This (or a, or several) 3D renders is preferably then presented/provided to the user. (The 3D render/imagery may be provided as a two dimensional image/render, which is typical when rendering out from 3 dimensional software).

CAD may or may not be done at this step. Many product development professionals like to do the CAD for a product, before or at the same time as the actual ‘design’ (ie external aesthetics/design) of the product. Thus it is feasible that, rather than just aesthetics and/or user-interface, that actual CAD is created for the product (which CAD may or may not become the basis for future tooling and/or manufacture of the invention/product(s)).

If this step is completed, in the example, the product is then prototyped 3006, which preferably comprises attempting to execute a prototype of the product design (and possible also the packaging) as designed in step 5. This will tend to comprise creating one (sometimes more) high quality prototype. Preferably this is done by the same PDP as who designed the product in step 5.

Next, in the example, a Trailer Video 3007 is made of the prototype, in action. This video can become useful in getting PLFs involved in the project. The Trailer Video may also include the current patent status of the project. One of the intends of the Trailer Video is to make the project/product(s) attractive to potential PLFs who may be needed by the user, in order to get the product(s)/project launched successfully.

In the present example, the Trailer Video is used to try to lure a high quality (preferably elite) Crowdfunding specialist (which is a type of PLF) into the project/situation. This is because, in the example of FIG. 32, it has been decided (either by the user and/or a provider on the system/platform (eg PDP) and/or by the proprietor/owner/provider of the platform/system/method itself)) that the course of action that will be taken is to try to crowdfund the invention/product(s) to market, preferably via Kickstarter (a well-known crowdfunding site). Thus a Trailer Video is made, showing the prototype in action (with video footage of the prototype), and preferably showing other attractive things about the project.

It may be that the Trailer Video mentions possible financial arrangements and/or benefits (if any are being provided). Thus, if the crowdfunding specialist PLF is being offered, for example 15% of all profit generated by the product for the first 18 months (or 2 years, for example, or 3 years, for example) after launch, this may be mentioned in the Trailer Video. Alternatively (or in combination), such things may be mentioned to the PLF, not in the video. (eg in an email, or via any form of communication, including, but not limited to calls, email, message, letter, on a website, or in any other way).

The crowdfunding specialists are preferably providers that may have had much previous success crowdfunding many products/projects successfully (preferably on Kickstarter). Preferably they have the ability to create high quality campaign (or other) videos. They may comprise/include professional videographer(s). It will be obvious these types of providers can hugely boost a user's chance of successfully crowdfunding a project (eg on a crowdfunding site, such as Kickstarter) as opposed to the user (or user and/or PDP) doing it themselves, with little or no previous experience/success in crowdfunding.

Preferably the crowdfunding specialist PLF (which may be one, or a plurality of people) can manage/create most, or all of the crowdfunding campaign. It is feasible (though not required) that some footage from the previous Trailer Video may be used as part of the crowdfunding campaign video(s) made by the crowdfunding specialist PLF, although it is also feasible none of it may be used, since it may be deemed not high quality enough, compared to work and/or video that may be done/created by the crowdfunding specialist PLF.

If the/a crowdfunding specialist PLF is successfully attracted, in step 3007a, a Kickstarter (or any crowdfunding site/method) campaign is created by/with the crowdfunding specialist PLF. In the example, a Kickstarter campaign is created and an attempt is made to get the product(s)/project funded on Kickstarter. This might require knowing the tooling/manufacturing costs for the product (and considering how many units, etc etc will be made, plus any other pertinent information/calculation(s)), so that a correct/appropriate target amount can be set for the crowdfunding campaign. Depending on the project, this could range from small amounts, to tens, or hundreds, of thousands of dollars. Thus, preferably, at or before this step, work may be done/provided (preferably by the PDP), to work out (and/or ascertain) the tooling and/or manufacturing costs for the product(s)/project. This may or may not be charged for (eg by the provider. As will be obvious, it is feasible the provider of the system/platform (who may also be called/referred to as the ‘facilitator’ of the system/platform) may, or may not, get an amount of any money maid to any provider using the system. Thus if a PDP charges a user £3000 for a service, it is feasible, for example that the payment is made via/through the platform/system (eg via escrow, for example) and/or it is feasible the provider/facilitator of the platform/system gets an amount of that money and/or a percentage (eg 8.5%, for example). This may or may not be the case. If such money (or any money) is paid through/via the system/platform, the system/platform may thus comprise a system and/or may comprise software, form example, whereby a percentage (or any amount) of all or any payment(s) made to any provider is syphoned/goes to the provider/facilitator of the system/platform.

There may or may not be further costs to consider in making the target amount for a crowdfunding campaign. These may be calculated.

The crowdfunding specialist PLF may simply be contacted (by any means), with a view to hiring them/getting them to help crowdfund the project. Eg they may simply be contacted, eg by phone, email, via a website of their's, etc. Preferably they are provided with the Trailer Video, although it is feasible a trailer video is not provided or made, and that the project is communicated to them in any other way. It may be that they charge a fee for the service of helping and/or creating/managing the crowdfunding campaign. The concept of the crowdfunding specialist PLF getting special bonus payment and/or having financial incentives, if the project is successfully crowdfunded and/or launched may be used to try to get the crowdfunding specialist PLF to charge less. It is even feasible that a crowdfunding specialist PLF may even pay money to take a project up for crowdfunding, if they are offered financial incentives, and they believe the project could make a lot of money.

An example of a bonus payment(s) and/or financial incentive would be, for example, that the crowdfunding specialist PLF may be 15% of all profit generated from the product, for the first three years (or any amount of time) after it is launched). (The time from when it is launched, in this example, of crowdfunding a project, may be decided upon in several ways—for example, it may mean the date when the crowdfunding campaign starts; it may mean the date the crowdfunding campaign ends (if successfully funded); it may mean the day the first sold units are shipped out. These are just examples; any date may be decided with regard to this. Preferably the date decided is universal, between all projects, for the type of launch that has been decided upon. Launching (when licensing an invention/product(s) may have different rules ad to what the ‘launch’ day is, for example).

It is possible, if the platform/system comprises a plurality of crowdfunding specialist PLF, that a system such as that shown, and described, with reference to FIG. 23-25 may be used, to attract a crowdfunding specialist PLF. A Trailer Video may be used in that way. Thus in the example of FIG. 32, between feature/step 3007 and 3007a, the Trailer Video may be uploaded to the platform/system (or made accessible/viewable in any way), and preferably, in the example of FIG. 32, where the user wants to crowdfund (and/or that option has been chosen/decided), preferably the platform/system optimizes the chance of finding a crowdfunding specialist PLF by only sending the Trailer Video out/notifying and/or alerting and/or making the video accessible to crowdfunding specialist PLFs on the system/platform. Thus, in the example shown, if the platform/system comprises such a system, because it has been decided that only crowdfunding specialist PLFs will be targeted, it may be that no other type of PLF (eg investors, potential licensee companies, etc) are notified and/or made aware. (Or that some or all of the other PLFs are not made aware and/or targeted). As previously stated, the targeting may be even further sub-categorized. In the example of FIG. 32, if the product is a kids' product, for example, it may be that only some of the crowdfunding specialist PLFs are targeted. Others, which specialize in crowdfunding projects that are perhaps in a very different field (eg artistic projects, computer games, or architectural projects, for example) may not be targeted. Alternatively, it is possible all crowdfunding specialist PLFs are targeted.

If a crowdfunding specialist PLF is not found/attained, then it may be that an attempt is made to crowdfund the project without a crowdfunding specialist PLFs (eg by the user and/or PDP doing or organizing the campaign/crowdfunding themselves). Thus a step 3007b is shown.

Preferably the crowdfunding campaign is successful, and the product is released. (Shown at end of flowchart in FIG. 32.

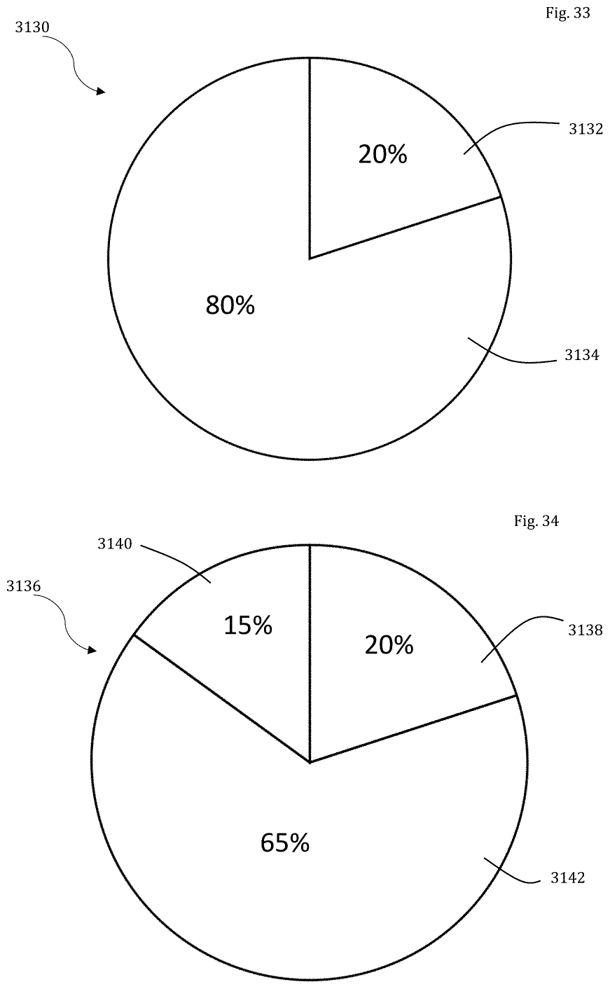

Preferably the platform/system is what may be referred to as a ‘success centric’ system. Thus, as stated, it may be that any (or a plurality) of providers involved may be incentivized to make the project a success (preferably meaning a financial success) by the fact that they (the provider(s)) will themselves financially benefit if the project/product(s) is a financial success. Thus, referring to FIGS. 33 to 35, there are shown several different models for who might benefit, and in what way, if the product(s)/project becomes a financial success.

In the example of FIG. 32, the product is a kids' playtime product. In the example, the PDP and/or PP was or included the provider/facilitator of the system/platform (although it could be any provider). In the model of FIG. 33, the user (inventor/original creator/proposer of the project, in the example) did not want to release the product himself, but instead wanted, ultimately, for this to be done by some other party. However, the PDP and/or provider/facilitator/owner of the system/platform here wanted to release the product themselves under their own brand. Therefore, in the example model 3130 of FIG. 33, a deal/licensing deal is signed between the user and the PDP for the PDP to release the product themselves under their own brand. A deal is signed that the PDP (who, in this example, is (or is derived from/a team of) the provider/facilitator/owner of the system/platform (but need not be in all examples)) that the inventor will get 20% (3132) of all profit generated by the product(s)/project, up to $100,000. They will then get 10% of all profit up to $100,000. And 7.5% of all profit from that point forth. The pie chart of FIG. 33 represent the agreement as it initially stands, with the user getting 20% (3132) of all profit initially, and the PDP getting 80% (3134) of all profit. (As stated, the percentages/amount may change in time). Percentage/amount may change, for example, based on profit generated by the product(s)/project, and/or elapsing of a time period, for example.

FIG. 34 represents a different (financial model/arrangement) 3136, whereby a similar agreement is in place for the profit that goes to the user, which is shown as 20% (3138), (and may again change, for example based on profit generated and/or time elapsing), but rather than the PDP now getting all the rest of the profit, an agreement is in place that the crowdfunding specialist PLF will get 15% (3140) of all profit generated from the product for 1.5 years (18 months). This type of agreement may incentivize high quality crowdfunding specialist PLFs to provide crowdfunding services. Again, this agreement may change due to profit and/or time elapsing. For example, it may be agreed that, once the crowdfunding specialist PLF gets $150,000 (or any decided amount/target), they receive no more money. Alternatively (or in combination), it may be that, once the crowdfunding specialist PLF receives a certain amount of money, their percentage falls. This allows for the crowdfunding specialist PLF to potentially make a lot of money fast, but for that percentage to them default back (to some extent, or fully) to the user and/or PDP and/or other party(s)/provider(s) involved. The PDP is therefore shown, in the example, now initially only having 65% (3142) of the profit generated from the product(s)/project. (‘Percentages’ and ‘profit’ are used by way of example only, and any parameter(s), not limited to ‘percentages’ and ‘profit generated’ may be used).

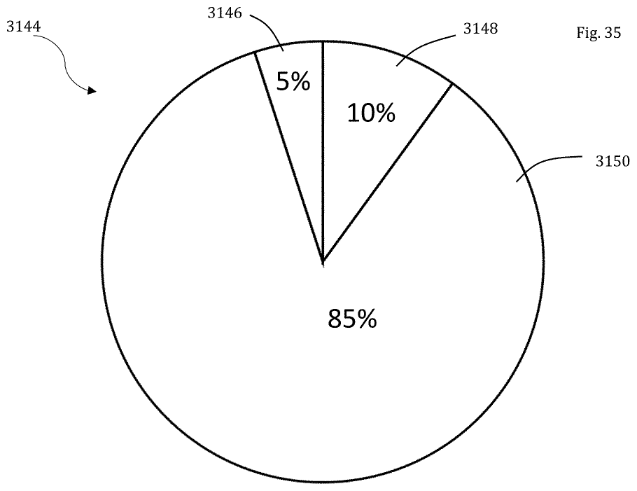

A still different model/example arrangement (financial) 3144 is shown in FIG. 35. In FIG. 35, this time the PDP is not the provider/owner/facilitator of the platform/system. Again, a deal/arrangement is done between the user (eg inventor) and the PDP that the PDP will release the product themselves. Therefore a licensing agreement is made between the user and the PDP. But in this example, the provider/owner/facilitator of the platform/system (eg a company called SHIINE®) get a percentage and/or amount too. In the example, for example, SHIINE® gets 5% of all profit generated by the project/product(s). This may be time and/or amount sensitive. For example, after 5 years, the amount to the provider/owner/facilitator of the platform/system may go down in amount/percentage, or may go down to zero. The example of FIG. 35 shows that, to start off with (or for any amount of time, or for all time), the provider/owner/facilitator of the platform/system gets 5% of all profit generated; the user (here an inventor) gets 10%; and the PDP (who the product(s)/projects has been licensed to by the user) gets 85%. If the 5% of the provider/owner/facilitator of the platform/system goes down or becomes 0% in time, that 5% (or whatever amount it is) may go back to the PDP (which would mean they would then get 90%, for example), and/or the user. Any or all amounts may be time and/or amount/milestone sensitive.

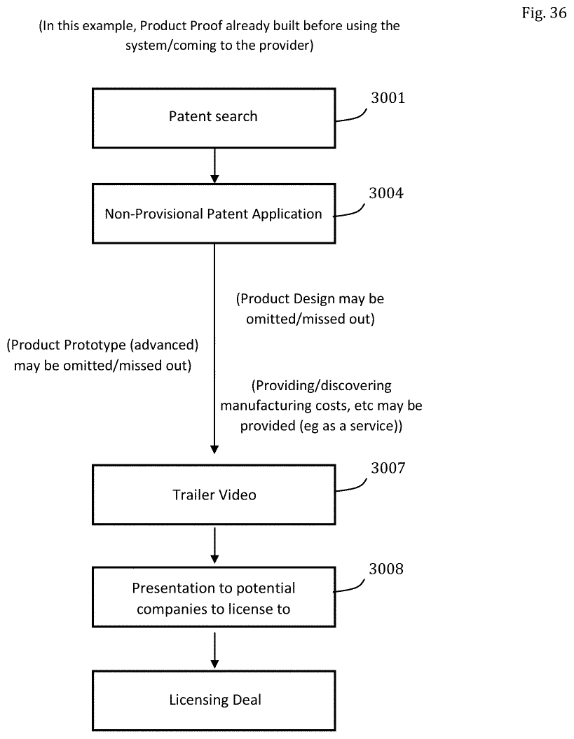

In FIG. 36, there is shown a basic example flowchart of a user (in this case an inventor) using the system, trying to patent and launch their product(s)/invention (which is an embodiment of a project). In the embodiment shown, the platform/system/method comprises/uses the steps as set out generally in FIG. 22, although the examples are not limited to using that system/embodiment.

As stated at the top of the flowchart, in the example, the inventor has already made a proof of principle (Product Proof) of their invention, before entering into the system/platform. A patent search 3001 is carried out. Then, because the inventor has already made a Product Proof, they can skip step 2, (and have already completed step 3: Product Proof by themselves) and can go to step 4—a full patent application (3004) drafted and filed at the patent office, for search and examination. In this example, as suggested in brackets between steps 3004 and 3007, Product Design (usually step 5 and Product Prototype (usually step 6) may have been omitted and not done by the inventor/user. This is because, in this example, the user/inventor has a very limited budget. The invention of the user is an industrial mechanical invention for an transport vehicle. Whilst they have built a proof of principle, the user, in this example, cannot afford high quality product design and a high quality prototype. It may, or may not, be allowed on the system to miss out any step(s). Missing out of any step(s) may (or does) negatively impact the chance of a project being successfully launched. (In this example, the user wants to license the product/invention—‘licensing’ is considered, for the sake of the present application, to be a form of ‘launching’). Nevertheless, it is feasible, in certain situations, that a user may be able to miss out some or any step(s). It may be that it is adjudged (eg by the owner/provider/facilitator of the system/platform) whether a user is allowed to miss out any step(s), or not.

As stated with reference to the example of FIG. 32, manufacturing and/or tooling costs, etc may be ascertained (preferably by a PDP and/or specialist in such an area, relating to manufacturing and/or tolling). This information may be extremely important, since providing such information to potential licensee companies may be useful in giving them information they need to decide whether they would like to enter into a licensing deal with the user.

A Trailer Video, in the example, is made (3007)—this time, because no advanced prototype has been made, it may show video footage of the proof of principle, in action. As stated previously, it may show/disclose other information, eg regarding patent status and/or tooling/manufacturing costs, etc.

In this example, the Trailer Video may comprise a script and/or be configured to show the potential licensee(s) why the invention/product is in their financial interest to enter into an agreement with the user for. For example, it may include information relating to why the invention will save the potential licensee company(s) money if they use the invention with their fleet of vehicles. Business figure(s) may be worked out to prove exactly (or show) to the potential licensee company how much money they will save and/or why the invention/product(s) is so beneficial to them. Thus the Trailer Video may be targeted (in script and/or information) to (a) potential licensee(s).

Thus the Trailer Video is presented to potential licensee companies (step 3008). This may be done by any means, For example—the potential company to license to may be called by phone, or contacted in nay way, eg email. Preferably the Trailer Video is delivered to them in some way, as part of the presentation. This could be as simple as sending the video by email, for example. It could be shown on a website, for example. It is also feasible, if the system of FIGS. 24-26 is part of the system and/or available, that, much as previously described, potential licensee companies may be on the system. These such companies would be considered PLFs (a company to license to is considered a PLF, since they are key to ‘launching’ (ie getting success, preferably financial success) with a product(s)/project). Thus, for the present example, if the system shown, and described with reference to, FIGS. 24 to 26 is part of the platform/system, then the Trailer Video may, for example, be categorized (and perhaps sub-categorized) and PLFs who are licensing companies (and preferably those in the industrial field(s) relevant to the invention/product(s)) may be targeted. Preferably PLFs who are not relevant (eg crowdfunding specialists) would not be targeted in such a situation as this.

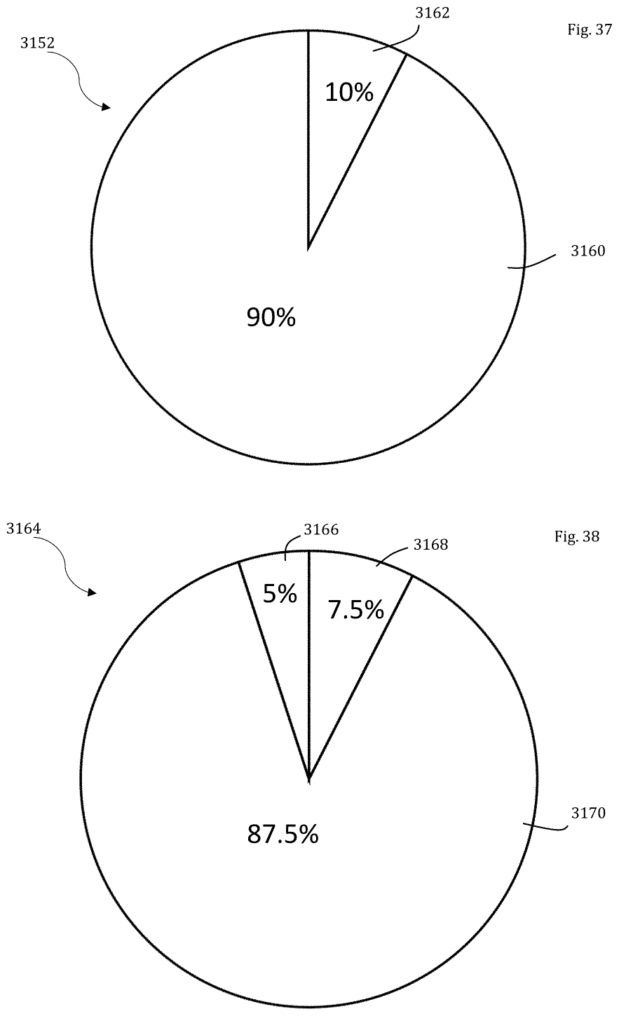

Referring to FIGS. 37 and 38, two possible example models/financial arrangements are shown for the example case of FIG. 36. In FIG. 37, an example arrangement 3152 is shown, wherein the user (an inventor in this case) has licensed his invention/product(s) successfully to a licensee company (eg an industrial vehicle company in this case). The licensing agreement sets out that the user/inventor gets 10% (3162) of profit generated from sales of the product(s), and that the licensee company who it has been licensed to (and who hopefully will use and/or release and/or make and/or manufacture the product) get 90% (3160) of profit generated from sales of the product(s). (It should be noted that the system/platform is not limited to ‘products’ and may be any project, for example, not limited to what might typically be considered to be ‘products’. For example, to give an odd/unusual example, a user (which may be an individual, or a plurality of people, for example) may use the system for a project to create a new building, (eg for meditation, or for any other use), (and/or change/adjust/do work to a building already built). This would not typically be seen as a ‘product’, although it would certainly be within the scope of being a ‘project’. It is feasible the user could use the present system/platform, to develop and/or complete and/or commercialise such a project. It is feasible the user may be able to get access to and/or find providers, such as providers who can design and/or do actual physical work (and/or architectural work) to make the project happen. Thus the platform/system may comprise such providers (and/or information relating to such providers and/or a database(s) of and/or including such providers). These could be argued to be PDP's for such a project (and/or may alternatively be seen as ‘project development providers’. (These may still be considered to be PDPs). (Thus the project could, for example, be a building (or work related to a building(s)). An architect (or any other type of provider) could, in such an example, be a provider. (This example is simply given by way of example only)). It is also feasible the user may be able to connect with and/or find investors and/or investment for such a project, using the platform/system. (An investor would be an example of a PLF). It is even feasible there may be patentable aspects of such a project, in which case, the user may be able to connect with and/or hire a PP to provide patent help/work/service(s), via the platform/system. Thus the system/platform can be used for any project. This example is simply given by way of example to show how the platform/system can be used/provided for any project, and that the scope of what projects can be provided for and/or helped and/or developed and/or facilitated is extremely broad. Providers of any sort, to help, and/or make any sort of project and/or thing happen, may be providers, (and/or may be used and/or hired). Thus the system/platform may, feasibly, be used and/or usable for any project (and/or job and/or thing).

Whilst ‘percentages’ are here part of the agreement/arrangement, it will be well known to those with skill and/or experience in the field of licensing deals that such agreements are not limited to percentage agreements, and may, for example, be based on lump sum amount(s), or any other agreement.

In FIG. 38, an example model/agreement/arrangement 3164 is shown, this time where not only so the licencee company get a share/amount, and the user, but the provider/owner/facilitator of the platform/system gets a percentage/amount. In the example, the provider/facilitator/owner (which may be a company called SHIINE®, for example) get 5% 3166 of all profit generated by the product(s)/project. This may be for a limited time, eg for 5 years for example (similarly to example as disclosed/described with reference to FIG. 35). The user/inventor is here shown getting 7.5% 3168, with the licensee company getting 87.5% 3170. These examples are shown by way of example only. If the 5% share of the owner/provider/facilitator of the platform/system is lowered, or becomes 0%, then that percentage and/or amount may go back to either the user, or the licensee company, or both.

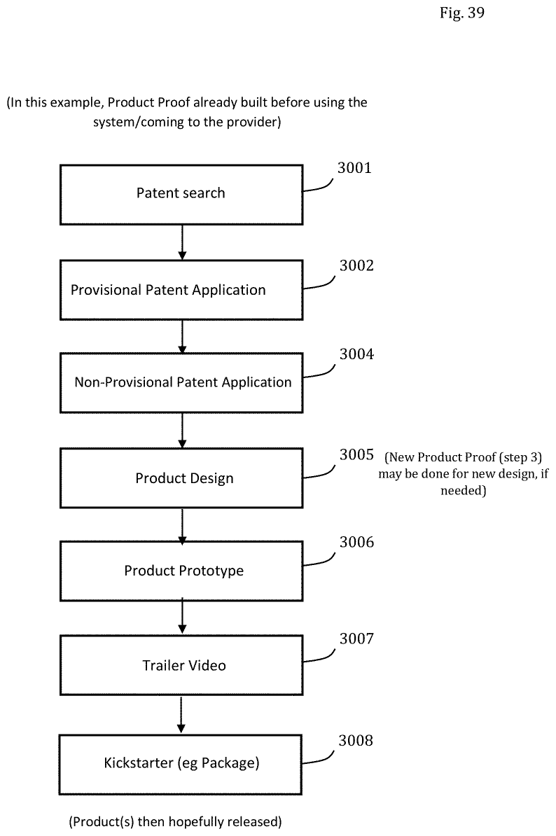

In FIG. 39, there is shown a basic example flowchart of a different user (in this case an inventor) using the system, trying to patent and launch their product(s)/invention (which is an embodiment of a project). In the embodiment shown, the platform/system/method comprises/uses the steps as set out generally in FIG. 22, although the examples are not limited to using that system/embodiment.

As stated at the top of the flowchart, in the example, the inventor has already made a proof of principle (Product Proof) of their invention, before entering into the system/platform. A patent search 3001 is carried out. Then, because the inventor is American, and because, in the example, their full (non-provisional) patent application will be filed at the UK Patent Office, and because American inventors, presently, are required to file their first patent application at the USPTO before any foreign patent office (by default), a provisional patent application is filed (3002) so that the inventor can get patent pending as soon as possible. The provisional patent application may be drafted and/or filed by a PP (patent provider). Alternatively (or in combination), it is feasible a product(s)/program(s) (or any information) is provided to the user/inventor, to allow the user to draft and/or file their own provisional patent application. In this case, the provisional patent application was filed at the USPTO. After this, because step 3 (Product Proof) has already been done by the inventor/user, they can move straight to step 4 (much as previously described with reference to the previous two example flowcharts. Similarly, then Product Design 3005 is carried out (much as described, for example, with reference to FIG. 32. It is noted that (and this may be relevant for any project), if, during the Product Design step, the or any professional product designer (or any PDP) comes up with a design that has any new feature(s), which feature(s) may need to be tested, before advanced prototype is made, then, as denoted in writing in FIG. 39 next to step 3005, the Product Proof step may be revisited, to make a proof of principle of the new design. (ie a second proof of principle may be built, this time of the new design.

Next, an advanced prototype of the product design is made (3006).

In this example, the user wants to crowdfund his invention/product, eg on Kickstarter. He does not want to license it. He wants to crowdfund, and release the product himself, perhaps even building his own company around it. His product is a consumer product, in the example.

A Trailer Video is made of the prototype in action. This is a useful presentation tool for his invention. This may be made with the help of provider(s) of/on the platform/system. In this example, however, unlike the example of FIG. 32, it may be hat the project is not apt for trying to attain a crowdfunding specialist PLF. Instead, the user/inventor may want to create his own crowdfunding campaign and/or do it with the help of the owner/provider/facilitator of the system/platform, and/or any provider(s).

The Trailer Video preferably shows the (advanced) prototype in action.

Next, the user/inventor tries to crowdfund his invention/product(s)/project, which may include trying to raise money to get it manufactured in any great number, for example. Crowdfunding can also be used to make the first sales of the product, because the product itself can be the prize for a pledge by a funder.

In this step (crowdfunding), as previously disclosed/described, a package may be provided on the platform/system, which includes help with any or various aspects of the crowdfunding campaign. This may include computation of manufacturing/tooling costs and/or crowdfund target amount(s). This may include help with making and/or managing the crowdfunding campaign. This may include video help. The Trailer Video may play an important part in the campaign and/or main crowdfunding campaign video. Hopefully (as denoted at the end of the flowchart), the crowdfunding campaign is successful. This may (or does) allow the user to officially release their product, and perhaps even make their first sales through the crowdfunding site (eg Kickstarter) itself, to pledgers who funded the project.

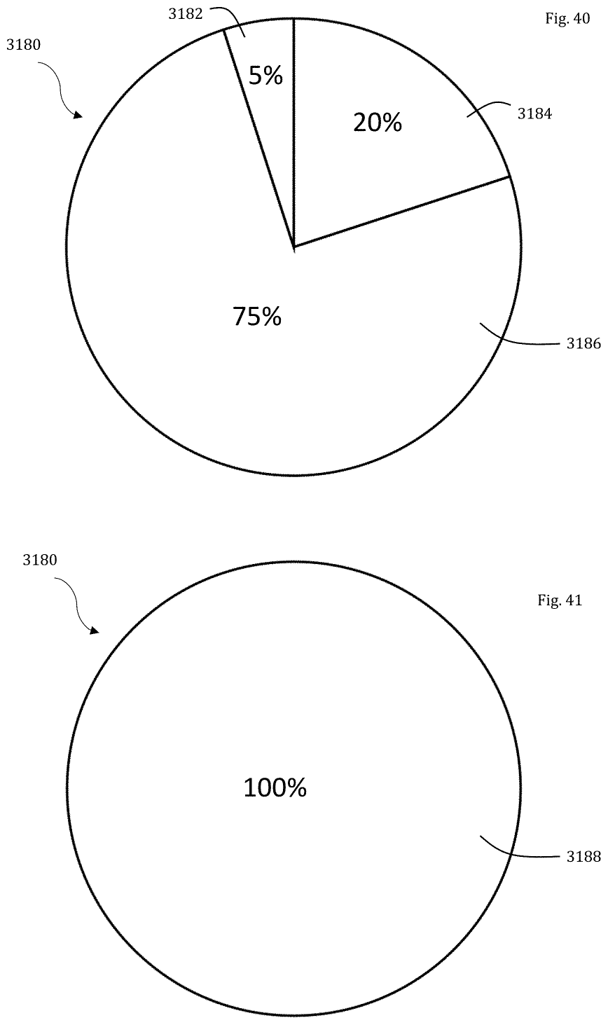

In FIGS. 40 and 41, a sequence of the same possible example model/arrangement 3180 is shown. In the example arrangement 3180, initially (as shown in FIG. 40), an arrangement/agreement is shown wherein the provider/owner/facilitator of the system/platform gets 5% (3182) of all profit generated by the product(s)/project. In the example, (provided by way of example only), after 5 years, this 5% then goes back to the user/inventor (ie becomes 0%). In the example, the PDP who developed the product (eg steps 5 and 6 (and possibly step 3) in this example, or any other example) gets 20% (3184) of all profit generated from the product(s)/project. In the example, this agreement lasts for 3 years, after which the 20% goes down to 0%, and that whole 20% default back to the user/inventor. (It is feasible, in other examples, that the 20%, either due to amount and/or time milestones being reached, become a lower amount, and may, or may not, become 0% at some point).

The user/inventor is shown initially getting 75% (3186).

In FIG. 41, the same agreement is shown, but after more than 5 years later. Now the 5% of the provider/owner/facilitator of the system/platform, and the 20% that initially was going to the PDP have now defaulted back to the user/inventor. Therefore, in the shown example, the user/inventor is now getting 100% (3188) of all profit generated by the product(s)/project. Such an arrangement may be beneficial for all parties, because the user/inventor may enjoy that they eventually get 100% of all profit generated from the product(s)/project, and the PDP may enjoy that they get a significant percentage amount, for several years when the sales of the product may well be high (in the initial years).

As will be obvious, it is possible the provider/owner/facilitator of the system/platform may not be time sensitive. So, for example, the percentage/amount(s) the provider/owner/facilitator of the system/platform gets may be continuous, for example—eg 5% indefinitely, during the whole sales life of the product(s)/project.

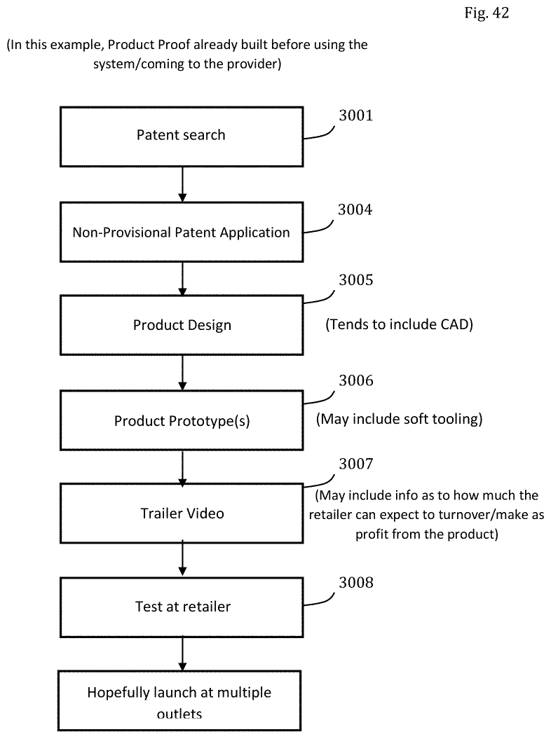

In FIG. 42, there is shown a basic example flowchart of a user (in this case an inventor) using the system, trying to patent and launch their product(s)/invention (which is an embodiment of a project). In the embodiment shown (and all the embodiments relating to FIGS. 32, 36, 39, 42, the user (an inventor, in the examples) the platform/system/method comprises/uses the steps as set out generally in FIG. 22, although the examples are not limited to using that system/embodiment.

In the example shown, as stated at the top of the flowchart, the user has already built a proof of principle (Product Proof) of their invention, before, for example, coming into contact with the platform/system and/or provider of the platform/system.

They are provided with a patent search 3001 (step 1 of the example of FIG. 22 and other examples shown). Their patent search shows, in the example, that there seems to be patentable matter. Therefore, because they have already built a proof of principle (and thereby completed step 3 of the example of FIG. 22 and others), and because filing a full (non-provisional) patent application (step 4 of the example of FIG. 22) gets them patent pending, just as a provisional patent application (step 2 of the example of FIG. 22) would, they are able to skip step 2, and because they have already completed step 3 themselves, they then have a non-provisional patent application 3004 (ie a patent application for search and examination at the/a patent office) filed at the/a patent office. As previously stated, bidding/offering by the PP(s) may or may not be provided/present.

Preferably results from the patent office (ie search, and preferably search and examination results) are received, before moving to the next step (which in the shown example, is Product Design 3005 (step 5)). (Much as previously described, with reference to FIG. 32, for example).

And then onto Product Prototype 3006. In the case of this particular project, it may have been decided (either by the PDP, and/or the user, and/or the provider/owner/facilitator of the platform/system, or any other party), that it will be attempted to launch this product(s)/project by actually getting some (perhaps free) versions to some newsagent(s)/retailer(s). (The product, in this example, is a basic product that can be sold in newsagent(s)/retailer(s)). For this reason, and because, in this example, the product is extremely simple, it may be possible to use soft tooling, which can be a useful way of making, for example, dozens of units of the product, at fairly low cost.

Once the prototype(s) is made, a Trailer Video is made of the prototype in action. Because newsagent(s) and/or retailer(s) are being targeted here (because the intent/strategy is to get the product sold at these retailers), the Trailer Video (as denoted on the flowchart next to the Trailer Video step 3007) may include important information for the retailer(s)/newsagent(s), such as how much extra money/turnover/profit the product may or will make them, over an amount of time and/or how many units will be sold, and/or wholesale price and/or minimum units for sale, etc. Thus the Trailer Video is being targeted to the PLF, which, in this case, is the/a retailer.

In the example, around thirty units of prototypes are made, via soft tooling. The packaging is also made, so that the item is ready to sell at/for the retailer. Then, in the example, three newsagents/retailers are approached, and ten units each (with relevant packaging) are offered/given to the retailer(s)/newsagent(s), free of charge. They are asked to try the product, and if it sells well (or appropriately), they may buy more units to sell in future. They are also given/provided with the Trailer Video, in any way (eg sent by email, eg given a webpage to view it, or even simply shown it by the user (or the/any person who approaches them, with a view to the free trial of selling the product(s)). Thus the product is tested at the retailer 3008.

The next box at the bottom of the flowchart denotes that hopefully the trial is a success, and the newsagent(s)/retailer(s) see that the product will give them an increase in revenue/profit/turnover. And hopefully the newsagent(s)/retailer(s) therefore decide to buy further units of the product(s) from the user/inventor. If this is the case, then perhaps this sales model can be replicated to sell the product(s) to hundreds, or even thousands of outlet(s)/retailer(s)/newsagent(s). This could lead to the user forming a successful business, and/or simply making money. (eg the many outlets may pay her money for units of the product (eg at wholesale)).

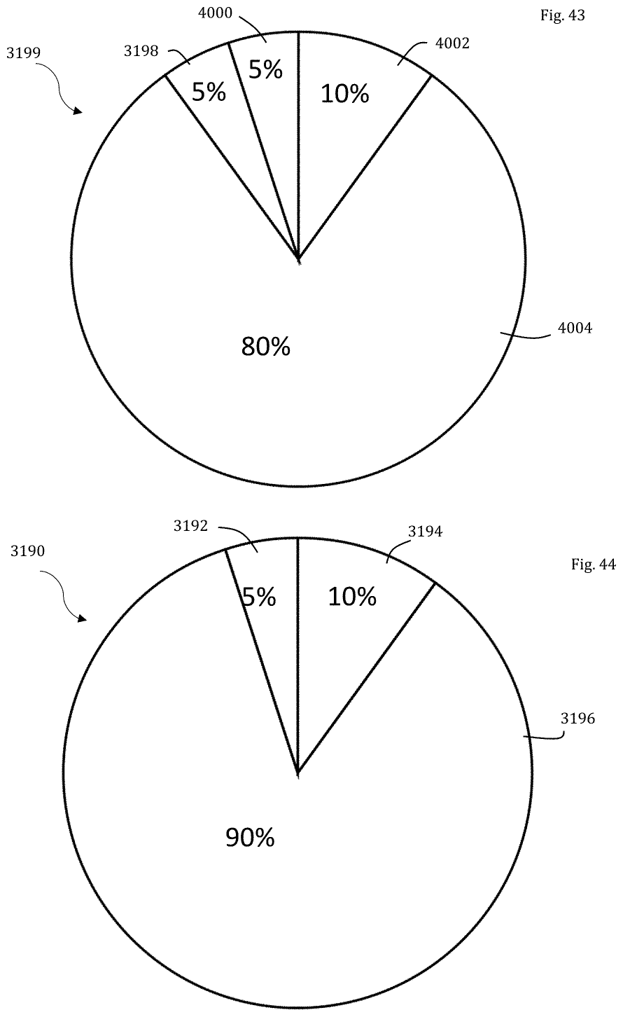

In FIG. 43, an example financial arrangements/model is shown, with reference to this example of FIG. 42. In the example of FIG. 43, an example arrangement 3199 is shown. In the example (shown by way of example only), the user/inventor has/gets 80% (4004) of the profit generated by the product(s)/project. The PDP who has done product development for the product gets/has 10% (4002). This amount may be time and/or amount sensitive, and is preferably time sensitive. Thus it may be, for example, that the PDP only gets this 10% for, for example, three years, or any amount of time. At that point (and thereafter), that amount may go back to the user (ie inventor, in this example). In the example, a 5% share (4000) goes to the patent provider (PP). This amount/percentage may be dependent on the quality of the patent protection and/or work done (as previously described, for example). This may be adjudged (as previously described, for example). This amount/percentage may differ, dependent on the quality of patent protection and/or work done by the PP. This amount/percentage may be dependent on the territory the sales and/or profit are made in (as previously described, for example). Thus if the PP has only got the user/inventor patent protection in America, then it may be they only get the example 5% with regard to profit and/or sales of the product in that given patent territory(s) that they have attained patent protection for the user/inventor in. Preferably this percentage and/or amount for the PP lasts for the duration of the patent protection attained. (Typically around 20 years, approximately).

In the example, there is shown a 5% share (3198) which is for the provider/owner/facilitator of the platform/system (eg a company called SHIINE®). This amount is preferably time sensitive. Preferably, after 5 years, this 5% share (3198) defaults back to the user/inventor. This amount may me amount sensitive (ie after a certain amount is achieved/attained, the percentage/amount may drop or go to 0%). An example of being amount sensitive would be if, due to sales and/or profit of the project, the owner/provider/facilitator of the system/platform, from the example 5%, makes $35,000, and that, due to reaching the threshold/milestone of $35,000, the 5% share then lowers, and/or goes down to 0%. This is just given by way of example, and any threshold amount may be agreed in such embodiments/examples, not limited to $35,000, which is given by way of example.

Preferably, in the example of FIG. 43, the user/inventor has come into contact with the PP and PDP, via the system/platform. Preferably the PP and PDP are/were providers as part of the system/platform, and most preferably information relating to them was/is stored on a database. Furthermore, they may have been attained as providers for the user via any of the aforestated and disclosed methods/means disclosed in the present application, such as, for example, but not limited to, some form of categorization system, where a project is ‘matched’ to provider(s) who have skill and/or interest and/or experience in the same (or a relevant) field(s) as the project/product(s)/invention. As stated several times, this may be done by categorizing (and preferably also sub-categorizing) the project/product(s)/invention/idea and/or the provider(s).

In FIG. 44, a basic example financial arrangement 3190 (which may or may not be relevant to the example of FIG. 42) is shown. This may be a typical financial arrangement for inventors/users who want to license their product(s)/invention(s)/project. It shows an example where the user/inventor has attained a PLF (here a company to license their invention(s)/product(s)/project to), with that licensee company getting 90% (3196) of the money/profit made by the product(s)/projects/invention(s). The user/inventor here gets 10% (3194). In the example, the provider/owner/facilitator of the platform/system gets 5% (3192) (preferably for a limited time, eg five years, for example). (‘Percentages’ and ‘profit’ are here mentioned by way of example. It will be obvious licensing deals are not limited to being defined by percentages and/or profit amounts. For example, some licensing deals work wherein the user/inventor gets a lump sum (and no more) for giving the licensee the right to make and/or manufacture and/or sell the invention/product(s)/project. Some licensing deals work wherein the user/inventor gets an amount, eg per unit(s) sold (rather than as a percentage of profit). Thus the or any deal (not limited to licensing, but possibly with regards to any agreement with any PLF and/or PP and/or PDP is not reliant on ‘percentages’ and/or ‘profit amounts’, but may be reliant on any agreement terms (including but not limited to the other examples just given regarding possible licensing deals/terms)).

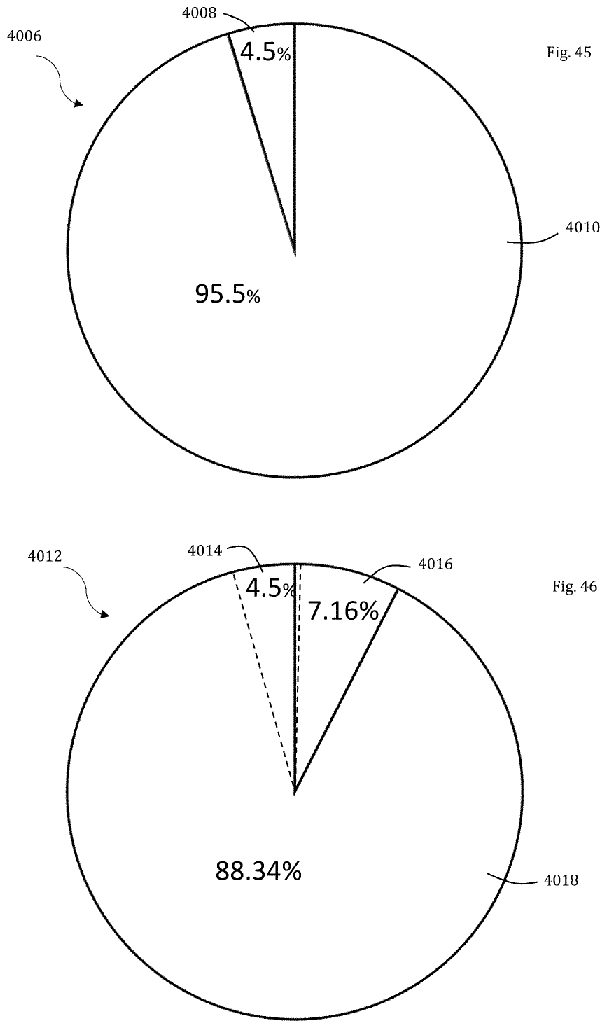

With regard to agreement of amount to go to patent providers (PPs), an example arrangement/financial model 4006 is shown in FIG. 45, which shows almost the same as shown in FIG. 41 (arrangement 3180). Arrangement 3180 of FIG. 41 had shown an example wherein, after a certain amount of time (ie after a time threshold), all the profit generated from the product(s)/project had defaulted back to the user/inventor. However, preferably, if an amount goes to the patent provider(s) (PP), preferably this amount/share/agreement lasts for the duration of any patent attained by the PP. Preferably, if the PP gets good/important patent protection, they get a 2.5% share of profit, for the duration of the patent attained (and preferably limited to sales/profit in the region/territory when the patent protection was attained). Preferably, if the PP attains ‘perfect’ patent protection (and/or the best possible patent protection that could be got, eg in light of any prior art), they get 4.5% share of profit (possibly even 5%). Thus the example of FIG. 45 shows how (perhaps even after any thresholds have elapsed in terms of other agreement(s)/share(s)/portion(s) for PDPs (or even PLFs-eg crowdfunding specialists, or any other PLF) and/or with/for the provider/owner/facilitator of the platform/system), the share/agreement with/for the PP may remain (and preferably remains for the duration of the patent attained (preferably on a territory-based methodology) by the PP(s)). Thus, in FIG. 45, which may show the state of the agreement after, for example any time from 5 years to around 15 years+, the user/inventor is getting 95.5% (4010) of all profit generated from the product(s)/project, and the PP is getting 4.5% (4008) of all profit generated. It will be obvious that these percentages may differ, on a territory based basis. For example, if the PP got ‘perfect’ patent protection in America (at the USPTO), they may get 4.5% (as shown in the example) of profit generated by the product in that territory. But if the product(s) also is selling in the UK, and the PP did not get any patent protection there, then they may get 0% of profit/amount for the product in the UK. It may even be that the PP got ‘perfect’ patent protection in the UK (and perhaps, therefore, as an example, gets 4.5% of all profit generated from sales in the UK), but that the PP only managed to get ‘good/important’ (but not perfect) patent protection in America (at the USPTO), in which case, they may get a lesser percentage/amount (eg 2.5% for sales in America). (or vice versa, etc). Therefore it may be that the PP(s) get different amounts and/or percentages and/or agreement(s), for different territories. It may also be possible that different PPs attained patent protection in different territories. Thus one PP may get a percentage/amount in one territory, and a different PP may get a percentage/amount in one territory, for the same project/product(s). This is not limited to two PPs, and it's possible more than two PPs are used, eg in more than two patenting territories. For example, one PP may achieve American patent protection; one may achieve European patent protection; and one may achieve Japanese patent protection. They may all receive any or no percentage/amount, and the percentage/amount they receive may, potentially, be decided after it being adjudged how useful/important/‘perfect’ the patent protection they attain is. (It will be obvious that, when it comes to patenting in territories such as Japan, the PP who attained patent protection in America, or Europe, for example, may use associates and/or a company/provider(s) in Japan, but effectively to file the same (or much the same) application/claim(s). In this case, any percentage/amount may still go to the original PP, rather than the Japanese ‘handlers’ who are filing effectively the same (or very similar) patent application in the other/foreign territory. This may be the case in any situation where patent protection and/or a patent application(s)/claim(s) are ‘shifted’ to a different territory. Thus the percentage/amount being given to the/a PP(s) need not rely on that PP being the actual attorney/provider, on paper, who filed and/or prosecuted that patent application to grant—it may simply be based on whether the claim(s) and/or patent application originates from their work (preferably mostly or wholly).

Thus the agreements with the PP(s) may be based on a territory and/or quality basis.

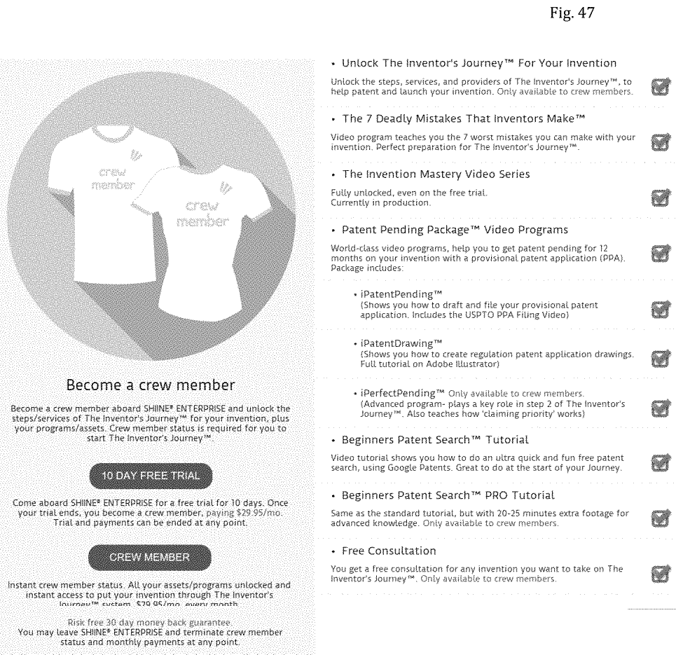

In FIG. 46, there is shown an example financial arrangement (4012). In the example agreement, the user has licensed their invention/product(s)/project to a company. The user may get 7.5% of profit generated (or any amount/percentage), and the licensee company 92.5%. But in the example of FIG. 46, a PP (patent provider) is also getting 4.5%. Whereas previously, a percentage like this was shown as a percentage that did not affect the user percentage, in this example of FIG. 46, the 4.5% (4014) of the PP is shown being 4.5% of both the user's share and also of the licensee's share. Thus, because the PP gets 4.5% of the user's 7.5% share, the user gets only a 7.16% share (4016). And the licensee company gets only an 88.34% share (4018). This is just one example of this type of arrangement, provided by way of example only. Similarly, the provider/owner/facilitator of the system/platform's share (if one is provided to the provider/owner/facilitator of the system/platform) may also take a percentage/share of the or any of the: user; and any provider(s) share. In the example, the PP gets a share of the user's share and/or the or any provider's share (not limited to a licensee company and/or PLF—any PDP and PLF's percentage/amount may be affected in the same way. (The agreement shown may have also initially included a share/mount to a provider(s) and/or provider/owner/facilitator of the system/platform, and may be being shown after any threshold (either of time and/or amount) has been reached, which may have defaulted the amounts back to the user and/or licensee company, in the example).

In FIG. 47, there is shown an example screen-shot for a possible sign up screen to (hopefully) tempt user(s) to sign up to use and/or be part of the platform/system. It shows some desirable product(s)/program(s)/feature(s) of the example platform/system, many of which are shown to be available free (Some of these have been discussed). There is then a call to action to either sign up and become a ‘crew member’, and to ‘come aboard’ to go through the journey of the steps of the platform/system. As aforestated, this preferably comprises potentially being either put in contact with and/or have/hire provider(s). Preferably, as stated, the platform comprises product developer providers (PDPs), patent providers (PPs), and product launch facilitators (PLFs) which may also be called/termed product launch providers (PLPs).

The user, in the example, can either go for a free trial (eg for 10 days) to get full or limited access to the system (preferably slightly limited access, in the example), in which case, they will come aboard and or get access (full or partial) for a limited time, and then preferably are charged a fee (preferably monthly, thereafter, although it may, for example, be an annual fee, or a fee for any time amount), at which point they preferably get full access, and can actually start to try to get access to and/ore work with and/or hire providers (eg any of: PDPs, PPs, PLFs (PLFs may also be termed PLPs).

If the user decides to ‘come aboard’ and/or start straight away, they have the option to go straight ahead (and, in the example, become a ‘crew member’). In the example, this gives them full access to the system/platform (and any, more, or all other assets, such as the program(s)/product(s) etc listed on the example webpage screenshot). If they take that option, they preferably are charged and/or pay a fee immediately, (preferably a monthly fee). Either by this route, or after the free trial expires, the user (if they become a ‘crew member’ in the example), then gets access and may be given a username and/or password, for example, to get into an interface. The interface preferably helps them on their journey through the system and/or method. Example interfaces have already been discussed (and shown in various drawings. The example of FIG. 20 is one example of such an interface. One preferred intent is for the interface to help and/or guarantee that the user (who may be an inventor) goes through the journey in the correct order. (Preferably completing steps in the correct order). Once the user(s) have ‘come aboard’/signed up, they may be part of a ‘database’ and/or part of the platform/system, and preferably will have a (preferably password protected) account. Thus what is shown in FIG. 47 is relevant to FIGS. 29 and 30, and shows how an idea creator/user and/or the or an idea/project of a user can enter into (and/or become part of) the platform/system, and that the project and/or user may be entered into (and/or become part of) a database(s) on/of the platform/system. Thus the user may be able to access extremely high quality providers, using the system, whilst also being ‘buckled into’ a system, configured to optimize their chances of making their project a success, (which may, or may not, also include trying to get ‘perfect’ (or the best possible) patent protection, if the project is/comprises an invention/is (potentially) patentable)

As stated, it is feasible that not only is the platform/system/method configured to take the user through a journey in a particular order and/or order of steps, but that, at any or all of the steps, the user and/or the project of the user may be made available to and/or put to provider(s), specialised in carrying out that step(s) of the journey. As stated previously, in various parts of the present application, this is preferably done via the platform comprising database(s) of the providers.

As has also been stated, the user may be ‘anchored’ at the or each step they're on, to make sure they cannot complete steps late in the journey, in the wrong order (ie too early) and/or generally to make sure the user completes the or any step(s) in the right order (preferably to optimize their chances of success and/or getting (the best possible) patent protection).

As stated many times, the platform/system is not limited to being used for inventions, or to the examples shown. To give a different example, a user may have an idea for a clothing brand. They may use the system to get in touch with and/or hire/use specialist providers to try to make that project happen/a success. For such a project, any of the following (types of) providers may be used/relevant, and/or may be provided as part of the platform: a clothing expert/designer(s) (this is an example of a PDP); a person(s)/provider who has experience in building a clothing range (eg former (or present) staff at clothes brand(s)); an investor (who may be able to invest money into the project and/or business and/or business concept, possibly with a view to owning part of the business/project. It will be obvious that such a project may even benefit from crowdfunding, or any other possible providers on the system/platform. Preferably the platform/system comprises all such provider(s) on the system/platform, preferably comprising a database(s) of the or any providers. The platform may even comprise retailer(s) that could retail such project(s). A retailer may be considered to be a PLF/PLP, because they play (or can play) a part in launch of the/a project/product(s).

For such an example as this clothing range example, if/since such a concept probably does not require any patenting, it may be that the platform/system makes it clear that the patenting steps do not need to be done. So in the example shown in FIG. 22 (and many of the drawings), it may make clear that steps 1, 2 and 4 are not needed (and may even black such steps out). It may also make clear what steps need to be carried out for that particular project. Alternatively, the/a platform/system may be provided not even including any patent provider(s)/service(s), etc, and may facilitate the project in moving forward, not including patenting. Thus, whether or not the platform/system comprises patent providers and/or patent service(s), it may facilitate projects that are not patentable.

(With respect to FIGS. 29 and 30, it is noted that there is no line coming from step 7 (Trailer Video) to any of the provider types. As stated, the or a Trailer Video may be made by a crowdfunding specialist (which is a type of PLF/PLP). But because the/a Trailer Video may be made (partially or wholly) by the user themselves (or with help from provider(s) on the platform/system who are not so specialized (ie not by a crowdfunding and/or videographer specialist)), no definitive line is drawn in those Figs, to explain/suggest or define which provider(s) may or may not (or can) play a part in that step).

As well as disclosing other possible information/features, FIGS. 27 (to 30) suggest/represent how the database and/or platform/system is preferably done in combination with and/or as part of set steps. They also show how the trailer video disclosure may play a part in a system/platform (preferably carried out at step 8, or possibly step 7).

In one embodiment(s) (which may have been previously mentioned), it is possible the system/platform is configured so that a project is only taken up/progressed, if a PDP (product development provider) takes the project up. So, for example, a user may enter the system/platform. The project/idea of the user may, in some way, be made viewable/accessible by the or any PDPs. In a preferred embodiment, this is done, for example, by creating a short disclosure of the project (which may include basic information and/or any other information). The disclosure may, or may not, for example, if the project is a product, include imagery or even footage/imagery of a prototype/proof of the product. But any information/disclosure may be provided. Preferably categorization is used to send the project/disclosure out to relevant PDPs (who are preferably stored on a database(s) of the platform). The PDPs may then be able to view the project/disclosure, and may be able to decide if they want to provide product development services for the project. It is feasible providers other than PDPs (eg PLFs/PLPs) may be able to view the project. Since the system/platform (as already stated) may allow for PDPs to make money/bonuses/extra money/percentages if the project becomes a commercial success, it will be obvious that PDPs (in such embodiments) may want to take up/work on projects where they think the project has a good or great chance of becoming a commercial success, because they might then make a lot of money from the project/product(s) being a success. Thus, by requiring, as part of the system that, in order to move ahead with the project, the user must have at least one PDP (or any provider) make an offer to take the project on (ie work on/for the project), it may act as a type of screening process/step, which weeds out bad ideas/projects, which perhaps no providers believe has a chance of making any profit. This could be beneficial in the sense that it may stop users moving forward and spending money on projects that have absolutely no chance of success (or seem extremely far-fetched).

It is possible (as may have been stated previously) that, if the platform/system is set up in this way, that this step (of providing a disclosure to the or any PDPs), so that they can decide whether to make an offer and/or whether to do work on the project, may be done right at the beginning of the journey/system, or may be done, for example, after other step(s)—eg after at least step 1 (patent search, in the example embodiment of FIG. 22 and others) is done.

If the platform comprises a database(s) of PDPs, then it may be easy to create a brief disclosure of the project (or have the user create a brief disclosure of the proposed project, eg via an online form and/or uploading service) and then send out that disclosure and/or make it available/accessible to (preferably relevant) PDPs. Preferably categorization of the project and/or the providers (preferably PDPs) is used. (The concept of categorization (which could be seen as a type of ‘matching’) has been disclosed earlier in the present application).

Thus this may weed out extremely poor projects/ideas, if no PDPs want to provide services for the project/idea.

It is possible a staff member(s) of the system/platform may create (or help create) the disclosure of the project. This may help make sure the disclosure is compact and/or professional. Alternatively, the platform/system may comprise a means for the user to ‘post’ their project, in such a way that the project goes out to relevant providers (preferably PDPs for this concept). This may involve an online form, for example, with the user, for example, able to sign in to their account, and ‘post’ their project. It will be obvious, if the project is at an early stage of development and/or the journey, the user may or may not have a prototype/proof (ie a ‘build’) of their project/product (although the system/platform is not limited to physical products). Thus the or any means for the user to ‘post’ their project may include ability to include video and/or imagery and/or disclosure of any build/version of their concept they have. If they have one (or more) they may be able to show that as part of their disclosure. They may have drawings, files, etc of their project. They may be able to post such drawings/files/images/imagery as part of the disclosure. Even if the disclosure is not created by the user (eg is done/helped by staff member(s) of the platform/system), such disclosure may be included (eg videos/pictures/imagery of prototype(s)/proof(s) of the project/concept, or any relevant files. It may be possible to upload these files as part of the disclosure/post. Obviously, it would be beneficial if the disclosure shows information about the project/product(s) that allows any PDP to quickly understand what the project/product(s) is, and thus any information that helps that may be included in such a disclosure.

The disclosure may be sent out/made accessible/viewable in any way. In a basic embodiment, an email may even be sent to (preferably relevant) PDPs, eg by the provider/owner/facilitator of the system (and/or a staff member of the platform/system), with either the disclosure included, or means for the receiver receiving the email to access the disclosure. In a preferred embodiment, the disclosure can be sent out to all relevant PDPs (or providers), in a (substantially) automated manner.

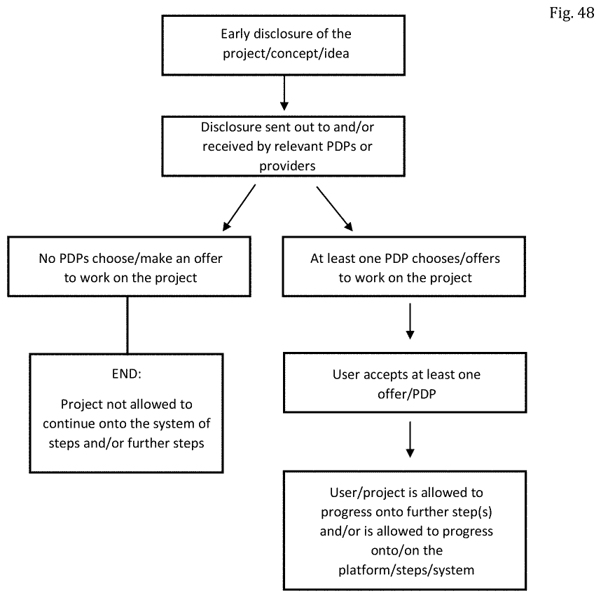

FIG. 48 shows an embodiment of this, and that the platform/system may comprise a/this ‘screening out’ system/feature(s)/step(s). The platform/system is not limited to having to include such a system/feature(s)/step(s), and may or may not comprise such a system/feature(s)/step(s) for screening out project(s).

It will be noticed that the term ‘launch’ has been used many times in the present application. To a casual layperson, the term ‘launch’ may tend to suggest that a product(s) must actually be put up for sale, for example. However, in the present application, the scope of the term ‘launch’ is much broader. The term ‘launch’ refers to any part of the process which, rather than focusing on product development (and/or patenting) focuses on or toward trying to get success with the project and/or trying to license, crowdfund, or release the product(s)/project and/or trying to attain the services of and/or help from and/or an agreement with, a PLF. Thus steps such as the ‘trailer video’ step, of making a video of a (preferably as close-to-sales ready as possible) prototype in action is considered a ‘launch’ step, because it is done to try to optimize the chances of the product(s)/project being successfully launched (eg licensed/crowdfunded, etc). Whilst other steps, ultimately, are also aimed at optimizing the possible success of the project, they are often product development (or patenting) steps, whereas a step such as trailer video (step 7 in the example of FIG. 22), or presenting the project/trailer video to potential PLFs (step 8 in the example of FIG. 22), such as but not limited to: potential licensees; crowdfunding specialist who can boost the chances of successfully crowdfunding the project; investors, who may want to invest and help bring the project/product(s) to market/fruition, is not a product development step, and is not a patenting step—it is really oriented toward getting success with the product and releasing it (or at least signing an agreement)—thus it is deemed a ‘launch’ step, whatever route/path is taken by the user to try to get success with the product(s)/project. Thus the term ‘launch’ is here used much more broadly than might otherwise, as standard, be typical.

When the term ‘launch’ is used with reference to licensing a project/product(s), the term ‘launch’ here is used broadly, and may include simply signing a licensing deal, and preferably includes actual launch of a product(s)/project. (ie starting to sell the product(s)/project at market/point of sale). The term ‘launch’ may even in fact be seen as broader and/or be more premature than this, because, for the sake of the present application, a user simply making a presentation to a potential PLF (such as a company they may license the product(s)/project to, or any other PLF) may be seen as a ‘launch’ of the product(s)/project, in the sense that it is the inventor ‘launching’ their attempt to try to get the product to market and/or get a licensing deal (and/or connect with a provider(s) who can help/facilitate them in successfully doing this). Thus it is a launch as such.

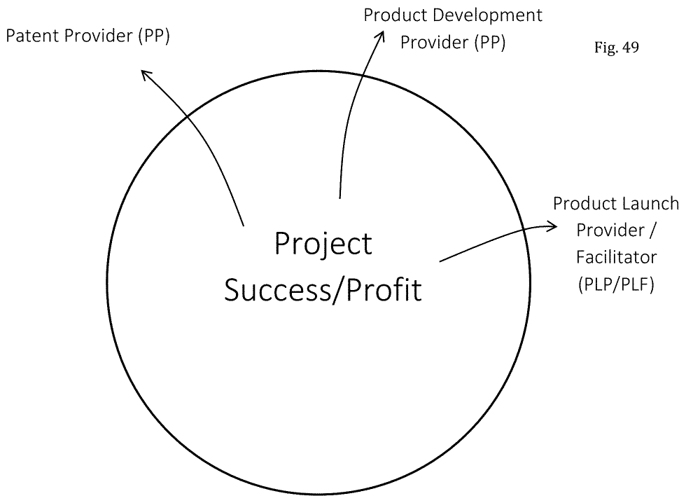

As may be clear from what has been disclosed, preferably the platform/system is what could be called a ‘success centric system’. What this means is that, preferably, the platform/system functions whereby provider(s) are attracted to providing work/services/help for a project, in part or wholly because they can or will profit if the product(s)/project becomes a financial success. This is represented in FIG. 49, where the term ‘project success/profit’ is shown. One of the arrows that angles out from that term ends in Patent Provider (PP); one ends in Product Development Provider (PDP); one ends in Product Development Provider/Facilitator (PLP/PLF). This represents that preferably any or all of these types of providers benefit financially if the product is or becomes financially successful. Whilst this may not be unusual (and in fact tends to be required) when entering into licensing deals for an invention/product(s)/project, or when receiving investment from an entrepreneur/investor (who will tend to receive a share of the business/project in return for their investment), it is, in fact, extremely unusual when working with/hiring a product development provider (eg product designer(s) and/or engineer(s) and/or team). It is also unusual when hiring video making and/or crowdfunding professionals/teams. And it is extremely unusual when it comes to patent providers.

Of course, two other parties that may or will benefit financially from the product(s)/project becoming a financial success are the user (of course), and also the provider/owner/facilitator of the platform/system (eg a company called SHIINE®).

It should also be stated that whilst FIG. 49 lists the providers in the singular, it is possible multiple (ie a plurality of) provider(s) (whether it be PPs, PDPs, or PLPs/PLFs) may be involved with an/or provide and/or benefit financially from the financial success of the or any project.

In the example case for FIG. 32 (given by way of example only), the PDP comprises (and/or may comprise) a professional product designer (who may carry out CAD/design, etc etc, and also comprises a product designer (PP), who also happens to be a patent practitioner/provider (PP). This person, (in the example) also acted as a ‘project leader’. It is feasible many or all of the PDP's and/or ‘teams’ may comprise a project leader(s). A project leader tends to make decisions as to the or a direction of a project. Such decisions are often made with (but may be made without) consultation with the user and/or other members of the or a team the project leader is leading and/or working within. The fact that one of these people is both a product designer (part of a PDP in this case, that comprises two people), and is also a patent provider (PP) shows that one person (or provider) may fulfil and carry out two roles. Thus a PDP (or member of a PDP) may also be a PP (or member of a PP). Thus a PDP (or member of a PDP) may also be a PLF (or member of a PLF). Thus a PP (or member of a PP) may also be a PLF (or member of a PLF), etc, etc, and so for all roles/fields/modules of provider.

This ‘team’ of two people, in the present example of the example of FIG. 32. who together could be said to be a PDP (although either one of them may feasibly be a PDP, individually), in the present example, just so happen to be a ‘team’ that is of, or formed from, the owner/provider/facilitator of the platform/system. In the example, the project leader is also the director of the owner/provider/facilitator of the platform/system. Thus the platform/system may have its own in-house ‘team’ (or teams). Of course, providers are not limited to being in-house teams(s) of the owner/provider/facilitator of the platform/system, as happens to be the case in the example of FIG. 32, which is shown/given by way of example only. The platform/system may comprise many providers (eg PPs, PDPs, PLFs), not limited in this way, and not limited to including a director, for example, of the platform/system. This example is simply given by way of example only, and in no way limits the scope of the term PDP, or what a PDP is. In the present example of FIG. 32, however, if the owner/provider/facilitator of the platform/system is, for example, a company called SHIINE®, the product(s) may be released as a SHIINE® product (ie by SHIINE®, or a company derived from SHIINE®). This is given by way of example only, but shows how, potentially, the or a project(s)/product(s) of a user(s) may be developed by and/or licensed to and/or released by the owner/provider/facilitator of the platform/system. This is taken by way of example only. The PDP (or any other provider) need not be, or include, the owner/provider/facilitator of the platform/system.

The embodiments described above are provided by way of example only, and various other modifications will be apparent to persons skilled in the art without departing from the scope of the invention as defined in the appended claims.

The appended claims define limited inventions. However, it should be recognized and understood that the disclosure of the present application includes a vast array of inventions, not limited to inventions set out in the appended claims and/or any statement(s) of invention.

For example, if the present disclosure of the present application (inclusive of drawing(s) and/or description) discloses features and/or steps a to z, it should be recognized and understood that any invention may be claimed, comprising any feature(s) and/or step(s) out of features a to z. Thus if the appended claim 1 defines the invention claimed as comprising essential features/steps a, b, and c, it should be understood that an invention may be claimed comprising solely feature/step a, or solely feature/step b, or solely feature/step c, or any combination of features/steps a, b, and c. Furthermore, it should be understood that an invention may be claimed comprising any of feature(s)/step(s) d to z, whether or not also comprising any of features/steps a, b, or c.

A final claim is appended which serves to signify that I reserve the right to claim any invention, comprising any feature/step, or combination of features/steps, disclosed in the present application (inclusive of drawing(s) and/or description). This statement (and/or final appended claim), if so desired, should be seen as a statement of invention, stating any invention, comprising any feature(s)/step(s) disclosed in the present application. It is intended (or plausible) that such invention(s) may be claimed in a future application(s) which claims benefit of priority of the present application. The present disclosure of the present application supports such invention(s)/claim(s).

Preferably the success rates of the or a provider(s) is monitored and/or calculated and/or provided/relayed to user(s).

There are severe problems, particularly in the ‘inventor help’ industry (although the present invention is not limited to only the field of invention). For example, there is one company, who position themselves, via marketing, as being a company that the/an inventor can go to and use, and the company will try to secure the inventor a licensing deal by the company promoting the invention to a company, with the hope/premise that the inventor may be able to get the invention licensed to the company.

However, the company in question was investigated by the Federal Trade Commission of The United States of America, and found guilty in U.S. courts of deceptive business practice. Initially, they were ordered to pay back $26 Million in redress to customers. However, despite what was agreed/put in place, the company was allowed to continue trading, and, at time of this writing, the company continues to charge inventors/customers a typical fee of $8000-$15,000 for their main invention service, which has a success rate of less than 1 in 1000 at generating profit for inventors/customers, more than they pay. There are other companies that also have extreme low success rates. Nevertheless, despite signing/completing any disclaimers, the inventor(s)/customer(s) often do not understand exactly how low the success rate of the/any company is. It is clear it would be desirable if success rates were monitored and/or provided to the user/inventor, so that they knew the quality of the provider they are using, and knew (to some or a great extent), what their likelihood would be of getting success and/or making a profit, if they use a given provider.

Thus, preferably, success rates of the or any provider(s) (eg of the platform) are monitored. Preferably, success rates of the or any provider(s) are relayed to user(s). (The term ‘relayed’ here is very broad, and includes within its scope any way of providing/getting the success rates to the user(s) and/or the user(s) getting access (in any way) to the success rate(s). Rather than the term ‘relayed’, the term ‘provided’ may be used. The two terms are considered equally as broad).

This feature (of success rates being monitored and/or calculated and/or provided) may be provided in any embodiment of a platform/system/method as previously disclosed in the present application. However, such a feature is not limited to being provided for a platform/method/system as previously disclosed, and may be claimed broadly. For example, there may be provided (and may be claimed) a method, comprising; having a platform comprising providers to take up project of users, wherein some or all of the providers provide in at least one of: patenting; product and/or project development; launch; monitoring success rates of some or all of the providers in terms of the success rate they have at projects they take up reaching a success threshold; making the success rate available to users. In another embodiment, there may be provided (and may be claimed) a method, comprising: compiling and/or having a database of users; compiling and/or having a database of providers; relaying a project of one of the users to one provider, or a plurality of the providers; allowing the provider, or the plurality of the providers, to make a bid or offer to take on the project; relaying the bid or offer to the user; allowing the user to accept the bid or offer; monitoring whether the project attains a success threshold; calculating a success rate of projects the provider takes up attaining the success threshold; relaying the success rate to users.

The term ‘taking up’ or ‘taking on’ a project is here a broad term. For example, if a PDP does product development work on a project (to develop the product), it is considered that they have ‘taken up’ the project. Typically, this may involve the PDP viewing a potential project, and ‘deciding’ to take the project up and/or make a bid or offer to take the project up. It may also involve, typically, a user ‘accepting’ the bid or offer, and ‘deciding’ to choose that provider.

Similarly, if a PLF who is a company that are interested in signing licensing deals decides to enter into a deal to have a project/product(s)/invention licenced to them (typically involving entering into a financial agreement and/or paying the user), then the licensee company (ie the company) is here said to have ‘taken up’ the project. Similarly, if an investor invests in a project, they are said to have ‘taken up’ the project. And similarly, if a PLF who is a crowdfunding specialist (eg skilled at videography and/or creating and/or managing crowdfunding campaigns) decides and/or is chosen to provide for and/or create and/or manage a crowdfunding campaign (partially or wholly) for a user, they are said to have ‘taken up’ that project. These are just given by way of example. Obviously for different providers/types of provider, there may be different criteria for what is meant by the term ‘taking up’ or ‘taking on’ a project.

In another embodiment, there may be provided (and may be claimed) a method, comprising: compiling and/or having a database of providers to take up projects of users; compiling and/or having a database of users; monitoring a success rate of a provider at projects they take up attaining a success threshold; relaying a project of a user to a provider (or providers); allowing the provider to make a bid or offer to take up the project; relaying to the user the provider's success rate at projects they take up attaining a success threshold; allowing the user to accept the bid or offer.

(This concept(s) will now be described with reference to various examples, taken by way of example only, and in no way limiting the concept. It will be noted that the term (and concept) of a ‘success denoting element/feature’ is often disclosed/mentioned. It will be obvious that this is just one way of relaying success rate and/or data to a user(s), in no way limiting a scope of the or an invention.).

It is feasible that not all providers must provide (and/or are monitored regarding) previous success rate information to the user and/or facilitator/owner/provided of the platform/system. In a preferred embodiment (which will be shown), the previous success rate information is provided to/relayed to the user in a way that is immediately noticeable with (ie at a time of) the bid or offer from the provider. (It should be noted that an ‘offer’ does not require that a fee is charged. It should also be noted that an ‘offer’ does not require that a bid is made—for example, a service may have a set fee (eg that all providers must charge for that service). Nevertheless, the provider may make an offer to take up the project, in which case, in such an example, no ‘bid’ need be made, as the price is a set-price that is pre-decided in such an example. Thus an ‘offer’ need not require that a bid is made, and may or may not comprise a bid).

Again referring to the relaying/providing of success rate information, for example, it (such data/information) may be provided at the top of the bid or offer, or, for example, ‘pinned’/provided immediately by the name (or with the bid or offer) of the provider, so that it is immediately visible to the user. There may be provided a success denoting element/feature (such as a virtual ‘badge’, for example). This is just one example of how to provide such data. A success denoting element is an element/feature that is, for example, not a paragraph, or long worded document that must be scrolled through—it is an element/feature that, in an immediate fashion, discloses success rate information and/or any other relevant information of the provider. In a preferred embodiment, the element is, or incorporates/includes/shows, a percentage success rate number. A percentage success rate number being the most immediately comprehendable method of disclosing success rates of a provider. (It will be obvious that all this data/information may be relayed/provided, without needing a success denoting element/feature and/or ‘virtual badge’, which is just one way of displaying such information).

It is obvious that, even for a person who has little or no business skills, if a previous percentage success rate at providing profit (or, more broadly, attaining a success threshold) for an inventor/user on any given project is displayed in this way (or any way), as a percentage, and in a way that it immediately noticeable, that it will be obvious (and can act, to some extent, as an indicator of) what likelihood of success the user has of generating a profit for their invention if they use the provider. Thus the previous percentage success rate of the provider at providing profit (or, more broadly, attaining a success threshold) to users on previous projects they've taken up (eg projects that a PDP has developed, for example, but not limited to PDP and product development) is, in a preferred embodiment, displayed to the user.

For example, in an aforementioned example, an invention promotion company who had approximately a 1 in 1000 (or worse) success rate (of generating profit/money for a user more than the user who used them had spent on their services) were shown to have generated a turnover of approximately $250 Million within a 5 year period. In a case of the present example, their success rating (if the success threshold was defined as the user generating profit/money more than what had been spent on their services) would be approximately 0.1%. Whilst it is unlikely such a company would choose to use such a system (or provide on such a system/platform—ie, which monitored success rates), if such a percentage success rate were clearly viewable to a user, in such a way that it was obvious and clear, it is likely that a huge amount of potential customers/users would be deterred from using such a provider. Thus it can be seen that providing/displaying/relaying success rates of providers to users can be extremely helpful to the user in helping them decided what providers to use, and what providers not to use. (It should also be noted in the example of the company that has an approximately 0.1% success rate, the company provides both product development services, and promotion services with a view to presenting the/an invention(s)/product(s)/project to potential licensee companies (ie companies the user may be able to license their invention(s)/product(s)/project to). Thus, such a company (who provides both product development services, and promotion services) would be deemed to be, for the sake of the present application, both a PDP, and a PLF/PLP, because they are providing both product development (and therefore are a PDP) and also are attempting to facilitate licensing (which is one embodiment/example of what is considered to be to do with product launch, for the present application), and are therefore also a PLF/PLP.

In one example/embodiment, the success rate is, or is incorporated onto, a virtual badge that is clearly visible and includes the previous percentage success rate of the provider, and feasibly (ie possibly) more details. Preferably the previous success rate of the provider is provided/relayed to the inventor/user in an immediate and explicit fashion, in a manner in which is it substantially (or wholly) impossible to avoid instant understanding.

In a preferred embodiment, the success rate is provided by way of/takes the form of what could be termed a ‘virtual badge’, and in a preferred embodiment, the success rate is denoted by way of a percentage number, which is thus simply one number. A percentage number is the easiest way for the user to instantly understand their potential and/or general likelihood of success if they hire/use the provider.

It will be obvious that, similar to a batting average of a batter, over years, and many customers, clients, etc, a previous success rate of a company/team, etc becomes a heavy indicator of a likelihood of success in using the said company for development. Similar to a batter that has a poor average, an Invention Development Company that has an extreme low success rate of less than 1% success at providing profit for inventors/users on project(s) they taken up more than the price the inventor/user paid for the service, cannot be expected to be particularly likely to provide profit for an inventor/user on a future project. It will be obvious that an Invention Development provider that has ten successes in 100 projects undertaken (10% success rate) will be more desirable for an inventor/user than a provider that, in the same amount of jobs (100) has only one success (1%). It could be said that there is approximately a ten times higher likelihood of generating a profit for the user (or attaining any given success threshold, whatever the success threshold may be) if they use the provider who has a 10% success rate (of attaining the/a given success threshold), as opposed to the provider that has a 1% success rate.

Thus it can be seen that a previous success rate is an important indicator of likelihood of future success and a potentially highly important attraction factor for an inventor/user (since the system/platform is not limited to use for invention(s)/inventor(s), as aforementioned) in determining and choosing who they should hire and/or use/work for their project. The term ‘hire’ does not necessarily mean ‘pay’, since it is feasible that a provider may offer and/or bid to develop the idea for free, especially in a case where the provider demands a (percentage of) future profit (or any amount) if the invention becomes profitable, which will be discussed.

The present invention may be incorporated into, or play a part in, a business model, so that, for example, a fee may be incurred payable to the owner/facilitator/provider of the system/platform/method when, for example, a provider is successfully hired (and/or paid), which fee may be paid by the provider, the user, or both. It is also feasible there may be fee (eg one off, eg monthly, eg annual) for using the system/platform, etc, or a membership fee and the like, payable to the facilitator/owner of the platform/system. Thus it can be seen the facilitator/owner/provider of the platform/system may profit from the system. It is also feasible the facilitator/owner/provider may receive a portion of profit if the invention goes to market and becomes profitable (or any fee/amount). This has been discussed to some extent.

In a preferred embodiment, both the provider and the user require an account in order to use the system, which may include a username and password, and may incur a fee, either large, or small, or of any size, in order to commence use of the system/platform for facilitating invention development services and the like. (This has already been mentioned).

It will be well known to those with skill in the art that confidentiality is extremely important in disclosing new product ideas, especially in disclosing to a multitude of people who are not previously known to a user. In order to provide a solution to this, it is feasible that all providers (or some, or a provider), in order to take part in the system for providing development services to a user, must sign an (all-encompassing) confidentiality agreement, and/or sign a secrecy act and the like, so that security and confidentiality of the ideas and products of the inventor is protected at all times. Such an agreement may (or may not) bar a provider from ‘inventing on top of’ an idea and/or may make clear that in such case, if the inventive step(s) the provider has come up with/invented is ‘claimed’ in a patent application and/or in a U.S. patent application, the provider (or the relevant person(s)) should be named as an inventor on the patent application(s), but that, as standard, the original inventor should remain as the applicant (and therefore as the owner of any patent(s) from the patent application(s), unless otherwise agreed, for example. This is a term (the term ‘inventing on top of’) used for adding innovative step(s) to an idea and obtaining and/or seeking a patent on top of the original idea. Thus an (preferably all-encompassing) agreement and/or confidentially agreement may be set up, which a provider must sign up to, that legally binds them to confidentiality, not inventing on top of, etc, so that an idea of the inventor is secure. Such an agreement may comprise an (eg all-encompassing) confidentiality agreement, secrecy act, both, or any other agreement for the purpose. This (or any) confidentiality agreement(s) may be embedded into the system/platform. This (or any) confidentiality agreement(s) may be provided by platform/system and/or by the facilitator/owner.

It is also feasible confidentiality agreement(s) may be sent out, either by email, or through/via the platform/system itself, which may include a file upload system/protocol and the like, so that documents, messages, and the like, can be sent through a website which the system uses, eg which the user and provider(s) can use to communicate with each other. Thus the user (or provider) may send each other a confidentiality agreement(s). This confidentiality agreement(s) may, or may not, be provided by the platform/system. This is well known to those with skill in the art and in a communicative workspace website (which the platform/system may provide), any files may be sent between user and provider(s). (eg by instant message). Preferably, though, the providers (some or all) are required to sign a (preferably confidentiality) agreement, in order to use the platform/system, which at least makes clear that they cannot publicly disclose any projects/concepts they see/view/receive via the platform/system. (There may be some exceptions clause(s), such as if the project(s)/concept(s) are already in the public domain, etc).

In a similar light, since it may be important and/or useful for an inventor/user to be patent-pending on an idea/invention/project before disclosing it (or for any other reason), a program or programs may be made available to users so that they can get patent-pending on their idea(s). This may include a program that specifically teaches them how to get patent-pending on their idea, so that they can achieve this themselves, which may lead them to disclose their idea with added security (or help at any other part/point of the platform/system/method and/or step(s), if the platform/system comprises a system of step(s). Such a program may be media based, and, for instance, comprise video(s) tutorial(s). Alternatively, (as an example), (or in combination), it may be downloadable. It may comprise video, and also comprise downloadable aspects and/or document(s). The program(s) may incur a cost from the user in order to purchase, or may be free. Preferably it comes as part of a membership package for using and/or having access to the system/platform.

The success rate concept provides two significant solutions to previously mentioned problems; firstly, because the previous success rate for the provider is preferably so explicitly disclosed to the inventor/user (who may be an inventor and/or designer, and/or entrepreneur, etc), in a preferred embodiment, there is no opportunity (or very little/less likelihood) for extreme low success rate providers to thrive—users will see their success rate and/or figures (which may be provided by way of a virtual badge that includes a previous percentage success rate at providing profit (or, more broadly, attaining a success threshold) for inventors/users/projects) and avoid use of the provider as it is explicitly obvious that they are extremely likely to fail to get success (which usually, but perhaps not always, entails making money/a profit) if they use an extreme low success rate provider.

Secondly, because the present system is preferably an online facilitatory service, providers can preferably sign up and provide services from a vast plurality of remote locations, and preferably with vastly different backgrounds and fields of expertise. With the present system/platform, for example, a team of engineers may sign up and form a team that have particularly acute skills in, for example, a very precise field, such as micro-motors, and inventions/products/projects thereof that feature micro-motors. This could be extremely beneficial where this expertise is required for a product. It is feasible that, in such a situation, teams and/or providers may be able to combine, and ‘team up’ to form teams that have particular skills and experience that is relevant to a posted project. This may require significant communication between user(s) and provider(s), provider(s) and other provider(s), etc. The platform/system and/or website may provide secure communicative tools such as instant messaging in a secure workroom, sharing of communication details, etc.

It is also feasible the present system/platform may be used as a platform to disclose an invention(s)/product(s)/project to a potential licensee (which tends to be a company, but is not limited to being a company, and may be an individual, for example), etc. (Various embodiments of how to do this have been discussed previously in the present application). For example, the product idea may be developed to such a point, and may require a large manufacturer and/or potential licensee with experience in a particular field. It will be obvious that if significantly high quality invention(s)/product(s) are being developed via the present platform/system, manufacturing companies and/or potential licensee, etc who may already have route to market, for example, may be interested in having such invention presented to them. This may incur fees, either from the user, the manufacturer, or both, or any other party, which fees may be payable to the facilitator.

According to a different aspect/embodiment (or also provided), there may be provided a search box/function or the like for a user so that, for example, the user can key in search terms relevant to their product/idea/project. Thus for example, if the user has a product for development that is, for example, a toy robot, they may be able to key in the term ‘toy robot’ and the like into a search box and pull up a list of relevant providers who may have expertise and/or experience in field(s) related to that area (eg PDPs and/or PPs, and/or PLFs/PLPs). In that way, a user can immediately find providers who have particular skills that are relevant to development of their product. Thus, providers may be monitored and categorised by the platform/system and/or the facilitator of the playtform/system, and optimising information such as any of: field of expertise, sub-field of expertise, and fields in which the provider is not an expert and therefore should not provide, may be received by the facilitator (or by the platform/system itself, eg on an automated level. For example, relevant information may be requested and/or received from the providers via the platform/system, so that they are categorized for the area or areas they have particular expertise in). This may be extremely useful for both the user, and for the provider, and thus for the facilitator, (who may gain financially if providers are hired/used and/or products/projects are successful—eg financially successful).

A user may be able to post their job/project via/on the system/platform (or it may be done for them, eg by staff of the system/platform) and may then receive bid(s) or offer(s) from provider(s) (if the provider(s) so choose). In such am embodiment/feature (or any other embodiment), categorisation may be used to ensure that relevant providers, who may have interest in the field of the posted project and/or have expertise in the said field, will receive notification of the posting and/or be targeted by the system when the project is posted. In this way, it is extremely likely that, on posting a project, a user may be required to fill out various boxes and questions (and/or this may be done for them, eg by member(s) of the platform/system), one of which may, for example, be a drop down menu asking what field the invention is in. There may be provided a sequence of sub-categories, similar to, for example, posting an item for sale on well-known auction websites, where it is essential a category (and often several sub-categories) are chosen for the field of the item for sale so that it can be sold in the right section and be more likely to attract a buyer. So similarly, it may be important for a correct field/category (and sub-category(s), etc) to be chosen by the user (or whoever posts and/or uploads the project to the system/platform, (if such a posting system is used) when posting the project, so that correct providers can be alerted, etc, and so that, if they (provider(s))search project postings in, for example, the consumer electronics section, they are likely to see and/or view the ‘toy robot’ project (if it has used the posting system). The term ‘posting’ and ‘post’ here does not refer to letters'—it refers to the ‘online’/computer meaning of posting.

Returning to the search box method of finding a provider, preferably the success rate of the provider(s) is provided where the provider's details are provided. This may help make success rates clear and transparent, and who is particularly apt for hiring/using. (The term ‘using’ and/or ‘hiring’ does not necessarily include payment). Thus, if fifteen providers are pulled up from the search term ‘toy robot’, preferably the success rate of the or each is provided. The success rate may be an extremely important attraction factor in a user deciding who to hire and/or use for a project. Success rates for patent providers (PPs) may be adjudged in a different way than PDPs and/or PLFs/PLPs. It is feasible success rates of one (or many) types of providers may be provided/relayed to user(s), ie not limited to just one type of provider. Thus success rates of any of: PDPs, PPs, PLFs, teams/combinations, etc, may, or may not, be provided). It should also be noted that even sub-sectors within types of provider may be assessed differently in terms of success rates/thresholds, and/or whether their success rates are monitored and/or relayed. Thus crowdfunding specialist PLFs, and investor PLFs, and potential licensee PLFs, for example, may be assessed differently in terms of success rates/thresholds, and may or may not have their success rates monitored and/or relayed. This goes for any and all providers, any and all of whom may, or may not, have their success rates monitored and/or relayed.

It is feasible the user may be able to directly contact a provider from the search results, (eg by messaging them, eg via the platform/system). However, this may cause problems for providers who may receive messages that they consider inappropriate. Thus providers may be given a choice as to whether they wish to be directly contactable, or not. It is also feasible that ability to directly contact providers in such a way may only be provided to certain users as a privilege. It is feasible that user(s) (and/or any other party/provider) contacting provider(s) directly in this way may not be allowed and/or possible.

Thus it can be seen that it may be possible for providers to be found via search function and/or direct searching. If so, it may be helpful if the providers have been categorised by the platform/system. Denoting the provider(s)' previous success rate at providing profit (or attaining a given success threshold) to users may still be extremely useful (and attractive) for the user. It is also feasible that the provider, if found in this way via search by the user, may be ‘favourited’ and/or ‘saved’ by the user so that, for example, when it comes time to post their project (or time that their project is about to/has been sent out and/or made available to providers (or at any time)), they can ensure, via an alert and/or message, the provider they have favourited is alerted of the project posting for viewing and/or can notify the provider(s) and/or the provider(s) can be notified in any way.

It may be possible for users to invite a provider(s) to bid or make an offer for their project.

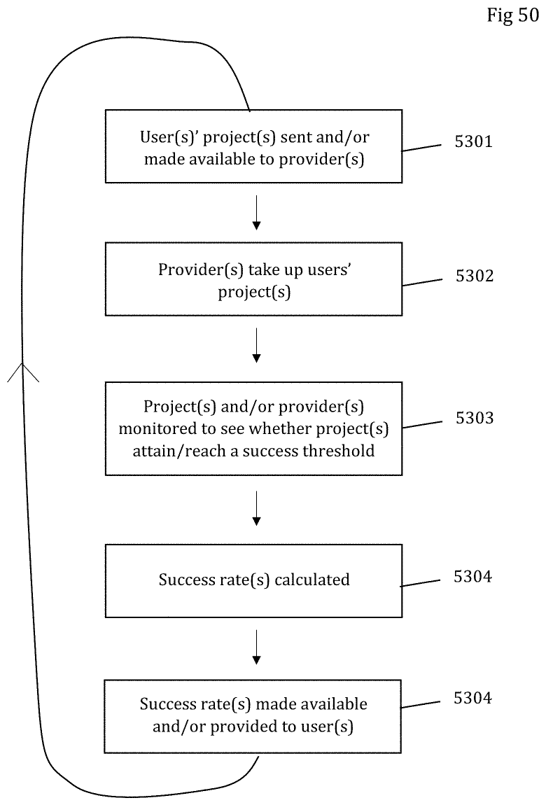

Referring to FIG. 50, there is shown a basic flowchart. Step 1 (5301) is the user's project (or users' projects) being sent and/or made available to provider(s). This may be done in any way. Various ways of doing this have been discussed. Step 2 (5302) is the or a provider(s) taking up a user's project (or users' projects). In step 3 (5303), the project(s) (and/or provider(s)) are monitored, to see whether the project(s) attain/reach a success rate threshold. In step 4 (5304), in light of whether the project(s) attain a success threshold, success rate of the provider(s) at attaining a success threshold is/are calculated. In step 5 (5304), the success rate data for provider(s) is made available and/or provided to user(s). Of course, this sequence of steps can play out (and may be claimed) with reference to just one provider and user. In a preferred embodiment, the platform/system/method comprises many providers and many users, and may feasible comprises hundreds or even thousands of users and/or providers.

The method/system can loop back on itself. Therefore (future) users are preferably able to see the updated success rates of providers. If there is a step wherein the user gets to choose whether to use the provider (which there preferably is), then it will be obvious that the method/system can provide valuable information to the user, which may affect their decision as to whether to use the provider (and/or which one to pick and/or use).

Preferably, it is inputted into the system/platform whether the provider/project (on any given project) has attained the success threshold. Preferably the system/platform comprises software whereby the system/platform/software then updates the success rate(s), without needing a human being to calculate the updated success rate(s).

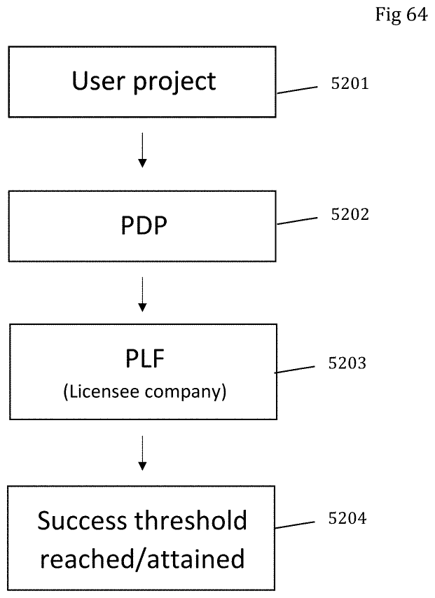

Referring to FIG. 64, there is shown a basic representational flowchart. In the example, the user both uses a PDP, and then successfully licenses their invention/product(s)/project to a company/party (who may, or may not, be part of the platform/system, as it will be obvious that users using the system/platform may be able to form successful relationship(s) (eg a licensing agreement and/or investment, or any other relationship relevant to ‘launching’ and/or with a PLF) whether the party they form the relationship be a provider on the platform/system, or not.

Box 5201 represents that the user has a project. Box 5202 represents that the user uses a Product Development Provider (PDP), who takes on the project. Box 5203 represents that the project, having been developed by the PDP, is then taken on by a company who the user licenses the product(s)/invention(s)/project to. (Preferably the PLF is a provider on the platform/system, but it is feasible they are not). Box 5204 then represents that a success threshold is reached/attained. In the example shown, both the success rate of the PLF (if the PLF is a provider on the platform/system) and of the PDP would go up, because they took up a project and it successfully reached/attained its success threshold.

What is deemed to be a/the ‘success threshold’ may differ, dependent on various things. In a preferred embodiment, the success threshold is attained when the user makes more money from the project than they have spent on the platform/system (preferably including all service(s) and/or provider(s). Thus, if the user has used a PP, a PDF, and a PLF/PLP, preferably, (in some embodiments), for example, the success threshold is defined as the user making more money from the project than they have spent, in total, on the PP, PDP, and PLF/PLP. Thus, if the user has spent $2700 on patenting, and $5200 on product development, and spent a total of $7900, then preferably the success threshold is defined by the user making more than $7900 from the project. In the example of FIG. 64, it is feasible the user may make this amount, even as an initial lump sum from the licensee company. Alternatively, the licensing agreement may for example, depend greatly on units of the product(s)/project sold, and/or profit, in which case, the success threshold being reached/attained may require a certain amount of units sold and/or ‘success’ of the product(s)/project. Thus sales of the product(s)/project may be required. This is just one example of a success threshold and how it may be reached/attained.

In a different embodiment/example, the success threshold may be defined as being equal to, or more than, the user has spent on any or all services. For example, it may be defined (given by way of example only), only with reference to how much money the user has spent on PDP(s), (rather than on the platform and/or on all provider(s) of the platform). (Or any other provider(s), rather than all provider(s) the user has used).

If the user launches via investment (ie an investor/entrepreneur investing in their project, eg for a percentage share of the project and/or business), then, again, the user may have to make an amount of sales, in order to make more money than they have spent on any one, or more, or all, provider(s) they have used. Thus, in a preferred embodiment, the success threshold is defined as the user making more money than they have spent on any or all provider(s) on the platform/system. However, this need not always be the case, therefore term ‘success threshold’ is not limited to this.

However, the or a ‘success threshold’ may be different for different providers. For example, if a PLF crowdfunding specialist takes on a project, to help the user crowdfund the project, for that provider, their ‘success threshold’ may be defined simply in terms of whether projects they take on are successfully crowdfunded. Thus if they've taken on fifteen projects, and six of them have been successfully crowdfunded, their success rate may be defined as 40%. This may be the case, irrespective of whether the user/project satisfied other factors, such as the user making more money than they spent using any or all provider(s) on the platform/system. (It is feasible, in such a situation, that the PLF crowdfunding specialist may even have two success rates—one that defines/displays/shows their crowdfunding success rate, and one that shows the success rate of the projects they worked on that were deemed to have passed another or alternative ‘success threshold’, such as the user making more money than they spent using any or all provider(s) on the platform/system. However, it is feasible that, for crowdfunding projects (ie projects that are crowdfunded), that simply being/getting crowdfunded is defined as the/a ‘success threshold’ for the project, in which case, the success rate of the PLF crowdfunding specialist provider successfully getting projects crowdfunded, and the ‘success threshold’ of the project, are one and the same, and would only require one figure/number.

Nevertheless, this gives an insight into how there may be different success rates rules and thresholds, for different providers. There may even be different success rate regulations/thresholds for different projects—for example, if a project is a charity project, it will be obvious that it may be that it is not done/intended to make money/profit. Thus there may be a different and/or even bespoke success thresholds, dependent on the project and/or provider. And, as aforestated, it is possible what is deemed a success threshold for a provider is different to what is deemed a success threshold for the/a provider. However, preferably, the success threshold of the project is what governs the success threshold with reference to the providers' success rate going up, or down.

With the charity example (or any other example), it is feasible a threshold of ‘units sold’ may be the success threshold for such a project. Or it may be that a special success threshold is made, personalised/bespoke to that project. Eg if the project was for creating water pumps in an African community, it may be deemed that the threshold is ‘once all people in the community have clean drinking water every day, within 20 minutes of where they live’. Or, for example, it the success threshold may be defined as being once four fully functioning water pumps have been built and are functioning for the community. These are just examples, but it will be clear that some projects may have different success thresholds. In many or most (or possibly all) projects, though, the success threshold may be a financial one.

The success threshold for a project may depend on the way the user is intending to launch the project. (The term ‘launch’ is here again used in the broad sense, as previously mentioned, and does not necessarily mean or require that the product(s)/project is actually launched for sale (although it may often include or lead to that)). For example, the/a success threshold for the/a project may be different, depending on whether the user is attempting to licensing/has licensed the product(s)/project, as opposed to, for example, launching the product(s)/project themselves (eg via crowdfunding, or any other way). The/a success threshold for the/a project may be different, depending on whether the user is attempting to invest/has received investment from an investor(s) as opposed to, for example, any other way/launch method. Thus the success threshold may be different, dependent on launch type/route.

There may be rules, with respect to what is the/a success threshold. For example, it will be obvious, if a user has spent around $6000 so far on the platform (and if the success threshold for their project is defined as being them making more money than they have spent on any or all provider(s) on the platform/system), then if a potential licensee company wanted to bump their success rate up, they could, potentially just decide (even if they are not financially/commercially interested in the project) to enter into a licensing deal with the user, and pay the user an initial lump sum of $6001 (or any mount more than $6000, so that the project reaches the success threshold). If this counted as a ‘success’, then it would/could bump up the licensee company's success rate. Obviously this is (or could be construed as) manipulation of the system/platform/success rate concept, and may not be in the interest of the system/platform. Therefore there may be rules in place to try to make this type of behaviour or action (or any other behaviour, and/or behaviour to try to manipulate success rates) impossible and/or not allowed. For example, there may be a rule that a licensee company must in fact ‘release’ the product(s)/project. This may be time sensitive—ie that the product(s)/project must be released (preferably commercially) within a certain time-limit. Furthermore, it may be that the success threshold (eg of the user making more money than they have spent on any or all provider(s) on the platform/system) can only be reached via actual sales of the product(s)/project (eg by the user having a percentage share of the profit generated from sale(s) of the product(s)/project). This is just one way in which such behaviour may be precluded and/or not allowed and/or not relevant to whether the project is deemed to have reached a success threshold.

It may be that it is not allowed for a company/PLF provider to enter into a licensing deal with a user, simply as a defensive act—ie to attain a/the patent(s) of the user as a ‘defensive patent’. A defensive patent, in terms of what is intended here, is a patent for an invention that the owner (or relevant party, such as licensee) does not intend to actually release as a product(s), but simply owns to protect against any competitors being able to release a product(s) that is within the scope of the defensive patent(s). This may, or may not, be allowed on the platform/system. It may be that the user is given a choice as to whether to allow any potential PLFs/providers/potential licensee to take on their project for reasons of this sort (such as as a defensive patent(s)).

It is feasible the success threshold, in various examples and/or for any or various provider(s) and/or project(s) and/or launch type(s) and/or route(s), rather than just being defined by the user making more money than they have spent on any or all provider(s) on the platform/system, may require that an additional amount if made by the user—eg the success threshold for any example/aspect may require user makes more than $2000, for example, or $5000, for example, more than they spent on any or all provider(s) on the platform/system.

The or any success threshold may be time sensitive—eg that an amount of money and/or profit must be made, within a certain/particular time-frame/limit. (eg $5000, within 3 years).

Patent Providers (PPs) may or may not be monitored for success rates, and, as previously disclosed, may be adjudged in a different way.

If a provider attains a very good success rate, it is possible this may give them leverage to raise their prices. It is possible it may give them leverage to raise and/or improve the profit amounts/share agreement(s) and/or financial arrangement(s) they make/get if the project is commercially successful and/or launched successfully. For example, a PDP who usually gets 20% of all profit generated from sales of the product(s)/project (eg for a limited time, such as 3 years) may, for example, decide and/or be able to change that to 22%, or 25%, for example, and/or may be able to extend the time they get the profit/amount for (if it is time sensitive), eg to 5 years from 3 years. If the provider has an extremely god success rate (eg compared to other, or many other, providers), users may still want to use the provider, even if they have to give away more profit/money and/or the agreement/arrangement is more beneficial to the provider.

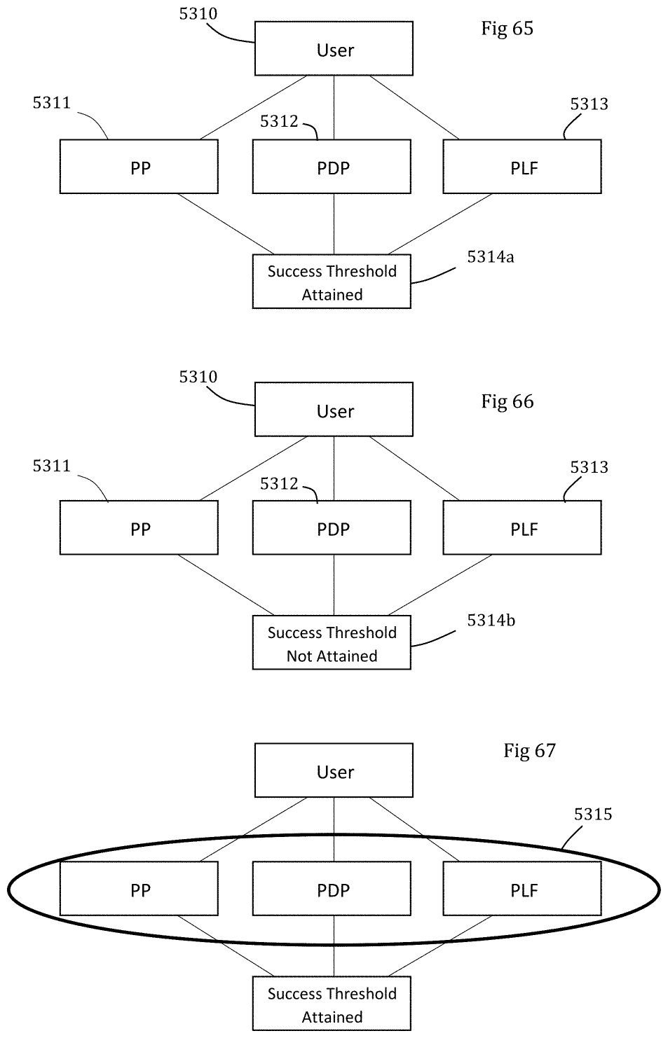

There is shown in FIG. 65 a representation. The representation shows a user 5310. The representation shows/denotes that the user has used, for their project, a Patent Provider (PP) 5311, a Product Development Provider (PDP) 5312, and a Product Launch Facilitator (PLF) 5313. (Note, as previously stated, a PLF (Product Launch Facilitator) may be referred to/termed a Product Launch Provider (PLP). Please also note that what is intended/within a scope of the term ‘launch’ is extremely broad, especially with references to taking up a project. This has also been discussed/mentioned previously). Please also note that wherever the term ‘PDP’ and/or ‘Product Development Provider’ is used/disclosed in the present application, so the term ‘Project Development Provider’ may be used/provided/claimed for any such embodiments and/or in its place.

The user may use any of: the PP; PDP; PLF. They may not use all of them, or may use all of them. (and may, in fact, use more providers). In the example, the user uses all of: a patent provider (PP), a product development provider (PDP), and a product launch facilitator/provider (PLF/PLP).

The representation also shows that, for the project, the success threshold for that project was attained 5314a.

In FIG. 66, there is shown the same example, wherein this time the success threshold was not attained 5314b.

In FIG. 67, there is shown the same example as FIG. 65, wherein it is shown/denoted/suggested that the providers (here the PP, PDP and PLF) may be a ‘team’ 5315. It is possible that there are teams on the platform/system that comprise multiple provider(s) and/or providers in different ‘modules’/roles (of the or any process). In the example of FIG. 67, all of the PP, PDP, and PLF may be a team (denoted by the black circle that surrounds the providers, suggesting/denoting that they are part of one team. However, any permutation for a team is possible. Thus the PDP and PLF may be a (or part of a) team, with PP not being part of the team, but instead being a separate provider. Any team/provider permutation is possible (and may be provided/claimed). Thus the PP and PLF may be a (or part of a) team, with the PDP not being part of the team. Of course, it is also possible that al the providers are separate, not being part of a team. (As has already bene mentioned, a team need not comprise providers in different modules/roles—for example, there may be a PDP that is a team of product developers (eg engineers, product designers, etc), which may not comprise separate PDPs from the platform, and may simply comprise individual(s) that always work together, as a team).

If the providers from different modules/roles (eg the PP, PDP and PLF in the example of FIG. 67) are all part of the same team, then they (or some of the providers) may be bound by the same success threshold for that project. However, this may not be the case, and it may be that a crowdfunding specialist PLF, if they are part of a team, may not be bound by the same success threshold, and may simply be bound by whether the project is successfully crowdfunded. (It should be noted that is the overall success threshold for the project, if crowdfunding is being attempted, is for the project to be successfully crowdfunded, then the success threshold, in that example, may well be the same for the crowdfunding specialist PLF, and for a PDP (and perhaps, or not, for any other provider(s) the user is using.

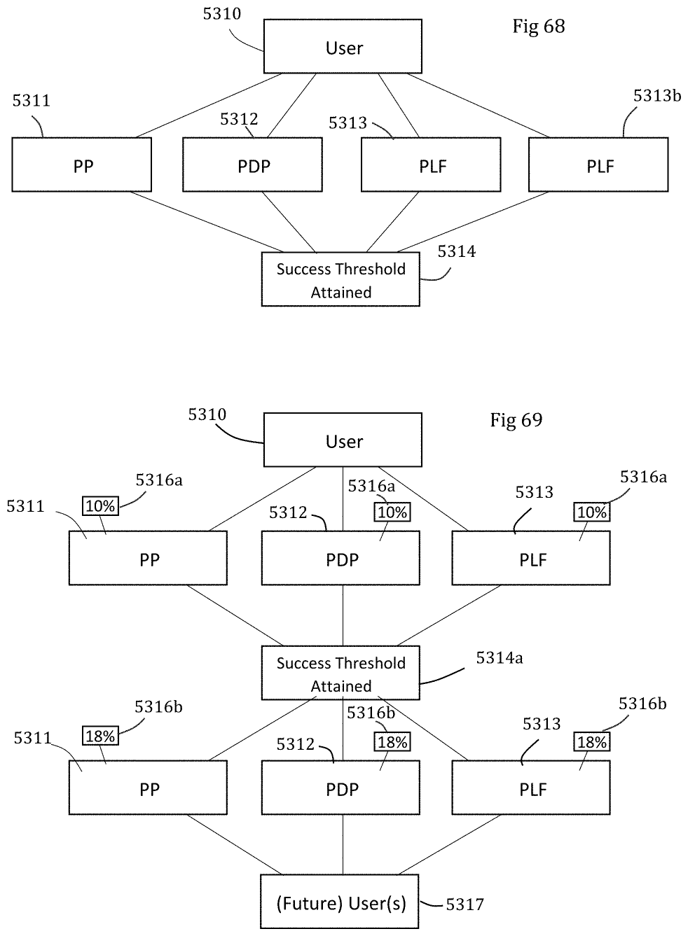

In the example of FIG. 68, the user has used four providers. Again, they have used a PP (5311), a PDP (5312) and a PLF (5313). But this time they have used a second PLF 5313b. In this example, perhaps the user was trying to license their project/product(s). They may have used a PP (to try to patent), and a PDP (to develop their product(s)/project). PLF 5313 may represent a PLF they successfully licensed their product(s)/project to. Therefore PLF 5313, in the example, would be a PLF licensee company. (This PLF may or may not be a provider on the platform/system. Preferably PLF 5313 is a provider on the platform/system. The second PLF 5313b may be a crowdfunding specialist PLF (and/or a videographer). This crowdfunding/videographer PLF 5313b may be used to make a more compelling video/presentation for the PLF 5313. For example, in the example of FIG. 22, for example, the user might usually go into the example step 8 with a Trailer Video which may, or may not, be of the highest quality. However, they may choose to use and/or hire a crowdfunding specialist PLF (eg PLF 5313b) to make an even better trailer video/video/presentation, so that they can present to the potential licensee PLFs with a better quality video/presentation. Thus they may end up using two PLFs. (It is feasible the same could be done with a PLF investor (or any other type of PLF), rather than a PLF potential licensee).

The crowdfunding/videographer PLF 5313b may feasibly also be used for a crowdfunding campaign. (Or only used for a crowdfunding campaign). Therefore it is feasible, in the example of FIG. 68, that the user tries to both crowdfund, and license their product(s)/invention/project. In the example, they used the crowdfunding/videographer PLF 5313b to aid in the presentation to PLF licensee 5313, and the user successfully got the licensing deal, and the success threshold was attained. This it is feasible both licensing and/or crowdfunding are attempted by the user for a project. It is also feasible that a PLF crowdfunding and/or videographer specialist is used, to aid presentation to another PLF (eg potential licensee, investor, retailer, direct-TV sales specialist/company/party and/or infomercial specialist/company/party). As stated (or now stated), it is feasible PLFs may, or may not, be part of/signed up on the platform. Thus work done by any providers may be used to present, for example, to a PLF that is not connected to/part of the platform/system. It is feasible presentation is done to either, or both: PLFs/PLPs that are part of the system/platform, and also to PLFs/PLPs that are not signed up/part of the platform/system. This goes for any embodiment of what is disclosed in the present application.

It is feasible that a user may simultaneously try to crowdfund, and also present to a PLF/PLP (such as potential licensee, investor, etc). This may, or may not, be done via use of PLF/PLP crowdfunding and/or videographer specialist to help crowdfund and present to a PLF/PLP (eg licensee, investor, etc).

The success rates of any (or all) provider(s) may be shown/displayed/relayed/provided to the user.

It is feasible that only success rates of PDPs are monitored and/or relayed to users. However, it is also feasible that success rates of other providers (or all providers) is monitored and/or relayed to users. (As stated, a provider may be both a PDP and PLF/PLP. This has been discussed).

There is shown a representation in FIG. 69 of an example similar or the same to FIG. 65, now showing how the success rate(s) of provider(s) may be affected. It also shows/denotes/represents how this can be useful to (future) users. In FIG. 69, for the sake of the present example, and to make things clear, it is imagined/shown that all the providers (PP 5311, PDP 5312, PLF 5313) have a 10% success rate, before taking on the project. For example, if it is imagined that each provider had previously taken on 10 projects, and they had each reached the success threshold on one of the ten projects they had taken on. This would mean they each have a 10% success rate, in the present example. (Notwithstanding things like the ‘green card’ concept, which will be discussed). Thus for each provider, there is shown an icon 5316, and it can be seen that, before the success threshold was attained (ie what is shown above the success threshold attained box 5314a), the providers all have a 10% success rate (denoted by icon 5316a).

In FIG. 69, it shows how, for this project, in the example, (which in the example, would be their eleventh project they had taken on), the project again attained the success threshold for that project (box 5314a). Therefore the providers, after the project has attained its success threshold, are shown how having icons 5316b, which shows that their success rate has now gone up to 18%. (Rounded to the nearest percentage point, two out of eleven successes is a success rate of 18%). It is then suggested/denoted that (future) users 5317 then have access to the provider(s) success rate data. This may, of course, be useful for (future) users in deciding whether to use the provider(s), especially if they have bids/offers from multiple providers, and need to choose which provider(s) to use.

(‘Future’ user(s) includes within its scope any user(s). The term ‘future’ is here used to suggest that the new/updated success rate may be particularly important and/or beneficial to user(s) who, in the future, use (and/or are interested in using) the provider(s), eg for a project. Displaying and/or relaying and/or providing the new/updated success rate(s) to a user(s) who is interested in using the/a provider(s) may or will be of particular use to them (and may affect their decision as to which provider(s) to use). This may be any user(s), including a/the user(s) who has already used the provider(s), or any other user(s).

Thus if a user(s), (after the success rate(s) of the provider(s) has been updated/changed) receives a bid/offer from the provider(s), (and/or finds the provider(s) via a search function(s)), the new updated success rate(s) of the provider(s) is preferably relayed and/or displayed and/or provided to/for the user. These are just two examples of when/where/how the or any (updated) success rate may be relayed to the/a user(s), given by way of example only. The or any success rate of the or any provider(s) may be relayed at any point, in any way.

Thus the term ‘future user(s)’ may be considered to suggest, here, user(s) who may use (and/or be interested in using) the provider(s), at a future point. However, it includes within its scope any user(s).

As has been stated, updated/new success rate(s) may be relayed to any user(s), at any point—eg any user(s) of the platform/system).

(As has been stated, PPs may, or may not, be adjudged in a different way. Their success rate of how many projects they take up attaining a success threshold may, or may not, be provided in such a way). PLF success rates may or may not be provided and/or monitored. Any provider (and/or type of provider) success rates may, or may not, be provided and/or monitored.

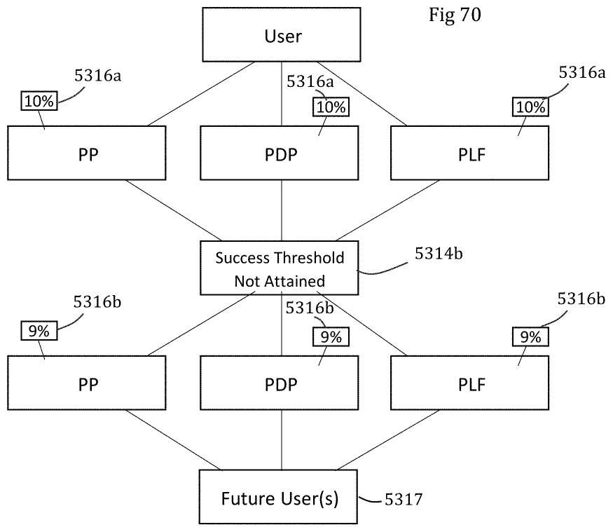

In FIG. 70, the same example as FIG. 69 is provided, but this time where the success threshold for the project is not attained. Therefore it is shown, again, how the providers have, in the example, a success rate of 10% before the project (via icons 5316a). But after the project and/or once it has been decided and/or determined that the success threshold has not been attained/reached, it is shown how the success rate of the providers has gone down to 9%. (Rounded to the nearest percentage point, one out of eleven successes is a success rate of 9%). Again, (future) user(s) 5317 can preferably get access to/see the updated success rate of the provider(s). (ie preferably such information is relayed and/or provided and/or displayed to the users of the system/platform).

In one example embodiment (disclosed by way of example only, and not limiting what is shown/disclosed/provided and not limiting what may be provided and/or claimed), there may be provided a method, comprising: allowing a user to use a provider; relaying to the user the provider's previous success rate at attaining a success threshold on previous projects the provider has taken up (before the user decides whether to use the provider); allowing the provider to take up a project of the user; monitoring whether the project attains a success threshold; updating the provider's new success rate, in light of whether the project attained the/a success threshold; relaying to a (future) user the provider's new success rate at attaining a success threshold on previous projects the provider has taken up. Relaying the new updated success rate to a (future) user may be helpful in the potential future user deciding whether or not to use the provider. (The term ‘future user(s)’ may be replaced with the term ‘user(s)’).

It may be that there are rules/criteria for deciding if a project has attained the success threshold. For example, it will be obvious that it's possible (especially if reaching the success threshold is dependent on sales being made of the product(s)/project), that it may take some time for the/a success threshold to be reached/attained. Thus, for such examples, it may be that there is a time window from when the project is started and/or finished, to when the success rate of the provider(s) will be updated, if the project has failed to reach/attain the success threshold. For example, twelve months may be given (or any other amount of time, for example). If this was not the case, then it may be unfair on the providers for projects which, for example, need some time to make sales, if, immediately after completing the project, for example, their success rate goes down, because the product(s)/project has not made enough sales and/or money for the user yet. Thus a decision as to whether the project has reached/attained its success threshold, and/or updating of the success rate of the provider(s), may be delayed.

Of course, in the case of the success threshold being reached/attained, preferably the success rate data for the provider(s) is updated as soon as possible once the success threshold has been reached.

For projects where reaching the success threshold depends on getting successfully crowdfunded (if the success threshold is defined for the/a crowdfunding project in such way, since there the success threshold may be otherwise defined), then, since it will be known, at the end of the crowdfunding campaign, whether the project has been successfully crowdfunded, then the success rate of the provider(s) may be updated at that point (or as soon after the crowdfunding attempt as possible). However, even for crowdfunding campaigns, it is feasible a different success threshold is defined. Eg a project may need to be successfully crowdfunded, and still further have to make more money for the user than any amount they've spent on the platform/system. (This is just one example). Thus, again, even if the project is successfully crowdfunded, there may be a delay in updating the success rate(s) of the provider(s), to give time for the project to generate enough money/profit/success to reach the success threshold. (eg 12 months, for example).

It is feasible a project could be deemed to have failed to reach/attain its success threshold, and that the success rate(s) of the provider(s) are updated to show the reduced success rate, and that, later than the updating is made, the project goes on to attain/reach its success threshold. For example, a user may be trying to crowdfund their project. It may fail. Six months may elapse. By this time, or before, the success rate(s) of the provider(s) may have been updated to show the reduction in their success rate. However, after 7 months, they may make a further attempt to crowdfund (eg using the same work done by a crowdfunding specialist PLF. If the project then gets crowdfunded successfully, and attains/reaches the project's success threshold, this may require the success rate(s) of relevant provider(s) be corrected. So, for the example success rates as shown in FIG. 69 and FIG. 70, if the provider(s) had a success rate of 10%, (after having got one success in ten projects), then, once the project failed to attain its success threshold, their success rate would have gone down to 9%. However, if that project later goes on to attain its success threshold, then that success rate (imagining that they had not taken on any projects since which had affected their success rate) may or would be amended to 18% (two out of eleven success rate). Thus a success rate may be updated to be reduced, and may later be corrected, to be raised.

Another example would be if a crowdfunding specialist PLF or a PDP had taken up a project, and the user was trying to license the project/product(s)/invention(s). It may be that it initially fails to get a licensee. (Preferably a PLF licensee on the platform/system, but could be a licensee outside of the platform/system). The success rates of the provider(s), (here a PDP and crowdfunding specialist PLF) may therefore be reduced. However, it may later attain a licensee (and attain its success threshold). In this case, the reduction in the success rate may be corrected, so that that project is marked as a success, rather than a failure, for the provider(s). (It may be that the provider has taken on more projects, in between when their success rate was reduced, and then corrected, in which case, preferably their success rate is updated with reference (ie also factoring in) those other projects. For example, if a provider has a success rate of 10%, (having attained a success threshold on one out of ten projects they took up), and their eleventh project is initially deemed not to have reached its success threshold, their success rate will have been updated/reduced to 9% (one out of eleven—here shown to the nearest percentage point, although it is feasible decimal points may be shown). If they then take on two more projects, and the projects both attain their success threshold, their success rate will now be 23% (3 out of 13, to the nearest percentage point). If the eleventh project then later goes on to attain its success threshold, then their success rate may then be updated/corrected, also factoring in the projects they've taken on and which have affected their success rate since. So their success rate may now be updated/corrected to 31% (four out of 13, to the nearest percentage point).

Of course, if the project they took on later attains its success threshold, but not as a result of the work/effort/what was done/provided by the provider (eg if the user decides to go with a new PDP, and the work of the new PDP (rather than the old previous PDP) leads to the project attaining its success threshold, then that will (or may) not count as a success for the previous provider. If their work, in part, contributed to the project attaining its success threshold (even if they were replaced by and/or the user used a different provider (eg/ie of the same module/provider role)), then a decision may have to be made whether that project should count as a success for the previous provider, or not. This decision may be taken, for example, by the platform/system and/or by staff of the platform/system, and/or by a specialist panel/person(s).

Success rate data may be shown in any way (not limited to a percentage), still being within the scope of ‘success rate’. For example, rather than (or in combination with) a success rate of 40% being shown/provided/relayed for a provider who has done 15 projects, 6 of which have attained their success threshold, instead, something such as ‘6 out of 15’ may be displayed/shown/relayed/provided, or ‘6 out of 15’ successes, for example. (Or ‘this provider gets success on 4 out of every 10 projects they take on’). Preferably a percentage is shown, since this is an elegant way to display/provide/relay the information/data.

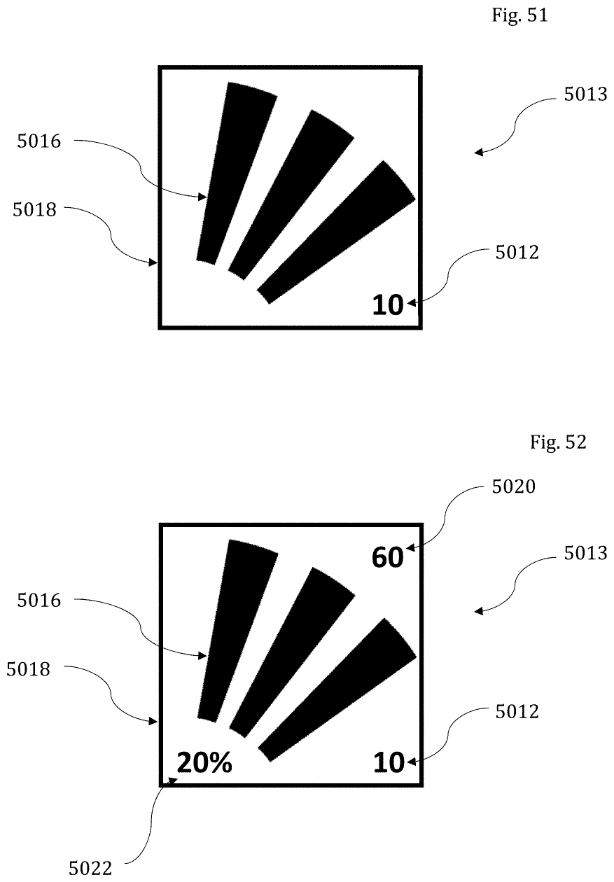

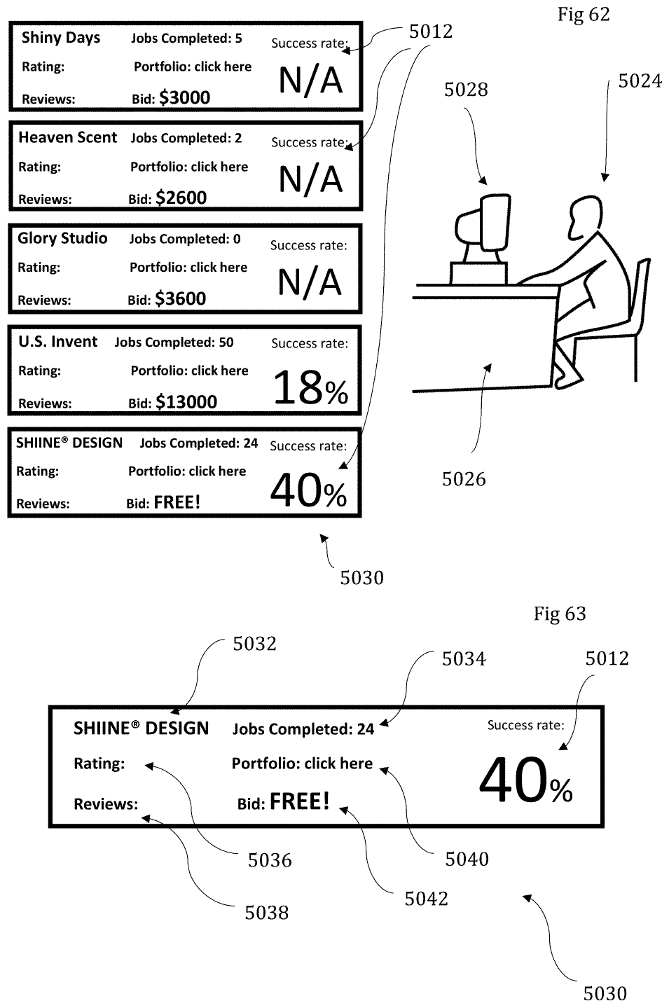

Referring to the drawings, there is shown an example of how a success rate 5012 may be shown. In FIG. 51 an embodiment of how a success rate 5012 is shown is shown, which, in the example as shown, is, or is incorporated onto and/or shown by way of, a virtual badge 5013. The badge is simple, but extremely effective as disclosing a previous success rate and/or figure of a provider. (A badge, such as this, is just one example of how to show a success rate, and it will be obvious a success rate may be shown in any way—for example, in FIG. 62 and FIG. 63, the success rate is simply clearly shown, without need for a ‘virtual badge’, or the like). The example ‘virtual badge’ may be substantially ‘pinned’ to and/or provided with the profile (and/or information/details) of the provider (which may, for example be a team who develop product ideas—ie a PDP, in the example, or any provider). As an example, it may be provided on, for example, a portfolio page, next to the details and/or name of the provider when they bid for a project, etc.

In the embodiment of FIG. 52, a previous percentage rate 5012 of the provider at projects they take up attaining/reaching a success threshold (eg providing profit for the user more than an amount paid to the provider by the user for development of a product/idea and/or paid by the user for any or all services provided by provider(s) on the platform/system). As stated, the example of FIG. 51 shows a virtual badge used to display information (including, in the example, the success rate 5012). However, the information shown (such as success rate, and any other information) may be shown, without a/the virtual badge 5013.

In the example embodiment, the percentage success rate 5012 is shown as the number ‘10’. Thus, in the example, the provider has a success rate of 10% at their projects attaining a success threshold). For example, if they have worked on sixty projects, six have generated a profit for the user of their service. (If the system is marketed correctly, there may be no need (as shown) for a [%] icon to appear, provided it has been correctly communicated to users what the, in this case, ‘10’ figure means). However, it may well be that a ‘%’ icon is shown, in which case, for the example shown, the success rate may be shown as ‘10%’, rather than just ‘10’).

There is provided in the embodiment a logo/symbol 5016. It is well-known that symbols/logo's can become extremely noticeable to users. In the example, this is the logo/symbol of the facilitator/owner/provider of the platform/system. The logo/symbol 5016 may attract attention to the badge 5013 and/or success rate 5012 and/or other information. This may be useful. The logo/icon need not be the logo of the facilitator/owner/provider, and could, in the example, be any logo/icon. A logo/icon may, or may not, be provided.

The badge 5013, in the example, has an outer stroke 5018. This may better define the badge and therefore help explicit disclosure.

The badge 5013 need not be limited to only disclosing a (preferably percentage) success rate 5012 and in fact, may not use a percentage success rate 5012 for denoting success of the provider, although percentage success rate is a preferred embodiment for disclosure of success of a provider.

There is shown in FIG. 52 an example of the badge 5013 where it further discloses a number of jobs/projects 5020 the provider has carried out, which in this case is sixty jobs. It is also feasible that providers, especially a provider who has a high success rate at providing profit for a user (or attaining any given success threshold on projects they take up), may charge a typical ‘percentage of success’ charge 5022, which may also be termed a profit fee, so that, in a case of the shown example, if the provider develops a product for the user (which may include taking the product to market, therefore being both a PDP and PLF/PLP), 20% of profit generated from the product is received by the provider. (Various embodiments of how this may be set out/achieved and/or arranged/agreed have been previously discussed/disclosed in the present application).

Thus, in the present example, extremely interesting and relevant information is or can be displayed/relayed to the user, which information, in the example of FIG. 52, denotes that: the provider has worked on/taken up 60 projects; the provider has a 10% success rate at providing profit for Inventors/users and/or of those projects attaining a success threshold, and should the product(s)/project of the user get to market and generate a profit via use of the provider, the provider must receive (and/or receives) 20% of the profit. Thus it can be seen that business transactions and/or financial arrangements can be suggested and relevant such business and transactional information disclosed. In the example, this is done via the/a badge 5013. However, such information, of course, can be displayed/relayed/provided, without a virtual badge, which is shown by way of example only. Further negotiation(s) may be required for such business dealings, which may be facilitated via the platform/system and/or by staff and/or provider(s) of/on the platform/system. (For example, significant communications tool(s)/function(s) may be provided for both parties (ie user and/or any provider(s) and/or any staff and/or provider(s) of/on the platform/system and/or any specialists to help facilitate such agreement(s)/arrangement(s), for example) and either within the system/platform, or outside of it. This is just one example of tool(s) to help facilitate business and/or financial dealings/arrangements. However, such tool(s) may or may not be required). Communication of any type may be provided/used, whether within the platform/system, or outside of it.

The badge 5013 and/or success rate 5012, etc may be coloured and/or colour-coded. Similarly the or any information/data provided (eg 5012, 5020, 5022) may be differently coloured and/or colour-coded.

It is feasible still more (and any amount of) information/data is disclosed (eg via the badge, or not). The/a badge is just example of how to disclose success rate data/information. For example, the exact number of projects where the provider has generated/got success (attained a success threshold for the project) may be displayed (which, in this example, would be ‘6’). Further information such as ratings by users and/or average review score may be displayed. If a badge is provided, such information may be displayed separately from the badge, or on/within the badge, which will be obvious.

The badge 5013 (or any information/data/what is provided) may be clickable, so that it can be clicked on by a user in order to find out more information. For example, it is feasible the badge and/or information may be clicked on to get more information about successful projects the provider has worked on. (Alternatively, there may simply be calls to action (eg button(s) that can be clicked by user(s), to get more information—eg a button(s) that says ‘FIND OUT MORE’, or, for example, there may be an ‘i’ symbol, (denoting/short for ‘information), which can be clicked and/or selected and/or hovered over by a user's cursor, to get more information. (Any method to deliver more information may be provided, including and not limited to, these examples. ‘The ‘hovering’ method is not limited to an icon/‘i’ symbol being provided).

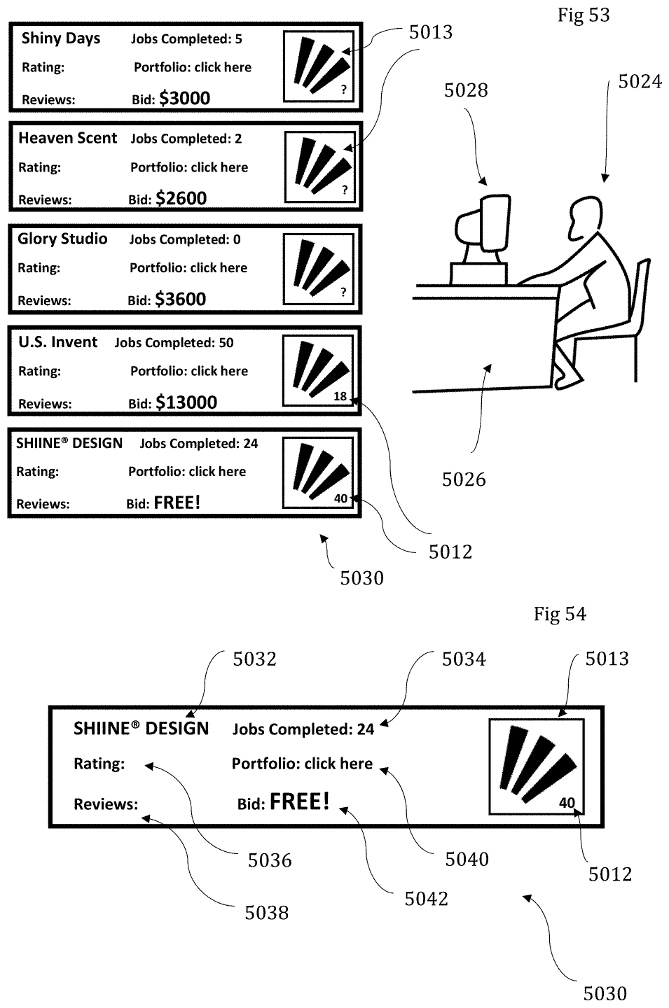

There is shown in FIG. 53 an example of an aspect of a possible user experience, with reference to what is disclosed, in action. A project of a user has been sent out and/or made available to provider(s). This may have been done, for example, by the user posting the project themselves, onto the platform/system. Alternatively (and/or in combination), the project may have been posted by the platform/system and/or staff member(s) of the platform/system. Thus, in the example, the/a project has been posted (although posting is just one example of how a project(s) may be made available to and/or viewable by provider(s). There is shown an example/the user 5024, who may have posted the project, using the system/platform. The user may, for example, have a product concept for a robot toy. The user may, for example, have already gone through some step(s) of the platform/system. (eg they may have had a patent search and/or got patent pending, and/or gone through any of the step(s), for example, as set out in the example of FIG. 22. It is feasible they may be required to have gone through some step(s), before being allowed to get access to this step of provider(s) potentially being found/used and/or hired. (This has been discussed/disclosed). It is also feasible (as has been discussed/disclosed) that the user/project may have to go through this step (or a step), and/or find/attain a provider(s) (eg a PDP), before being allowed onto any step(s) of the rest of the platform/system/method. This may be used as a ‘screening’ step, to make sure at least one provider (eg/preferably PDP) is willing to take up the project. This could act as a screening step, because if the project/idea is a very bad project/idea, which clearly is never going to make any money and/or be a success and/or attain its success threshold, then provider(s) may be unwilling to make a bid or offer and/or take up the project. If no provider is willing to take up the project, the project/user may not be allowed to go through any further (or any) step(s) for that project and/or advanced any further on the platform/system/method, for that project.

The project having been posted, in this case via a website (the platform/system preferably being carried out via a website) provided by the facilitator, in the example, the user 5024, in the example, may have left the house for the day, for example, and is now pictured, having returned, and is pictured sitting at the/a desk 5026, and may have, for example, logged into their account for the platform/system in order to view any bids/offers. As can be seen, there are five offers 30 in the example (which, in FIG. 53) are represented to a side of the user 5024 although they are preferably viewable on the screen of the computer 5028, and preferably from within the user's (preferably password protected) account). It can be seen that each of the offers 5030 reveals/shows a provider, who is named, in the example. Details of the bid/offer are shown, in the example. Success rate 5012 (and/or information relevant to the success rate) of the provider(s) is shown in the example. In the example, the success rate is incorporated onto and/or shown by way of a virtual badge 5013, but it may be shown/provided in any way.

The top three offers do not have a percentage success rate (but show a ‘?’ mark where the others show a success rate. Providers who have not yet attained a success threshold on any given project (e.g. providing profit for a inventor/user, for example) may or may not have a success rate and/or indicator and/or information/data provided. In such a case, their success rate (as shown) may simply be/show a question mark and the like. This can be seen on all of the top three providers. It is feasible it may be made obvious to the user that the provider is new, for example. Thus even if no success rate and the like is provided, it can be seen that success rate information/data may still be provided, the information/data, for example, showing that the provider does not presently have a success rate.

In the case of the first provider (named ‘Shiny Days’), it can been seen/information is provided that they have completed 5 jobs. (It may be shown how many projects they have taken up, and/or completed). In the example, they have not achieved any successes yet. It may be that none of the projects have reached their success threshold deadline yet, in which case, this may be one reason why a ‘?’ mark is shown for their success rate. Or it may be that one or more of the projects have, officially, not attained their success rate yet, but that the platform/system, so as to avoid displaying a ‘0’ or ‘0%’ success rate, may give the provider an amount of projects before the success rate must be displayed/shown/relayed, if no successes have been attained. So, for example, if a provider continues to fail to attain any successes for projects they work on, it may be that a success rate percentage will only be shown after, for example, ten projects (or any amount of projects, ten here given by way of example only). Until that point, something like N/A, or ‘?’ may be shown. Of course, if the provider takes on a project and the project attains a success threshold, preferably their (preferably percentage) success rate is shown immediately. That may be helpful to that provider in being more attractive to users.

There is shown one of the bids in close up in FIG. 54. In the example embodiment (preferably the provider is allowed to send the user a message(s), which may include why they think they are well placed to take up the project and/or what skills/experience/background that suits them to the project, and/or what they envision the work to entail and/or any vision they have for the project and/or its development), there is provided a bid or offer 5042, a name of the provider 5032 (which, in the example, is a team called SHIINE® DESIGN, and in the example, is what could be called an ‘in-house’ team of the facilitator/owner/provider of the platform, and includes the Director of the company that own/provide the platform/system, in the example (who is also the drafter/filer and inventor/applicant of the present patent application). ‘Jobs/projects completed’ is shown 5034. This shows/reveals to the/a user how many jobs/projects the provider has completed for inventors/users and the like. In the example, it is shown that the team/provider has completed 24 projects/jobs. (Note: the term ‘projects’ may be used in the example, in place of ‘jobs’). A rating 5036 may be shown, which is suggested in the Figures, but is not filled out here. It may, for example, show a marks out of 5 rating of users who have used the provider, or any other rating that previous users have rated the provider as. A reviews part/portion 5038 may be provided. This may, for example, provide a direct link to review(s) of the provider. A portfolio part/portion 5040 is/may be provided, which may provide a link to the provider's portfolio. This may be of use to the user in deciding if they would like to hire and/or use the provider. (The or any portfolio page/venue may be provided integrally as part of the website and/or platform/system, a portfolio for provider(s) being set up on and/or being part of the website and/or platform/system—the or a website the or any portfolio is provided on may, or may not, be the same website the platform/system is provided on (of the platform/system is provided by way of a website. However, the platform/system may comprise many websites. The portfolio(s) may be on the same, or a different website, for example). A bid or offer amount 5042 is shown/provided. In the example, the provider has bid or offered to take up the project free. However, as seen in other bids/offers in FIG. 53, provider(s) may be able to bid/make an offer that requires the user to pay to use the provider. It is feasible significant amounts may be charged by providers using this system. In such a case, it is feasible a portion (which may for example be a percentage, eg 7.5% of the amount charged by the provider and/or paid by the user, for example, or any other amount, whether it be a percentage, or not) of the bid amount, if accepted by the user, may be paid to the facilitator/owner/provider of the platform, which is one possible avenue of revenue that may be sought by the facilitator of the (facilitatory) service/platform/system. These types of payments may be automatedly taken by the platform/system when payment is made by the user to the provider. Thus the platform may comprise software which automatically takes an amount and/or percentage of payments made using the system/platform. Nevertheless, the platform may allow users to make payment via various ways, such as, but not limited to, credit card, bank transfer, PayPal, etc, or any other way. However, there are many ways that a charge may be charged by the facilitator/owner/provider of the platform/system, which will be obvious. Thus there are many business methods that may be utilized by the facilitator/owner/provider of the platform/system.

Thus, as shown, it is not unfeasible that a bid may be made, even by a high success rate provider (eg the provider of FIG. 54), to develop an idea and/or take up a project for free. For example, if a high success rate provider, which is known to be highly skilled at bringing products to market, and charges a 40% profit fee for a successful product they have developed/taken up, views a posting of (and/or gets wind of and/or receives a disclosure of, in any way) a product/project they think will be extremely profitable, they may be highly motivated to win/take up the project (eg as opposed to any other provider's bid/offer). If they believe, for example, that they could make several hundred thousand dollars, or more, from the project (eg by virtue of their percentage or amount they will make if the project/product(s) is financially successful), they may decide to bid free for the project (as shown in FIG. 54) It is even feasible that a provider(s) may bid in such a way that they in fact offer to pay the user in order to win development of and/or take on the project (this may be claimed). It is feasible that such bids may be regulated by the facilitator. Even if a free bid, for example, is made, which wins the project, it is feasible a fee may/must still be paid to/charged by the provider to the facilitator/owner/provider of the platform/system (eg if/once the project is taken up by the provider and/or an/the offer or bid is accepted by the user). It is also feasible that a system is set up so that, if a product is successful using the platform/system, that payment(s) are made to the facilitator. (This has already been disclosed/discussed) Thus it is feasible that all of: the user, the provider(s) and the facilitator gain financially from a successfully developed and/or launched product (eg if a product(s)/project makes money/a profit). This may be extremely beneficial since all parties would be motivated to generate a profit and/or get success for the inventor/user/project.

If the provider attains success for the inventor/user/project, their, (preferably percentage) success rate, rating goes up. This leads to significant benefits and enhancements for the provider—a higher rating means they are/may be more attractive to inventors/users. Users are then more likely to accept bids/offer from that provider and/or are then more likely to use that provider. The provider, with a higher rating, may, for example be able to bid a higher bid amount on projects. (However, as stated, provider(s) (eg PDPs) that are very successful may actually lower their bids (or charge no money at all), and try to make a lot of money off of success of the project/product(s), rather than from the user. The provider (if they have/get higher success rates) may be able to charge a higher profit percentage fee (or any amount/financial arrangement, not limited to a percentage of profit) from a profitably developed project/product(s) that generates profit. Thus there are significant benefits for the provider if they provide success to the inventor/user. This could be considered a ‘goal match’, because the more success the provider gets at projects attaining a success threshold, the more they may gain. This is also good for users, because the provider(s) having high success rates ultimately is good from their point of view of the project being successful (eg financially successful) and/or attaining a success threshold. This may also benefit the facilitator/owner/provider of the platform/system, especially if they also benefit financially from projects that are a success and/or commercial success.

On a reverse side, if a project the provider takes up fails to attain/reach its success threshold, (eg to provide profit (success) for the inventor/user), their success rate goes down. This can make them less attractive to users, who are now less likely to accept bids from the provider and/or use the provider. The provider may not be able to charge such high bid amounts since/if their rating is lower. They may not be able to charge such high profit percentage fees (or amounts), which may affect their income, if they develop a product(s)/project they take up become financially successful.

This system (of success rates) may be particularly useful with reference to PDPs. However, as stated, it may be used/provided for any or all types of provider(s). As has also been stated, a team/provider may be both a PDP, and a PLF/PLP (or a combination/permutation of any type(s) of providers).

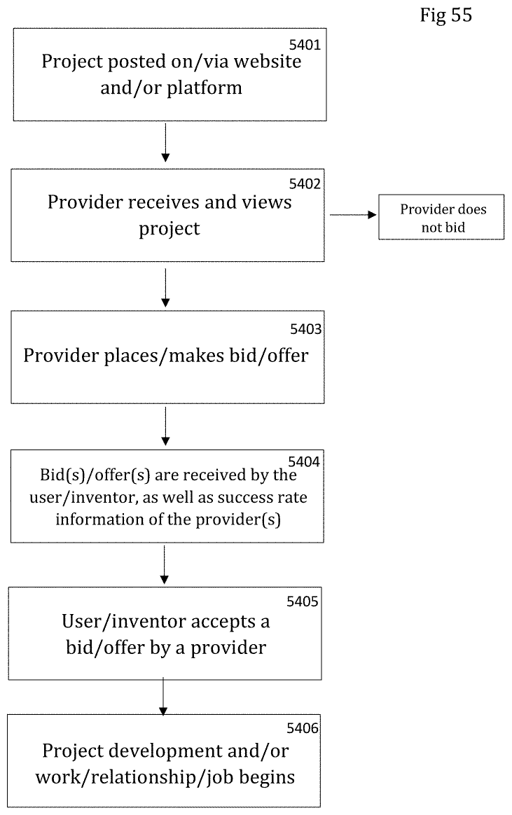

There is shown in FIG. 55 a flowchart of a basic structure and/or embodiment of the success rate concept is shown. In the flowchart, a preferred embodiment is shown wherein the user is an inventor, who may have a potentially patentable invention to develop and/or patent and/or launch. However, the platform/system (and/or success rate concept) may feasibly be used for products where a patent is not sought, not limited to inventions/inventors. It is also feasible the platform/system (and/or success rate concept) could be used for entrepreneurial pursuits and other projects. This has been discussed.

In the flowchart of FIG. 55, in step 1 (5401), a project is posted (eg via/on a website of the platform). The project may or may not be ‘posted’ which is just one way of syphoning information and/or a disclosure. The project may be posted by the user/inventor, or by/with the help of any other person(s)/party. (This has been discussed). The user is attempting to find a provider(s) to take up the project. Whilst what is shown in FIG. 55 is particularly pertinent with regard to the process of finding a PDP, it may be used to find any type of provider (eg PP(s) and/or PLFs/PLP(s)). The project may be, for example, an idea for a robot toy product, which the inventor/user wants to bring to market (and may also be seeking a patent on). Preferably there is provided and incorporated into the system means/method for the idea of the inventor to remain confidential when it is disclosed. This may include confidentiality agreements and the like, or may feasibly include, for example, all-encompassing agreements and/or secrecy acts that (all, or any) providers must sign up to in order to be allowed to receive projects (eg project posting(s) and/or disclosure) from users, and thus use the example method/system. Such agreements and the like may protect disclosures from a user in a plurality of ways, not limited to the present basic example, so that an idea cannot, for example, be stolen by a provider, and/or developed/patented by a provider without agreement and/or consent from the user. Any such provisions and/or agreements may be provided. (This has been discussed). It is feasible users may be required and/or asked to sign secrecy agreements, confidentiality agreements and the like also.

One way a potentially patentable idea of a user may be protected is by attaining patent-pending status, which may be a beneficial status for a user to attain before disclosing an idea/project. It is well known that Inventors tend to like to be patent-pending before disclosing their idea. Thus it is feasible that a program or programs is offered to the user to facilitate them in getting patent-pending. (This has been discussed). A program to facilitate the user in getting patent-pending on their idea may include media, video and the like, teaching them how to write a provisional application for patent (or similar such applications by alternate names, or any patent application), and may include example(s) of provisional patent application(s) (or any patent application) for learning purposes. Such a program may also include a template for how to write a provisional application for patent. The template may be universal, thus usable by any user for any idea. Such a program may or may not incur a fee by the user for purchasing. In an example, such a program(s) may be provided as part of the platform/system, if/when the user become a ‘crew member’. This may typically involve the user paying a fee (eg a monthly fee) to have access to the platform/system.(This has been discussed).

Thus it can be seen that significant provisions and measures can be taken to ensure (or substantially ensure) safety and protection on an idea for the user so that they can disclose their idea freely and without significant concern, said provisions and measures not limited to the given examples, which may be any provisions and measures.

It should also be noted that the user may not need (or want) to get patent pending before disclosing the project. The platform/system may be set up to be private. All PDPs, for example (and/or any other providers), may be signed up to confidentiality.

Preferably both the user and provider have accounts with the facilitator so that they can securely log on, for example, with a password. Preferably in step 1 the project (which may require development and may thus require a PDP) is posted, preferably via a website and/or web form/interface, but it could feasibly be posted via an App and the like, or in any way, and/or could be sent and/or made available and/or viewable to providers in any way. Any business methods can be used in co-ordinating with and/or incorporated into what is disclosed. For example, a fee may be incurred for posting a project by the user and/or a project being made available to and/or viewable by providers. It is feasible that a (small) charge is incurred to join the system/platform, either by the user(s), the provider(s), or both. It is also feasible the system/platform includes storage of information of the user, including, but certainly not limited to, credit card information, etc. Charges to provider and user (to facilitator/owner/provider of the platform/system) may differ in amount and/or nature.

Thus in step 1 of FIG. 5, a job/project is posted, eg by the inventor/user (or anyone else). Preferably this is done via an online system whereby the project can be viewed by providers who may be interested in the project. When creating an account and/or being registered, providers may be allotted fields in which they have expertise and/or skill. (This has been discussed). It is also feasible projects may be viewable by any provider, or that a provider can search listing(s) of job in order to view them. It is feasible a project posting may include media. This may include, or may not, video, for example.

Thus the posting and/or disclosure is preferably received by the platform/system, which may include taking details of what field the invention/project is in, uploading relevant document(s) and link(s) (for example to videos, demos, of the invention/project/product(s), websites, patent applications, and the like) so that the project, its nature, and the requirements may be better understood by providers that view the project. The posting and/or disclosure and/or information is then relayed to providers, preferably particularly relevant providers who have relevant skills and/or experience, relevant to a field and/or category of the invention/project, the platform/system thus optimised to find the perfect and/or best provider(s) for the invention/project/user/.

Thus in step 2 (5402), the project posting/disclosure/information is received by the provider (and may be received by any number of providers), so that the provider can view the project and view the nature and requirements of the job/project. Preferably they can thus decide if they would be a good candidate for the job/project and/or whether they would like to make a bid or offer to take up the project. (Whilst this system is particularly useful for PDPs and finding/attaining PDPs, it could also be used for PPs and/or PLFs/PLPs).

It is feasible, (which may be optional for a provider), that they may be notified by email and the like (or in any other way) when a project is posted/disclosed/made available, preferably when a project is posted/disclosed/made available that is within their field of expertise. Matching skilled providers to projects in fields that they are skilled at may be highly beneficial for all parties. Thus the project posting is received and viewed by the provider (5402).

It is feasible there may be requirements in order to post a project and/or make a project available to providers and/or to find provider(s) on the system/platform. For example, it may be counter-productive if a user or users post projects in an extremely undeveloped and/or incomprehensible manner. For example, extremely poor hand-sketched pencil drawings, and a poor quality written description may negatively impact the system and the experience for providers (and thus for users). Thus it is feasible certain requirements may be set up, said requirements required for a user to post and/or make a project available to providers and/or to find provider(s) on the system/platform.

This opens up a possibility for programs and/or purchases that may be offered and/or required for a user to purchase. For example, it is feasible a program, or a package and the like, may provide the user with a method of creating, or purchasing a video demo of their idea/product and the like. Such a video, for example a 30 second video (or any amount of time) of the product in action may be extremely beneficial and significantly streamline the process of posting jobs (for the user) and viewing (for the provider). It is well known that video is an extremely good medium for providing information. It is also known that video tends to be more entertaining than, for example, a written description. Thus a quick video, which may be a rendered and/or animated video, of the invention in action, may be particularly useful for disclosing. However, it may well be that this is not needed at the early stage of the process. Furthermore, an animated video and/or renders may be expensive and unneeded at this stage/part of the process. Furthermore, rendering of products into 3D designs, etc, may be carried out later in the process, for example. (Although the example flowchart of FIG. 55 may itself be carried out early in the process (eg to find a PDP), but may also be carried out later (eg to find a PLF(s)/PLP(s). The step of making a video (as shown in the example of FIG. 22) may be carried out in a more advanced manner (or any manner) later in the process, eg once the product(s)/project has been developed into an advanced prototype. However, if the user already has a prototype (or even a proof of principle that is basic in nature), nevertheless, a short video may be useful for disclosure.

Thus it is feasible a program may be offered to a user showing them how to make a demo video and the like for their invention/product/project. This may incur a fee (or may not) so that a payment is made to the facilitator, for example. It is also feasible that services may be provided, so that, for example, renderers and the like can render images and animations etc for a user to create a demo video of the invention/product/concept/project. (It is unlikely this will be provided). It would thus make business sense if the facilitator of the system provided means for users to purchase such services by, for example, offering an online marketplace that allows the user to post their project to designers/graphic renderers and the like in order to obtain renders, imagery, animations, video etc, which may then be used to attract providers to the project and may be used for posting the job for providers to view. It is also feasible that providers provide such services as part of their development of the project. Such services may be integral to the (preferably online) platform/system. Note: given what has been disclosed with reference to sequences of step(s) (eg FIG. 22), it is not likely that such extra services such as rendering of graphics and animations will be provided, before the user attempts to attain a PDP, for example. Such services/work may be provided, as part of work with a PDP, for example. Nevertheless, any or all such services (and any or all services mentioned) may, feasibly, be provided.

Thus it can be seen that a vast array of services can be offered by the platform/system, eg to inventors, designers, entrepreneurs who may have business concepts, or any other user(s).

If the provider does not decide to offer their services for the project (perhaps thinking the invention/idea/project is not likely to be commercially viable, or perhaps not being interested in the project for other reasons), then there may be no further contact between user and provider. In step 3 (5403), in a case where the provider does make a bid/offer, the provider places a bid/offer, in which case they may be able to reply to the project posting, and may feasibly include a message to the user for why they believe they are a good candidate for the job/project and/or a link(s) to a portfolio and/or previous work and/or successes, etc. Preferably this step is made as easy as possible for the provider. They may, for example, simply have to press a button on the project posting (or any place) entitled ‘make offer’, ‘reply’ and the like. They may also be allowed to include a project bid or offer, such as an amount of money they want to be paid taking on the job/project. Such a bid may be optional at this point. Thus it can be seen that the provider may be allowed to receive a project posting and/or disclosure/information, and to reply to the project posting, communicating to the user and/or placing/making a bid or offer.

As stated, success rates are preferably provided, also the/a platform/system may function, eg using many of these feature(s)/functionality, with or without the success rate concept and/or data/information being provided.

However, in a preferred embodiment, a database of the providers is stored. Providers may be asked to provide pertinent information as to their previous success rate at developing invention and/or products/project successfully. This may be recorded by the facilitator and/or logged.

Preferably, providers may simply start with no history, and accrue a success rate from jobs/projects performed using/on the platform/system, and that relevant systems are implemented so that the (percentage) success rate of the provider alters (ie is updated) if they are successful, or the opposite, with project(s). Thus it could be said that such information is preferably received, and monitored. Thus, for example, if the provider is hired for ten invention development jobs, and one is developed and brought to market successfully, they now have a ten percent previous success rate at providing profit for the inventor. It is feasible that, for the first, for example, six jobs performed, if the provider has not had any success at providing profit for the inventor, their success rate may simply be denoted with a question mark and the like, such as a ‘new’ icon or symbol, since a ‘zero’ success rate indicator may be unfair for the provider if they have carried out significantly few jobs. (This has been discussed).

Thus it can be seen that information may be (requested) and/or received, and/or monitored by the facilitator with regard to previous success rates of the providers for providing profit to inventors on previous projects, and that information regarding this can alter in the course of a provider providing services/taking up projects via the platform/system. Thus it can be monitored and altered and/or updated by the facilitator. As stated, this may be done on an automated level, with the platform comprising software (for example) that updates the success rate of any given provider(s), when a project has attained/reached its success threshold. It is feasible any party (eg user and/or provider(s) and/or facilitator/owner of the platform/system may be able to input that the or any project(s) has attained its success threshold. The system/platform (and/or software of) then preferably updates the success rate accordingly. It may be that the success rates of multiple providers can or is updated simultaneously, eg if a project has more than one provider (eg PDP and PP and/or PLF/PLP), and success threshold information is inputted (ie whether the project has, or has not, has attained its success threshold). In such a case, once the success threshold information is inputted into the system/platform, the platform/system may recognise the project for which it has been inputted and/or recognise the provider(s) for that project (which information may have been/be stored on the platform/system and/or software), and may then update the success rates of all the providers (if there are more than one) for that project.

If information is received by the facilitator and/or platform/system that a project has been developed successfully by a provider, (ie attained its success threshold, eg the inventor/user profiting more than the sum they paid the provider and/or platform provider(s)), such information may be logged on a database, which may incorporate/include software, so that the details and/or stored information of the provider is altered for viewing by providers and/or users. Thus the system/platform may be configured for alteration and/or updating of success (rate) information of providers.

In step 4 (5404) in the example of FIG. 55, a bid(s) and/or offer(s) from provider(s) are/is received by the user, who may view them, preferably online having signed into a secure account they have signed up to and/or set up for the platform/system. Thus, as shown in FIG. 53, a user 5024 may log in to their account to view bids 5030 and/or offers 5030 received from/for their posting/project. It is feasible the user may receive email notifications and the like when any bid is received/made, in which case as part of their profile, they may have provided a relevant email address to the platform and/or facilitator/owner of the platform, the system/platform thus emailing the user when a bid/offer comes in. As stated, it is feasible that a provider may charge a significant amount of money for taking up a project. It is also feasible that a provider may offer to take up a project (which may involve product development—eg for product and/or project development providers) for free, especially if they charge/get a profit percentage (or an amount) and the like if the project becomes profitable and/or commercially successful. It is also feasible a provider(s) may offer to pay a user to develop the project, especially if the provider charges a profit percentage fee (or any amount) and the like and believes the project could be extremely commercially/financially successful. It is, however, feasible that regulations may be put in place by the facilitator of the system if such bids/offers negatively impact the system. For example, it may stifle new team(s) and provider(s) if highly successful teams are allowed to place free bids, or pay users, and therefore have a significant advantage at developing the best projects. Thus it may not be allowed for providers to pay users in order to ‘win’ the project. This may or will not be the case in PLF cases, where the purpose of the PLF is for the user to be paid. Eg for a licensing deal with a PLF that is a company/party the user is licensing their invention/product to, it will be obvious that the PLF licensee company/party may pay the user, as part of the licensing agreement, to ‘win’ the project. Similarly, this may be the case for investors, who may, for example, pay the user an amount of money, in exchange for a share of the project/business, (and may help the project/business to be commercialized (or in any other way), for example. Thus if there is a restriction/ban on providers being able to pay the/a user (eg making a bid or offer than involved them paying the user), such a ban may only be in places for particular providers (eg only for PDP providers/providing and/or for PLF crowdfunding providers/providing).

It is also feasible that there are no such regulations. (ie that providers are allowed to pay and/or bid or offer to pay) the user money to ‘win’ a project). It is also feasible provider(s) may be able to bid or offer a percentage that they get, if the project is commercially successful. This may or may not include the user having to pay and/or be paid by the provider(s).

(In the example of FIG. 55. The percentage profit fee 5022 is preferably a percentage charge a provider charges of profit generated from a project they successfully develop. However, such payment structures/arrangement(s) are not limited to being a percentage; there may, for example, be an agreement in place that a set fee is incurred (and paid) to the provider if, for example, the project generates in excess of $50,000 profit. Similarly any other payment structure/arrangement(s) may be in place with reference to profit generated (and/or based on any other principle and/or milestone and/or amount) on/by a product(s)/project).

Preferably success rate information of the provider is provided to the user at the same time, or substantially the same time, as the bid/offer is received (eg as shown in FIG. 53, shown by way of example only).

As aforementioned, preferably the success rate is relayed/provided/shown/displayed as a percentage success. This is the most obvious and immediate way to demonstrate success information to a user. For example, if, rather than a percentage previous success rate, simply a number of previous successes is used (eg amount of projects the provider has taken on where the project has attained its/a success threshold), this may lead to poor comprehension and misunderstanding of the quality of the provider; a first provider may only have 10 previous successes; a second provider may have 146 successes. It would seem the second provider has more experience and is a better provider, which may lead to them being hired and/or used and to them being able to charge high prices and/or percentage success charges, and the like. However, if the first provider has 10 successes from a total of 100 jobs, they have a 10% success rate at providing profit for the inventor; if the second provider has 15,000 previous jobs, with the 146 projects having attained their success thresholds, they have a 0.1% (rounded up) previous success rate. Thus it can be seen that the first provider, despite having far less successes, is by far the higher quality provider, and provides a far higher likelihood of success than the second provider.

(It may be that the providers are not allowed to alter their percentage (or amount) they get if a project they take up becomes a commercial/financial success; the amount/arrangement may be pre-set/determined by the platform/system, and/or may be universal for all providers (eg for all providers of that type—eg for all PDP's, for example). Thus the amount/arrangement a provider (eg a PDP, or any provider) gets if a project they take up becomes a commercial/financial success may be non-adjustable by the provider and/or may be pre-determined.

Thus it can be seen that the success rate 12 may be provided with the/a bid/offer, and that this information may be crucial in a decision by the user for who to hire and/or use for the project. It can also be seen that, delivered in such a way, it may be/is substantially impossible to not notice such information, thus solving the problem of inventors/users not noticing/understanding.

In step 5 (5405) of FIG. 55, the user decides who to hire and/or use from their offers and chooses a provider. (It is not impossible, in some situations, that a user may be able to hire and/or use a plurality of providers. For example, in a case where the providers are PLF investors, it may be that the investors can both invest, and create, for example, a merged bid (or not). Thus it may be possible, in that situation, for the user to hire more than one provider).

Again, this (deciding who to hire and/or use from their offers) may be possibly to do online, simply by choosing, for example, a ‘hire’/‘choose’ button and/or option, and confirming which offer they would like to choose. Thus the platform/system may provide an option/function for the user to choose which provider(s) they want to use. If an offer/bid amount 5042 needs to be paid, a payment system may be incorporated/provided so that, for example, a payment can be made by the user via the platform/system. The payment system may allow payment by any or many different ways, such as, but not limited to, bank transfer, credit card, PayPal, etc, etc. It may be held in escrow, for example, which has obvious benefits for such a system. It is feasible a system may be provided whereby the project (and perhaps payments) can be split into smaller milestones so that more manageable payment amounts can be made by the user and smaller parts of the whole job/project can be completed by the provider, which may provide an element of security for the user, who can pay less and see how the project and/or what is provided develops.

Preferably the system incorporates storing of both the/a credit card and/or bank account and/or bank/payment provider (eg PayPal) details of both the provider, and the user, so that the platform/system can incorporate/include interchange of funds between user and provider. The platform/system may be configured so that a percentage and/or amount of any given payment is retained by the facilitator, so that the facilitator, for example, retains a 8.5% share of all money paid by the user, the provider, for example, retaining 91.5%. This is just one possible way of the facilitator generating a profit and/or money from the platform/system. however, there are many ways a profit and/or money can be generated by the facilitator via the present platform/system.

When the Inventor/user chooses a bid/offer, the provider is preferably notified, and thus arrangements can begin for development and/or work of/on the project (or whatever is to be provided and/or has been agreed and/or requested and/or for any step(s), if a step(s) of the platform/system is to be provided). Once relevant arrangements and/or payment(s) have been made, in step 6 (5406), development and/or work of/on the project (or whatever is to be provided and/or has been agreed and/or requested and/or for any step(s), if a step(s) of the platform/system is to be provided) can begin. Various communication tools and/or channels may be opened up and/or provided, eg for communication between user(s) and provider(s) (and/or even for communication between provider(s) and other provider(s), and/or for communication between provider personnel/people and other provider personnel/people (eg even if they are part of the same team/provider, (and/or even if they are not)). Such things may or may not be provided. (These may include secure way(s) and/or channel(s) of communication, for example). It is feasible a private workroom/workspace may be provided whereby the user and the provider can securely communicate. This may be digital and/or software based and/or website based and/or webpage based. It is feasible files and the like can be uploaded between the user and provider via the workroom/workspace. It is feasible that instant messages can be sent and/or received, so that significant communication can take place. It is also feasible that telephone type communications such as Skype and the like can be integrated into the system, and/or used separately. It may be beneficial to the facilitator for the user to be kept on the website during development/work of/on the project if there are provided programs, services and the like for the user to purchase and/or use. Thus said programs, services, and the like may, potentially, be marketed and/or displayed via the website/interface/platform to the user when they are using the website/interface/platform.

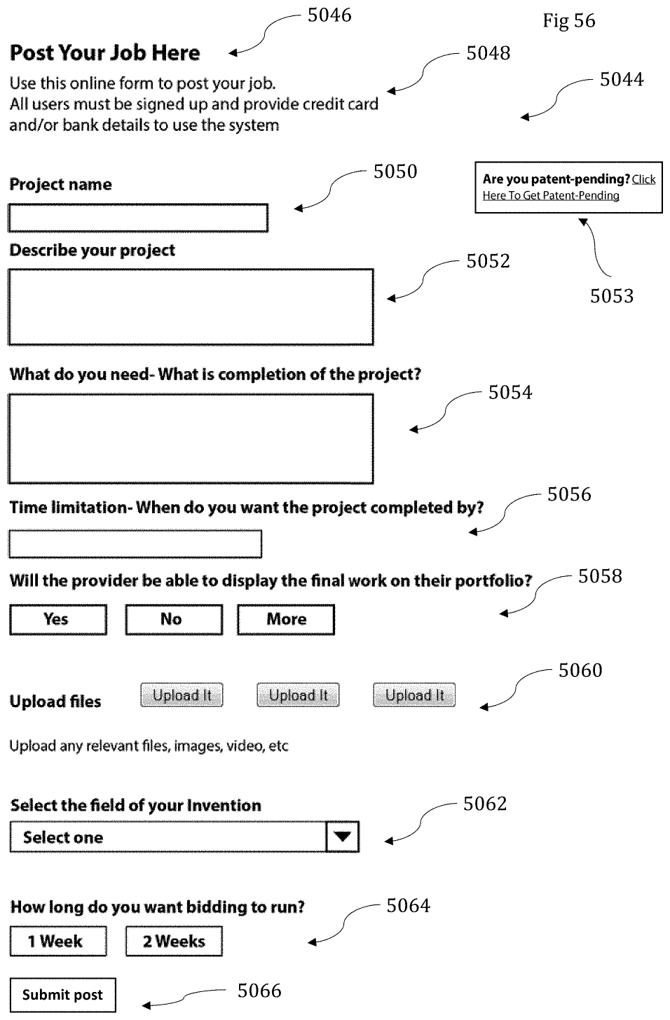

There is shown in FIG. 56 a basic embodiment of an online form 5044 whereby the online form 5044 (which is preferably provided via the/a website) can be filled out by the user to post a project for development. (As has been stated, this is just one way a project can be put on the platform/system and/or made viewable and/or accessible for providers. It is possible, as previously stated, that the project may be put on the platform/system (and/or made viewable and/or accessible for providers) in any way, and may not be done by the user. It may be done by the platform/system and/or staff member(s) of the platform/system (possibly in combination with the user). It may not be done by posting. If it is done by posting, then if it is done by the platform/system and/or staff member(s) of the platform/system, then a slightly modified version (or the same/similar version) of what is shown in FIG. 56 may be provided, for the staff member(s) (or any other party), rather than the user, to input data and/or post the project. Having staff members input the project into the system/platform may lead to more professional and/or compact disclosure(s). Thus a form (preferably an online form) may be provided, even if the staff member(s) of the system/platform (or any party) and not the user, inputs the project and/or makes it available and/or viewable for providers.

The example online form 5044 may have a plurality of sections to fill out by the user. In the example 5044, there is shown an exhortation 5046 to ‘Post Your Job Here’ denoting to the user that this is a form and/or page where the user can post their project to connect with providers to take up (and/or develop) their project. Preferably the project is a product idea, although it may feasibly be a business venture, etc. There is shown text 5048 denoting to the user that credit card, bank details, and the like must be provided by the user in order to use the system. This may, or may not, be the case. This is given by way of example only. It is feasible that bank details and the like do not need to be provided in order to post and/or input a project and/or use the system. In a preferred embodiment, bank details and the like must be provided by both the user, and the provider, to use the system. Providers may be further restricted and/or monitored so that only verified providers (verified by the facilitator of the system) may view jobs. This may act as a security measure to make sure laymen, potentially negative parties and the like may not view jobs/projects and ideas (and feasibly steal and develop them) without having been verified by the system. Thus it is feasible providers will undergo substantially severe and/or strict (or any) measure(s)/step(s) in order to be verified to use the system, which may, or may not, include a payable fee. Providers may be screened by the facilitator/owner/provider of the system/platform. Providers may only be allowed to use and/or be part of the system and/or provide on the system by invitation from the facilitator/owner/provider of the system/platform.

There is provided on the form 5044 a project name portion 5050, where a name of the project may be inputted by the user. For example, a user may input as a project name ‘Toy Robot Development’ as their project name, thus denoting the name and/or general description, which may be useful for providers who view the job/project post and/or disclosure. The user may key their project name into the box provided, via keyboard, touchscreen, or any other method of inputting.

There is provided a project description box 5052, where a description of the project may be given by the user. This may be limited, for example, to 1000 words, or any limitation. Thus the project can be described by the user (or whoever is filling out the form and/or inputting the project and/or project information onto the system/platform), for viewing, as will be shown, by providers. If the project is an inventive product, the user may describe the project, including any technical requirements, etc, and details of the product. If the project is, for example, a clothing range, the clothing range and concept may be described by the user, for viewing and reading by providers, as will be shown. If the project is a business venture, the business venture may be described by the user, etc. It will be obvious this system could be very useful for finding providers to help with projects. If success rates are provided (which may be provided partially, or wholly (or not at all) throughout the whole system/platform and/or providers, it may be still more useful. These options are simply provided by way of example alone.

There is shown a question box 5053 which asks the user if they are patent-pending on their project. It is feasible such questions are included on the form. It is feasible, even if all providers are signed up under secrecy act(s)/confidentiality that a user is warned, with due diligence, that it may be advisable to be patent-pending before disclosing if they have an idea that they believe may be patentable. The question box 5053 is shown including a link. The link may lead to a product or program that facilitates the user in getting patent-pending on their idea. Inventors (and potentially ‘designers’, if a design is considered to be a ‘patent’, which is a term used in some territories for design protection) tend to like being patent-pending on a potentially patentable idea/concept before disclosing, and that this may have benefits for the user. Thus it can be seen, if a program/product and the like is offered to the user to help them get patent-pending on their idea they wish to disclose, they may be heavily motivated (and/or need) to purchase and/or use the product, program etc before disclosing. This is yet another possible source of revenue for the facilitator. (As stated, however, such a program(s)/product(s) may be available on the platform/system, especially if the user is a paid member, for example, (or has paid) to have access to the system and/or platform, and/or step(s) and/or providers. Preferably the facilitator sells their own program facilitating the user in getting patent-pending, (this has been discussed), but it is feasible third party program(s) may be offered, so that marketing, affiliate relationships, etc may be a further feasible source of income for the facilitator. For example, a particular person and/or company may be particularly highly skilled at licensing inventions. They may have a program that helps Inventors, designers, etc license their ideas. It is feasible this may be advertised and sold by way of an affiliate relationship, the facilitator gaining from a sale of the product, program and the like. It is feasible any paying and/or affiliate arrangement is in place. For example, in such a situation, a banner, link or the like may be provided, the third party charged for every click that the banner, link and the like receives from users.

Referring to the example form 5044, there is provided a completion of project box 5054, whereby the user can describe what they perceive to be completion of the project. Completion may entail bringing the product to market. It may entail simply building a working prototype. It may be that some providers (eg even PDPs) can bring the product fully to market, but it is feasible that providers carry out a portion of bringing the product to market, such as any of: product building, designing, testing, etc. It is well known that, for particular products, many steps need to be carried out to bring a product to market. Thus it can be seen that the present platform/system can be used to hire providers providing portions of the product completion and/or success/launch/release/commercialisation process. (It should be noted, box 5054 (or the like, or information about what is needed) may not be required, if the platform/system comprises particular step(s) (eg in a particular order) eg as shown in the example of FIG. 22, because it may or will be obvious what needs to be done, and the platform/system may, if it is known what ‘step’ of the system/process the user is on/at/needs to complete next, already know what step the user/project is on, and therefore what needs to be done. This may include asking/consulting with the user to see what step they're on (which could be done with person-to-person communication (eg email, call, etc), and/or could be done by the user sending information (eg via a form (eg online form), etc), and ascertaining what step of the process/system the user is on. It may also be obvious what step the user is on, if the platform/system knows what step(s) of the process/system the user has already completed. Therefore if the user, with respect to the example of FIG. 22, has completed steps 1 and 2, but has not had a ‘Product Proof’ (ie proof-of-principle) built, then for the example of FIG. 22, it will be known by the system/platform that their next step is step 3 (to get a Product Proof done), and that they will also need step 5 (Product Design) and step 6 (Product Prototype). This information may be stored on the platform/system, and therefore the system may ‘know’ what the user needs done/completed, and may relay that to providers. It is also feasible the user (or whoever is inputting the project into the system/platform) may have to state what step the project/user is on. (A PP (patent provider), for step 4, (in the example of FIG. 22) may be attained using the same system/method as here shown (ie a form/posting system, or any way of inputting the project onto the system/platform), or may be attained in any other way.

There may be provided a time limitation box 5056, where a time limit can be provided by the user so that the provider is aware by which time the user would like the project completed by. A calendar may be provided so that the user can choose a date via the calendar. It is possible, however, that time limits are not relevant and/or provided, or that the platform/system sets the time limits for work and/or completion, etc.

In the example, there is provided a portfolio question portion 5058, where the user is asked whether the provider will be able to display the work provided on their portfolio. Some jobs may be of a nature wherein the user prefers not to have the project (and information thereof) disclosed on a portfolio, or, for example, only to have it disclosed once relevant intellectual property rights are attained/filed. It is important for providers to be able to display work on their portfolio to attract further users and clients. Thus the user can either choose ‘No’, ‘Yes’, or can hit a ‘More’ button to find out more about whether or not they should allow work completed to be displayed on a portfolio of the provider. It is preferable for the system/platform if the user allows work to be displayed on the portfolio of the provider so that users can view the portfolio and better understand the skills and quality of the provider, which portfolio, as will be seen, may be viewable by the user when a bid/offer of a provider is received. This feature 5058 may or may not be provided.

There may be provided an upload file portion 5060, which may include a file upload protocol. File(s) may be uploadable by the user and may be viewable by providers who view the posting/disclosure/project. Imagery may be uploaded, documents, drawings, patent documents, etc. It may be possible to upload video(s)—eg video disclosure and/or presentation of and/or explanation of, a project/product(s)/invention(s). It is feasible there is a file upload limit, in number and/or size, for instance a limit of 25 MB. It is feasible users may be able to disclose video(s) to providers via links, rather than uploading the video itself.

The example shown in FIG. 56 is preferably an example of an example that may be used early on in the process, where the invention/product(s)/project has not been fully developed. At this point, attaining a PDP may be first and foremost for the user/project. The ‘trailer video’ system of disclosing (discussed previously) is preferably a more advanced system of disclosure, that may happen and/or be used later on in the process (preferably once the project has been developed into an advanced prototype (if the project is a product) and/or an advanced stage. Thus the example of FIG. 56 may be used earlier in development, and may be mostly used/usable to attain PDPs. However, it may feasibly be used to attain and/or get the project disclosed to (or to) any providers (eg PPs and/or PLFs/PLPs), and may, potentially, be used at any part of the process.

Uploading of such files (as previously mentioned) may significantly aid communication of the invention/product(s)/project, which is extremely useful for the provider (and thus the user).

There may also be provided a video and/or website link on the form, so that a user can provide a link to a video of the invention/product(s)/project, perhaps on Youtube, or a website, etc. The platform/system may have its own video upload system. The platform/system may provide a video hosting facility.

In the example, there is provided a field of invention portion 5062, whereby, a field(s)/category(s) of the project/product(s)/invention can be chosen by the user (or whoever is filling out the form and/or inputting information), which may be used to attract and/or target relevant providers who are skilled and/or interested in the particular chosen field(s)/category(s) of the project, so that relevant providers and alerted and/or view the post. (This has been discussed, as well as the concept of ‘sub-categories’, which may be used in this example, and any other(s)).

In the example, there is provided a length of posting portion 5064 on the form, whereby duration of the post being visible can be chosen by the user. Various options may be provided.

In the example, there is provided a submit post button 5066, so that, having completed the form, the posting may be submitted by the user, thus being received by/onto the platform/system.

Various other options may be provided on the form, such as proposed budget, etc, and any other option.

Thus it can be seen that a project can be posted by the user (and/or inputted onto the platform/system, in any way, and not limited to being done by the user) and can be received by/onto the platform/system. In the example embodiment of FIG. 56, it is done via an online form 5044.

The project is then preferably relayed to providers for viewing. As aforementioned, relevant providers may be notified and/or alerted of jobs that are relevant to their particular skills, the system thus optimised to facilitate matching of projects with relevant providers. Jobs may also (and/or alternatively) appear on a listing.

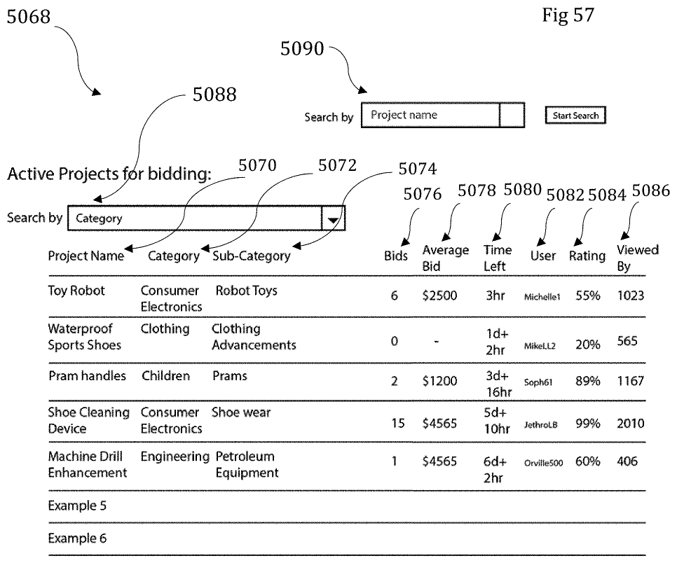

There is shown in FIG. 57 an embodiment of how the project posting and/or disclosure and/or information is relayed to providers, whereby a listing 5068 is shown of listed/relayed/provided projects which are receiving (and/or can receive) bids/offers. A bid/offer may involve the/a provider offering to take on a project (eg to provide services) for an amount of money. However, as aforementioned, it is feasible a fee is not demanded. Furthermore, in situations such as PLFs that are investors, potential licensees (and other examples), taking on a project in such a situation may in fact involve the provider paying the user, rather than the other way around. The listing 5068 is shown here on a webpage.

The listing 5068 reveals projects posted by users (any other party/persons—eg staff member(s) of the platform/system), (and/or inputted into the platform/system and/or made viewable/accessible to providers in any way), and information. A first column 5070 in the example embodiment of a listing system 5068 is a name of project column 5070; a second column 5072, in the example, is a category of the project column 5072; a third column 5074, in the example, is a sub category column 5074. Within these first three columns, information from the user in their posting is thus disclosed and listed. The next six columns, in the example, include/provide a number-of-bids/offers column 5076, where providers can view how many bids/offers have been received by the user for the project (it could, for example, be titled ‘offers’, rather than ‘bids’; an average bid/offer amount column 5078, where an average price/amount of the received bids/offers for the project is shown (this may be particularly useful for PDPs, and possibly for PPs too, and may also be useful/relevant with regards to PLF crowdfunding specialists/videographers too; a time left column 5080, where it can be seen how much time is left before the bidding/offering/post/time-for-making-offers and/or posting closes, so that the provider can know how much time they have left to make an offer; a username column 5082, where there is shown the user (eg there is, in the example, provided the/a username, for example, of the/a user who has posted the project and/or who is the user of the project (ie the project may not have been inputted and/or made viewable/accessible to providers by the user—however, the user is shown here); a rating column 5084, which may provide a feature whereby providers can rate whether they like or do not like a project that they view, irrespective of whether they place a bid or offer, or not, the rating being viewable by providers on the listing 5068; and a viewed-by column 5086, which shows how many providers have viewed the project and/or post and/or disclosure.

The projects are preferably clickable (and thus viewable) and/or viewable in any way by the provider, who preferably can click on a project in the listing and view the project and/or disclosure and/or information for that particular project.

The following is given by way of example only: For a first example in the example listing and/or project viewability and/or providing system 5068, there is shown a project and/or project posting entitled ‘Toy Robot’ in the name of project column 5070. It is categorised in the ‘consumer electronics’ category in the category of the project column 5072, with a subcategory of ‘robot toys’ in the sub category column 5074 . Thus it can be seen that information provided by the user (or any other party), for example, via, for example, the online form as shown in FIG. 56 (or via any other means/method) can be received by the platform/system, and can be relayed to providers for viewing. This is just one example of how this can be done/achieved. For the present example, it can be seen in the number of bids/offers column 5076 that the said project has received six bids/offers, with an average bid of $2500, shown in the average bid amount column 5078. Thus it can be seen there may be significant competitiveness between providers using this platform/system/example, which may lead to lower prices for the user (or feasibly to the user in fact being paid more, if providers are paying the user, to try to ‘win’ taking on the project—thus it is feasible the average bid/offer may in fact be a ‘negative’ amount, from the providers point of view. As stated, in the case of licensing and investing, it may often/sometimes be the case that the bid/offer is a payment from the provider to the user, rather than from the user to the provider. However, there may be provided a slightly different system for such PLFs. The system here may be more applicable/useful for PDP's and PLF crowdfunding specialists/videographers, and perhaps other providers, and perhaps, feasibly, patent providers (PPs).

It can be seen in the time left column 5080 that there are three hours left before the project bidding/offering and/or time ends for the posting. The user/username is shown in the username column 5082, the rating from providers for the project is shown, in the example, as 55% in the rating column 5084, and the project has been viewed 1023 times as shown in the viewed by column 5086. Thus significant information may be relayed to the provider via the listing 68.

Further examples of projects are shown on the listing, including denoting ‘example 5’ and ‘example 6’ denoting that the listing could be of any length, feasibly including hundreds of projects and/or project postings and/or disclosures, or more.

There is also provided a search box 5088 which preferably facilitates the/a provider in searching for jobs/projects particularly relevant to their skillset. Thus, for example, a highly skilled engineer provider may optimise the listing to show only (or heavily biased towards) engineering projects that are active for bidding and/or offers and/or available. This may be useful for the provider and user, further optimising the platform/system to facilitate high quality and focused invention and design development services, and helping the provider to find jobs, for which they typically hope to earn pay.

Alternatively, there is shown a second search box 5090, where the provider may be able to key in keywords and terms to find interesting and/or relevant projects, eg for bidding and/or offering on.

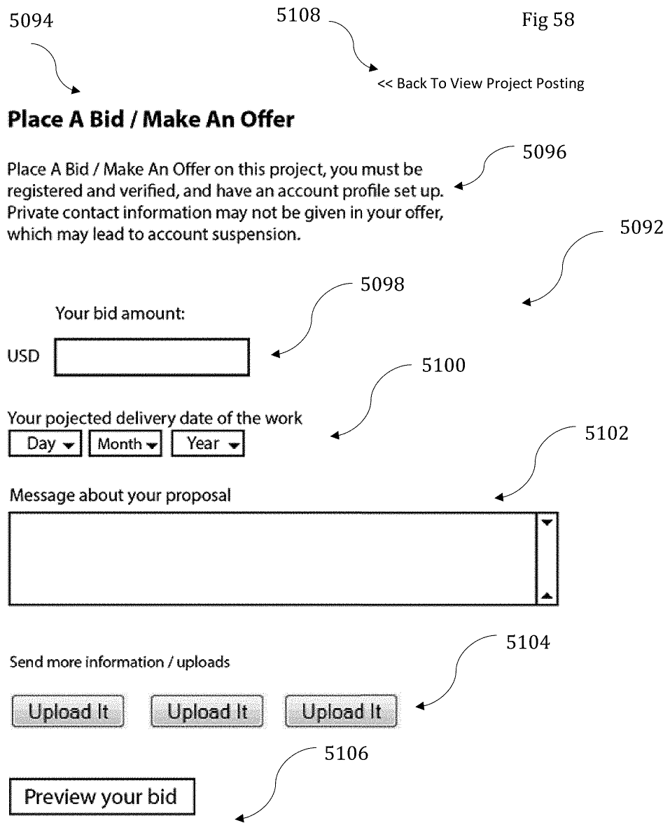

The provider preferably can click on (or in any way select) the projects on the listing 5068 to view them. When viewing the project, they may click, for example, a ‘make an offer’ button and the like, which preferably takes them to an online offer form 5092, as shown, by way of example, in FIG. 58. Via the form 5092 (or via any other means and/or method) they can make an offer for/to take up the project. There is provided on the example embodiment of a form 5092 (which is just one way the provider may be able to make an offer to take up a project) an exhortation 5094 to make an offer. Providers are informed in text 5096, in the example, that, as aforementioned, preferably, they may be required to be registered (preferably having an account on the platform/system) and preferably verified (thus being verified by the facilitator/owner/provider of the platform/system. The text 96 is shown by way of example only. Preferably the providers are checked for quality, with only skilled providers allowed to provide services for users and/or take up projects and/or be part of the platform/system and/or be providers on the platform/system.

In the example, there is provided a bid amount box 5098 where a bid amount can be inputted by the provider; a projected delivery date portion 5100, where a projected delivery date of the completed work can be inputted by the provider; a message box 5102, where a message can/may be inputted/inputtable by the provider, about the proposal and/or project, that is relayed to the user, (which may, potentially, aid communication); and an added information/uploads portions 5104, where, for example, images and relevant matter and/or files can/may be uploadable by the provider for viewing by the user. Previous work may be uploaded/uploadable by the provider to provide evidence to the user and/or show that they are apt for work on the project and/or for taking up the project.

There is provided an option to ‘preview bid’ 5106 for the provider, which preferably allows then to preview what they have inputted, at which point they may submit their bid (there may be a submit button or the like on (and/or at the end of) the preview, for example. The embodiment of the form as shown is taken by way of example only, and many other and different options may be provided. It is feasible there may be provided added portions for the form, for example, whereby a percentage profit fee may be inputted by the provider for work on/taking up the project, for example. For example, the provider may demand a 20% profit fee (or any amount/arrangement) of the product(s)/project if it generates a profit (or any amount/arrangement), eg selling successfully, for example. It is feasible this is denoted previously (as shown in FIGS. 53 and 54, by way of example) or that, as described, the percentage profit fee (or any amount/arrangement) may be separately decided and inputted by the provider for any given job. (As stated, the or such financial arrangements may be decided by the platform/system, and it may not be possible for the provider to alter these—(eg what percentage profit they make from projects they take up). It may be pre-decided by the platform/system, eg for the service provided. It may be pre-decided by the platform/system, dependent on what is to be provided by the provider and/or how much work is required, and/or what step(s) of the system/method are to be provided for (if step(s) are provided) and/or what route/method of launch is being attempted by the user and/or provided by the/a provider (either at this point, or later, eg by a different (or feasibly the same) provider(s).

In the example, there is shown a link 5108 so that the provider can return to view the project from the online bid form 5092.

Thus it can be seen that a bid/offer, including added information by the provider, can/may be received by the platform/system. As shown and described with reference to FIGS. 53 and 54, the bid(s)/offer(s) is preferably then relayed to the user, and may include showing success rate of the provider(s), which is preferably shown as a percentage success rate. This may be incorporated onto and/or provided by way of a virtual badge, and may be substantially ‘pinned’ to (and/or clearly visible on) the profile and/or offer/bid of the provider so that, preferably, it is immediately and explicitly viewable/noticeable by the user when the bid(s)/offer(s) is received. The success rate information may become a significant deciding factor for the user in who to hire and/or use for the project.

As shown, the success rate concept has the ability to create a guaranteed goal match between the/a user and the/a provider; when the provider is successful, with the project attaining a success threshold, their (percentage) success rating goes up. Thus not only does the user benefit from the project being successful (eg making a profit more than they paid the provider and/or the platform and/or the providers they use for the project), but the provider benefits since a higher success rate rating may well be an attraction for (future) users, who may therefore be more likely to hire and/or use the provider for future projects. Furthermore the provider, with the higher rating, may be able to charge higher fees for their services, and/or charge a higher percentage profit fee and/or improved/better financial arrangement, feasibly being paid a percentage of the profit the project generates, which may, for example, be limited to a certain time frame, or may not be limited.

(It is feasible the platform/system may give higher profit percentage and/or financial arrangement(s) to providers who have a high success rate. Thus, for example, the platform system may have success rate thresholds. Eg if a provider (eg PDP, for example) has a success rate of 20% or better, they may get, for example, 22% of profit generated from the project, rather than the/a normal 20% (or an improvement on whatever is the normal arrangement/amount). If the provider has a success rate of 40% or more, they may get, for example, 25% of profit generated from the project, rather than the/a normal 20% (or an improvement on whatever is the normal arrangement/amount). If a provider falls below a success rate threshold (and/or has a low success rate), the platform may let that provider go (ie not allow them to provide on the platform/system any more—ie ‘fire’ them, so to speak). Thus, for example, if a provider has less than a 5% success rate, the platform/system may no longer allow them to provide on the platform/system and/or take up projects. This may be project amount sensitive—ie may only come into being after, for example, 10 projects have been completed and/or taken up by the provider. This may help the provider have time to show they can get at least 5% success rate (or whatever the threshold/requirement may be).

However, although the success rate concept creates what could be called a ‘goal match’ between user and provider, there is a potential problem with such a system/concept. The provider, through fear of lowering their (percentage) success rating, may become overly cautious. For example, on seeing a project which is potentially extremely profitable, but high risk, they may choose not to bid/make an offer and/or take up the project out of fear of the risk of lessening their (percentage) success rating. Thus it would be desirable, in particular for such projects, if the provider were incentivised to bid/make an offer, without having the problem (and/or associated fear) of having a lower (percentage) success rating if they fail to provide a profit. However, if this was afforded on any project (ie on every project), it would negate the purpose of the system, since a provider could take up any project without fear of lessening their (percentage) success rating if they fail to provide success for the user and/or the project fails to attain/reach its/a success threshold.

Thus there may be provided an option (which may be referred to/termed, for example, as a ‘green card’ option, or the like), (green being a colour internationally recognised as meaning ‘freedom’/‘go ahead’, etc), which option incorporates/includes an ability for the provider, on selected project(s), to be immune from a lowering of their success rating, even if that project fails to attain its success threshold and/or the provider fails to provide profit for the user. Such an option is preferably regulated/available on a limited degree/to a limited amount of project(s), so that (percentage) success ratings remain meaningful for the system. A green card, which could also be termed a ‘joker card’ thus preferably permits the provider to take up a given project, without fear of being penalised, their success rating not being negatively affected, even if the project fails to attain a success threshold and/or they fail to provide a profit. In a preferred embodiment, such an option may only be made available to the provider in, for example, one out of every twelve projects they work on. Thus the option is provided sparingly so as to keep (percentage) success ratings significantly valid and meaningful for the system.

Thus preferably the platform/system and/or method further comprises: allowing a provider to take up a project wherein if the project does not attain the/a success threshold, it does not negatively impact the provider's success rate, and wherein if the project attains the success threshold, it positively affects the provider's success rate. Thus preferably, if the project does not attain the/a success threshold, the provider's success rate does not go down. But if the project does attain/reach its success threshold, their success rate preferably goes up, preferably as it normally would. As stated, this may only be available for a limited amount of projects, otherwise it could make the success rate concept useless (or negatively impact it). Thus, for example, this option (which may be called, for example, taking/using/playing a ‘green card’ and/or ‘joker card’ for a project, may, for example, only be available for one in every six projects the provider(s) takes up and/or bids on/makes an offer for. It may be that the provider has to decide on whether they are taking this option (ie playing a green card and the like) for the project, before they bid/make an offer. Alternatively, they may be able to decide later and/or after (making a bid/offer and/or taking up the project). It is possible the provider may be given a ‘green card’(s) before they start providing for any projects. Thus, when they start, they might be given one (or two) of these, that they can ‘play’ for any project(s) they want. Thus the platform/system/method may comprise apportioning a ‘green card’(s) to providers. (ie the provider(s) may be apportioned a selected number/times that they are allowed to use this option (to take up the/a project without the project negatively impacting their success rate if it fails to attain its success threshold)). It is also feasible that, on such an option, rather than the project not negatively impacting their success rate at all, it simply negatively impacts their success rate less (eg it may only impact their success rate negatively 50% (ie half), or any mount/fraction, for example) as much as a normal project would. So the same may be the case for such a project(s)m positively affecting the provider's success rate (eg it may only impact their success rate positively 50% (ie half), or any mount/fraction, for example) as much as a normal project would.

Not only does such an option allow a provider to bid on/make an offer for and/or take up a project that they may have avoided out of caution, (despite the project being potentially profitable and/or could be successful), it also adds a potential element of excitement. Preferably the provider must communicate to the facilitator and/or platform/system that they are using this (ie their ‘green card’) option on the/a given project, before taking up the project, otherwise it could, potentially, be used in a deceptive manner, only after a project fails, or during work/what is provided, when it starts to look like it will fail. The user need not necessarily know if this (ie a ‘green card’) option has been used by the provider. The user may know and/or be informed. The user may not know and/or not be informed (by the provider and/or platform/system. Thus, if the provider has used this option before bidding/making an offer and/or before taking up the project, it is possible the fact that they have chosen/used this option (ie the ‘green card’ option) may be hidden/masked from the user. Rules and/or number of such green cards and the like may be decided and provided by the facilitator/owner/provider of the platform and/or the platform/system.

It is feasible this option (ie green card(s)) may be awarded, (almost like/as prizes) to a provider. For example, if, for example, a provider successfully provides profit for the inventor/user on 5 projects (and/or if five projects the provider takes up attain/reach their success threshold), they may, for example, be awarded a green card (ie one or more apportioned chances to use this option). The amount of green cards/times they can use this option may be stored/saved on the system/platform. If the/a provider uses one of these options, preferably the system/platform (eg by software) updates/amends the amount/times available that the provider can use this option (ie the ‘green card’ type option). Thus if the provider has two ‘green cards’, and uses one on a project. Preferably the amount/times/green cards available for that provider is reduced to one, by the platform/system. This may be done manually (eg by staff of the platform/system). Preferably it is done automatedly (eg by software on/of the platform/system). Preferably the allotted/apportioned amount of times the provider can use this option (and/or use a green card(s)) is viewable to the provider from within their account. As states, preferably it is updated/reduced when they use this option, and that is then viewable and/or saved/stored (information) on/inside their account. Similarly, if they are awarded a ‘bonus’ time they can use this (eg a ‘bonus’ green card), preferably the number of times they can use this option is raised, and preferably is viewable by the provider inside their account.

In one example, for example, the/a provider (or all providers) may be given one green card at the start of them providing/becoming part of the system/platform. This might be a nice way to start because it takes (and/or may take) a little bit of the pressure off of the provider. Thus they may be able to use that green card option, for example, for the first project they bid/make an offer on and/or take up. Alternatively, they may decide to ‘save’ their green card, and use it on a later project. (eg a high risk project). Thus an element of strategy comes in for the provider—the green card option is a powerful option, which can help them maintain a high/good success rate. But they may not want to use it on projects they think have a very good chance of attaining/reaching their success threshold, because that would be a ‘waste’ of the green card. Instead, they may choose to use it on projects they either think are high risk/high reward (eg a project which may well not attain its success threshold, but that, if launched successfully (and/or if it becomes a success), could be highly commercially/financially successful, (and could highly financially benefit the provider who takes the project up).

If a provider chooses this green card option when/before bidding/making an offer on a project, if they fail to win/take up the project (eg if a different provider is chosen by the user and/or the project never moves forward, for some reason, and/or the provider in question is not chosen by the user), preferably that does not count as the provide using the/a green card, because they never won/took up the project. Thus preferably their amount of green cards/times they can use this option remains the same in such a case.

In one example, the/a provider (eg a PDP, or any provider) may be given one green card to start, before they've taken up and/or bid on/made an offer for any projects. They may then be given a bonus green card once five projects they've taken up attain their success threshold. They may then be given a further bonus green card once a further ten projects they've taken up attain their success threshold (ie fifteen in total). They may then be given a further bonus green card for every further ten projects that they've taken up attain their success threshold—ie once 25 projects they've taken up successfully attain their success threshold, then 35, then 45, etc etc. This is just one example, but shows how green cards/this option can be allotted to/given to/apportioned to a provider, as a ‘reward’, for example, for projects the provider has taken up reaching/attaining their/a success threshold.

In another example, the/a provider may be awarded a green card if they bring three projects (or any other number of projects) to market profitably for the user in a row and/or if the projects attain their success threshold. These may be awarded on top of regular provisions of green cards. Thus it can be seen that such green card options, and the like, can be provided, whilst significantly retaining the integrity of a (percentage) success rate system. (ie by regulating and/or limiting the amount of times this option can be used). It is feasible, if a green card is used, that a success on the project where the green card is used does not count positively towards the success rating of the provider. Preferably, however, it does.

Green cards may also simply be awarded as prizes, for example, in a raffle, etc, or used as incentivisation—for example, if providers buy program(s) offered by the system to improve their development skills, or for any other reason. For example, a green card(s) may be awarded/given to a provider(s) if they have very good or high rating(s) from users, for example.

The amount of times the provider has used this option (referred to here as the/a ‘green card’ option) may be relayed/provided/displayed, eg to users. It may be displayed/provided along with the success rate of the provider(s). This may be useful for the user (or any party) to understand what the ‘true’ success rate of then provider is, taking aside any use of ‘green card(s)’. Thus, if the/a provider has taken up 46 projects, and 14 of them have attained their success threshold, one might think that their success rate would be 30% (which is the percentage for 14 out of 46, rounded to the nearest percentage point). However, if the provider has used three green cards in that time, with two of the projects the provider used the green card on not having attained their success threshold, and one of the projects the provider used the green card on having successfully attained its success threshold, then their success rate may be provided/displayed/relayed as 33% (which is the percentage for 14 out of 43, rounded to the nearest percentage point, since 3 of the 46 projects are projects the provider used a green card on, and therefore do not, in this example, count towards, when calculating success rate, the project total. Thus, since the provider has taken up 46 projects, but three of them were ones where they used the green card option, their success rate is here, in this example, determined to be 14 out of 43 (ie 46 projects, minus three, which were projects where the provider used a green card). If this is the way success rates are calculated when green card option is used, then if, for example, a provider has taken up 10 projects, without every using a green card option, and one of them has attained its success threshold, then their success rate is 10% (1 out of 10). If they then use a green card option on their next, eleventh, project, and the project attains its success threshold, then, if green card projects don't count, when calculating success rates, as part of the project total, then their success rate would/may be 20% (2 out of 10, with the eleventh project not counting as part of the project total when it comes to calculating success rates). However, it may be that projects where the provider has used a green card option do not count as part of the project total, (when calculating success rate), when the project fails to attain a success threshold, but that they do count as part of the project total, (when calculating success rate), when/if the project successfully attains its/a success threshold. Thus, if the provider, again, in the example, has taken up 10 projects, without every using a green card option, and one of them has attained its success threshold, then their success rate is 10% (1 out of 10). If they then use a green card option on their next, eleventh, project, and the project does not attain its success threshold, then, preferably, their success rate stays at 10%, because the project, when calculating success rate, preferably does not count in the project total—ie their success rate is preferably calculated as: 1 out of 10, with one green card project that did not attain its success threshold. However, if the project successfully attains its/a success threshold, preferably it does count towards the project total, when calculating success rate. Thus, if the eleventh project the provider takes up (and uses a green card option on) does attain its/a success threshold, preferably their success rate is calculated as and/or displayed/shown/relayed as: 2 out of 11 (ie 18%). This is how success rates are preferably calculated, with reference to use of the/a green card option(s). Thus in the example mentioned earlier, of the provider that had 14 successful projects out of 46, with two green card projects that failed, and one green card project that succeeded, their success rate would preferably be provided/relayed/displayed as 32% (14 out of 44). These computations may be calculated (and/or may be updated) by the platform/system (eg by software). It is feasible they are calculated and/or updated by a person. Preferably, however, this is achieved by the platform/system itself and/or software of the platform/system.

Amount of green cards the provider has used may be displayed/provider/relayed to user(s) (or any party). It may be that an option is provided so that a user (or any party) is able to see the ‘true’ success rate of a provider, with the green card projects simply calculated as normal projects and/or with green card projects that did not reach/attain a/their success threshold being included in the success rate. This may be calculated and/or provided/relayed/displayed by the platform/system.

It is feasible a provider (eg PDP, or any other) may be able to bespokely decide what percentage of profits amount (or any amount(s) they will get/want to get, bespoke to each or any particular project. They may, feasibly, be able to input this on and/or at a time of making their bid/offer. Feasibly, this may be done, for example, by inputted what they want/require, eg via a form such as that shown in FIG. 58, or via any other means/method.

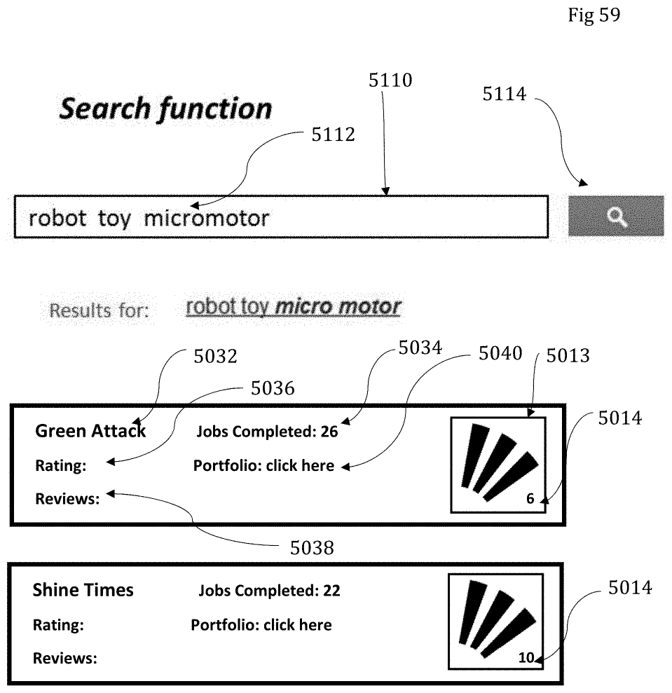

It is feasible, as shown in FIG. 59, that the platform/system comprises a search function. This may be used for users to search, for example, for providers. It may also be used, for example, for providers to search for projects.

In the example of FIG. 59, an example is shown which can be used by a user(s). There is shown, for example, a search box 5110, which is provided, in the example, for the user (or any party), so that, in the example, they can key in words and terms relevant to their project, the search results displaying teams and/or providers who have relevant skills to the searched words. In the example embodiment, as shown in FIG. 59, a user who has a toy robot invention/product, the robot toy invention/product having a micromotor that facilitates movement for the robot, has typed in a search term 5112 ‘robot toy micromotor’ into the search box 5110. Having hit a search return button 5114, there are shown two results, the two results being/showing two providers, whose details are displayed for the user. Preferably, as shown, a previous percentage success rate 5014 of the provider at projects attaining a success threshold is shown (although this search function may be provided whether or not the platform/system provides and/or calculates success rates, etc. The success rate is shown clearly with the provider's details, thus being eminently noticeable for the user. As shown, the user may find out more about the provider, for example, viewing their full profile, portfolio etc. Thus information may help the user ascertain if the provider may be a good provider for their project.

It is feasible that the user may be able to open up communication with the provider, for example, by messaging the provider direct through the website. However, it is feasible privileges may be required for this, or that the provider has a choice of not receiving messages in this way, or whether they would like to/allow receiving messages in this way.

The user may be able to ‘favourite’ and/or ‘save’ the provider, and may later be able to target and/or invite the provider to their project. It is feasible an alert may be sent to the provider when their job project is posted (or now, if the project has already been posted and/or made viewable/accessible to providers and/or inputted into the system/platform) if the user has targeted and/or invited them. Thus the provider may receive an alert, feasibly with a message, notifying the provider that they have been particularly targeted/invited by the user. This information may be helpful for the provider in knowing that they are a desired target for the job.

For such a search function, it will be obvious that the system/platform may need information about the provider(s), such as category/field of expertise/interest. Such information may be inputted into and/or received by the system/platform, eg for what fields of expertise the provider has; what particular product types, fields etc the provider has expertise in and/or interest in. (This type of categorization has been discussed). Such information having been accrued and/or received and/or stored, search results for the user can reveal and display relevant providers, relevant to their search term(s). It is also feasible the user can simply use a ‘category’ search—for example, searching the category of ‘Engineering’, for example, and more feasibly searching subcategories, thus optimising and specifying their search for a provider.

It is also feasible the user can search the exact subcategory of their invention for all providers that are qualified to bid/offer and/or take up projects in the given field. It is feasible providers are not qualified/allowed to bid/offer and/or take up projects in every filed, and may be restricted from bidding in certain field(s) if they do not have required expertise.

Thus it can be seen there are a plurality of ways for contact and/or searching/finding projects and/or providers to be facilitated between user and provider using the present system/platform. Preferably, as stated, success rate information of the provider is provided/relayed/displayed to the user, and preferably the said success rate information can be or is provided extremely immediately and explicitly to the user.

It may be extremely useful and/or necessary to accrue a significant amount of information from providers to facilitate the present system. For example, according to the/a search function (eg FIG. 59, for example), a search algorithm may be used, it may be extremely useful and/or necessary to have significant information about the provider, field of expertise, etc so as to provide high quality search results that successfully reveal relevant providers for the user. It may even be possible for the user to limit the search to providers that have a success rate above (or at least equal to) a certain amount (eg user may be able to limit their search to providers who have a success rate of at least 10% or more, or limit the search to providers who have a success rate of at least 15% or more, or 20%, for example.

It is feasible communication tools are provided for users to communicate with one another. (This has been discussed). It is well known that social media sites that provide business and professional communication between users in similar fields can be useful for users and significantly link people in. Forums for users may also be extremely useful, particularly in design and, more particularly, invention forums, for linking people and helping each other with projects. In such an embodiment, it would be beneficial if users, as well as providers as aforementioned, are signed up to secrecy and/or confidentiality (agreement(s)), so that ideas can be disclosed to one another without fear of losing patenting rights, ideas being stolen, etc. Thus, for example (in no way limiting what may be claimed), a computer implemented method may be provided, which may comprise any of: providing an online marketplace for a user to post a project and/or product to develop; signing up providers to at least one of: an all-encompassing secrecy act; an all-encompassing confidentiality agreement, thus facilitating disclosure of a project by the user without fear of at least one of: losing patentability rights of the project; a provider developing the project without due consent from the user; accepting a product and/or project and/or project post from the user; relaying the product post to providers; allowing providers to bid/make an offer on the project; relaying the bid/offer to the user so that the user can view the bid(s)/offer(s) from providers; relaying success rate information/data of the provider to the user (preferably with the bid/offer of the provider), the user thus having information that provides them with a heavy indicator of likelihood of success if they use the provider; allowing the user to accept the/a bid/offer and/or use the provider; allowing the user and provider to open up (preferably secure) communication to work on, and/or develop, the product and/or project, and/or work together. Optionally, users may also be (and/or can/may feasibly be) signed up to at least one of an (all-encompassing) secrecy act; an (all-encompassing) confidentiality agreement, or any other similar agreement, and where, optionally, communication tools are provided for communication between users, which may include, but is not limited to, forums, social media type sections for discussions, discussion boards, and the like. Such confidentiality agreements may, for example, define that all disclosures from one user(s) to another user(s) are confidential.

These features are just listed by way of example, and in no way limit what may be claimed.

There may also be provided program(s) to facilitate the users in getting patent-pending on their ideas, to further enhance protection of their ideas and facilitate greater freedom for the user in disclosing their idea, for example, to other users. Any means of communication between users may be provided.

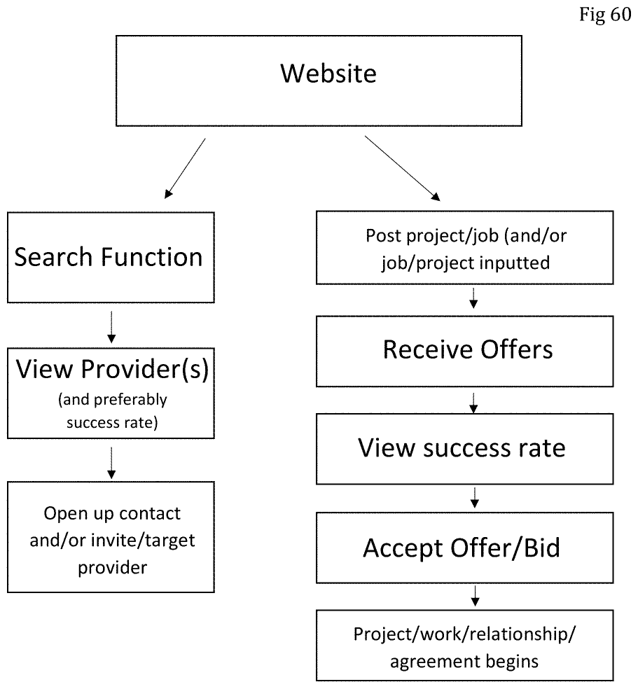

There is shown a flowchart in FIG. 60, shown by way of example only, which generally/roughly denotes how the platform/system can incorporate/include both a ‘post and bid’ function (or any project inputting function), and/or a search function, which both may be available for a user. (The search function may also facilitate a provider(s) in finding projects. The projects may also be categorized, to help provider(s) find project(s) relevant to what they are looking for and/or their skills/interest(s). In cases of both search function and project inputting and/or posting function, a payment(s) may be made by the user before work and/or relationship with the provider(s) commences. As stated a payment may feasibly be made by the provider before work commences. In any case, a portion of the payment, or a portion of a future profit of the project if it is developed successfully, may lead to a payment being made by either the user, or the provider, or both, to the facilitator. (This, and various options, have been discussed).

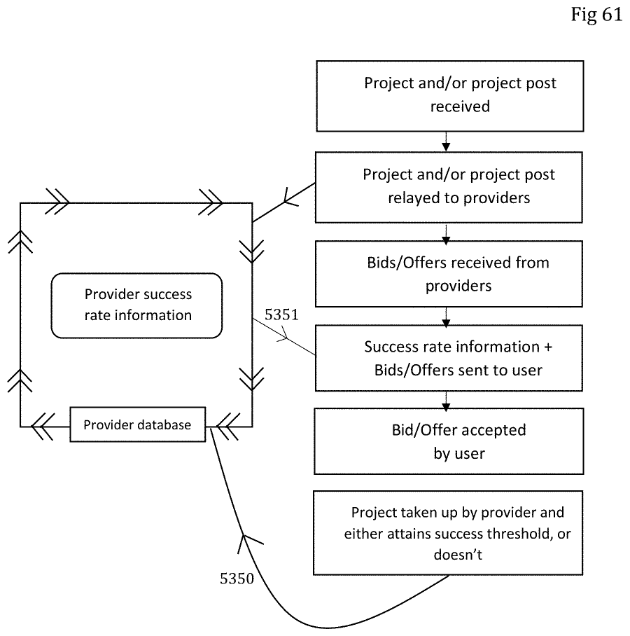

There is shown in FIG. 61 a flowchart representation of a method/platform/system which preferably comprises a provider database, and which preferably stores and monitors provider success rate information. Arrows on left and middle of the flowchart denote/represent how success rates may be monitored and/or stored and/or relayed. For example, arrow 5350 denotes how information as to whether the/a project the/a provider takes up attains a success threshold or not may be fed back into the system/platform, and arrow 5351 denotes how that success rate may be relayed to users (preferably with the/a bid/offer of the provider, and perhaps available at other points to—eg on the provider's profile). The flowchart/image of FIG. 61 is representational only, and should not be taken to limit how the platform/system may function. For example, it will be obvious that the general square that include within it the shape within that includes the text ‘provider success rate information’ is just a representation. Therefore FIG. 61 is given by way of representation alone, rather than being an accurate indicator of any database(s) and/or database formation and/or information storage, for example.

Information may be held by the platform/system on how many jobs have been carried out (either by a provider(s) and/or by all providers, for example), how many were successfully developed (ie attained/reached a success threshold and/or generating a profit for the user) (either by a provider(s) and/or by all providers, for example). Thus, preferably, a percentage success rate may be stored and/or monitored for the provider, which may (or may not) be incorporated onto, and/or provided by way of, a virtual badge of/for the provider. If information regarding such facts (eg project totals, success rates, etc) changes, the information may be received and updated/altered. The updated success rate information may then be dispersed/relayed in whatever way is deemed fit (preferably to users and/or any other party). Updating may take place immediately if a success rate changes, eg once data as to whether a project attained a success threshold or not is inputted and/or received by the system/platform. Evidence may need to be provided (by the user and/or provider(s)) to show the project has successfully attained a success threshold (eg generated a profit), at which point, said information having been proven and/or provided and/or inputted and/or received, the platform/system may, preferably substantially immediately and instantly, update the success rate information of the provider. Preferably it is then substantially immediately viewable on the provider's profile, bids/offers, etc. This may be the case for any providers (eg PLFs, PPs, PDPs). However, this system/concept may be particularly useful for providers that are provided product and/or project development.

In the example flowchart of FIG. 61, it can be seen how the project and/or project post is received (eg by posting by the user, or any other way) and is relayed to the provider(s), preferably via use of the/a provider database(s). As aforementioned, the platform may have/comprise relevant programming/coding and/or software and/or be configured to target and/or alert relevant providers for the project (eg via categorization), and thus preferably alert them, and/or rule out providers who do not have significant (or the required) expertise in the field of the project.

FIG. 61 is just one basic representation of a platform that may store and/or monitor and/or update and/or calculate success rate information of providers, have a database of provider(s), and be able to send project(s) and/or a project post out to the or any provider(s) of the and/or via use of the database(s). Success rate information is preferably stored and monitored, and may be/preferably is fluidly updated by the system as information is received as to whether project(s) have attained a success threshold and/or generated profit for the user. Of course, the platform/system may (and preferably) comprises a user database(s). Thus it will be obvious that FIG. 61 is simply a representation. It is hoped the representation in some way represents how the platform/system may fluidly store and/or monitor and/or update success rates of providers, and be able to connect user(s) to provider(s), and preferably relay success rate information of provider(s) to user(s).

It is feasible a vast amount of providers (and users) may be signed up to and/or part of the platform/system, which is preferably fully scalable.

In Use

An example will now be provided with reference to just one embodiment, in no way limiting scope of what is disclosed and what may be claimed. It will be obvious this is just an example alone. It will be obvious this example portrays a very narrow feature(s)/embodiment of what is disclosed in the present application. This the following example is described: In use, a user logs onto a website. Preferably they are signed up to the website which preferably includes an online marketplace and/or space for finding and/or locating and/or using providers to take on a project. This may include PDPs to develop a product/project. This may include PPs to help patent an invention(s). This may include PLFs for various functions, including, but not limited to, entering into licensing agreements with; investment; crowdfunding help. It is hoped the providers can be used to try to being a project to market, successfully (preferably financially successfully, although non-profit projects may also be helped/provided for/taken up by providers).

The user logs in and posts a job/project (and/or another party (eg staff member) does it for them), which preferably is a product they want developed, and may be an invention that is patentable. This may also be used to find a PLF (eg potential licensee/investor, crowdfunding specialist). However, preferably a PDP is sought before a PLF, which is preferably sought after later in the process. (As has been stated, it is feasible a provider may be both a PDP and PLF, and even may also be a PP (or any combination of type(s) of provider). Preferably all providers are signed up to secrecy agreements/confidentiality so that the user can disclose their idea (whether it is patentable or not) in the safe knowledge that their idea will not be stolen/developed/patented, for example, without their knowledge. It is also feasible that the provider of the website (and/or the platform/system) provides program(s) and information and the like to facilitate the user in getting patent-pending on the potentially patentable idea (if it is in fact potentially patentable), which program(s), information etc may be paid for (eg by the user), thus incurring a fee from the user. Such programs/information may not be paid for. It may be the user gets access to such program(s)/product(s)/information, by becoming a member and/or paid user of the platform/system.

Preferably the user (and/or a staff member) clicks a ‘post a project’ or the like button and is taken to a preferably form-type webpage where they can post information about their/the/a project, which may include a description, a facility to upload files, documents, videos, etc, thus communicating their invention and/or product and/or concept and/or project. Preferably their project can be given a title and/or name, and add added information, which may be facilitated via drop down menus and the like, which may, for example, include fields of the invention/project/product(s), etc, which may feasibly help attract relevant providers who have particular experience and/or expertise in the field of the invention, product, etc.

Provider(s) preferably register and/or are signed up to the platform/system. They may be invited (eg by the facilitator/owner of the platform system, and/or by the platform/system). The Platform/system may comprise a means for potential providers to sign up and/or join. Put broadly, the platform/system/method may comprise receiving a request from a provider to be allowed to provide and/or take up projects on the platform/system/method. Preferably previous success rate details are received by the platform/system and are preferably stored and logged in a fluid manner, so that they can be changed/updated if success rates of the provider changes. It is feasible success rates of providers are not logged until they begin to take up projects and the like via the platform/system, in which case/at which point they are preferably stored and monitored. Preferably the platform/system is configured so that the success rate information (which could also, feasibly, be any element/number/indicator/data/information that denotes previous success and need not be a success ‘rate’ although a percentage success rate is preferred) is denoted/relayed to users (and feasibly others) when the profile of the provider is viewable/viewed on the website. Preferably it is also showed/displayed/relayed to a user when the/a provider makes a bid/offer on a user's project.

The project and/or project posting is received by the platform/system and is relayed to potential providers. Preferably the system is optimised so that providers who have particularly defined skills in the field(s) of the project posted are targeted by the system, the project relayed to the said targeted providers. Similarly, providers who clearly do not provide services in the field of the invention/product and the like may not receive an alert/have the project and/or project posting relayed to them. Thus it is extremely feasible that such skills/expertise details and information of the provider are also logged and stored by the platform/system, (which has been discussed), which may also be viewable on the profile of the provider, viewable, for example, by a user.

The projects may also be provided for viewing by providers on a project listings section of the website (as previously shown by way of example and described), so that a provider can log in and go to the project listings section, which may be regularly updated showing projects the provider can view so that they may, if so desired, place a bid/offer for the project. The platform/system may not be limited to ‘product’ projects, and may, for example, be used for entrepreneurial pursuits, charity projects, and the like. (This has been mentioned/discussed).

The provider is preferably allowed and/or facilitated in making an offer for the project, which offer is received by the platform/system and preferably relayed (preferably securely) to the user, who can preferably view the offers. Preferably, (and this may be particularly useful for inventions, as the invention development/promotion industry has such low success rates at generating profit for inventors), a previous success rate of the provider in terms of how many of the projects they've taken up have attained/reached a success threshold (eg providing profit for the inventor/user) (and the like) is shown (preferably clearly and explicitly), preferably with the bid. Preferably the success rate information is immediately viewable by the user. It may, however, require that the user takes action (eg views a provider's profile) in order to get success rate information.

The user is preferably allowed to choose which provider they want to hire and/or use for their project (eg which PDP to choose to develop their project/product). It is feasible money may not exchange between the user and provider, however, in a preferred embodiment, a fee is demanded/bid by the/a provider for taking up the project (eg product development of the idea/concept, if the provider is a PDP). The platform system may have its own payment system preferably incorporated into/onto the website/platform so that payments are handled fluidly. The platform/system may use/allow traditional payment methods, (which has been discussed). Thus payments may be taken by credit card, PayPal, etc or any other payment method.

Webpages and systems may be set up to allow milestones to be set up for the job so the full amount is not paid up front by the user. Payments are preferably held in escrow by the facilitator/platform/system until projects and/or milestones are completed, at which time the payments are preferably sent and/or relayed to the provider. In such a case, a, for example, percentage (or any amount) of the payment may be paid to the facilitator/platform/system for facilitating the service. It is feasible that payments may be sent to the user via the platform/system, although it is preferred that users pay providers for taking up projects, rather than providers paying users to take up a project. Nevertheless, it is feasible, for a particularly desirable project, which is deemed to be potentially highly marketable/successful by the provider, that the provider may offer to take up the project free, or that the provider may even offer to pay money to take up/‘win’ the project. It is also feasible that a bidding and/or bidding war system may be provided via the platform/system for such a situation, whereby providers (of any type-eg PDPs', PLFs/PLPs, etc) may be able to take part in a bidding war, similar to an auction, to win the/a project. In such a scenario, it may be that/preferably a portion of the accepted amount is paid to the facilitator of the service and/or platform/system. Thus it is feasible a user may benefit financially and/or gain contract(s) by disclosing their project via the present platform/system.

Various programs and services may be offered to the user, which may be marketed and/or displayed on the website/platform/system. It is feasible many of the aforementioned actions may be carried out via an App. The whole platform/system (and/or a portion of the platform/system) may be provided and/or usable via an App.

Referring to FIG. 62 and FIG. 63, almost the same is shown as what is shown in FIGS. 53 and 54. However, this time, the success rate is shown perhaps even more clearly, and this time not by way of a virtual badge. One can see the success rate of 18% shown for a provider/team called U.S. invent, and a success rate of 40% shown for the team/provider SHIINE® DESIGN. It can be seen how clear the success rates are shown here, and how easy it is for a user to see them. The top three providers have not been given a success rate yet, for a variety of possible reasons, as has been discussed (eg not enough projects completed and/or take up yet, and/or not any projects that have attained a success threshold yet).

SHIINE® DESIGN has been mentioned as being an in-house team/provider of the platform/system. In a preferred embodiment, SHIINE® DESIGN comprises both the director of the company/platform/system that provides the method/system, who happens to be a PP and product designer, and also comprises a further professional product designer, who is preferably also skilled at CAD, prototyping, made-for-manufacture, etc. Thus this team/provider has (or may have) the ability to take the/a product(s)/project all the way to manufacture, if required. This team/provider may also comprise a professional patent searcher. Similarly, other teams/providers may comprise a professional patent searcher and/or PP. SHIINE® DESIGN may also even team up with and/or be affiliated with and/or comprise a PLF crowdfunding specialist. Thus it may be able to take a project/product(s) all the way to being successfully prototyped and crowdfunded. Thus it can be seen that complex teams can be put together and/or provide, on/via the platform/system. It is feasible other teams/providers have multiple/a plurality of people/providers in different parts of the process. It is feasible other providers/teams may be able to take a project/product(s) to market (eg by crowdfunding or self-release, or any other way) all by themselves. This may not be required, however.

In the example, the other teams/providers (Shiny Days, Heaven Scent, Glory Studio, and U.S. Invent) are not in-house teams/providers of SHIINE® (the owner/facilitator/company behind/in charge of the platform/system/method). For example, these providers/teams may comprise people/providers that have been invited by the Director of SHIINE® and/or the owner/facilitator/provider of the platform/system, to provide on the platform/system. Preferably only extremely high quality providers are invited. It is also possible they have applied to provide on the platform/system. This may have been done by contacting the owner/facilitator/provider of the platform/system and or the platform/system in any way. (eg phone call, online application form, etc etc. These applications may then be screen, so that only providers of a good and/or extremely high quality are allowed to provide on the platform/system.

Referring back to SHIINE® DESIGN, it is possible the further professional product designer mentioned may even provide, on the platform/system, by himself. He/she has the ability, all by himself, to design an idea into a product, and execute prototype(s). Thus he may be a PDP on the platform/system all by himself. Thus it is possible he could both be part of a team provider on the platform/system, and also provide as an individual provider on the platform/system. This may be allowed. However, it may be not allowed for a provider (such as this provider mentioned) to be in two separate ‘team’ providers. Thus being a provider in a team, and also being a separate provider may be allowed. But being a provider in two different teams may not be allowed. (Although it is feasible this may also be allowed and may happen)

If providers from different modules (eg a PP, PDP and/or PLF/PLP, or any permutation between different types of providers, even if the providers are in the same type/module, but perform different duties/work (eg a PLF crowdfunding specialist and PLF investor, for example, or any providers, even of the same type, which carry out same/similar duties/work) together for a team, and provide and/or bid and/or offer and/r take up project(s) as a team, they may be adjudged under/given one success rate, for the whole team, and/or may be adjudged separately and/or have separate success rates. It is feasible they/any provider may have a a plurality of success rates (eg a success rate when they are providing as part of a team(s), wherein the team(s), for example, have a success rate, and the provider also having a success rate when the provider separately as a provider and/or as part of a separate team). Thus, for example, taken by way of example, a team with a provider(s) may be deemed to be a provider, and may have a success rate, and a provider of that team may themselves be a provider and have a different success rate. It is even feasible that, even when providing as part of a team, the/a provider may be assessed and/or monitored (in terms of success rate) as a separate entity/provider, rather than (and/or rather than just as) a/the team. This may be the case for provider(s) that are an individual, and/or may also be the case for provider(s) that are more than one person.

It is feasible the in-house team (which is here called SHIINE® DESIGN), may be able to draft in many or all providers and/or individual provider(s) into their team.

Each team may be able to carry out any or all of the set step(s) of the platform/system/method (if the platform comprises a sequence/system of step(s)). This may even be required of every or some team(s).

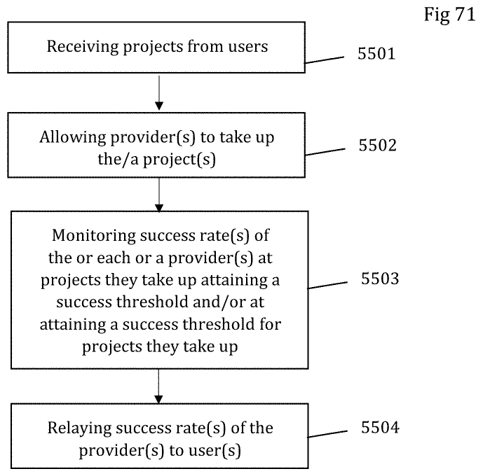

Referring to FIG. 71, there is shown a basic flowchart showing steps of a success rate system/concept. In step 5501, project(s) are received from a user(s). In step 5502, provider(s) are allowed to take up the project(s). This may, or may not, include a bidding/offering system. The project(s) may be relayed and/or made accessible to the provider(s) in any way, not limited to a bidding/system or a complex disclosure system/structure. For example, the/a provider may simply be ‘told’ about the/a project (eg via email, or call, or any way). These are just given by way of example only.

In the example, success rates of provider(s) are monitored (step 5503). In the example, success rate(s) of provider(s) are relayed to user(s).

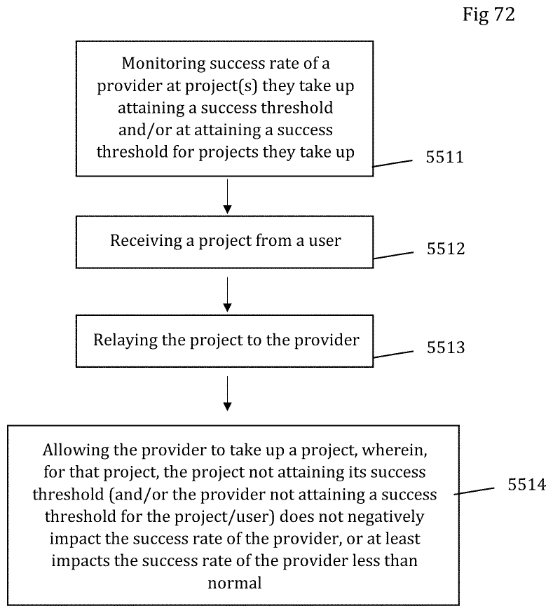

In FIG. 72, another basic flowchart is shown, denoting a way of looking at and/or defining an embodiment of a success rate system/concept. In FIG. 72, in step 5511, success rate(s) of a provider(s) is monitored. In step 5512, a project is received from a user (eg by/via the platform/system, or in any way—eg as simple as a user telling a member of staff of the/a platform/system about the project). In more complex embodiments, the project (as previously stated and/or shown and/or described, may be posted onto an online system and/or inputted in any way). In step 5513, the project is relayed to the/a provider(s). (This may be done in any way. Some embodiments of how to do this/how this may be done have been disclosed and/or discussed). In step 5514, what has been described as the ‘green card’ concept is mentioned, a concept whereby a provider is allowed to take up a project, preferably where if the project does not attain its/a success threshold (and/or the provider does not attain the/a success threshold for the project/user (which success threshold preferably is the user at least making back, or making more money than the or any amount the user has spent on the provider and/or on provider(s) used on the platform/system)), the success rate of the provider is not negatively impacted (and/or at least is not negatively impacted as much as it normally would be if the project/provider/user does not reach/attain the/a success threshold.

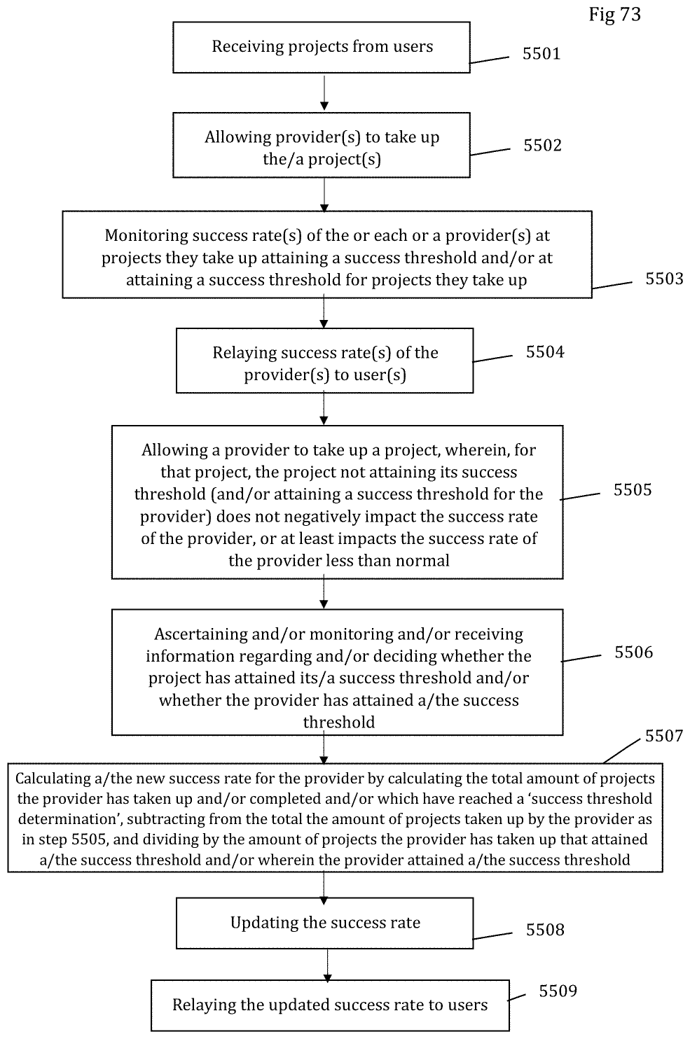

In FIG. 73, a flowchart that starts similarly/the same to FIG. 71 is shown. However, is shows five more steps, shown by way of example only and/or preferably, and generally showing step(s) which may be taken as regards to calculating and/or updating a success rate of a provider(s), with regard to (and/or taking into account) time(s) when the provider has used a ‘green card’ on a project. Thus, the flowchart, shown by way of example only, in step 5505 mentions the concept of the/a provider being able to take up a project where the project, if unsuccessful, does not negatively affect their success rate as an unsuccessful project normally would. In step 5506, the flowchart hints at the platform/system, for example, in some way learning/finding out/knowing whether or not the project has been a success/attained a success threshold or not. In step 5507 (preferably carried out by software, but could, feasibly, be done by and/or in conjunction with man/human/staff, etc) a new success rate for the provider is calculated, preferably by taking the total amount of projects the provider has taken up and/or completed, then subtracting from that total the number of projects the provider has taken up and/or completed and/or which have reached a time threshold and/or threshold for determination as to whether they have attained success and/or a success threshold or not wherein the provider used the ‘green card’ function/option (as it has been described and/or referred to as). Then dividing this new total by the number of projects the provider has taken up that have successfully attained their/a success threshold.

(Note: as stated here, there may (or may not) be a time threshold and/or threshold of any type for determination as to whether they/a project have/has attained success and/or a success threshold or not. (This may be called/referred to as a ‘success determination threshold’ and/or a ‘success determination threshold point’, for example). This goes for any project and/or embodiment).

As an example of this calculation, if a provider has taken up and/or completed and/or got to a ‘success determination threshold’ for 46 projects, and 3 of the projects were projects where the provider took this ‘green card’ type option, and 2 of those ‘green card’ type option projects failed to get to a/the success threshold, and one of them did (attain a/the success threshold) and 14 projects the provider has taken up and/or completed and/or reached to a ‘success determination threshold’ on have attained/reached the/a success threshold. Then preferably, (in what is roughly denoted as step 5507 in FIG. 73, the success rate of the provider would be calculated by taking the total projects—ie 46; subtracting the projects that failed, where the provider used the ‘green card’ type option—subtracting 2; (thus the new total would be forty-six minus two, which would be forty four; and dividing that total (ie forty four) by the amount of projects the provider had taken up that attained their/a success threshold (ie fourteen). Therefore, in this/that example of how calculation and/or how success rates may be done/calculated/considered with regard to the ‘green card’ (and/or immunisation of the provider from negative impact (or standard/regular negative impact) on success rate(s), (and this is just one example, as obvious in view of previous disclosure), the success rate of the provider would be fourteen out of forty-four, which is preferably calculated and/or relayed as a percentage, and thus preferably is calculated and/or relayed as 32% (rounded to the nearest percentage point). In step 5508, thus the success rate of the provider is thus preferably updated to this new percentage (even though it may stay the same percentage, if rounded up/down, for example). In step 5509, preferably the updated/new success rate is relayed to users. (This has been described in detail previously). Thus the new percentage may be relayed/shown to user(s) when the provider bids/makes an offer on new project(s), etc, and/or may be relayed/shown/provided at any other point.

(It is feasible success rate(s) of provider(s) may not be shown/provided to user(s), and may, for example, simply be stored (preferably on the platform/system)).

As stated previously, the method may comprise allotting an amount(s) of ‘green cards’ to a provider(s). (ie giving them the option the user this ‘green card’ type option on a project(s) they take up. As stated, the provider(s) may be given an amount/limit of ‘green card(s)’ for a certain amount of projects—eg only one green card per six projects taken up, for example. (This is just an example, in no way limiting any aspect of this concept). The provider may be given and/or allotted (as previously mentioned) a ‘green card(s)’ for passing and/or attaining/reaching a milestone and/or threshold. An example of this would be for attaining a success threshold on a certain amount of projects—eg provider gets a further green card once five projects they have taken up attain their/a success threshold (or any amount/threshold). This has been discussed previously. It has also been mentioned that such an option/a ‘green card(s)’ may be given to a provider(s) as a result of an achievement. An example of an achievement would be, for example, having a good/high rating(s)/review(s)/feedback(s) from users, for example. Another example may be having an extremely high success rate, and/or providing on the platform for a threshold amount of time (eg 3 years, or any other threshold time). Another example might be providing for a threshold amount of projects (eg taking up and/or completing and/or reaching a success threshold determination point for 100 projects, for example, (or any other threshold amount). (Some of the examples given here may be/may be described as/are both or any of: achievement(s), and/or milestone(s) reached, and/or threshold(s) reached and/or attained, by the provider).

A user may even be rewarded by having their project made a universal green card project, where it acts as a green card for all providers (without the provider(s)) having to use their (or have any) green card(s). This may make the project extremely/more attractive to providers, as it will either not in any way impact their success rate if the project is not a success/does not attain its/a success threshold, or at least will impact their success rate less.

The method and/or platform and/or system may (comprise) monitor(ing) and/or stor(ing) and/or relay(ing) and/or display(ing) success rate(s) of providers and/or users. Success rate data of user(s) in terms of how many of their project(s) attain a success threshold may be stored and/or monitored and/or relayed (eg to other users and/or providers and/or any party). Success rates of user(s), in this way, may potentially be useful for provider(s) to know, as it may indicate how good and/or profitable and/or successful the user's projects tend to be. The highest success rate providers and/or users may be displayed and/or relayed and/or monitored and/or stored. Thus, it is feasible, the system/platform may display who are the ‘best’ provider(s) (eg by showing the ‘top 3’ (or any amount) provider(s), in terms of success rate, and/or in terms of and/or in combination with any other data/information. Similarly, the top/best user(s) may be displayed and/or relayed and/or monitored and/or stored. Thus the platform may display/reveal who is/are the highest success rate user(s), in terms of projects that have attained a/their success rate threshold. This or any information/data (not limited to user success rates, but also with regard to provider or any other party) may be made available and/or relayed/displayed to any or all provider(s) and/or user(s), and/or may feasibly be provided privately (eg only to the party (eg user/provider) in question). Success rate data of the or each user may be provided and/or relayed and/or made available and/or accessible to providers when a project of the user is made available (eg for bidding/offering). However, such information/data may be made available and/or relayed, feasibly, at any point. Such data may or may not be made available and/or stored and/or monitored.

(Success rate data/information of provider(s) and/or user(s) may be stored on the platform/system).

In flowcharts in the present application, wherever possible, steps are denoted chronologically. However, this is not, or may not, always be the case. Thus the flowchart(s) and/or step(s) of the flowcharts may not be shown/depicted in chronological order, and the/or any disclosure and/or steps is/are not limited to being provided/claimed in such order.

Referring generally to the success rate concept, the method/platform/system may further comprise, for example: allowing a provider to take up a project wherein if the project does not attain the success threshold, it does not negatively impact the provider's success rate (or at least does not negatively impact the provider's success rate as much as a failure of a project to attain its success threshold normally would), and preferably wherein if the project attains the success threshold, it positively affects the provider's success rate. (This has been described mostly with reference to the term ‘green card’). The method may further comprise: rewarding a provider for an achievement (eg for the provider reaching a threshold amount of projects they take on successfully attaining their success threshold) by giving the provider an (added) opportunity (eg by rewarding them with a green card(s)) to take up a project wherein if the project does not attain the success threshold, it does not negatively impact the provider's success rate, (or at least does not negatively impact the provider's success rate as much as a failure of a project to attain its success threshold normally would), and preferably wherein if the project attains the success threshold, it positively affects the provider's success rate.

The method may further comprise: allowing a user to use a search function to search for a provider, and preferably allowing the user to see/relaying the success rate of the or a provider(s) when found using the search function.

The method may further comprise: the project of the user being posted in a computer implemented method and/or the method being a computer implemented method.

The method may further comprise: allowing the user to post the project (or allowing/having a staff member to post and/or input the project).

The method may further comprise: allowing the bid or offer accepted by the user to be a shared bid or offer, from a plurality of providers.

The method may further comprise: relaying to the user the amount of projects the provider has taken up that attained a success threshold.

The method may further comprise: relaying to the user the amount of projects the provider has taken up.

The method may be a computer implemented method.

The method may further comprise: providing a system and/or sequence of steps for a user to complete. (It is thought it may be extremely unusual for a platform to comprise this, and also use/comprise the success rate concept.

The method may further comprise: forcing the user to complete the steps in a particular order.

The method may further comprise: converting the project of the user into a product. (eg by a PDP).

The method may further comprise: the product being manufactured and/or prototyped.

The method may further comprise: having different success thresholds for different types of provider and/or for different service provided.

As previously stated, if a provider (eg PDP for product development) is used, but then the user later uses a different provider (eg PDP for product development), and the project only attains its success threshold as a result of the second provider (and not as a result of what was provided by the first provider), then that project may/preferably is not counted as a ‘success’ for the first provider. Thus preferably a project is only chalked up/counted as a success for a provider, if it reaches/attains its success threshold as a result of what was provided by the provider. This may have to be assessed/decided (eg by the platform/system and/or owner/facilitator/provided of the platform/system). If success is attained ‘partially’ as a result of what was provided by the provider, this may, or may not, count as a ‘success’ for that provider. This may have to be assessed/decided. If it is decided the success threshold was not attained as a result of what was provided by the first provider, then that project may, in fact, be deemed to be a failure to attain the success threshold for the first (or previous) provider(s). If it is deemed what was provided by the first (or previous) provider(s) was partially responsible for the success threshold being attained, it is feasible that project may be deemed to be neither a ‘success’ nor a ‘failure’ for the first (or previous) provider(s), and it may thus neither negatively, nor positively, affect their success rate. It is feasible, for a project to count as a success, that it may have to be deemed that the success threshold was attained directly as a result of what was provided by the provider. (ie even if a project reaches/attains its success threshold, it is feasible/possible it may not be deemed a success for the/a provider. However, this may be rare).

The embodiments described above are provided by way of examples only, and various modifications will be apparent to persons skilled in the art without departing from the scope of the invention. The appended claims are not intended to limit the invention.

The appended claims define limited inventions. However, it should be recognized and understood that the disclosure of the present application includes a vast array of inventions, not limited to inventions set out in the appended claims and/or any statement(s) of invention.

For example, if the present disclosure of the present application (inclusive of drawing(s) and/or description) discloses features and/or steps a to z, it should be recognized and understood that any invention may be claimed, comprising any feature(s) and/or step(s) out of features a to z. Thus if the appended claim 1 defines the invention claimed as comprising essential features/steps a, b, and c, it should be understood that an invention may be claimed comprising solely feature/step a, or solely feature/step b, or solely feature/step c, or any combination of features/steps a, b, and c. Furthermore, it should be understood that an invention may be claimed comprising any of feature(s)/step(s) d to z, whether or not also comprising any of features/steps a, b, or c.

A final claim is appended which serves to signify that I reserve the right to claim any invention, comprising any feature/step, or combination of features/steps, disclosed in the present application (inclusive of drawing(s) and/or description). This statement (and/or final appended claim), if so desired, should be seen as a statement of invention, stating any invention, comprising any feature(s)/step(s) disclosed in the present application. It is intended (or plausible) that such invention(s) may be claimed in a future application(s) which claims benefit of priority of the present application. The present disclosure of the present application supports such invention(s)/claim(s).

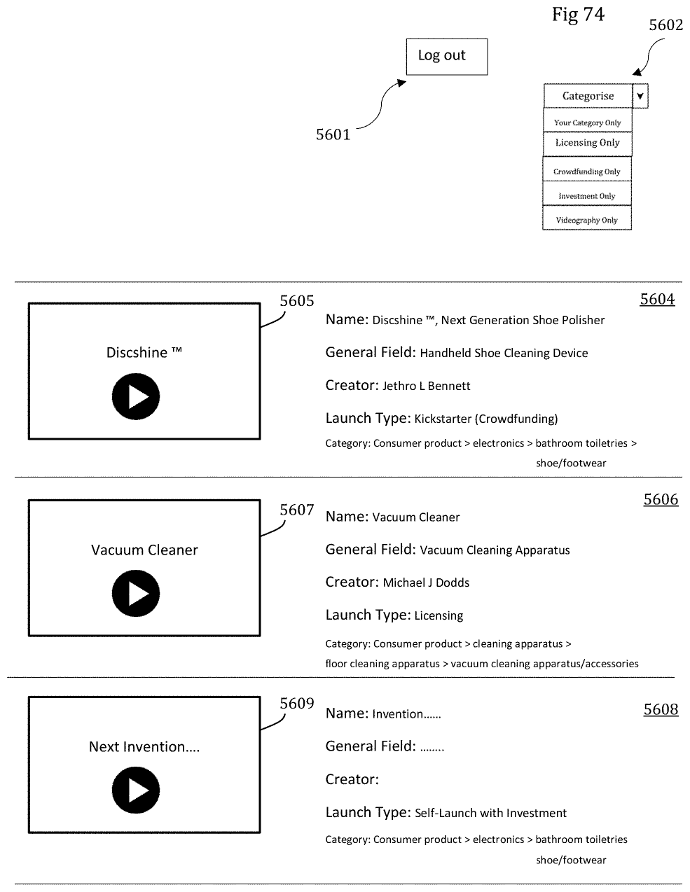

Referring to FIG. 74, there is shown a basic (and partially representative) example of a possible interface for a PLF. Whilst the example of FIG. 57, for example, (although it could be used to attract and/or attain any provider(s)/type(s) of provider(s)) may be used/provided, for example, to attain PDPs (or any provider) fairly early on in the process and/or development of a project (although it could be used at any point of development), the example interface of FIG. 74 may be particularly useful for trying to attain a PLF(s)/PLP(s), such as an investor(s), licensee party(s), and/or even a crowdfunding specialist(s), for example.

In the example, for example, a PLF may have an account (preferably password protected). The example of FIG. 74 shows the PLF (or any provider) signed in, and shows part of what may be a webpage and/or interface. There is shown a ‘log out’ button/option 5601. There are shown several (although there may be any number) of tabs. In each of the tabs, there is shown a video and/or video link and/or thumbnail. In the example, in tab 5604, there is shown a video thumbnail 5605. Preferably each disclosure comprises a video disclosure, although it is feasible any information may be disclosed, not limited to video.

An interface such as this may be particularly useful for what was discussed and/or disclosed with reference, for example, to FIGS. 23 to 25, and the ‘trailer video’ concept, (though not limited to that). Thus these videos may be ‘trailer videos’ (or any video) of the project and/or prototype of the product(s)/project. In an example such as that shown in FIG. 22, for example, these videos may show the (preferably advanced) prototype as executed and/or provided in step 6 of the example embodiment of FIG. 22. (Feasibly, the video(s) may be of a less advanced prototype, rather than an advanced one). Preferably the, or some of the, or most of the, video(s) shown an advanced prototype of a/the project/(product(s)/invention(s), in action. (This has been discussed, especially, but not limited to, with respect to the ‘trailer video’ concept).

In the example, video 5605 is for a project/product(s)/invention called ‘Discshine’. More information about the project is shown/provided in tab 5604, including, in the example, the fact that Discshine is a ‘next generation shoe polisher’. There is provided the/a general field of the project as being ‘handheld shoe cleaning device. The creator/user is provided as being ‘Jethro Bennett’. And the launch route that the user has chosen and/or prefers, and/or the preferred and/or chosen launch route of the project is shown as being crowdfunding. Therefore this is a project that the user/creator wants to release themselves, via crowdfunding. As previously stated, it is possible a user may choose more than one launch route/method (eg both crowdfunding and licensing, for example).

The ‘tab’ concept is shown by way of example only, and ‘tabs’ need not be provided in order to provider such/any information.

The category and/or sub-category of the project is shown. In the example of the Discshine project, it is shown as ‘Consumer product>electronics>bathroom toiletries>shoe/footwear’. This is shown by way of example only, and may or may not be shown. Nevertheless, this is the type of categorization which may, for example, be used by the/a platform/system, in order to try to ‘match’ the project with the most apt/applicable provider(s), (who may also be tagged and/or categorized). This has been discussed.

If/when the provider/PLF clicks the video thumbnail/image 5605, preferably it plays the video of the project, or more preferably takes them to another webpage (or creates something like a lightbox) and plays the video, which is preferably a trailer video.

There is shown a second disclosure/project 5607. This one is for a vacuum cleaner. Further information provided for this example reveals that the project is a vacuum cleaning apparatus; that the user/creator (and/or inventor, for example) is Michael J Dodds; that the launch choice/route/method (and/or preferred launch choice/route/method) is licensing. The category for this project is also shown.

(All of the examples shown are under ‘consumer product’, so it might be that the PLF/PLP that is viewing this page is a PLF with particularly specialisation and/or interest is facilitating and/or helping launch for product(s) that are consumer products. Thus the interface (or any interface) may be optimize and/or personalized for the PLF/provider, so that projects that are ‘matched’ to them are prioritized in terms of what is shown on their interface and/or what projects are relayed to them, and/or so that only projects matched to them are relayed to them.

The third video/disclosure and/or tab shows a video/project. The details for this project are now shown. This is just for the sake of representing that there may be many such projects of many types disclosed, and the drawing (FIG. 74) is simply shown by way of example only. For example, there may be literally hundreds of projects (eg over many webpages). The third example does show, by way of example only, that a user/project may be launched via the route of self-launch with investment. Thus the user/creator of/for that project may be looking for an investor(s) to invest in the project/business. For example, a wealthy entrepreneur PLF may be able to invest in the project/product(s)/idea/concept/business, perhaps giving money, for a share of the business and/or project (and/or business generated by the project).

Thus several examples are here shown, of video disclosures and/or interface for video disclosure(s), which may be provided for a PLF (or any provider) of the platform/system.

There is shown a drop-down 5602, which, in the example, has been clicked. This may be a way that the/a PLF/provider can optimize/change what projects are shown in/on the interface. There is shown an options for ‘Your category only’. If the PLF/provider selects this, this may only show projects that are being launched in their launch field (eg if they are a potential licensee PLF, it may alter/update and/or change the disclosure(s)/interface, to only show projects that have chosen an option to launch vide licensing (or an option to launch vide licensing+any other option), and/or wherein the project is in their field/categorization. (ie their field of skill and/or interest). (Of course, this option may be the default for the interface in any case).

There is shown an option for ‘licensing only’. If clicked/selected, this may alter/update/change the projects on the interface, to only shown projects where the project route includes possibility for licensing (and/or is only for licensing). Even if the PLF using the interface is not a licensee PLF/PLP, by clicking/selecting this option, it may show such projects.

There is shown an option for ‘crowdfunding only’. If clicked/selected, this may alter/update/change the projects on the interface, to only shown projects where the project route includes possibility for crowdfunding (and/or is only for crowdfunding). Even if the PLF using the interface is not a crowdfunding PLF/PLP, by clicking/selecting this option, it may show such projects.

(If projects are on the interface, looking for a crowdfunding specialist PLF/PLP, as stated, the crowdfunding specialist PLF/PLP may take up the project and may make a more professional video (preferably as part of or as a main crowdfunding campaign video and/or may be able to create and/or manage a crowdfunding campaign (partially or wholly/fully) for the project. (It is also feasible such provider(s) may be able to make a better video and/or disclosure for the project, and that the better video and/or disclosure may be usable by the user to find/get/present to a potential licensee, and/or any PLF/PLP.

There is shown an option for ‘investment only’. If clicked/selected, this may alter/update/change the projects on the interface, to only shown projects where the project route includes investment (and/or is only for investment—ie seeking an investor(s)). Even if the PLF using the interface is not an investor PLF/PLP, by clicking/selecting this option, it may show such projects.

There is shown an option for ‘videographer only’. If clicked/selected, this may alter/update/change the projects on the interface, to only shown projects where the project route includes possibility for videography providing (and/or is only for videography). Even if the PLF using the interface is nota videographer PLF/PLP, by clicking/selecting this option, it may show such projects. These types of provider(s) may be able to make better quality video(s)/trailer video(s) for a project/user. This option/type of provider may or may not be provided—it may be that the videographer type/option is part of the crowdfunding provider type, and/or vice versa. Thus there may be only one provider type for videography, rather than both ‘videography’ and also a separate type of ‘crowdfunding’.

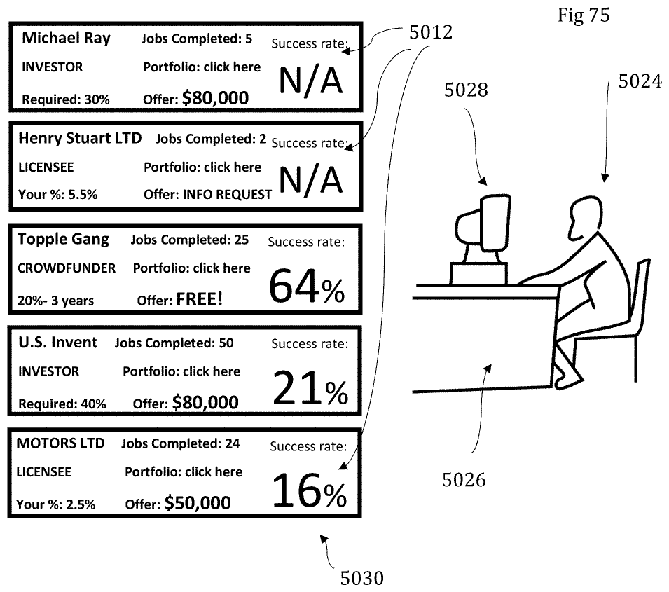

Referring to FIG. 75, there is shown a situation/representation similar to FIG. 53. However, what is shown now is/are offer(s) more relevant to ‘launch’, and what may happen, for example, at a more advanced level of the process (although it may be provided at any point of the process). What is shown may be, for example, offer(s) from provider(s), relayed to the/a user 5024. Again, a representation is shown (same as FIG. 75), to denote, (by way of example only), that the user may have signed into their account, and may view these offer(s), for example, on a computer and/or electronic device, for example. (Such as a computer, laptop, tablet, smartphone, etc).

What is shown in FIG. 75 may, for example, be offers received from PLFs/PLPs, who have made offer(s) in response to the/a video disclosure(s) of a project, as shown, by way of example only, in FIG. 74. (However, such offer(s) may be received as a result of any disclosure).

The offers shown are from PLFs/PLPs. Again, in the example, their success rate (5012) is shown. There is shown an offer from an investor PLF, called Michael Ray. This may, for example, be an (affluent) entrepreneur investor, which may have achieved a significant amount of business success. Now he is able to provide investment/funding for project(s).

His offer is shown as $80,000. It may be that this (or any ‘target’ amount) has been pre-determined for the user's project. This may involve calculating a required total (and/or a target amount), based, for example, on manufacturing and/or any other cost(s) for the project/product(s). It may be, for example, that the target for this project is $80,000, and that the PLF investor Michael Ray is therefore offering the full amount. Or, for example, the target may be, for example, $160,000 (or any amount), which would mean the PLF investor here has offered half of the total.

In his bid, it states that he has required 30% of the business and/or project. Thus, if he gives $80,000, his initial offer and/or requirement is that, for that amount, he gets 30% of the business/project (and/or profit generated from the project).

It states he has completed 5 jobs/projects. His success rate is noted as N/A. This may, for example, mean that none of the projects he has taken up have reached/attained a success threshold yet. If he continues not to get success with any of his projects, the platform/system may allow for him to complete, for example, eight, or ten projects, for example, (and/or take them to a success determination threshold’), before marking his success rate as ‘zero’. If his success rate continues to be very small (and/or too low), he may be prevented from being allowed to provide on the platform/system. He may be prevented from being able to take up projects and/or may have his account suspended and/or deleted, for example.

(All the offers seen may be, for example, viewable by the user 5024, on their computer screen, inside their account, (or in any other way/place).

There is seen another bid/offer from a PLF/PLP provider, who is noted as being a potential licensee, and is a company, called Henry Stuart LTD. They have not offered an amount—they have put in an ‘info request’. This may, for example, be a situation where the provider feels they need more information about the project, or any aspect about the project, before they feel they can make a complete offer (eg a financial offer). Such an offer (requesting more info) may be accompanied by a message from the provider, asking for the information they want and/or require. If they feel content with the information that is then provided (eg by the user), they may then adjust/alter their bid, to offer a financial amount and/or agreement. This, or any other communications, may be opened up with the user, to provide the requested information and/or reach an agreement. A messaging system may be provided and/or be part of the platform/system, to facilitate communication between the user and provider(s).

The success rate of Henry Stuart is shown as N/A. This may, for example, be because neither of the two projects they/he has taken up have attained a success threshold. If this is the case, it is feasible the success rate may, however, be shown as 0%. Either are possible and/or may be provided.

Another bid/offer is shown from a PLF provider called Topple Gang. In the example, this is an outfit/provider that specialise in crowdfunding. (Thus it is stated they are a crowdfunder). In the example, they have offered to help crowdfund the project, for free. Thus, for example, they may take up the project (if chosen), and, for example, do any of: create (and/or help create) an advanced main crowdfunding campaign video; and/or create and/or manage a crowdfunding campaign (partially or fully) for the project. This may involve, for example, creating an even more advanced video/footage of the project/product(s) in action, as part of a crowdfunding campaign.

Their success rate is shown as 64%. They are stated as having completed 25 jobs/projects. Thus they may, for example, have taken up sixteen projects that have attained a success threshold, out of the twenty five. (However, it may well be that, for example, they've also used two green cards, eg on two projects that did not attain their/a success threshold).

Thus, if the user is interested in crowdfunding their project, this provider (and offer) would seem to be extremely attractive, and give the user a huge chance of successfully crowdfunding their project.

It is shown that this provider requires and/or gets and/or has offered/provided agreement details such that they get 20% (preferably of profit generated from the project/product(s)) for 3 years (preferably from the time the project/product(s) is launched and/or goes on sale and/or makes its first sale(s) and/or is successfully crowdfunded, in this example). This amount and/or agreement, as has been discussed, may be pre-determined, or it is feasible the provider may be able to decide (to some extent, or fully), what the amount/agreement is. (There may also be shown, for any of the provider(s)/offer(s)) how many projects the provider has taken up which have attained their/a success threshold. Thus, for provider Topple Gang, it may be shown that they have attained success for 16 projects. (This may be shown on the main offer information, and/or may be shown if the user views further information about the provider).

Topple Gang may be an individual. In the example, Topple Gang are preferably a group of people (and/or more than one person), who act as a group (and as one ‘provider’), to help crowdfund projects/product(s).

There is shown a further bid/offer from a provider called ‘U.S. Invent’, who are there listed as an investor. This may be an investment group, for example, and/or a group of investors, acting as one provider/PLF. They have completed fifty jobs/projects, and are shown having a success rate of 21%. They have offered $80,000. They require and/or get and/or have offered/bid that they get 40% of the project/business(es) and/or business created by the project.

There is shown a further bid/offer from a provider called MOTORS LTD. They are shown as being a potential licensee (ie a company the user may license their project(s)/product(s)/invention(s) to). They have offered to pay the user $50,000 in a lump sum payment to the user. They have also offered that, as part of the licensing deal, the user (who may be an individual, but may be more than one person, and may be any party, or any number of people) will get 2.5% of the sales and/or profit amount (or any agreement), once the project starts to sell and/or make money. It is shown that they have a 16% success rate.

The example given here is, in fact, fairly unlikely, in that so many different types of provider has put in offers. (eg investors, potential licensees, and a crowdfunding PLF). It may well be that, in many situations, it has been decided/determined (eg by the user) that the project will, for example be going for licensing, or crowdfunding. In a case where a user, for example, has chosen either licensing or investment (but that they do not want to crowdfund, because, for example, they may not want to start a business and sell the project/product(s) and/or manage the business and/or project themselves, then preferably their offers would be limited to only those providers of that type(s) they have chosen. However, it is feasible a user/project may allow for any or all types of providers, in which case, it is not impossible that offers from an array of different types of providers (such as that shown in FIG. 75), may occur and/or be received.

In the example, it may be that only $80,000 investment is required and/or asked for. However, in an example, for example, wherein $160,000 is required and/or asked for, it is possible that investor(s) may be able to ‘team up’ to meet the requirement(s) and/or invest together on a project. Thus, for example, investor Michael Ray, and investor U.S. Invent, may feasibly be able to ‘team up’ to make up the total $160,000. If such were the case, it would be likely the two investors would be asking for less percentage/share of the project/business, as they would only be offering 50% of the requirement and/or amount. Thus they may, for example, require approximately half (for example) of what they have required in their bids/offers shown in FIG. 75. In such situations (eg if an investor has offered half (or any fraction) of the amount and/or what is required, and where another investor has offered half (or any fraction) of the amount and/or what is required), then the or each investor may be alerted (eg by the system/platform), to tell them and/or make them aware that they may be able to team up with other investor(s), to make the target and/or required amount. The platform/system may allow for and/or facilitate communication between the investors in such a situation.

Similarly, a provider who has made a bid/offer (or ‘saved’ and or shown interest in the project) and/or any provider whether or not they have made a bid/offer and/or saved and/or shown any interest in the/a project) may be shown any bid(s)/offer(s) made on a project and/or alerted as to whether any bid(s)/offer(s) have been made. Thus any bid(s)/offer(s) for a project may be relayed to any other provider(s). Provider(s) who have ‘favourited’ and/or ‘saved’ the project (both of which are examples of a provider taking interest in a project (and using their account to show and/or denote this)) and providers who have themselves made a bid/offer may, or may not be told and/or made aware of and/or shown any other bid(s)/offer(s) for the project.

It is possible there may be an initial period (ie an amount of time) where providers are not told of (or not told the exact nature of) the other bid(s)/offer(s) made for the project. A time may then occur at which point some or any of the providers are told about the (or the nature of the) or any bid(s)/offer(s) made for the project. It is feasible the user may be able to reject offer(s). Thus they could ‘rule out’ some provider(s)/offer(s), by ruling them out and/or rejecting their bid. This could leave the bid(s)/offer(s) the user is interested in. It may be that only at that point do the provider(s) (who are in the group the user is interested in) are told about bid(s)/offer(s) from other providers. This may create competition, with the providers that are in with a chance of ‘winning’ (ie taking on) the project seeing what other provider(s) have offered. Not only could this lead to provider(s) improving their bid/offer (the platform/system/method thus further comprising, potentially, provider(s) to improve and/or adjust their bid(s)/offer(s)), it could also (/or) lead to provider(s) being able to team up to meet the or any requirements for the project. (eg two (or more) investors teaming up to make an investment amount/target/requirement for a project).

The user may be able to choose any of the top/best offers (the platform/system/method thus further comprising allowing this). The providers may then be told/informed of this, (the platform/system/method thus further comprising relaying this to the provider(s)). This may then lead to the providers being able to communicate with each other, and/or bid/offer against each other (eg improving their offer) and or team up with each other(s).

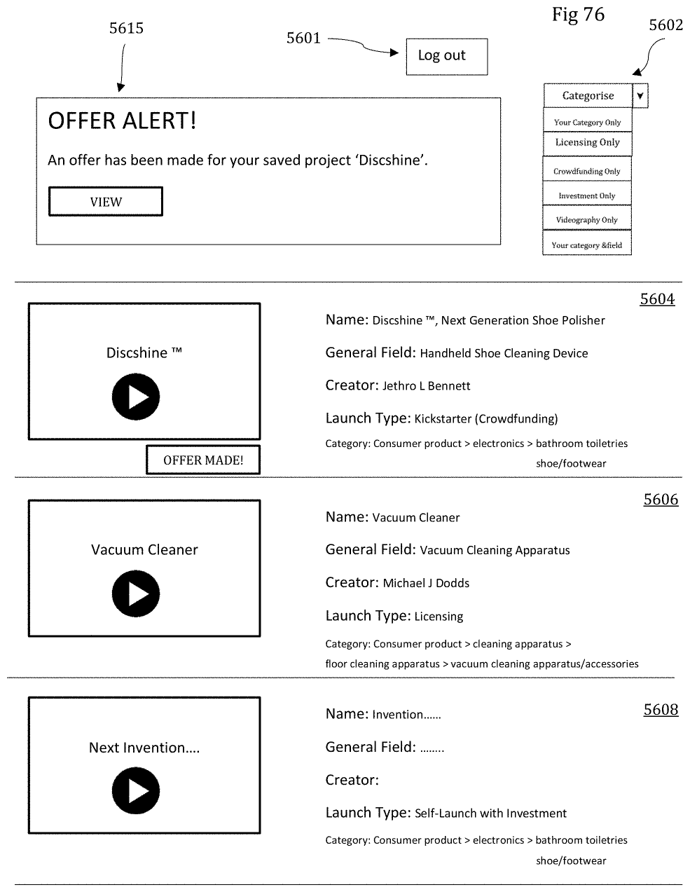

In FIG. 76, there is shown a very similar/same example (shown by way of example only) of a PLF/PLP (and/or any provider) interface. This time, an alert (5615) is shown. In the example, the provider/PLF provider had ‘saved’ and/or ‘favourited’ a project called Discshine (a next generation shoe polisher). Thus they had shown interest in the project. Thus they had altered their account (in a sense) by showing interest in the project, which interest/information their account had saved/stored. Now, an alert 5615 has appeared, relaying information to the provider that this project (which they had shown interest in) has received an offer/bid from a provider(s). It will be obvious that this may create interest from the provider who sees this alert because a) they had already shown interest in this project, and now b) a different provider has made an offer. Thus the provider seeing/receiving this alert may now be even more likely to make an offer/bid, eg in case they are concerned they may lose/not win the project. The example alert has a link (in the example, provided by way of a button stating ‘VIEW’) that allows the provider to go to see what the bid(s)/offer(s) are. They may then be allowed to make their own bid/offer.

The provider (eg in the example shown in FIG. 76) may have received an email notification (eg if their email is linked to their account), which may tell them about the or any bid (especially if made on a project they have shown interest in and/or made a bid/offer on).

(The amount of (and/or nature of any) bids/offers made on a project may be shown to any provider(s), whether they have shown interest in the project or not).

The fact that the alert in FIG. 76 is for a project (‘Discshine’) that was noted as being a project that had chosen ‘crowdfunding’ as its method/means of launch suggests that the provider who is signed into and/or using the interface of FIG. 76 is likely to be a PLF crowdfunding specialist/provider.

It is possible the platform/system/method may comprise allowing for/facilitating and/or provided a live bidding/offering function. In such an example, some or any PLFs (eg providers who have already bid/made an offer on a project) may be allowed and/or made able to join in in a live bid/offer function, where the providers are able to bid/offer and/or communicate live (eg with the user and/or other provider(s)). As stated, this may be particularly useful for use for provider(s) (eg PLF providers, or any type of providers) who have already made a bid/offer on/to take up a project. Thus, for example, if the user has isolated five PLF providers that they are potentially interested in using, a live bid may occur, where, for example, all the five bidders (eg from different locations) are able, for example, to sign in, for example, to their account, for example, to a secure communications interface (and/or use any interface, not limited to using the platform and/or system and/or their account—eg they might use phone call and/or conference call, for example). Then a live bid/offer session may occur and/or happen. This could lead to competition. This could lead to and/or include improved and/or altered bid(s)/offer(s) being made. Preferably an agreement is reached between the user and at least one provider (eg a PLF provider, but feasibly any provider—and this could be provided for any provider(s), including PDPs and/or PPs), and preferably a/the provider(s) take up the project. Thus live bidding/offering may be provided and/or may be facilitated and/or may be organized, as part of the/a method and/or system and/or platform. As stated, the live or any bidding/offering may occur via/on the/a platform, and/or may occur outside of the platform—eg via the user(s) and/or provider(s) meeting by phone, call, video, in person, or any other way.

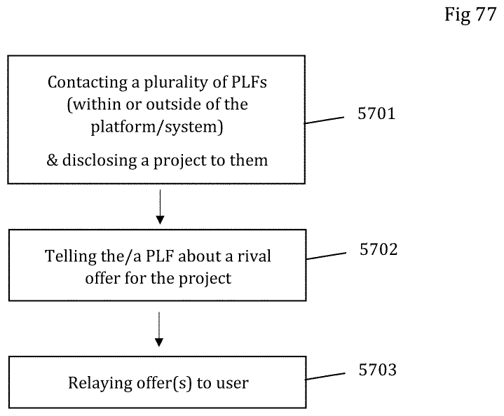

In FIG. 77, a basic flowchart shows an example of how a method may be used to help a user attain a PLF provider and/or attain the best possible PLF provider and/or provide the best possible deal, regarding attaining a PLF provider. This may be done partially or wholly outside of the platform/system, for example. For example, if a user wants to license their project/product(s)/invention, a staff member of the platform/system, for example, and/or a provider, or any party may contact a plurality of PLFs/PLPs (whether the PLFs/PLPs are part of the platform/system (ie with an account/presence etc), or whether they are simply contacted, outside of any system. Thus in 5501 (FIG. 77), a plurality of PLFs/PLPs are contacted. The/a project is disclosed to them. If any of the PLFs/PLPs makes an offer for the project, then the/a/any PLFs/PLPs may be told about the offer (5702) (which could be said to be a ‘rival’ offer, as it is from a different PLF/PLP—although, as said, PLFs may be able to ‘team up’—thus it is feasible PLF(s) may team up with any other offer(s)/PLF(s). If any offer(s) are made, the offer(s) are preferably relayed to the user (5703). This shows how such steps (and/or any steps disclosed and/or carried out with reference to the platform (and which may be disclosed with both user and provider having an ‘account’/presence within the or any platform/system) may, feasibly, be carried out outside of the platform/system and/or in a less computer implemented way. (And possibly simply by a staff member(s) of the platform/system). The method may use such step(s) instead of (and/or in combination with) any step(s) carried out via a computer implemented method/means/way.

Thus various embodiment(s)/method(s) are shown of how a project and/or disclosure and/or video disclosure of a project/product(s) may be relayed to and/or received by a PLF (or any provider). Thus various embodiment(s)/method(s) are shown of how a user may attain a provider(s), and/or how a user and provider(s) may be connected and/or form an agreement and/or relationship.

As stated, ay any point of the process and/or system, and/or method and/or platform, the method/system/process/platform may comprising working out and/or calculating, and/or providing manufacturing and/or tooling costs for a project(s)/product(s). This may be particularly useful when trying to help a user launch their project, either by attaining a licensee, and/or by attaining funding/investment (eg via crowdfunding, or via investor(s)). Working out and/or calculating, and/or providing manufacturing and/or tooling costs for a project(s)/product(s) may help work out a total and/or target amount that is required by a user/project. For example, it may help work out (and/or be) a target amount for how much investment and/or funding is required. This may be useful for a crowdfunding campaign, for example, to know what the/a target amount of the/a crowdfunding campaign should be (eg on Kickstarter or the like). The manufacturing costs for a project(s)/product(s) may or may not include cost(s) for an amount(s) of units of the product(s) to be manufactured and/or tooled. The amount calculated may be, or be part of, a target amount; for example, the manufacturing and/or tooling costs for a project(s)/product(s) may be the/a crowdfunding target amount to be funded, or may be ‘part’ of the target amount to be funded (which target amount may also include other cost(s).

Working out and/or calculating, and/or providing manufacturing and/or tooling costs for a project(s)/product(s) may be useful/important information for potential licensee PLFs. Thus these/such information and/or data may be provided (and may be relayed to potential licensee PLFs, or any PLF and/or provider). Working out and/or calculating, and/or providing manufacturing and/or tooling costs for a project(s)/product(s) may be useful/important information for potential investor PLFs. Thus these/such information and/or data may be provided (and may be relayed to potential investor PLFs, or any PLF and/or provider). It may also be important information in calculating and/or determining and/or providing what any investment total/target should be for a project/user. This may also be worked out and/or calculated, and/or provided.

Working out and/or calculating, and/or providing manufacturing and/or tooling costs for a project(s)/product(s) may be useful/important information for potential crowdfunding specialist PLFs; for example, this information might be important for them to know/ascertain/work out what the crowdfunding target amount should be for such a project and/or for them to consider what the crowdfunding target may be, and whether the crowdfunding target is, or may be, attainable. Thus these/such information and/or data may be provided (and may be relayed to potential crowdfunding specialist PLFs, or any PLF and/or provider).

Such information may be provided to any provider and/or any PLF provider.

As has been stated, a PDP may also be a PLF/PLP (eg may form/be a team/provider that can do both). If that is the case, and a user has attained a/the PDP to take up their project (and do product/project development work), then they may not need to have their project relayed to any potential PLFs/PLPs, as the provider who has/is providing PDP may be able to and/or have means to launch the project/product(s) themselves. In that case, examples shown for how a project may be disclosed to any PLFs may not, (or may), be required.

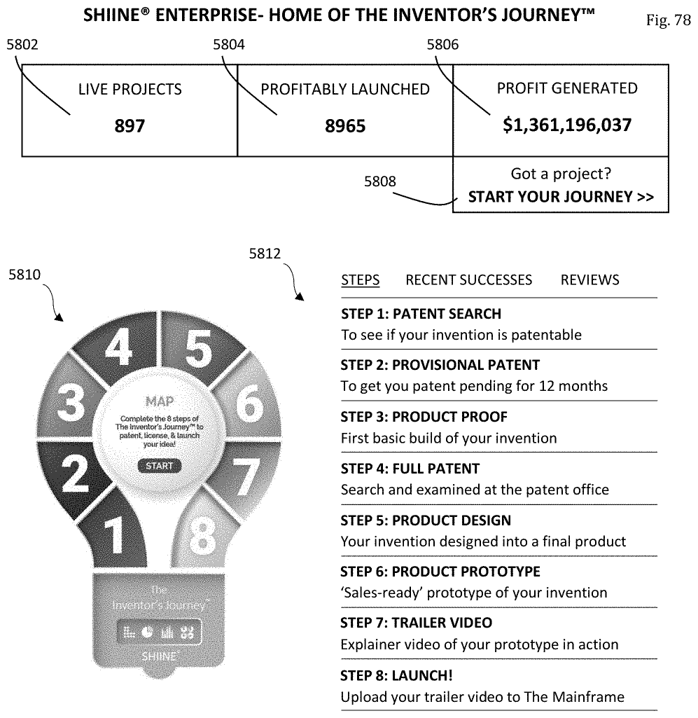

Referring to FIG. 78, there is shown an example of a portion or a whole of a possible webpage. The webpage provides/shows some information. The information shown includes information 5802 displaying the amount of ‘live projects’, (which is denoted in an example box, but may be shown/provided in any way, and which is shown as being 897, in the example). This means the amount of projects that are currently ongoing, using the system/platform. In an example where the project is an invention, for example, this may mean at least starting step 1 (preferably the patent search step)

The information shown includes information 5804 displaying the amount of ‘profitably launched’ projects. These, in the example, are projects/products that were launched, using the system, and made more money than the creator paid, using the platform/system, to get them to launch, (and/or ‘to use the platform/system’). In the example, it says 8965 projects have been profitably launched, using the platform/system.

The information shown includes information 5806 displaying the amount of ‘profit generated’ by projects. In the example, over one billion dollars profit has been generated, using the platform. (note, rather than displaying how much ‘profit’ is generated, it may be that simply the amount of money generated (not limited to profit) is shown, or both may be shown. (Obviously the total amount of money generated by projects being successfully launched will be more than profit generated, because profit is a net calculation, which includes taking into account costs, (which costs may include, for example, amount of money spent by the creator(s)/user(s), to launch the project, (and/or any further cost(s) to continue selling the product(s)/project, for example). Further costs may include business costs, for example, and/or any other business costs (or any other cost(s)). Thus similarly to how these are worked out on accounts done (eg by an accountant, for a business), these things/costs may come into the reckoning. (It is even feasible such cost data is taken from accounts made out (ie provided/done by) accountant(s), for example, for annual accounts work (or any other work done by accountants).

At 5808, there is shown a call to action and/or option for a user to start their journey (ie to start using (and/or apply to use) the system/platform, to move forward with their project. In the example, preferably this is a clickable/selectable link.

At the top of the example portion or whole of the webpage is some text (which may be the company providing the platform/system and/or may be the owner (and/or sponsor) of the platform/system, for example.

Below is shown an example graphic 5810 of the system/method, in the example, which, in the example, is a system of 8 steps. Next to the graphic, in the example, is a widget (shown by way of example only. On the widget, the ‘STEPS’ option is selected (and is therefore underlined, in the example), which therefore shows a brief summary of the steps of the platform/system, in the example. (This is clearly shown). However, if the ‘RECENT SUCCESSES’ option were selected, it may list/show, for example, projects which have been recently successfully launched, with a brief summary/breakdown of the project (eg name of the project/product, for example, and possibly further information relating to the successful launch). If the ‘REVIEWS’ option were selected, it may show review(s) of the platform/system by users of the platform/system, for example. This is just an example of some information which may be shown on a webpage. The example portion or whole webpage may be a homepage, for example (and/or any information on the example portion or whole webpage may be provided on a homepage or any webpage/place).

Regarding the information shown, (eg live projects, amount/profit generated, profitably launched projects) any or all of this information may be monitored and/or stored and/or relayed and/or shown by/on the platform/system. Furthermore, any of the following may be monitored and/or stored and/or relayed/shown:

number of projects (journeys) started; number of projects launched (whether successfully/profitably or not); number of projects launched successfully/profitably; percentage success rate(s) at projects being launched that generate a profit for the user(s)/creator(s), (the percentage may be with reference to total number of projects(/journeys) started, using the system/platform, or with reference to any other data/criteria, and may also be segmented into different segments—eg projects which are/include ‘invention(s)’ (ie include patenting service(s), and one which don't, and/or, for example, different types of projects—eg physical product(s) and/or business ideas and/or models, and/or software products/projects, etc, or any other segments); success rate(s) of any provider(s) and/or highest success rate provider(s); total sales (money) generated from all or any projects; total units sold for all or any projects; profit generated from any project and/or highest profit generating project(s) and/or product(s); profit generated by any creator(s) and/or highest profit total generated by any creator (over one or many or all projects the creator has created); profit and/or amount of money generated by any or all provider(s) and/or provider(s) who has generated the most money and/or profit (which may or may not include data relating to how much the provider has been paid for any work); profit and/or amount of money generated by any or all product development provider(s) and/or product development provider(s) who has generated the most money and/or profit (which may or may not include data relating to how much the provider has been paid for any work); profit and/or amount of money generated by any or all patenting provider(s) and/or patenting provider(s) who has generated the most money and/or profit (which may or may not include data relating to how much the provider has been paid for any work); profit and/or amount of money generated by any or all launch provider(s) and/or facilitator(s) and/or launch provider(s) and/or facilitator(s) who has generated the most money and/or profit (which may or may not include data relating to how much the provider has been paid for any work).

(It should be stated yet again that, whilst the creator may be an inventor and the project may be/include an invention(s), the project is not limited to being/including an invention(s), and the creator/user is not limited to being an inventor(s). The system may be used, for example, for any idea/project, which may not even include patenting work being provided/needed, for example.

It will be apparent from the nature of the disclosure in the present application that any or all of this information/data may be monitored and/or stored and/or relayed and/or shown, by/on the platform/system. Thus, for example, when a project is launched, all such information may be stored—and it may be known where each project is in the system—ie at what point/step and/or what step has been completed. Such information may be updated at any point, and may or may not include human (or any other) inputting of information into the platform/system. Thus, for example, if a project completes step 4, for example (or any point/step), that may be inputted into the system, (eg by a member of staff, or by any other person and/or in any other way). Thus this may be stored/known by the system/platform, (and may be shown/relayed). Thus, for example, the platform may (monitor and/or) store data that, in the example, out of the ‘live’ projects, 99 (or any number) are currently on step 1 (ie have started, but have not completed step 1 yet); 122 (or any number) are at the point where they have completed step 1, 111 (or any number) are at the point where they have completed step 2, 101 (or any number) are at the point where they have completed step 3, 90 (or any number) are at the point where they have completed step 4; 81 (or any number) are at the point where they have completed step 5; 79 (or any number) are at the point where they have completed step 6; 71 (or any number) are at the point where they have completed step 7, 210 (or any number) are at the point where they have are on step 8 (but have not successfully completed it), and (any number) are at the point where they have completed step 8 in such a way, for example, where they have made a connection (such as with a licensee, investor(s), retailer(s), etc, but have not made profit yet. (The example numbers given here are not intended to necessarily be accurate to the example, and are given by way of example only. What is being shown/suggested is that the platform/system may monitor and/or store data relating to what point/step the or any project(s) are on. As has been stated, this data may be updated/updatable. Any of this data (and any data mentioned) may be relayed to user(s) and/or may be shown. For example, whilst the example portion or whole webpage shows just some data, there may be an option for the user/viewer to be able to see more data. For example, they may be able to see what step all the projects are on. This may even be shown by showing the graphic (which in the example is an 8 step graphic, but may be any number of steps and/or any type of graphic), with a number at each step/point/part of the graphic, to show how many of the projects have completed each step and/or at what step/point any or all of the projects are on and/or what step (eg the most advanced step) the projects have completed).

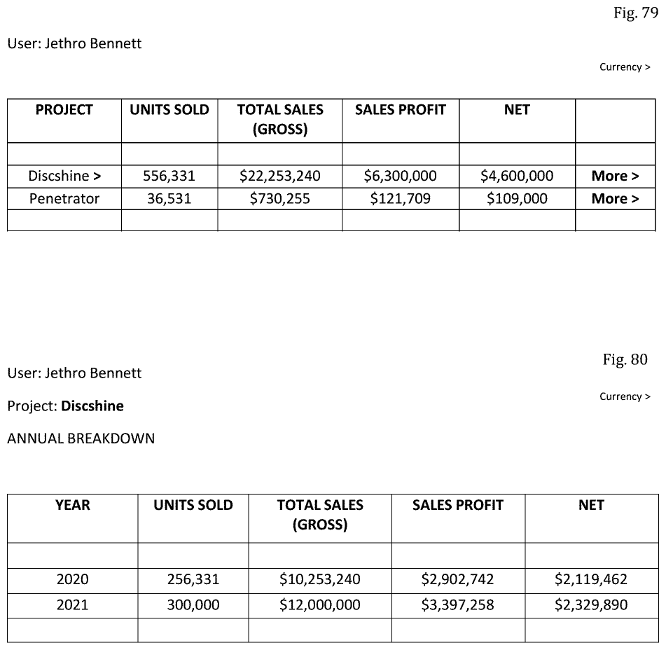

In FIG. 79, there is shown an example of an interface where a user/creator may be able to see how much money and/or profit (and/or any data relating to the project and/or launch and/or sales). (This may only be available/visible once they've signed in to their account). In the example, there is shown a name of a user at the top of the information shown (which is preferably shown on a webpage and/or via an app (application), etc. In the example, the user has two projects (which, in the example, are physical products, and, in the example, are (or may be) inventions. One, in the example, is called ‘Discshine’, (and may be a shoe cleaning device, for example). The other, in the example, is called ‘Penetrator’ (and may be an eyewear apparatus, for example). The user may be able to name their projects in this way. (It is feasible (and preferable that) they may be able to name their projects via their interface/account).

In the example, units sold data is shown. Discshine, for example, has sold 556,331 units. This may mean units sold at retail, or, may for example, mean units sold to a retailer (or any party(s)), for example—both or either (with reference to units sold, and/or any data relating to units sold) may be shown. Total sales is shown. This is preferably a financial amount, relating to how much money has been sold (and therefore purchased) at retail. However, again, this may relate to sales total from the user/creator, in terms of how much has been sold to a relevant party(s), (eg a retailer(s), or any other party(s)). A ‘Sales Profit’ is also shown. This is preferably the total sales, minus cost price of the product to get it to the relevant party(s) and or to get it to sale (and possibly other cost(s)). Thus whilst, in the example, ‘total sales’ amount does not take into account cost of making/manufacturing the product, (or any relevant cost(s), which may, or may not, include cost of making/manufacturing the product), the ‘sales profit’ amount, in the example, does take into account such costs. However, whilst, in the example, the user is perhaps not licensing the product/project, it is extremely possible many user(s)/creator(s) may license their product(s). Therefore relationship between sales figures etc, and how profit/sales/data is calculated (and/or what data is shown and/or how it is calculated) may be very different, in examples where the product(s) is licensed. A ‘NET’ total is also shown. This is preferably the sales profit, minus any further costs, eg staff costs, for example. Thus whilst ‘sales profit’ may be total sales amount, minus cost price of making/manufacturing the product (in some examples), ‘net’ may further include other cost(s). (As stated, if the product(s) is being licensed, then data shown (and nature of the data) may be different. In the examples, the user owns a company and is manufacturing the product(s) himself. However, with the example of ‘Penetrator’, the user may have a more simple model (perhaps due to the product being more simple), where they manufacture, and often deliver/ship to retailers. With less staff needed (and/or less complexity), there may be less overheads/costs, and thus there may be less difference between ‘sales profit’ (or any other data), and ‘net’ data.

There is shown a ‘currency’ link/option. The user may be able to change the currency in the data, by clicking/selecting/changing this. (eg changing from dollars to pounds). It's also possible, in the figures/data, that there may be still more data and/or segmentation. For example, user may be able to see data just for (sales in and/or to) America, (or any other territories), eg also data for UK, Europe, or any country and/or territory. Therefore user may have a very useful interface, and/or may be provided with very useful information/data, relating to success and/or sales of the project(s)/product(s).

There is shown another example, for another project/product, called ‘Penetrator’. In both cases, there is shown a link/option, which says ‘More>’, in the example. In FIG. 80, there is shown a basic example of what may be shown, when the ‘more>’ option is selected for Discshine. It can be seen, in the example, more data is shown for Discshine. In the example, breakdown/summary of year and/or annual data (which is preferably related to sales) is shown. Thus the breakdown for the year 2020 and 2021 is shown. (In accountancy terms, (or for any other reason(s)), the ‘year’ may not be from January 1^{st} to December 31^{st}—ie a ‘calendar’ year, and may be any annual figure—eg perhaps an accountancy year, which may start, for example, at any date). The user may also be able to see their accountancy figures for these years (or any year(s)/period(s), for example).

Accountancy service(s) may be offered and/or provided to the user. Thus the platform may include accountancy service(s). These may include doing ‘accounts’ for the user/creator and/or for any project(s) of any user/creator. This may include starting a company(s) for any user(s)/creator(s) and/or project(s). Thus there may be an accountant database(s), for example. It will be apparent that such services may be very useful, as part of the platform, for example. As stated, once accountancy work is done, it may be visible/viewable on the platform/system, for the user/creator.

Payment may be made by the user/creator, for accountancy work. The payment may be done via the platform/system and/or may be paid to the owner/proprietor/provider of the system/platform. Payment may then be relayed onto the accountant(s). (More generally, the term ‘accountancy provider’ may be used). Any method/system of payment may be used—whether payment is made directly from the user to the accountant(s), or indirectly, by paying the owner/proprietor/provider of the system/platform, with payment then relayed to the accountant(s, for example.

(However, the accountants may even be paid as a wage (eg by the owner/proprietor/provider of the system/platform). Any payment way (or no payment) may be undertaken/used/provided.

It may be that the owner/proprietor/provider of the system/platform helps with payment, or at least offers a good deal or discount to user(s)/creator(s). For example, (and taken by way of example only, there may be an agreement wherein the owner/proprietor/provider of the system/platform gets an amount if the/a project is successful and/or generates a profit and/or makes sale(s) and/or generates money. For example, the owner/proprietor/provider of the system/platform may get 5 percent of profit generated from the (or any) project that generates a profit using the platform/system, (and/or that uses the platform/system). There may be an agreement that, if the user/creator and/or project generates a certain amount (or reaches a ‘threshold’) of money and/or profit generated, (thereby making money for the owner/proprietor/provider of the system/platform, who, in this example, gets 5 percent of said money/profit) that the user/creator gets the or any accountancy work (eg annual accounts for the project(s)) at a discounted rate and/or free). Thus such agreement may be in place and/or offered. Thus the owner/proprietor/provider of the system/platform may help with accountancy (and/or any other) cost(s). Accountancy data may be received and/or stored on the platform/system. The platform may comprise/include a database of accountancy providers, and/or may facilitate and/or provide accountancy provider(s).

Thus it is feasible a holistic experience can be provided to the user. This can give the user a lot of useful and/or helpful information/data.

Furthermore, not limited to the user experience, (and relating to any data), it can be seen that a huge amount of possibilities become available, via the platform/system monitoring and/or storing and/or displaying data from the platform/system. (And it has been stated how data may be updated (ie updatable) on the platform/system). As stated, data may be updated and/or inputted into the platform/system in any way—eg manually by a party (eg a staff member). For example, if a project is confirmed as having generated a profit, the data that this is the case may be inputted by a member of staff, for example. This may then update the data on the platform/system so that, for example, success rate of the/a provider(s) on the project is updated (ie improves, in this example). Data relating to the user/creator may also therefore be updated, (eg a success rate they have of their projects generating profit), or any other data may update, once this data (ie that the project has generated a profit) is inputted. Thus the platform/system (and/or any software that underlies the platform/system) may be configured to be able to receive data, and update various information, as a result of the received data. In another example, new data may come into the system relating to how much profit and/or sales and/or money a project(s)/product(s) has made. Whether the project(s)/product(s) already had made money/profit/sales before, this preferably can be inputted into the system/platform, which then updates all relevant data/information on the platform/system. Thus this may update the data/information for how much money/profit that user/creator has made. It may also update data/information for how much money/profit relevant provider(s) who provided for that project(s) have made. Thus it can be seen that the platform/system may be configured so that data can be inputted, and the platform then alters all relevant data (not limited to the data provided), due to the data received. (‘Success rates’ would or could be one example of this).

In a preferred embodiment, (simply given by way of example, knowing that this in no way limits what is disclosed: preferably (in this one example embodiment), the owner/proprietor/provider of the system/platform gets five percent (or any amount) of the profit and/or money and/or sales generated for five years (or any time length) after launch of the/a project; a product development provider gets twenty percent (or any mount) of the profit and/or money and/or sales for three years (or any time length) after launch of the project; a patent provider (preferably of they attain ‘perfect’ patent protection of the product(s)/project, or any other requirement defined) get four and a half percent of the profit and/or money and/or sales generated for the duration of the patent(s), preferably after launch; preferably a crowdfunding specialist provider (which is an example of a PLF/PLP) gets fifteen percent (or any amount) of profit and/or sales and/or money generated for 18 month (or any amount of time) after launch.

Furthermore, agreement(s) may be related (eg relating to equity, or any financial agreement(s)) with an investor(s), (or any other PLF, eg a ‘dragon’). This is just an example, in no way limiting (the nature of) what is disclosed. (As stated, work of patent providers may be ‘assessed’, and this may lead to different judgment(s) as to what amount of money/sales/profit they should receive, for example. (Of course, it should once again be stated that not all of these types of provider may be needed for the or any project. The or any project is not limited to being/including an invention(s). Furthermore, very different types of projects may occur. Thus providers may be of very different types and or very different skills, and are not limited to the definitions/example types given. Any project is possible, of any type, and with any type(s) of provider, in any field, or any sort. Not at all limited to ‘inventions’, or standard ‘products’. The system/platform may be used for any type of project, of any type, under the Sun.

Furthermore, the platform may comprise a database of manufacturers. This may include factories, for example, (eg factories in China, or any other territory). It will be apparent that it may be in the interest of user(s)/creator(s) to be able to link with/use manufacturers, who can manufacture their product(s) and/or part(s) of their products, and that it will also be in the interest of manufacturers (eg factories) to manufacture for project(s). It is thus feasible the platform/system comprises a database of manufacturers and/or facilitates contact between the user(s)/creator(s) and manufacturers (and/or vice versa).

Thus the platform may include manufacturer(s) data.

It is also feasible data relating to manufacture (and/or manufacturer(s)) may be monitored and/or stored and/or displayed on the platform system. Thus, for example, on the user's user interface, it is possible data relating to manufacture (and/or manufacturer(s)) (of any given project(s)) may be monitored and/or stored and/or displayed. For example, the manufacturer(s) a user/project is suing may be stored. Cost price (and/or any cost data) from the manufacturer(s) (and/or of a product(s)/project) may be monitored and/or stored and/or displayed. In fact, it is feasible it may be required (by the manufacturer(s) and/or user) that such information/data in inputted and/or updated on the system/platform). Thus the platform may include highly holistic data coverage, (relating to the product/project experience).

The platform/system may also monitor and/or store and/or display money received by manufacturer(s). Thus the platform/system, feasibly, may store information (and/or ‘know’/be able to calculate) total amount of money received by any or all manufacturers on the platform/system, and/or for any give project(s). Thus the platform may know/store that, for example, $351,661,987 has been received (ie paid to) manufacturers. It will be apparent such a system may be attractive to manufacturers, to make money by manufacturing products (or parts of products) of any given project. Thus the platform/system many include manufacturers (and may include means to allow manufacturers to apply to be able to be part of the system/platform. Furthermore, the platform/system may facilitate allowing manufacturers to make offer(s), relating to manufacture of a product(s) or part(s) of product(s)/project(s), to the user(s)/creator(s), (or to any party(s) to which such data may be useful and/or relevant). This may come in the form of a quote, or quote per number of units, etc, and may (or may not) include delivery/shipping costs, etc. (Similar to other examples given (eg highest success rate, etc), it is feasible the platform may monitor and/or store and/or display data relating to which manufacturer(s) have made the most money/profit, using the system/platform, (and may know/have stored the exact amount). As already suggested/denoted/stated, such data may be updated on the system/platform. Thus the platform/system may be able to update such data.

In the example of FIG. 80, (or FIG. 79, then), it may be that further (more detailed) information/data, relating to manufacture, is stored and/or viewable. The platform/system may allow for the user/creator to get continued quotes (eg from manufacturer(s) other than the one(s) they are using. Thus they may be able to monitor whether they can get a better deal, and whether it would/might be in their interest to switch manufacturer(s). This could help keep quotes/prices down from the manufacturers.

It is feasible the platform/system may handle money and/or payment transaction(s). It may even pay the user(s)/creator(s) the money they make from the project(s). Thus the platform may receive money made from the or any project, and may pay money to relevant party(s), which could include (and is not limited to: user(s)/creator(s); and providers (eg product development provider(s) and/or patent provider(s) and/or product launch provider(s)/facilitator(s), or any party(s)). (As stated, product launch provider(s)/facilitator(s) may include many different types of parties, (eg crowdfunding (help) providers, investors, dragons, licensee companies (eg companies the project(s)/invention(s)/product(s) is licensed to), infomercial specialist(s) and/or companies, retailer(s), etc, etc, and not limited to these examples.

Thus it is feasible the money (eg a percentage) made by a provider (eg a product development provider) may actually be paid to the provider, via and/or by the platform/system.

The platform/system may monitor and/or store and/or display data relating to how many projects any provider has taken on, (and may monitor and/or store and/or display success rate data, money/profit/sales (and/or other) data, etc, etc). As stated, this may be updated/updatable on/by the system/platform.

The platform/system may monitor and/or store and/or display data relating to total gross or net money made on project(s) by provider(s). Thus they could know the provider that has worked on projects that have made the most money, compared to other providers. For example, one provider may have worked on 36 projects, which together may have generated $59,000,000 profit/sales. Thus the platform may ‘know’ which provider has worked on projects generating, (together), the most money/sales. Such totals may be monitored and/or stored and/or displayed for any provider. The platform may know/store/monitor this data, with reference to different types of provider, (eg for patent providers, and/or product development providers, and/or launch providers/facilitators, etc).

The concept of a ‘success threshold’ has been mentioned. The/a success threshold may be inputted/known on/to the system/platform, and when the funds/sales (data) for the product/project come in, without any need for human inputting, the platform/system/computer/software may see (/be able to see) that the success threshold has been reached. Any of the following may then happen and/or be possible: success rate of provider(s) is/may be updated; an alert(s) is/may be sent out to inform provider(s) and or user(s); information as to how many projects on the platform have successfully attained the success threshold may be updated (and the computer/platform/system preferably also stores how many projects there are, total). This would or may give a total, overall success rate, for example. Any or all of these are possible, and many of these options have already been discussed. It will be apparent that the platform/system may be able to update the or any such data by itself (eg once a (first) piece(s) of data/information has been inputted, for example).

As stated, user's success rate/successes (eg at attaining/reaching a success threshold) may be monitored and/or stored and/or displayed (either to the user(s), and/or to others).

It has been mentioned and explored that providers (of any type) may make an offer(s)/bid(s). It has been explored that, in some situations (or many situations), a provider may make an offer/bid where they quote an amount of money that they charge for their service, for example. However, it should also be stated, it is feasible (eg with a very good project(s)), that a provider may in fact offer to pay the user(s)/creator(s) (rather than be paid), to get/‘win’ a project. (Again, it is feasible such payment may be able to be made via the platform/system. Again, it is feasible an escrow system, (which may be provided by the platform/system), may be provided). Thus, not limited to investors, etc, it is feasible even a product development provider, for example, (or any type of provider), may offer to pay an amount(s) to the user(s)/creator(s), to ‘win’ the project. (And this may be the case even when that includes the provider doing work for the project).

However, it should be noted that, (at least for some part(s) of the process and/or for some types of provider(s), eg product development providers, for example), it may be that it is not allowed for product development providers to offer to pay money to ‘win’ a project. This may be not allowed, to prevent the system being unfairly biased to wealthy/richest and/or most successful providers being able to use this tactic, to have a big advantage in ‘winning’ projects over, say, a provider who does not have enough money to make such an offer. Thus a threshold may be set (eg for part(s) of the process), below which an offer cannot be made. The threshold, for example, may be zero (ie zero pounds/dollars). Thus they may be able to bid to do the project and/or work for free, but not pay money to win the project. The threshold, however, may be any amount, (ie may be any amount above, or below, zero). It should be made clear, there may be parts of the process where bids are made to pay the user(s)/creator(s), (eg investment, licensing, etc, and others). There may then be other parts of the process, (eg product development), where thresholds may be put in place. This may, or may not, be the case.

In some cases, (eg where an agreement has been struck between a licensee and/or investor, for example, (or any other example and/or provider), the provider/facilitator may pay the user, and the payment may be made through/via the platform/system. (eg The platform/system may receive the or any payment, and may relay the or any payment to the user/creator). This data may then be logged and/or stored (and/or relayed and/or displayed). Preferably such data/information is available and viewable on the user's interface and/or account. Such data (or any data) may be saved on the system/platform.

As has been explored, total money made by any provider(s) may be monitored and/or stored and/or displayed on the platform/system.

The embodiments described above are provided by way of examples only, and various modifications will be apparent to persons skilled in the art without departing from the scope of the invention. The appended claims are not intended to limit the invention.

The following disclosure is also herein included in the present application:

There may be provided a platform to facilitate idea or project development, comprising: storing information relating to and/or providing at least one of: product development providers; patent providers; product launch facilitators. (The platform may comprise a database or databases of the at least one of: product development providers: patent providers; product launch facilitators).

The platform may comprise storing information relating to and/or provide all of: product development providers: patent providers; product launch facilitators. (The platform may comprise a database or databases of the product development providers: patent providers; product launch facilitators).

The platform may comprise a system and/or sequence of steps for a user to complete. (It may further comprise: forcing the user to complete the steps in a particular order). (It may comprise: only allowing access to a particular type of provider at a particular step or steps of the system).

The platform may comprise: a trailer video being made of the project of the user. (It may further comprise: requiring the trailer video to be made, for, or before, presentation to at least one product launch facilitator). (It may comprise: delivering the trailer video to a crowdfunding specialist provider, and the crowdfunding specialist provider making a further video or videos of the project, for use in a crowdfunding campaign). (It may comprise: the crowdfunding specialist provider receiving a financial bonus and/or amount and/or percentage, if the crowdfunding campaign and/or launch and/or sales of the project, or a product or products of the project, are successful).

The platform may comprise: a patent provider bidding on a project, in order to provide patent work, help, or services on the project.

The platform may comprise: a patent provider receiving financial bonus and/or amount and/or percentage if they attain patent protection for a project and if the project is financially successful and/or generates a profit for a user/idea creator. (The platform may further comprise: adjudicating whether the patent provider has attained useful or important patent protection for the project). (The platform may comprise: the patent provider receiving a different financial bonus and/or amount and/or percentage, dependent on the adjudication as to the quality of the patent protection that has been attained for the project).

The platform may comprise: a disclosure of a project being made available to a, or a plurality of, product or project development providers; allowing the product or project development providers to decide if they want to provide work for the project; and not allowing the user and project to progress to a further step or steps unless at least one provider decides they want to provide work for the project. (The platform may further comprise: the provider or providers bidding on the project, to express an interest in doing work on or for the project). (The platform may further comprise: the user accepting a bid of a provider.

The following disclosure is also herein included in the present application:

A method of facilitating idea development, comprising: having a database of product development providers; having a database of product launch facilitators; means to upload an idea of an idea creator to the database of product development providers; the idea being developed into a product or products by a product development provider; a presentation video of the product or products being created; means to upload the presentation video to the database of product launch facilitators; means to facilitate linking between a product launch facilitator and the idea creator of the idea, and/or the product launch facilitator providing help and/or a service and/or a part and/or role in launching the product or products and/or the idea creator generating money from the product or products. (There may be provided a bidding system, wherein product development providers can bid in order to get a job of developing an idea). (Previous success rates of the product development providers may be displayed to a creator of the idea with bids that are received). (The product development provider may receive a percentage of profit generated from sales of the product when developed). (The percentage of profit may be received by the product development provider for a limited portion of time).

(The method may comprise a patent service, and the patent service may only be provided if a successful link is made between a product development provider and the idea creator to develop the idea).

(The method may comprise a patent search step and a patent pending step, and the means to upload an idea to the database of product development providers may not be made available to the idea party unless both the patent search step and the patent pending step have been completed by the idea party).

The product development providers may be categorized in terms of field of product ideas to help develop, and the means to upload an idea of an idea party to the database of product development providers may be configured to notify product development providers about ideas uploaded to the database that are in their category(s).

(The method may comprise an idea development system comprising a plurality of steps that must be completed in a certain order, and the idea creator may be anchored at each step, to make sure the development of the idea is completed in a particular order).

(There may be provided to the idea party a means for the idea party to get patent pending before uploading the idea to any database).

(There may be provided a bidding/offer system, wherein product launch parties can bid/make an offer to win the ability to facilitate launching of the product.

(The product launch facilitator may be a company, and the idea creator and the company may enter into a licensing agreement for the product or products to be licensed to the company).

The following disclosure is also herein included in the present application:

A method, comprising; having a platform comprising providers to take up project of users, wherein some or all of the providers provide in at least one of: patenting; product development; launch; monitoring success rates of some or all of the providers in terms of the success rate they have at projects they take up reaching a success threshold; making the success rate available to users.

The following disclosure is also herein included in the present application:

A method, comprising: compiling and/or having a database of users; compiling and/or having a database of providers; relaying a project of one of the users to one provider, or a plurality of the providers; allowing the provider, or the plurality of the providers, to make a bid or offer to take on the project; relaying the bid or offer to the user; allowing the user to accept the bid or offer; monitoring whether the project attains a success threshold; calculating a success rate of projects the provider takes up attaining the success threshold; relaying the success rate to users.

The following disclosure is also herein included in the present application:

A method, comprising: compiling and/or having a database of providers to take up projects of users; compiling and/or having a database of users; monitoring a success rate of a provider at projects they take up attaining a success threshold; relaying a project of a user to a provider, (or a plurality of providers); allowing the provider to make a bid or offer to take up the project; relaying to the user the provider's success rate at projects they take up attaining a success threshold; allowing the user to accept the bid or offer. (The method may further comprise: allowing a provider to take up a project wherein if the project does not attain the success threshold, it does not negatively impact the provider's success rate, or does not negatively impact the provider's success rate as much as normal, and wherein if the project attains the success threshold, it positively affects the provider's success rate).

The method (any of the methods above, or relating to any method(s) disclosed herein) may further comprise: rewarding a provider for an achievement by allowing them to take up a project wherein if the project does not attain the success threshold, it does not negatively impact the provider's success rate, or does not negatively impact the provider's success rate as much as normal, and wherein if the project attains the success threshold, it positively affects the provider's success rate.

The method (any of the methods above, or relating to any method(s) disclosed in the present application) may comprise: allowing a user to use a search function to search for a provider, and relaying the success rate of the or a provider when found using the search function and/or allowing the user to see the success rate of the or a provider.

The method (any of the methods above, or relating to any method(s) disclosed in the present application) may comprise: the project of the user being posted in a computer implemented method and/or the method being a computer implemented method. (The method may further comprise: allowing the user to post the project).

(The method (any of the methods above, or relating to any method(s) disclosed in the present application) may comprise: allowing the bid or offer accepted by the user to be a shared bid or offer, from a plurality of providers).

The method (any of the methods above, or relating to any method(s) disclosed in the present application) may comprise: relaying to the user the amount of projects the provider has taken up that attained a success threshold.

The method (any of the methods above, or relating to any method(s) disclosed in the present application) may comprise: relaying to the user the amount of projects the provider has taken up.

(Any or all steps of the (or any relevant) method may be computer implemented. (In various embodiments, preferably all the steps of the method are computer implemented). (Preferably the method is a computer implemented method)).

The method (any of the methods above, or relating to any method(s) disclosed in the present application) may comprise: providing a system and/or sequence of steps for a user to complete. (The method may further comprise: forcing the user to complete the steps in a particular order).

The method (any of the methods above, or relating to any method(s) disclosed in the present application) may comprise: converting the project of the user into a product. (The method may further comprise: the product being manufactured and/or prototyped).

The method (any of the methods above, or relating to any method(s) disclosed in the present application) may comprise: having different success thresholds for different types of provider and/or for different service provided.

(Any novel subject matter or combination including novel subject matter disclosed herein may be claimed, whether or not within the scope of or relating to the same invention as defined in the claims).

The embodiments described above are provided by way of examples only, and various modifications will be apparent to persons skilled in the art without departing from the scope of the invention. The appended claims are not intended to limit the invention.

Broader and/or Different Invention(s) may be Claimed (and are Supported)

The appended claims define limited inventions. However, it should be recognized and understood that the disclosure of the present application includes a vast array of inventions, not limited to inventions set out in the appended claims and/or any statement(s) of invention.

For example, if the present disclosure of the present application (inclusive of drawing(s) and/or description) discloses features and/or steps a to z, it should be recognized and understood that any invention may be claimed, comprising any feature(s) and/or step(s) out of features and/or steps a to z. Thus if the appended claim 1 defines the invention claimed as comprising essential features/steps a, b, and c, it should be understood that an invention may be claimed comprising solely feature/step a, or solely feature/step b, or solely feature/step c, or any combination of features/steps a, b, and c. Furthermore, it should be understood that an invention may be claimed comprising any of feature(s)/step(s) d to z, whether or not also comprising any of features/steps a, b, or c.

Furthermore, no feature/step disclosed is limited to only being set forth in a claim when used in conjunction with other particular feature(s)/step(s) it is disclosed with in the specification, but may be claimed with any other feature/step or combination of features/steps disclosed in the present application. Thus if a feature/step is disclosed ‘clustered’ with several other feature(s)/step(s) when disclosed in the specification, the applicant(s) nevertheless reserves the right to ‘extract’ that feature(s)/step(s) from the several other feature(s)/step(s) it is disclosed with, and set it forth in a claim, combined with any other feature(s)/step(s) disclosed in the present application, which other feature(s)/step(s) may, or may not, also be ‘extracted’ from any other feature(s)/step(s) they are clustered with in the disclosure of the present application. Thus any permutation/combination of features/steps may be claimed for patent in a future claim and/or patent application.

A final claim is appended which serves to signify that I reserve the right to claim any invention, comprising any feature/step, or combination of features/steps, disclosed in the present application (inclusive of drawing(s) and/or description). This statement (and/or final appended claim), if so desired, should be seen as a statement of invention, stating any invention (ie ‘thing’), comprising any feature(s)/step(s) disclosed in the present application (in any permutation/combination). It is intended (or plausible) that such invention(s) may be claimed in a future application(s) which claims benefit of priority of the present application. The present disclosure of the present application supports such invention(s)/claim(s). The applicant(s) reserves the right to claim any (such) invention (ie ‘thing’), and considers an objection by a patent office/examiner (stating that such an invention is not supported by/disclosed in the present application) to be in direct conflict with this statement of invention. Thank you to the relevant patent office/examiner for taking note of this. It is intended (or plausible) that such invention(s) may be claimed in a future application(s) which claims benefit of priority of the present application, or, for example, in future filed claims of the present application. The present disclosure of the present application supports such invention(s)/claim(s).

The Title of the Present Application Does Not Limit what may be Claimed

The title of the present application (and the claims presented) do not limit what may be claimed futurely, based upon (and supported by) the present application. For example, if the title is ‘Pet Cleaning Apparatus’, even if all disclosure in the patent application relates to a pet cleaning apparatus (as do the claims), nevertheless, a ‘cleaning apparatus’ may be claimed (not limited to being for pets), as it is clear a ‘pet cleaning apparatus’ is an embodiment of a ‘cleaning apparatus’. In the present application, adjectival/adverbial definition of a noun/verb in no way limits the ability to claim the noun/verb (and/or an invention comprising the noun/verb), without the adjective/adverb. This also applies to the title. Furthermore, an invention may be claimed comprising any feature/step, or combination of features/steps, disclosed in the present application.

Feature(s) Shown in the Drawings may be Combined to Form an Invention

Any feature(s)/step(s) or combination of feature(s)/step(s) shown in any drawing(s) may be combined with any other feature(s)/step(s) or combination of feature(s)/step(s) shown in any other drawing(s), to form an invention, which may be claimed. This may be the case for any embodiment shown in any drawing(s), and applicant(s) reserves the right to claim any such invention(s). Furthermore, such feature(s)/step(s) may, of course, be combined with any other feature(s)/step(s) and/or disclosure of the present application, to form an invention(s), which may be claimed. Such an invention(s) may be claimed in a future application(s) which claims benefit of priority of the present application, or, for example, in future filed claims of the present application. The present disclosure of the present application supports such invention(s)/claim(s).

1. A method, comprising;
having a platform comprising providers to take up a project of a user, wherein some or all of the providers provide in at least one of the following fields:
patenting;
product development;
launch;
monitoring success rates of some or all of the providers in terms of the success rate they have at projects they take up reaching a success threshold;
making the success rate available to users.

2. A method, comprising:
compiling and/or having a database of users;
compiling and/or having a database of providers;
relaying a project of one of the users to one provider, or a plurality of the providers;
allowing the provider, or the plurality of the providers, to make a bid or offer to take on the project;
relaying the bid or offer to the user;
allowing the user to accept the bid or offer;
monitoring whether the project attains a success threshold;
calculating a success rate of projects the provider takes up attaining the success threshold;
relaying the success rate to users.

3. A method, comprising:
compiling and/or having a database of providers to take up projects of users;
compiling and/or having a database of users;
monitoring a success rate of a provider at projects they take up attaining a success threshold;
relaying a project of a user to a provider, (or a plurality of providers);
allowing the provider to make a bid or offer to take up the project;
relaying to the user the provider's success rate at projects they take up attaining a success threshold;
allowing the user to accept the bid or offer.

4. A method as claimed in claim 1, further comprising:
allowing a provider to take up a project wherein if the project does not attain the success threshold, it does not negatively impact the provider's success rate, or does not negatively impact the provider's success rate as much as normal, and wherein if the project attains the success threshold, it positively affects the provider's success rate.

5. A method as claimed in claim 1, further comprising:
rewarding a provider for an achievement by allowing them to take up a project wherein if the project does not attain the success threshold, it does not negatively impact the provider's success rate, or does not negatively impact the provider's success rate as much as normal, and wherein if the project attains the success threshold, it positively affects the provider's success rate.

6. A method as claimed in claim 1, wherein the method further comprises:
allowing a user to use a search function to search for a provider, and relaying the success rate of the or a provider when found using the search function and/or allowing the user to see the success rate of the or a provider.

7. A method as claimed in claim 1, further comprising:
the project of the user being posted in a computer implemented method and/or the method being a computer implemented method.

8. A method as claimed in claim 7, further comprising:
allowing the user to post the project.

9. A method as claimed in claim 2, further comprising:
allowing the bid or offer accepted by the user to be a shared bid or offer, from a plurality of providers.

10. A method as claimed in claim 1, further comprising:
relaying to the user the amount of projects the provider has taken up that attained a success threshold.

11. A method as claimed in claim 1, further comprising:
relaying to the user the amount of projects the provider has taken up.

12. A method as claimed in claim 1, wherein the method is a computer implemented method.

13. A method as claimed in claim 1, further comprising:
providing a system and/or sequence of steps for a user to complete.

14. A method as claimed in claim 13, further comprising:
forcing the user to complete the steps in a particular order.

15. A method as claimed in claim 1, further comprising:
converting the project of the user into a product.

16. A method as claimed in claim 15, further comprising:
the product being manufactured and/or prototyped.

17. A method as claimed in claim 1, further comprising:
having different success thresholds for different types of provider and/or for different service provided.

18. A method as claimed in claim 2, wherein the database of users and the database of providers are the same database.

19. A method as claimed in claim 2, wherein the database of users and the database of providers are different databases.

20. A method as claimed in claim 3, wherein the database of users and the database of providers are the same database.
